(19) United States
(12) Patent Application Publication
(10) Pub. No.: US 2002/0174082 A1
(43) Pub. Date: Nov. 21, 2002

(54) Reusable parts for assembled software systems

(75) Inventors: Vladimir I. Miloushev, Laguna Niguel, CA (US); Peter A. Nickolov, Irvine, CA (US); Becky Hester, Irvine, CA (US); Leonid Kalev, Laguna Hills, CA (US); Borislav Marinov, Costa Mesa, CA (US)

Correspondence Address: PILLSBURY WINTHROP, LLP, P.O. BOX 10500, MCLEAN, VA, 22102, US

(73) Assignee: Z-Force Corp.

(21) Appl. No.: 09/964,257

(22) Filed: Sep. 26, 2001

Related U.S. Application Data
(60) Provisional application No. 60/235,463, filed on Sep. 26, 2000.

(51) Int. Cl. G06F 17/00; G06N 5/02

(52) U.S. Cl. 706/47

(57) ABSTRACT

The present invention provides a system of reusable parts for assembled software systems. the invention describes certain parts that provide advantageous features, including event source parts, distributor parts, concurrency parts, property parts, event manipulation parts, data manipulation parts, hardware access parts, system configuration parts, debugging and instrumentation parts, dynamic structure parts, and test framework parts.

### BACKGROUND OF THE INVENTION

This application claims priority from U.S. Provisional Patent Application No. 60/235,463, entitled REUSABLE PARTS FOR ASSEMBLED SOFTWARE SYSTEMS, filed Sep. 26, 2000, the disclosure of which is herein incorporated by reference.

1. Field of the invention

The present invention relates generally to the field of object-oriented software engineering, and more specifically to reusable parts for assembled software systems.

2. Description of the related art

Over the last twenty years, the object paradigm, including object-oriented analysis, design, programming and testing, has become the predominant paradigm for building software systems. A wide variety of methods, tools and techniques have been developed to support various aspects of object-oriented software construction, from formal methods for analysis and design, through a number of object-oriented languages, component object models and object-oriented databases, to a number of CASE systems and other tools that aim to automate one or more aspects of the development process.

With the maturation of the object paradigm, the focus has shifted from methods for programming objects as abstract data types to methods for designing and building systems of interacting objects. As a result, methods and means for expressing and building structures of objects have become increasingly important. Object composition has emerged and is rapidly gaining acceptance as a general and efficient way to express structural relationships between objects. New analysis and design methods based on object composition have developed and most older methods have been extended to accommodate composition.

### Composition Methods

The focus of object composition is to provide methods, tools and systems that make it easy to create new objects by combining already existing objects.

An excellent background explanation of analysis and design methodology based on object composition is contained in Real-time Object-Oriented Modeling (ROOM) by Bran Selic et al., John Wiley & Sons, New York, in which Selic describes a method and a system for building certain specialized types of software systems using object composition.

Another method for object composition is described in HOOD: Hierarchical Object-Oriented Design-Oriented Design by Peter J. Robinson, Prentice-Hall, Hertfordshire, UK, 1992, and “Creating Architectures with Building Blocks” by Frank J. van der Linden and Jurgen K. Müller, IEEE Software, 12:6, November 1995, pp. 51-60.

Another method of building software components and systems by composition is described in a commonly assigned international patent application entitled “Apparatus, System and Method for Designing and Constructing Software Components and Systems as Assemblies of Independent Parts”, serial number PCT/US96/19675, filed Dec. 13, 1996 and published Jun. 26, 1997, which is incorporated herein by reference and referred to herein throughout as the “'675 application.”

Yet another method that unifies many pre-existing methods for design and analysis of object-oriented systems and has specific provisions for object composition is described in the OMG Unified Modeling Language Specification, version 1.3, June 1999, led by the Object Management Group, Inc., 492 Old Connecticut Path, Framingham, MA 01701.

### Composition-based Development

Composition—building new objects out of existing objects—is the natural way in which most technical systems are made. For example, mechanical systems are built by assembling together various mechanical parts and electronic systems are built by assembling and connecting chips on printed circuit boards. But today, despite its many benefits, the use of composition to build software systems is quite limited, because supporting software design by composition has proven to be extremely difficult. Instead, inferior approaches to composition, which were limited and often hard-to-use, were taken because they were easier to support. Approaches such as single and multiple inheritance, aggregation, etc., have been widely used, resulting in fragile base classes, lack of reusability, overwhelming complexity, high rate of defects and failures.

Early composition-based systems include HOOD (see earlier reference), ObjecTime Developer by ObjecTime Limited (acquired by Rational Software Corp.), Parts Workbench by Digitalk, and Parts for Java by ObjectShare, Inc. (acquired by Starbase Corp.). Each of these systems was targeted to solve a small subset of problems. None of them provided a solution applicable to a broad range of software application types without impeding severely their performance. Specifically, use of these systems was primarily in (a) graphical user interfaces for database applications and (b) high-end telecommunication equipment.

One system that supports composition for a broad range of applications without performance impediments is the system described in the commonly assigned '675 application, with which it is possible to create new, custom functionality entirely by composition and without new program code. This system was commercialized in several products, including ClassMagic and DriverMagic, and has been used to create a variety of software components and applications ranging from graphical user interface property sheets, through Microsoft COM components, to various communications and device drivers.

Since 1996, other composition approaches have been attempted in research projects such as Espresso SCEDE by Faison Computing, Inc., and in commercial products such as Parts for Java by ParcPlace-Digitalk (later ObjectShare, Inc.), and Rational Rose RealTime by Rational Software Corp. None of these has been widely accepted or proven to be able to create commercial systems in a broad range of application areas. The only system known to the inventors that allows effective practicing of object composition in a wide area of commercial applications is the system described in the '675 application. The system and method described in the '675 application and its commercial and other implementations are referred to hereinafter as the “'675 system.”

### Dynamically Changing Sets of Objects

Despite the apparent superiority of the system described in the '675 application, it, like all other composition-based systems described above failed to address adequately the important case in which part of the composed structure of objects needs to change dynamically, in response to some stimulus.

Except in trivial cases, most working, commercially viable software components and applications require at least one element that requires dynamic changes. Examples include the ability to dynamically create and destroy a number of sub-windows in a given window of a graphical user interface, and the ability to dynamically create and destroy a connection object in a communications protocol stack when a connection is established and dropped.

Although most of the above-described composition-based systems do have the ability to modify structure dynamically, they do this through some amount of custom code and a violation of the composition view of the software system being built—in both cases essentially undermining the composition approach and at least partially sacrificing its advantages.

In fact, one of the most common objections to the composition-based software design approach is that the structure of software applications is generally dynamic and changes all the time, and so the ability to compose statically new components is of very limited use. Furthermore, the implementation of the functionality required to handle dynamic structures is quite complex, requires high professional qualifications and is frequently a source of hard-to-find software defects. As a result, the systematic and effective practice of software design and development by composition is seriously limited whenever the underlying system does not provide a consistent, efficient, universal and easy-to-use support for dynamically changeable structures of objects.

### Reusable Objects

Even if support for static composition and dynamic structures of objects is available, the use of composition is still difficult without a significant number of readily available and easily reusable objects from which new functionality can be composed.

Without such a library of reusable objects the composition systems mentioned above including the system described in the '675 application is useful primarily for decomposing systems and applications during design, and in fact, all these systems have been used mostly in this way. With decomposition, the system designer uses a composition-based system to express the required functionality in terms of subsystems and large-scale (thousands of lines of code) components, from which those systems are to be composed. This approach inevitably leads to defining subsystems and components in a way that makes them quite specific to the particular application. Individual components defined in such custom way then have to be custom implemented, which is typically achieved by either writing manually or generating unique code that expresses the specific functionality of the component being developed.

Because of this absence of a substantial set of reusable component objects from which new functionality can be easily composed, composition-based systems are essentially used in only two capacities: (a) as design automation aids, and (b) as integration tools or environments, with which individual components and subsystems designed for composition but developed in the traditional way can be put together quickly.

In order to practice composition to the full extent implied by the very name of this method and in a way that is similar to the way composition is used in all other technical disciplines, there is a need for a set of well-defined, readily available and easily reusable components, which is sufficiently robust to implement new and unanticipated application functionality, so that most, if not all of this new functionality can be built by composing these preexisting objects into new, application-specific structures.

The issue of software reusability has been addressed extensively over the last thirty years by a wide variety of approaches, technologies, and products. While the complete set of attempted approaches is virtually impossible to determine, most people skilled in the art to which this invention pertains will recognize the following few forms as the only ones which have survived the trial of practice. These include function libraries, object-oriented application frameworks and template libraries, and finally, reusable components used in conjunction with component object models like Microsoft COM, CORBA and Java Beans.

Function libraries have been extremely successful in providing reusable functionality related to algorithms, computational problems and utility functions, such as string manipulation, image processing, and similar to them. However, attempts to use function libraries to package reusable functionality that has to maintain a significant state between library calls, or that needs to use a substantial number of application-specific services in order to function, typically lead to exploding complexity of the library interface and increased difficulties of use, as well as application-dependent implementations. An excellent example of the inadequacy of the functional library approach to reusable functionality can be found in Microsoft Windows 98 Driver Development Kit, in particular, in libraries related to kernel streaming and USB driver support. These libraries, which provide less than half of the required functionality of both kernel streaming and USB drivers, do so at the expense of defining hundreds of API calls, most of which are required in order to utilize the reusable functionality offered by the library. As a result, attempts to actually use these libraries require very substantial expertise, and produce code that is unnecessarily complex, very difficult to debug, and almost impossible to separate from the library being used.

Application-specific object-oriented frameworks proliferated during the early to mid-nineties in an attempt to provide a solution to the exploding complexity of GUI-based applications in desktop operating systems like Microsoft Windows and Mac OS. These frameworks provide substantial support for functionality that is common among typical windows-based applications, such as menus, dialog boxes, status bars, common user interface controls, etc. They were, in fact, quite successful in lowering the entry barrier to building such applications and migrating a lot of useful functionality from DOS to Windows. Further use, however, showed that application-specific frameworks tend to be very inflexible when it comes to the architecture of the application and make it exceedingly difficult to build both new types of applications and applications that are substantially more complex than what was envisioned by the framework designers. It is not accidental that during the peak time of object-oriented framework acceptance, the major new Windows application that emerged—Visio from Shapeware, Inc., (now Microsoft Visio), was built entirely without the use of such frameworks.

Component object models, such as Microsoft COM and ActiveX, Java Beans and, to a lesser extent, CORBA, were intended to provide a substantially higher degree of reusability. These technologies provide the ability to develop binary components that can be shipped and used successfully without the need to know their internal implementations. Components defined in this way typically implement input interfaces, have some kind of a property mechanism and provide rudimentary mechanisms for binding outgoing interfaces, such as COM connectable objects and the Java event delegation model.

And, indeed, component object models are considerably more successful in providing foundations for software reuse. Today, hundreds of components are available from tens of different companies and can be used by millions of developers fairly easily.

Nevertheless, these component object technologies suffer from a fundamental flaw which limits drastically their usability. The cost at which these technologies provide support for component boundaries, including incoming and outgoing interfaces and properties, is so high (in terms of both run-time overhead and development complexity) that what ends up being packaged or implemented as a component is most often a whole application subsystem consisting of tens of thousands of lines of code.

This kind of components can be reused very successfully in similar applications which need all or most of the functionality that these components provide. Such components are, however, very hard to reuse in new types of applications, new operating environments, or when the functionality that needs to be implemented is not anticipated by the component designer. The main reason for their limited reusability comes from the very fact that component boundaries are expensive and, therefore, developers are forced to use them sparingly. This results in components that combine many different functions, which are related to each other only in the context of a specific class of applications.

As we have seen above, the type of reuse promoted by most non-trivial functional libraries and practically all application frameworks and existing component object models makes it relatively easy to implement variations of existing types of applications but makes it exceedingly difficult and expensive to innovate in both creating new types of applications, moving to new hardware and operating environments, such as high-speed routers and other intelligent Internet equipment, and even to add new types of capabilities to existing applications.

What is needed is a reuse paradigm that focuses on reusability in new and often unanticipated circumstances, allowing software designers to innovate and move to new markets without the tremendous expense of building software from scratch. The system described in the '675 application provides a component object model that implements component boundaries, including incoming and outgoing interfaces and property mechanisms, in a way that can be supported at negligible development cost and runtime overhead. This fact, combined with the ability to compose easily structures of interconnected objects, and build new objects that are assembled entirely from pre-existing ones, creates the necessary foundations for this type of reuse paradigm. Moreover, the '675 system, as well as most components built in conjunction with it, are easily portable to new operating systems, execution environments and hardware architectures.

### Properties

One of the acknowledged goals of object-oriented design and programming is reusability—once an object class is implemented and made to work, it can be used in various circumstances, including ones for which the object has not been specifically designed. To facilitate reusability, certain attributes of the object are designed to be modifiable. Such modifiable attributes allow each object instance to be specialized, within limits, to fit its particular application. For example, a button object in a graphical user interface object library typically can be specialized with the button's position on the screen (x and y origins), size (width and height), label (text), etc. The process of specializing an object by setting its modifiable attributes is called parameterization.

In C++ and most object-oriented programming languages, such attributes can be specified when invoking the object's constructor, as arguments of the constructor; also, they can be provided as public members of the object class, visible and modifiable from outside the object instance. Both of these parameterization mechanisms require a strong level of binding, which, while consistent with the object-oriented design principles, limits the reusability of the code that creates the objects.

Component object models improve on the parameterization mechanism. Most component models provide a property mechanism, through which the object attributes can be modified without requiring (albeit not preventing) tight binding. Some component object systems have generic descriptors that allow the code that creates and specializes the newly object instances to be independent of the class of the created instances. For example, controls in Microsoft Visual Basic are parameterized by general purpose code using descriptors that contain the names and values of the properties to be set after the object is created.

It is the responsibility of each object class to implement the property mechanism so that the object's properties will be accessible. The implementation of the property mechanism usually requires significant amount of code, proportional to the number of properties of the class. Some component object systems provide assistance to the component writers: from tools that generate code (Microsoft Foundation Classes), base classes or libraries (Microsoft OLE Control Developer's Kit), to built-in support (the system described in the '675 application).

All these systems fail to provide support for class-independent handling of properties in the following cases:

There is no adequate support for properties of composite objects. While the '675 system provides the basic support—property redirection, group and broadcast properties—the designer of the composite object may be restricted to the types and set of properties that the subordinate objects provide.

There is no adequate support for manipulating properties of objects at runtime in a class-independent manner.

There is no adequate support for manipulating the properties of dynamically created instances in a class-independent manner.

All these limitations limit the utility of the property mechanisms to the most basic of cases. The lack of advanced support frequently leads designers to reduce the reusability of components, to implement custom components instead of using existing ones, or to violate the property mechanism defined by the object model. This is especially disruptive in object composition systems, where the reusability is otherwise extremely high.

A set of reusable components is needed to provide representation of arbitrary sets of properties without need to write or generate code, and to provide frequently used mechanisms for manipulating properties.

### Part Libraries in Composition-based Systems

Each generation of software technologies provides certain means of achieving reusability. Once these means are defined, a library of general-purpose reusable software entities based on these means is developed and becomes widely used. Structured programming brought, for example, the FORTRAN mathematical libraries (still used to this day) and the standard C libraries. Object-oriented programming brought us standard Java class libraries and the C++ template library (the latter is excellently described in the book “The C++ Standard Template Library”, by P. J. Plauger, et. al., published by Prentice Hall, 2000).

Component-based systems are the next generation software technology following object-oriented systems. Among other advantages, they bring a higher level of reusability. While most early component systems have delivered relatively successful application-specific libraries, especially in graphical user interface and database access, they have failed to address the general-purpose libraries of components. Many of the shortcomings of those early systems are responsible for that; for example, the high cost of component boundaries forces developers into building components that combine many different functions which are related to each other only in the context of specific class of applications.

Composition-based component systems, such as the '675 system, provide the ability to have general-purpose component libraries. However, neither the function libraries nor the object libraries contain good candidates for general-purpose reusable components. There is a need to define a comprehensive set of such components so that frequently needed application behaviors can be composed using mostly, if not entirely, those components.

Such library components are parts described in U.S. patent application Ser. No. 09/640,898, entitled SYSTEM OF REUSABLE SOFTWARE PARTS AND METHODS OF USE, filed Aug. 16, 2000, and in PCT Patent Application Serial No. US00/22630, entitled SYSTEM OF REUSABLE SOFTWARE PARTS FOR IMPLEMENTING CONCURRENCY AND HARDWARE ACCESS, AND METHODS OF USE, the disclosures of which are herein incorporated by reference.

### SUMMARY OF THE INVENTION

### Advantages of the Invention

As described herein, the present invention has many advantages over the previous prior art systems. The following list of advantages is provided for purposes of illustration, and is not meant to limit the scope of the present invention, or imply that each and every possible embodiment of the present invention (as claimed) necessarily contains each advantageous feature.

1. The present invention provides a system of reusable and composable objects that manipulate individual aspects of event and data processing, so that components and systems performing complex processing can be assembled by interconnecting these objects.

2. The present invention provides a reusable object that has arbitrary set of properties that can be modified after the object is instantiated. The object provides two independent but complementary mechanisms for accessing the properties, making it possible for designers to utilize the appropriate mechanism.

3. The present invention provides a reusable object that when used as a subordinate object in an assembly, can hold a set of properties of the assembly that no other subordinate has, allowing that set to be arbitrarily defined by the assembly designer.

4. The present invention provides reusable container objects for holding data items. The set of data items held can be defined either by a designer at design time or may be defined at runtime.

5. The present invention provides a reusable object for transferring properties or data items from one object to another.

6. The present invention provides a system of reusable objects that convert variously encoded data fields to and from the native machine format. These objects allow separation of the data encoding from the processing of data, allowing usage of the same data processing objects with variously encoded data, including data received or to be sent to network or other systems.

7. The present invention provides a system of reusable objects that provide the capability of assemblies to keep assembly-specific instance data and store, retrieve and otherwise manipulate that instance data, based on data and events that pass through these parts.

8. The present invention provides a system of reusable objects for copying fields from data passing through these objects to and from instance data kept by the objects.

9. The present invention provides a system of reusable objects for manipulating data in events passing through these objects.

10. The present invention provides a reusable object for distributing and generating events based on the count of events received by that object.

11. The present invention provides reusable objects that facilitate the life cycle—creation, parameterization, serialization and destruction—of dynamically created components.

12. The present invention provides a reusable object for generating a predetermined event upon receiving an event.

To address the shortcomings of the background art, the present invention therefore provides:

In software system including a standard mechanism for accessing properties, the standard mechanism including:

a first operation for obtaining a property identifier;

a second operation for obtaining a property value; and

a third operation for setting the property value,

an object comprising:

a property, the property comprising a property identifier and a property value;

an implementation of the first operation;

an implementation of the second operation; and

an implementation of the third operation, the implementation of the third operation setting both the property identifier and the property value if the third operation is executed for a first time, and changing the property value to a specified new property value if the third operation was previously executed.

The property of this object may also further comprise a property type.

The present invention alternately may be practiced with a software system including a standard mechanism for accessing properties of objects, the standard mechanism including:

a first operation for enumerating property identifiers;

a second operation for obtaining a property value of a property identified by a property identifier; and

a third operation for setting the property value of a property identified by a property identifier,

an object comprising:

a table containing a plurality of entries, each entry comprising a property identifier and a property value;

an implementation of the first operation, the implementation of the first operation retrieving a first property identifier of a first property from one of the entries in the table;

an implementation of the second operation, the implementation of the second operation obtaining the property value from the one entry;

an implementation of the third operation, the implementation of the third operation setting a property value in the one entry if a value for the first property has been previously set, the implementation of the third operation setting a property identifier and a property value in the one entry in the table if a value for the first property has not been set.

The property of this object may also further comprise a property type or a terminal through which properties are accessed and their values from the first table.

The present invention alternately may be practiced with a copier object in a software system, the copier object comprising:

a first terminal through which the copier object requests enumeration of property identifiers;

a second terminal through which the copier object requests obtaining property values;

a third terminal through which the copier object requests setting property values;

a fourth terminal through which the copier object request receipt of a trigger signal, and

upon receipt of the trigger signal the copier object obtains a first property name identifier through the first terminal, through which the copier object requests obtaining a first property value using the first property identifier through the second terminal, and through which the copier object requests setting the first property value using the first property identifier through the third terminal.

The present invention alternately may be practiced with system of objects in a software system having a data memory, the system comprising:

an extractor object for extracting first encoded values from the data memory and storing them in the data memory in native machine format;

a stamper object for storing second encoded values into the data memory, the second encoded values obtained from the data memory in native machine format.

In such a system, the data memory can be an event object.

The present invention alternately may be practiced with a system of objects in a software system, the system comprising:

a container object for storing a plurality of data values;

an extractor object for extracting encoded data from data memory and storing the encoded data in the container object;

a stamper object for obtaining the plurality of data values from the container object and storing them as encoded data in the data memory.

Such a system may further comprise a comparator object for comparing a first data value of encoded data from the data memory to a second data value from the container object and sending a reference to the data memory to a first terminal if the first value is less than the second value, to a second terminal if the first value is equal to the second value, and to a third terminal if the first value is greater than the second value.

In such a system, the data memory can be an event object.

Such a system may further comprise an arithmetic-logic-unit object for performing arithmetic operations on data values in the container object.

The present invention alternately may be practiced with a method in a composition-based software system for transferring data values in event objects, the method comprising the steps of:

extracting a first value from a first event object;

storing the first value into a container object;

loading the first value from the container object;

storing the first value into a second event object.

Such a method may further comprise the step of modifying the first value in the container object, and in such a system the first event object and the second event object can be the same event object.

The present invention alternately may be practiced with a method in a composition-based software system for manipulating encoded data values in event objects, the method comprising the steps of:

extracting a first value from a first data field of a first event object;

decoding the first value into a normalized form;

storing the first value into a second data field of the first event object;

performing an operation that modifies the first value in the second data field, resulting in a second value being stored in the second data field;

loading the second value from the second data field;

storing the second value into the first data field.

The present invention alternately may be practiced with a system of interconnected objects in a software system, the system comprising:

an extractor object for extracting a first value from a first data field in a first event object and storing it into a second data field in the first event object;

a modifier object for modifying the second data field;

a stamper object for loading a second value from the second data field and storing it into a third data field in the first event object.

The present invention alternately may be practiced with an object in a software system, the object comprising:

a first terminal through which the object receives a source event;

a first offset property specifying starting offset in the source event;

a size property specifying size in the source event;

a second offset property specifying starting offset for merging;

a reference to a data memory for storing a data portion from the source event, starting from offset specified by the offset property and of size specified by the size property;

a second terminal through which the object receives a merge event;

a third terminal through which the object sends the merge event, the merge event modified by storing the data portion into the merge event at offset specified by the second offset property.

In such an object the first terminal and the second terminal can be the same terminal.

The present invention alternately may be practiced with an object in a software system, the object comprising:

an input terminal through which the object receives an input event;

a first output terminal through which the object sends an event containing a first portion of the input event;

a second output terminal through which the object sends an event containing a second portion of the input event;

a first property specifying the size of the first portion.

The present invention alternately may be practiced with n object in a software system, the object comprising:

a first input terminal through which the object receives a latch event;

a second input terminal through which the object receives a trigger event;

a field for storing a reference to the latch event when received on the first input terminal;

an output terminal through which the object sends the latch event when the trigger event is received through the second input terminal.

The present invention alternately may be practiced with n object in a software system, the object comprising:

an input terminal through which the object receives a first input signal;

an output terminal through which the object sends the first input signal;

a factory terminal through which the object requests the creation a new object instance when the object receives the first input signal;

a property terminal through which the object requests the setting of properties on the new object instance.

Such an object may further comprise a parameterization terminal through which the object sends a parameterization signal so that an external object can parameterize the new object instance.

The present invention alternately may be practiced with a system of interconnected objects in a software system, the system of interconnected objects comprising:

a factory object for receiving creation and destruction events;

a dynamic container object for containing objects created by the factory object.

The present invention alternately may be practiced with an object in a software system, the object comprising:

an input terminal through which the object receives events;

a property specifying a target number of events;

a field for maintaining a count of events received through the input terminal;

a first output terminal through which the object sends events received through the input terminal when the count of events reaches the target number.

Such an object may further comprise a reset terminal through which the object receives a request to reset the count to zero, or may further comprise a second output terminal through which the object sends events received through the input terminal when the count of events is under the target number.

### BRIEF DESCRIPTION OF THE DRAWINGS

The aforementioned features and advantages of the invention as well as additional features and advantages thereof will be more clearly understood hereinafter as a result of a detailed description of a preferred embodiment of the invention when taken in conjunction with the following drawings in which:

FIG. 1 illustrates the boundary of part, Timer Event Source (EVT and EVT2)

FIG. 2 illustrates the boundary of part, Event Source Adapter (EVSADP)

FIG. 3 illustrates the boundary of part, Event Generator (EGEN)

FIG. 4 illustrates the boundary of part, Synchronous Event Sequencer (SSEQ)

FIG. 5 illustrates the boundary of part, Switch On A Boolean Data Item (SWB)

FIG. 6 illustrates the boundary of part, Event-Controlled Switch (SWE)

FIG. 7 illustrates the boundary of part, Bi-directional Event-Controlled Switch (SWEB)

FIG. 8 illustrates the boundary of part, Selective Asynchronous Completer (ACTS)

FIG. 9 illustrates the boundary of part, Property Holder (PHLD)

FIG. 10 illustrates the boundary of part, PRCCONST part

FIG. 11 illustrates an advantageous use of part, PRCCONST

FIG. 12 illustrates the boundary of part, Event Field Stamper (EFS)

FIG. 13 illustrates the boundary of part, Event Field Extractor (EFX)

FIG. 14 illustrates the boundary of part, Event Recoder (ERC)

FIG. 15 illustrates the boundary of part, Bi-directional Event Recoder (ERCB)

FIG. 16 illustrates the boundary of part, Fast Data Container (FDC)

FIG. 17 illustrates Cascading FDC

FIG. 18 illustrates the boundary of part, Arithmetic/Logic Unit (ALU)

FIG. 19 illustrates the boundary of part, Data Concatenator (CAT)

FIG. 20 illustrates the boundary of part, Integer Constant Stamper (ICS)

FIG. 21 illustrates the boundary of part, Integer Transmogrifier (ITM)

FIG. 22 illustrates the boundary of part, Status Code Stamper (SCS)

FIG. 23 illustrates an advantageous use of part, SCS

FIG. 24 illustrates the boundary of part, Status Code Extractor (SCX)

FIG. 25 illustrates an advantageous use of part, SCX

FIG. 26 illustrates the boundary of part, Integral Data Field Comparator (IDFC)

FIG. 27 illustrates the boundary of part, Integral Data Field Stamper (IDFS)

FIG. 28 illustrates the boundary of part, Integral Data Field Extractor (IDFX)

FIG. 29 illustrates the boundary of part, Universal Data Field Comparator (UDFC)

FIG. 30 illustrates the boundary of part, Universal Data Field Stamper (UDFS)

FIG. 31 illustrates the boundary of part, Universal Data Field Extractor (UDFX)

FIG. 32 illustrates the boundary of part, I_DAT to I_PROP Converter (DPC)

FIG. 33: Use of DPC with Property Exposer (PEX)

FIG. 34: Use of DPC at end of cascaded Fast Data Containers (FDC)

FIG. 35 illustrates the boundary of part, SYSIRQ part

FIG. 36 illustrates the boundary of part, SYS_EVPRM part

FIG. 37 illustrates the boundary of part, Log File Output (SYS_LOG)

FIG. 38 illustrates the boundary of part, Event to asynchronous request converter (UTL_E2AR)

FIG. 39 illustrates the boundary of part, Property Copier part (UTL_PCOPY)

FIG. 40 illustrates an advantageous use of part, UTL_PCOPY

FIG. 41 illustrates the boundary of part, Property Query Processor (UTL_PRPQRY)

FIG. 42 illustrates an advantageous use of part, UTL_PRPQRY

FIG. 43 illustrates the boundary of part, UTL_PRCBA part

FIG. 44 illustrates an advantageous use of part, UTL_PRCBA

FIG. 45 illustrates the boundary of part, Virtual Property Container Extender (UTL_VPCEXT)

FIG. 46 illustrates Chaining Multiple Virtual Property Container Extenders

FIG. 47 illustrates the boundary of part, Return Status to Event Status Converter (UTL_ST2ES)

FIG. 48 illustrates the boundary of part, Error Detection Coder and Verifier (UTL_EDC)

FIG. 49 illustrates the boundary of part, Event Data Latch (UTL_EDLAT)

FIG. 50 illustrates the boundary of part, Event Data Merger (UTL_EDMRG)

FIG. 51 illustrates an advantageous use of part, UTL_EDMRG

FIG. 52 illustrates the boundary of part, Event Data Splitter (UTL_EDSPL)

FIG. 53 illustrates the boundary of part, Event Counter (UTL_ECNT)

FIG. 54 illustrates the boundary of part, Life-Cycle Sequencer (APP_LFS)

FIG. 55 illustrates the boundary of part, Instance Enumerator on Property Container (APP_ENUM)

FIG. 56 illustrates Dynamic Creation and Destruction of a part Instance based on instance enumeration by property container

FIG. 57 illustrates the boundary of part, APP_FAC part

FIG. 58 illustrates instance creation by a factory upon receiving of a creation request

FIG. 59 illustrates the boundary of part, APP_LFCCTL

FIG. 60 illustrates an advantageous use of part, APP_LFCCTL

FIG. 61 illustrates an advantageous use of part, APP_LFCCTL

FIG. 62 illustrates the boundary of part APP_CFGM

FIG. 63 illustrates an advantageous use of part, APP_CFGM

FIG. 64 illustrates the boundary of part, APP_PARAM

FIG. 65 illustrates Property Parameterization and Serialization

FIG. 66 illustrates the boundary of part, APP_BAFILE part

FIG. 67 illustrates the boundary of part, APP_EFD

FIG. 68 illustrates an advantageous use of part, APP_EFD

FIG. 69 illustrates an advantageous use of part, APP_EFD

FIG. 70 illustrates the boundary of part, Event Hex Dump (APP_HEX)

FIG. 71 illustrates an advantageous use of part, A-PP_HEX

FIG. 72 illustrates an advantageous use of part, APP_HEX

FIG. 73 illustrates the boundary of part, Exception Formatter (APP_EXCF)

FIG. 74 illustrates the boundary of part, Exception Generator (APP_EXCG)

FIG. 75 illustrates the boundary of part, Exception Generator on Status (APP_EXCGS)

FIG. 76 illustrates the boundary of part, TST_DCC Component

FIG. 77 illustrates the boundary of part, TST_DTA—Dynamic Test Adapter

FIG. 78 illustrates the boundary of part, TST_DTAM—Dynamic Test Adapter for Multiple Tests

FIG. 79 illustrates the boundary of part, TST_TCN—Test Console I/O

FIG. 80 illustrates the boundary of part, TST_TMD Component

FIG. 81 illustrates an advantageous use of part, TST_TMD and TST_DCC

FIG. 82 illustrates the boundary of part, FAC—Factory

FIG. 83 illustrates an advantageous use of part, FAC—Factory

FIG. 84 illustrates the boundary of part, CMX—Connection Multiplexer/De-multiplexer

FIG. 85 illustrates an advantageous use of part, CMX—Connection Multiplexer/De-multiplexer

FIG. 86 illustrates an advantageous use of part, CMX—Connection Multiplexer/De-multiplexer

FIG. 87 illustrates the boundary of part, FMX—Fast Connection Multiplexer/De-multiplexer

FIG. 88 illustrates an advantageous use of part, FMX—Fast Connection Multiplexer/De-multiplexer

FIG. 89 illustrates an advantageous use of part, FMX—Fast Connection Multiplexer/De-multiplexer

FIG. 90 illustrates an advantageous use of part, FMX—Fast Connection Multiplexer/De-multiplexer FIG. 91 illustrates the boundary of part, SMX8—Static Multiplexer/De-multiplexer

FIG. 92 illustrates an advantageous use of part, SMX8—Static Multiplexer/De-multiplexer

FIG. 93 illustrates the boundary of part, EDFX—Extended Data Field Extractor

FIG. 94 illustrates an advantageous use of part, EDFX—Extended Data Field Extractor

FIG. 95 illustrates the boundary of part, EDFS—Extended Data Field Stamper

FIG. 96 illustrates an advantageous use of part, EDFS—Extended Data Field Stamper

### DETAILED DESCRIPTION OF THE INVENTION

The following description is provided to enable any person skilled in the art to make and use the invention and sets forth the best modes contemplated by the inventor for carrying out the invention. Various modifications, however, will remain readily apparent to those skilled in the art, since the basic principles of the present invention have been defined herein specifically to provide a configurable state machine driver and methods of use. Any and all such modifications, equivalents and alternatives are intended to fall within the spirit and scope of the present invention.

### Glossary

The following definitions are provided to assist the reader in comprehending the following description of a preferred embodiment of the present invention. All of the following definitions are presented as they apply in the context of the present invention.

| | |
|---|---|
| Adapter | a part which converts one interface, logical connection |
| | contract and/or physical connection mechanism to another. |
| | Adapters are used to establish connections between parts that |
| | cannot be connected directly because of incompatibilities. |
| Alias | an alternative name or path representing a part, terminal or |
| | property. Aliases are used primarily to provide alternative |
| | identification of an entity, usually encapsulating the exact |
| | structure of the original name or path. |
| Assembly | a composite object most of the functionality of which is |
| | provided by a contained structure of interconnected parts. In |
| | many cases assemblies can be instantiated by descriptor and do |
| | not require specific program code. |
| Bind or binding | an operation of resolving a name of an entity to a pointer, |
| | handle or other identifier that can be used to access this entity. |
| | For example, a component factory provides a bind operation |
| | that gives access to the factory interface of an individual |
| | component class by a name associated with it. |
| Bus, part | a part which provides a many-to-many type of interaction |
| | between other parts. The name “bus” comes from the analogy |
| | with network architectures such as Ethernet that are based on a |
| | common bus through which every computer can access all |
| | other computers on the network. |
| Code, automatically | program code, such as functions or parts of functions, the |
| generated | source code for which is generated by a computer program. |
| Code, general purpose | program code, such as functions and libraries, used by or on |
| | more than one class of objects. |
| COM | an abbreviation of Component Object Model, a component |
| | model defined and supported by Microsoft Corp. COM is the |
| | basis of OLE2 technologies and is supported on all members of |
| | the Windows family of operating systems. |
| Component | an instantiable object class or an instance of such class that can |
| | be manipulated by general purpose code using only |
| | information available at run-time. A Microsoft COM object is a |
| | component, a Win32 window is a component; a C++ class |
| | without run-time type information (RTTI) is not a component. |
| Component model(s) | a class of object model based on language-independent |
| | definition of objects, their attributes and mechanisms of |
| | invocation. Unlike object-oriented languages, component |
| | models promote modularity by allowing systems to be built |
| | from objects that reside in different executable modules, |
| | processes and computers. |
| Connecting | process of establishing a connection between terminals of two |
| | parts in which sufficient information is exchanged between the |
| | parts to establish that both parts can interact and to allow at |
| | least one of the parts to invoke services of the other part. |
| Connection | an association between two terminals for the purposes of |
| | transferring data, invoking operations or passing events. |
| Connection broker | an entity that drives and enforces the procedure for establishing |
| | connections between terminals. Connection brokers are used in |
| | the present invention to create connections exchanging the |
| | minimum necessary information between the objects being |
| | connected. |
| Connection, | a characteristic of a connection defined by the flow of control |
| direction of | on it. Connections can be uni-directional, such as when only |
| | one of the participants invokes operations on the other, or bi- |
| | directional, when each of the participants can invoke |
| | operations on the other one. |
| Connection, direction | a characteristic of a connection defined by the data flow on it. |
| of data flow | For example, a function call on which arguments are passed |
| | into the function but no data is returned has uni-directional |
| | data flow as opposed to a function in which some arguments |
| | are passed in and some are returned to the caller. |
| Connection, logical | a defined protocol of interaction on a connection recognized by |
| contract | more than one object. The same logical contract may be |
| | implemented using different physical mechanisms. |
| Connection, physical | a generic mechanism of invoking operations and passing data |
| mechanism | through connections. Examples of physical mechanisms |
| | include function calls, messages, v-table interfaces, RPC |
| | mechanisms, inter-process communication mechanisms, |
| | network sessions, etc. |
| Connection point | see terminal. |
| Connection, | a characteristic of a connection which defines whether the |
| mechanism | entity that invokes an operation is required to wait until the |
| | execution of the operation is completed. If at least one of the |
| | operations defined by the logical contract of the connection |
| | must be synchronous, the connection is assumed to be |
| | synchronous. |
| Container | an object which contains other objects. A container usually |
| | provides interfaces through which the collection of multiple |
| | objects that it contains can be manipulated from outside. |
| Control block | see Data bus. |
| CORBA | Common Object Request Broker Architecture, a component |
| | model architecture maintained by Object Management Group, |
| | Inc., a consortium of many software vendors. |
| Critical section | a mechanism, object or part the function of which is to prevent |
| | concurrent invocations of the same entity. Used to protect data |
| | integrity within entities and avoid complications inherent to |
| | multiple threads of control in preemptive systems. |
| Data bus | a data structure containing all fields necessary to invoke all |
| | operations of a given interface and receive back results from |
| | them. Data buses improve understandability of interfaces and |
| | promote polymorphism. In particular interfaces based on data |
| | buses are easier to de-synchronize, convert, etc. |
| Data flow | direction in which data is being transferred through a function |
| | call, message, interface or connection. The directions are |
| | usually denoted as “in”, “out” or “in-out”, the latter defining a |
| | bi-directional data flow. |
| Descriptor table | an initialized data structure that can be used to describe or to |
| | direct a process. Descriptors are especially useful in |
| | conjunction with general purpose program code. Using |
| | properly designed descriptor tables, such code can be directed |
| | to perform different functions in a flexible way. |
| De-serialization | part of a persistency mechanism in object systems. A process |
| | of restoring the state of one or more objects from a persistent |
| | storage such as file, database, etc. See also serialization. |
| De-synchronizer | a category of parts used to convert synchronous operations to |
| | asynchronous. Generally, any interface with unidirectional data |
| | flow coinciding with the flow of control can be de- |
| | synchronized using such a part. |
| Event | in the context of a specific part or object, any invocation of an |
| | operation implemented by it or its subordinate parts or objects. |
| | Event-driven designs model objects as state machines which |
| | change state or perform actions in response to external events. |
| | In the context of a system of objects, a notification or request |
| | typically not directed to a single object but rather multicast to, |
| | or passed through, a structure of objects. In a context of a |
| | system in general, an occurrence. |
| Event, external | An event caused by reasons or originated outside of the scope |
| | of a given system. |
| Execution context | State of a processor and, possibly of regions of memory and of |
| | system software, which is not shared between streams of |
| | processor instructions that execute in parallel. Typically |
| | includes some but not necessarily all processor registers, a |
| | stack, and, in multithreaded operating systems, the attributes of |
| | the specific thread, such as priority, security, etc. |
| Factory, abstract | a pattern and mechanism for creating instances of objects under |
| | the control of general purpose code. The mechanism used by |
| | OLE COM to create object instances is an abstract factory; the |
| | operator “new” in C++ is not an abstract factory. |
| Factory, component | portion of the program code of a component or part which |
| or part | handles creation and destruction of instances. Usually invoked |
| | by an external abstract factory in response to request(s) to |
| | create or destroy instances of the given class. |
| Flow of control | a sequence of nested function calls, operation invocations, |
| | synchronous messages, etc. Despite all abstractions of object- |
| | oriented and event-driven methods, on single-processor |
| | computer systems the actual execution happens strictly in the |
| | sequence of the flow of control. |
| Group property | a property used to represent a set of other properties for the |
| | purposes of their simultaneous manipulation. For example, an |
| | assembly containing several parts may define a group property |
| | through which similar properties of those parts can be set from |
| | outside via a single operation. |
| Indicator | a category of parts that provides human-readable |
| | representation of the data and operations that it receives. Used |
| | during the development process to monitor the behavior of a |
| | system in a given point of its structure. |
| Input | a terminal with incoming flow of control. As related to |
| | terminals, directional attributes such as incoming and outgoing |
| | are always defined from the viewpoint of the object on which |
| | the terminal is defined. |
| Interaction | an act of transferring data, invoking an operation, passing an |
| | event, or otherwise transfer control between objects, typically |
| | on a single connection between two terminals. |
| Interaction, incoming | in a context of a given object, an interaction that transfers data, |
| | control or both data and control into this object. Whenever both |
| | control and data are being transferred in one and the same |
| | interaction, the direction is preferably determined by the |
| | direction of the transfer of control. |
| Interaction, outgoing | in a context of a given object, an interaction that transfers data, |
| | control or both data and control out of this object. Whenever |
| | both control and data are being transferred in one and the same |
| | interaction, the direction is preferably determined by the |
| | direction of the transfer of control |
| Interface | a specification for a set of related operations that are |
| | implemented together. An object given access to an |
| | implementation of an interface is guaranteed that all operations |
| | of the interface can be invoked and will behave according to |
| | the specification of that interface. |
| Interface, | an interface the operations of which are invoked through |
| message-based | messages in message-passing systems. “Message-based” |
| | pertains to a physical mechanism of access in which the actual |
| | binding of the requested operation to code that executes this |
| | operation on a given object is performed at call time. |
| Interface, OLE COM | a standard of defining interfaces specified and enforced by |
| | COM. Based on the virtual table dispatch mechanism |
| | supported by C++ compilers. |
| Interface, remoting | a term defined by Microsoft OLE COM to denote the process |
| | of transferring operations invoked on a local implementation of |
| | an interface to some implementation running on a different |
| | computer or in a different address space, usually through an |
| | RPC mechanism. |
| Interface, v-table | a physical mechanism of implementing interfaces, similar to |
| | the one specified by OLE COM. |
| Marshaler | a category of parts used to convert an interface which is |
| | defined in the scope of a single address space to a logically |
| | equivalent interface on which the operations and related data |
| | can be transferred between address spaces. |
| Multiplexor | a category of parts used to direct a flow of operations invoked |
| | on its input through one of several outgoing connections. |
| | Multiplexors are used for conditional control of the event flows |
| | in structures of interconnected parts. |
| Name | a persistent identifier of an entity that is unique within a given |
| | scope. Most often names are human-readable character strings; |
| | however, other values can be used instead as long as they are |
| | persistent. |
| Name space | the set of all defined names in a given scope. |
| Name space, joined | a name space produced by combining the name spaces of |
| | several parts. Preferably used in the present invention to |
| | provide unique identification of properties and terminals of |
| | parts in a structure that contains those parts. |
| Object, composite | an object that includes other objects, typically interacting with |
| | each other. Composites usually encapsulate the subordinate |
| | objects. |
| Output | a terminal with outgoing flow of control. See also Input. |
| Parameterization | a mechanism and process of modifying the behavior of an |
| | object by supplying particular data values for attributes defined |
| | by the object. |
| Part | an object or a component preferably created through an |
| | abstract factory and having properties and terminals. Parts can |
| | be assembled into structures at run-time. |
| Property | a named attribute of an object exposed for manipulation from |
| | outside through a mechanism that is not specific for this |
| | attribute or object class. |
| Property interface | an interface which defines the set of operations to manipulate |
| | properties of objects that implement it. Typical operations of a |
| | property interface include: get value, set value, and enumerate |
| | properties. |
| Property mechanism | a mechanism defining particular ways of addressing and |
| | accessing properties. A single property interface may be |
| | implemented using different property mechanisms, as it |
| | happens with parts and assemblies. Alternatively, the same |
| | property mechanism can be exposed through a number of |
| | different property interfaces. |
| Proxy | program code, object or component designed to present an |
| | entity or a system in a way suitable for accessing it from a |
| | different system. Compare to a wrapper. |
| Repeater | a category of parts used to facilitate connections in cases where |
| | the number of required connections is greater than the |
| | maximum number supported by one or more of the |
| | participants. |
| Return status | a standardized type and set of values returned by operations of |
| | an interface to indicate the completion status of the requested |
| | action, such as OK, FAILED, ACCESS VIOLATION, etc. |
| Serialization | part of a persistency mechanism in object systems. A process |
| | of storing the state of one or more objects to persistent storage |
| | such as file, database, etc. See also de-serialization. |
| Structure of parts | a set of parts interconnected in a meaningful way to provide |
| | specific functionality. |
| Structured storage | a mechanism for providing persistent storage in an object |
| | system where objects can access the storage separately and |
| | independently during run-time. |
| Terminal | a named entity defined on an object for the purposes of |
| | establishing connections with other objects. |
| Terminal, cardinality | the maximum number of connections in which a given terminal |
| | can participate at the same time. The cardinality depends on the |
| | nature of the connection and the way the particular terminal is |
| | implemented. |
| Terminal, exterior | a terminal, preferably used to establish connections between |
| | the part to which it belongs and one or more objects outside of |
| | this part. |
| Terminal, interior | a terminal, of an assembly, preferably used to establish |
| | connections between the assembly to which it belongs and one |
| | or more subordinate objects of this assembly. |
| Terminal interface | an interface which defines the set of operations to manipulate |
| | terminals of objects that implement it. |
| Terminal mechanism | a mechanism defining particular ways of addressing and |
| | connecting terminals. A single terminal interface may be |
| | implemented using different terminal mechanisms, as happens |
| | with parts and assemblies. |
| Thread of execution | a unit of execution in which processor instructions are being |
| | executed sequentially in a given execution context. In the |
| | absence of a multithreaded operating system or kernel, and |
| | when interrupts are disabled, a single-processor system has |
| | only one thread of execution, while a multiprocessor system |
| | has as many threads of execution as it has processors. Under |
| | the control of a multithreaded operating system or kernel, each |
| | instance of a system thread object defines a separate thread of |
| | execution. |
| Wrapper | program code, object or component designed to present an |
| | entity or a system in a way suitable for inclusion in a different |
| | system. Compare to a proxy. |

The preferred embodiment of the present invention is implemented as software component objects (parts). The presently described parts are preferably used in conjunction with the method and system described in the '675 application, as well as with parts described in U.S. patent application Ser. No. 09/640,898, entitled SYSTEM OF REUSABLE SOFTWARE PARTS AND METHODS OF USE, filed Aug. 16,2000, and in PCT Patent Application Serial No. US00/22630, entitled SYSTEM OF REUSABLE SOFTWARE PARTS FOR IMPLEMENTING CONCURRENCY AND HARDWARE ACCESS, AND METHODS OF USE, the disclosures of which are herein incorporated by reference.

The terms ClassMagic and DriverMagic, used throughout this document, refer to commercially available products incorporating the inventive “System for Constructing Software Components and Systems as Assemblies of Independent Parts” (referenced above) in general, and to certain implementations of that system. Moreover, an implementation of the system is described in the following product manuals:

“Reference—C Language Binding—ClassMagic™ Object Composition Engine”, Object Dynamics Corporation, August 1998, which is incorporated herein in its entirety by reference;

“User Manual—User Manual, Tutorial and Part Library Reference—DriverMagic Rapid Driver Development Kit”, Object Dynamics Corporation, August 1998, which is incorporated herein in its entirety by reference;

“Advanced Part Library—Reference Manual”, version 1.32, Object Dynamics Corporation, July 1999, which is incorporated herein in its entirety by reference;

“WDM Driver Part Library—Reference Manual”, version 1.12, Object Dynamics Corporation, July 1999, which is incorporated herein in its entirety by reference.

Also, the terms Dragon, Z-force, Z-force engine, Dragon engine and Dragon system, used throughout this document, refer to products of Z-force Communications, Inc., incorporating the inventive “System for Constructing Software Components and Systems as Assemblies of Independent Parts” (referenced above) in general, and to certain implementations of that system.

Appendix 1 describes preferred interfaces used by the parts described herein. Appendix 2 describes preferred events used by the parts described herein.

### Events

One inventive aspect of the present invention is the ability to represent many of the interactions between different parts in a software system in a common, preferably polymorphic way, called event objects, or events. Events provide a simple method for associating a data structure or a block of data, such as a received buffer or a network frame, with an object that identifies this structure, its contents, or an operation requested on it. Event objects can also identify the required distribution discipline for handling the event, ownership of the event object itself and the data structure associated with it, and other attributes that may simplify the processing of the event or its delivery to various parts of the system. Of particular significance is the fact that event objects defined as described above can be used to express notifications and requests that can be distributed and processed in an asynchronous fashion.

The term “event” as used herein most often refers to either an event object or the act of passing of such object into or out of a part instance. Such passing preferably is done by invoking the “raise” operation defined by the I_DRAIN interface, with an event object as the operation data bus. The I_DRAIN interface is a standard interface as described in the '675 application, it has only one operation—“raise”, and is intended for use with event objects. A large portion of the parts described in this application are designed to operate on events. Also in this sense, “sending an event” refers to a part invoking its output I_DRAIN terminal and “receiving an event” refers to a part's I_DRAIN input terminal being invoked.

### Event Objects

An event object is a memory object used to carry context data for requests and for notifications. An event object may also be created and destroyed in the context of a hardware interrupt and is the designated carrier for transferring data from interrupt sources into the normal flow of execution in systems based on the '675 system. An event object preferably consists of a data buffer (referred to as the event context data or event data) and the following “event fields”:

a. event ID—an integer value that identifies the notification or the request.

b. size—the size (in bytes) of the event data buffer.

c. attributes—an integer bit-mask value that defines event attributes. Half of the bits in this field are standard attributes, which define whether the event is intended as a notification or as an asynchronous request and other characteristics related to the use of the event's memory buffer. The other half is reserved as event-specific and is defined differently for each different event (or group of events).

d. status—this field is used with asynchronous requests and indicates the completion status of the request (see the Asynchronous Requests section below).

The data buffer pointer identifies the event object. Note that the “event fields” do not necessarily reside in the event data buffer, but are accessible by any part that has a pointer to the event data buffer. The event objects are used as the operation data of the I_DRAIN interface's single operation—raise. This interface is intended for use with events and there are many parts that operate on events.

The following two sections describe the use of events for notifications and for asynchronous requests.

### Notifications

Notifications are “signals” that are generated by parts as an indication of a state change or the occurrence of an external event. The “recipient” of a notification is not expected to perform any specific action and is always expected to return an OK status, except if for some reason it refuses to assume responsibility for the ownership of the event object. The events objects used to carry notifications are referred to as “self-owned” events because the ownership of the event object travels with it, that is, a part that receives a notification either frees it when it is no longer needed or forwards it to one of its outputs.

### Asynchronous Requests

Using event objects as asynchronous requests provides a uniform way for implementing an essential mechanism of communication between parts:

a. the normal interface operations through which parts interact are in essence function calls and are synchronous, that is, control is not returned to the part that requests the operation until it is completed and the completion status is conveyed to it as a return status from the call.

b. the asynchronous requests (as the name implies) are asynchronous, control is returned immediately to the part that issues the request, regardless of whether the request is actually completed or not. The requester is notified of the completion by a “callback”, which takes a form of invoking an incoming operation on one of its terminals, typically, but not necessarily, the same terminal through which the original request was issued. The “callback” operation is preferably invoked with a pointer to the original event object that contained the request itself. The “status” field of the event object conveys the completion status.

Many parts are designed to work with asynchronous requests. Note, however that most events originated by parts are not asynchronous requests—they are notifications or synchronous requests. An event recoder part, in combination with other parts may be used to transform notifications into asynchronous requests.

The following special usage rules preferably apply to events that are used as asynchronous requests:

1. Requests are used on a symmetrical bi-directional I_DRAIN connection.

2. Requests may be completed either synchronously or asynchronously.

3. The originator of a request (the request ‘owner’) creates and owns the event object.

No one except the ‘owner’ may destroy it or make any assumptions about its origin.

4. A special data field may be reserved in the request data buffer, referred to as “owner context”—this field is private to the owner of the request and may not be overwritten by recipients of the request.

5. A part that receives a request (through an I_DRAIN.raise operation) may:

a) Complete the request by returning any status except ST_PENDING (synchronous completion);

b) Retain a pointer to the event object and return ST_PENDING. This may be done only if the ‘attr’ field of the request has the CMEVT_A_ASYNC_CPLT bit set. In this case, using the retained pointer to execute I_DRAIN.raise on the back channel of the terminal through which the original request was received completes the request. The part should store the completion status in the “status” event field and set the CMEVT_A_COMPLETED bit in the “attributes” field before completing the request in this manner.

6. A part that receives a request may re-use the request's data buffer to issue one or more requests through one of its I_DRAIN terminals, as long as this does not violate the rules specified above (i.e., the event object is not destroyed or the owner context overwritten and the request is eventually completed as specified above).

Since in most cases parts intended to process asynchronous requests may expect to receive any number of them and have to execute them on a first-come-first-served basis, such parts are typically assembled using desynchronizers which preferably provide a queue for the pending requests and take care of setting the “status” field in the completed requests.

### The Notion of Event as Invocation of an Interface Operation

It is important to note that in many important cases, the act of invoking a given operation on an object interface, such as a v-table interface, can be considered an event, similar to the events described above. This is especially true in the case of interfaces which are defmed as bus-based interfaces; in such interfaces, data arguments provided to the operation, as well as, data returned by it, is exchanged by means of a data structure called bus. Typically, all operations of the same bus-based interface are defined to accept one and the same bus structure.

Combining an identifier of the operation being requested with the bus data structure is logically equivalent to defining an event object of the type described above. And, indeed, some of the reusable parts use this mechanism to convert an arbitrary interface into a set of events or vice-versa.

The importance of this similarity between events and operations in bus-based interfaces becomes apparent when one considers that it allows to apply many of the parts, design patterns and mechanisms for handling, distributing, desynchronizing and otherwise processing flows of events, to any bus-based interface. In this manner, an outgoing interaction on a part that requires a specific bus-based interface can be distributed to multiple parts, desynchronized and processed in a different thread of execution, or even converted to an event object. In all such cases, the outgoing operation can be passed through an arbitrarily complex structure of parts that shape and direct the flow of events and delivered to one or more parts that actually implement the required operation of that interface, all through the use of reusable software parts.

### XDL—Event Sources

### EVT, EVT2—Timer Event Source

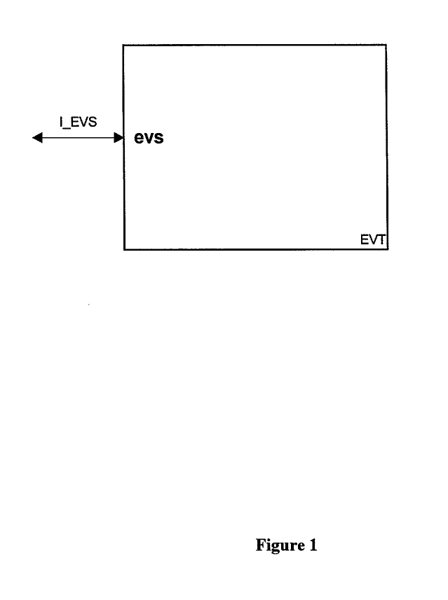

FIG. 1 illustrates the boundary of part, Timer Event Source (EVT and EVT2)

1. Functional Overview

EVT is an event source that generates both single and periodic timer events for a part connected to its evs terminal. EVT is armed and disarmed via input operations on its evs terminal and generates events by invoking the f i r e output operation on the same terminal. A caller-defined context value may be passed to EVT when it is armed and is passed back with the fire operation.

EVT2 has the same boundary and functionality as EVT, except that it invokes its output in a dedicated worker thread.

EVT[2] may be armed only once. If EVT[2] has not been armed to generate periodic events, it may be re-armed successfully as soon as the event is generated; this includes being re-armed while in the context of the fire operation call.

EVT[2] may be disarmed at any time. Once disarmed, EVT[2] will not invoke the fire operation on evs until it is re-armed. The context passed to EVT[2] when disarming it must match the context that was passed with the arm operation.

EVT[2] may be parameterized with default values to use when generating events and flags that control the use of the defaults.

The ‘fire’ call from EVT may be invoked in interrupt time. The part connected to the ‘evs’ terminal should be able to operate in interrupt time. Typically, the ‘fire’ call should be converted to an event and passed through ‘desynchronizer with thread’, e.g., DWT to obtain a timer event in normal thread time.

The ‘fire’ call from EVT2 always comes in normal thread time, in a dedicated worker thread created by EVT2.

In the text below, EVT refers to either EVT or EVT2.

2. Boundary

2.1 Terminals

| Name | Dir | Type | Notes |
|---|---|---|---|
| evs | Bidir | In: | Used to arm and disarm the event source |
| | | I_EVS | on the input and to send the event on the |
| | | Out: | output. EVT will accept NULL bus pointer |
| | | I_EVS_R | for the “arm” and “disarm” operations and |
| | | | use the values of its properties as arguments |
| | | | for the operation. The I_EVS.arm operation |
| | | | may be invoked in interrupt context. |

3. Events and Notifications

EVT has no incoming or outgoing events. The “event” generated by EVT is a fire operation call defined in I_EVS_R; it is not a Dragon event object passed via an I_DRAIN interface.

3.1 Special Events, Frames, Commands or Verbs

None.

3.2 Properties

| Property name | Type | Notes |
|---|---|---|
| force_defaults | uint32 | Boolean. If TRUE, the time and continuous |
| | | properties override the values passed in |
| | | the I_EVS bus. Default is FALSE. |
| time | sint32 | Default time period in milliseconds. |
| | | Valid range is 0-0x7fffffff. |
| | | When this time period expires (after EVT is |
| | | armed), EVT will fire an event (by calling |
| | | evs.fire). Default is 0. |
| continuous | uint32 | Boolean. If TRUE and EVT is armed, generate |
| | | periodic events until disarmed. |
| | | Default is FALSE. |
| thread_priority | sint32 | (EVT2 only) Worker thread priority. The |
| | | default value is 0. |
| | | The following values are valid: |
| | | −3 Lowest possible priority |
| | | −2 Very low priority |
| | | −1 Low priority |
| | | 0 Normal priority |
| | | 1 High priority |
| | | 2 Very high priority |
| | | 3 Highest possible priority |
| | | The mapping of these values to the priority |
| | | scheme of the target environment is defined in |
| | | detail in the Target Support Reference. In |
| | | any case (except, if the target environment |
| | | has no priority scheme at all), −1 and +1 |
| | | are guaranteed to be lower and higher than the |
| | | normal priority, and −3 and 3 are always |
| | | the lowest and the highest priority supported |
| | | by the system. |

4. Events and Notifications

None.

5. Environmental Dependencies

5.1 Encapsulated Interactions

EVT uses operating system services to set up a one-shot or a periodic timer. In some environments, thread and synchronization services may be used to create a worker thread for the ‘fire’ calls. For details on the services used in a specific environment, please refer to the Target Support Reference document.

5.2 Other Environmental Dependencies

None.

### EVSADP—Event Source Adapter

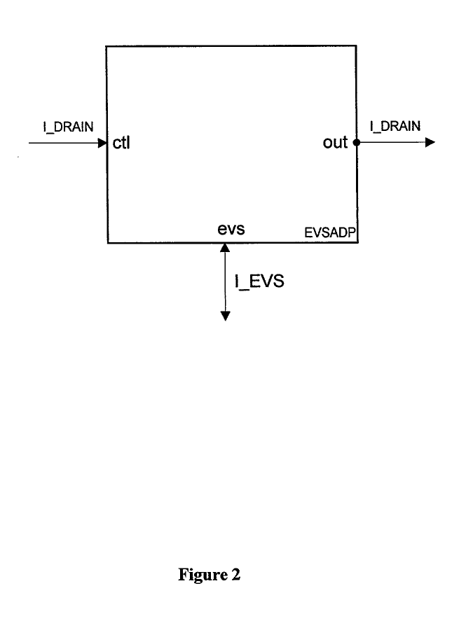

FIG. 2 illustrates the boundary of part, Event Source Adapter (EVSADP)

1. Functional Overview

The event source adapter (EVSADP) is a plumbing part that allows event sources to be connected to unidirectional I_DRAIN control and output terminals; making them easier to use in assembled parts.

EVSADP converts “arm” and “disarm” events into the arm and disarm operations on the I_EVS interface. It converts the fire I_EVS operation into a fire event sent through the out terminal. The events recognized as “arm” and “disarm” as well as the emitted “fire” event are parameterizable as properties.

By default, EVSADP ignores the data coming with the arm and disarm events, forcing the event source to use its default parameters. If the use_data property is changed to TRUE, the data coming with the arm and disarm events is passed to the event source (the incoming event data must be a correctly filled B_EVS structure).

In all cases, the fire event is sent with the data provided by the event source (B_EVS).

2. Boundary

2.1 Terminals

| Name | Dir | Interface | Notes |
|---|---|---|---|
| Ctl | in | I_DRAIN | Event source arm and disarm events are |
| | | | expected to be received through this |
| | | | terminal. |
| out | Out | I_DRAIN | An event is generated through this terminal |
| | | | when the event source connected to the evs |
| | | | terminal fires. |
| evs | bi | I_EVS | EVSADP converts the arm and disarm |
| | | (in) | events received through ctl into evs.arm and |
| | | I_EVS_R | evs.disarm operations invoked through this |
| | | (out) | terminal. |

2.2 Properties

| Property name | Type | Notes |
|---|---|---|
| arm_ev_id | uint32 | Arm event source event ID. |
| | | This is the ID of the event used to arm the |
| | | event source connected to the evs terminal. |
| | | Upon receiving this event, EVSASP invokes |
| | | the evs.arm operation through the evs terminal. |
| | | Default value is EV_REQ_ENABLE. |
| disarm_ev_id | uint32 | Disarm event source event ID. |
| | | This is the ID of the event used to disarm |
| | | the event source connected to the evs terminal. |
| | | Upon receiving this event, EVSASP invokes |
| | | the evs.disarm operation through the evs |
| | | terminal. |
| | | Default value is EV_REQ_DISABLE. |
| fire_ev_id | uint32 | Event source fire event ID. |
| | | This is the ID of the event that is generated by |
| | | EVSADP (through the out terminal) when the |
| | | event source connected to the evs terminal fires |
| | | (by invoking evs.fire). |
| | | Default value is EV_PULSE. |
| use_data | uint32 | Boolean. |
| | | TRUE if EVSADP uses the data as the |
| | | operation bus of the arm/disarm event to |
| | | arm/disarm the the event source. In this case, |
| | | the incoming event data must contain the |
| | | the B_EVS operation bus. |
| | | If FALSE, EVSADP passes a NULL operation |
| | | bus to the operations invoked through |
| | | the evs terminal. This causes the event source |
| | | to use its default parameters. |
| | | Default value is FALSE. |

3. Events and Notifications

The events recognized and generated by EVSADP are specified as properties.

3.1 Special Events, Frames, Commands or Verbs

None.

3.2 Encapsulated Interactions

None.

4. Specification

4.1 Responsibilities

Upon receiving the arm_ev_id or disarm_ev_id events through the ctl terminal, invoke the evs.arm and evs.disarm operations respectively.

If use_data is TRUE, use the operation buses contained in the incoming events as the buses used when invoking the evs operations. Otherwise, invoke the evs operations with NULL operation buses.

When the event source connected to the evs terminal fires, generate a fire_ev_id event through the out terminal.

4.2 Theory of Operation

4.2.1 Mechanisms

None.

4.3 Use Cases

None.

### XDL—Distributors

### EGEN—Event Generator

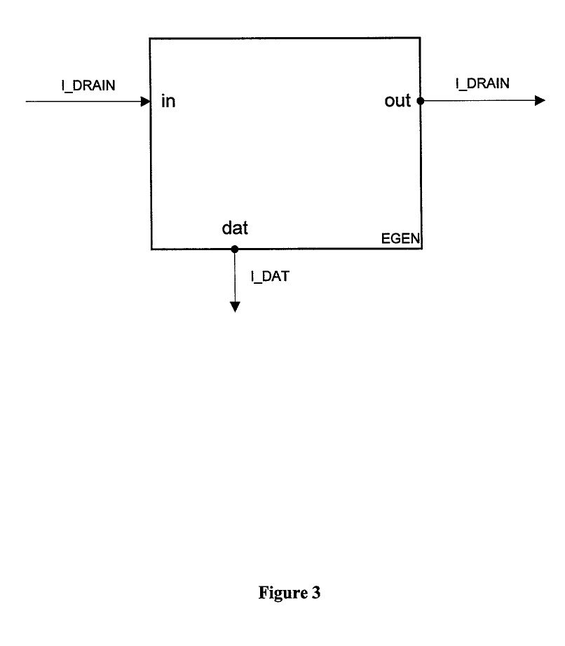

FIG. 3 illustrates the boundary of part, Event Generator (EGEN)

1. Functional Overview

EGEN is a notifier part that generates a new event (zero-initialized) through the out terminal when an incoming event is received through the in terminal.

The generated event ID and attributes are specified through properties. The size of the generated event is calculated by taking the base size (specified through a property) and adding to it the specified data item's value or the size of the data item value (retrieved using the dat terminal).

The generated event processing status (return status from the out terminal) is propagated back to the original caller.

The dat terminal may be left unconnected (floating). In this case EGEN can be used to generate constant-sized events.

EGEN is typically used in assemblies to generate new events based on the value of a data item.

2. Boundary

2.1 Terminals

| Name | Dir | Interface | Notes |
|---|---|---|---|
| in | in | I_DRAIN | An incoming event received through this |
| | | | terminal triggers EGEN to generate a new |
| | | | event through the out terminal. The generated |
| | | | event's ID, attributes and size are specified |
| | | | through properties. |
| | | | This terminal is unguarded. |
| out | out | I_DRAIN | All events generated by EGEN are forwarded |
| | | | through this terminal. |
| dat | out | I_DAT | EGEN invokes the bind, get_info and get |
| | | | operations through this terminal to retrieve |
| | | | the value and size of the specified data item. |
| | | | The retrieved value and size can be used to |
| | | | modify the size of the generated event. |
| | | | This terminal can remain unconnected |
| | | | (floating). |

2.2 Properties

| Name | Type | Notes |
|---|---|---|
| ev_id | uint32 | Event ID of the generated event sent through |
| | | the out terminal. If EV_NULL, EGEN |
| | | initializes the event ID to the ID of |
| | | the incoming event. |
| | | The default value is EV_NULL. |
| attr | uint32 | Event attributes of the generated event |
| | | sent through the out terminal. |
| | | The default value is |
| | | (ZEVT_A_SELF_CONTAINED). |
| base_sz | uint32 | Base size of the generated event sent |
| | | through the out terminal. |
| | | The default value is 0 (empty event). |
| item_name | asciz | Name of the data item whose value is used to |
| | | adjust the base size of the generated event. |
| | | If this property is empty or if the dat terminal |
| | | is not connected, EGEN does not modify the |
| | | base size for the generated event. |
| | | The default value is “”(empty). |
| item_is_sz | uint32 | Boolean. If TRUE, EGEN adds the data item's |
| | | value to the base size for the generated event. |
| | | If FALSE, EGEN adds the size of the data item |
| | | value to the base size. |
| | | This property is used only if item_name is |
| | | not empty; otherwise it is ignored. |
| | | The default value is TRUE. |

3. Events and Notifications

EGEN accepts any Z-Force event through the in terminal.

3.1 Special Events, Frames, Commands or Verbs

None.

3.2 Encapsulated Interactions

None.

4. Specification

4.1 Responsibilities

Upon receiving an incoming event, generate a new event and pass it through the out terminal.

Initialize the generated event's ID and attributes according to the ev_id and attr properties. Calculate the size of the generated event according to the specified base size and data item.

If any of the operations invoked through the dat terminal fail, fail the incoming event.

After passing the generated event through the out terminal, free the event according to the specified attributes (see the Mechanisms section below for more information). Also propagate the return status back to the original caller.

Fail construction if both the ZEVT_A_ASYNC_CPLT and ZEVT_A_SELF_OWNED attributes are set for the generated event attributes.

4.2 Theory of Operation

4.2.1 State Machine

None.

4.2.2 Mechanisms

### Determining the Size of the Generated Event

The size of the generated event is determined as follows:

If no data item is specified (item_name equal to “”) or the dat terminal is not connected, the size of the generated event is the value of the base_sz property.

If a data item is specified (item_name not equal to “”), EGEN retrieves the data item value and type through the dat terminal. The generated event size is then calculated the following way:

If the item_is_sz property is TRUE, the generated event size is base_sz+data item value.

If the item_is_sz property is FALSE, the generated event size is base_sz+data item size (based on the size of the data item value).

Note that when using the data item value to determine the size of the generated event, the data item must be one of the following integral types: DAT_T_UINT32, DAT_T_SINT32, DAT_T_BOOLEAN or DAT_T_BYTE. If using the data item value size, the data item can be any type.

### Generated Event Freeing Discipline

EGEN uses the following disciplines for freeing the generated event after passing it through the out terminal:

If the generated event allows asynchronous completion (ZEVT_A_ASYNC_CPLT attribute is set) and the return status of the event processing is ST_PENDING, EGEN does not free the event. It is up to the recipient of this event to free the event bus. EGEN will only free the event if a status other than ST_PENDING is returned.

If the generated event is self-owned (ZEVT_A_SELF_OWNED attribute is set), EGEN will only free the event bus if the return status is not equal to CMST_OK.

All other events are always freed regardless of return status or event attributes.

5. Notes

EGEN zero initializes the data of the generated event before passing it through the out terminal.

EGEN's access through the dat terminal is non-atomic. Therefore, an assembly using this part may need to use external guarding.

### SSEQ—Synchronous Event Sequencer

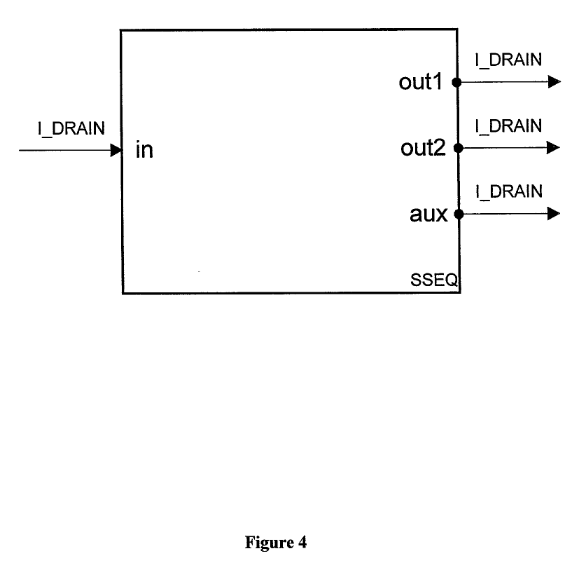

FIG. 4 illustrates the boundary of part, Synchronous Event Sequencer (SSEQ)

1. Functional Overview

SSEQ is a synchronization part that synchronously distributes incoming events received on in to the parts connected to the out1 and out2 terminals.

SSEQ relies on SEQ for the event distribution functionality. SSEQ is parameterized with the events distributed through its terminals. For more information about the event distribution, see the SEQ documentation.

2. Boundary

2.1 Terminals

| Name | Dir | Interface | Notes |
|---|---|---|---|
| in | In | I_DRAIN | Incoming events for distribution are received |
| | | | here. All recognized events are distributed |
| | | | according to their discipline. |
| | | | Unrecognized events are sent out the aux |
| | | | terminal. |
| out1 | Out | I_DRAIN | Event distribution terminal. |
| | | | The distribution depends upon the discipline |
| | | | of the event received on in. |
| out2 | Out | I_DRAIN | Event distribution terminal. |
| | | | The distribution depends upon the discipline |
| | | | of the event received on in. |
| aux | Out | I_DRAIN | Unrecognized events received on in are sent |
| | | | out this terminal. |
| | | | This terminal may remain unconnected. |

3. Events and Notifications

SSEQ is parameterized with the event IDs of the events it distributes to out1 and out2.

When one of these events are received from in, SSEQ synchronously distributes the event according to its discipline. If the distribution fails and the discipline allows cleanup, SSEQ distributes the cleanup event in the reverse order from where the distribution failed.

3.1 Special Events, Frames, Commands or Verbs

None.

3.2 Properties

| Property name | Type | Notes |
|---|---|---|
| unsup_ok | uint32 | If TRUE, a return status of |
| | | ST_NOT_SUPPORTED from the event |
| | | distribution terminals out1 or out2 |
| | | is remapped to ST_OK. |
| | | Default is TRUE. |
| ev[0].ev_id- | uint32 | Event IDs that SSEQ distributes to out1 |
| ev[15].ev_id | | and out2 when received on the in terminal. |
| | | This property is redirected to the SEQ |
| | | subordinate. |
| | | The default values are EV_NULL. |
| ev[0].disc- | asciz | Distribution disciplines for ev[0].ev_id- |
| ev[15].disc. | | ev[15].ev_id, can be one ofthe following: |
| | | [symbol] fwd_ignore |
| | | [symbol] bwd_ignore |
| | | [symbol] fwd_cleanup |
| | | [symbol] bwd_cleanup |
| | | See the Mechanisms section of the SEQ |
| | | documentation for descriptions of the |
| | | disciplines. This property is redirected to |
| | | the SEQ subordinate. |
| | | The default values are fwd_ignore. |
| ev[0].cleanup_id- | uint32 | Event IDs used for cleanup if the event |
| ev[15].cleanup_id | | distribution fails. |
| | | The cleanup event is not sent if it |
| | | is EV_NULL. |
| | | Cleanup events are used only if the |
| | | distribution discipline is fwd_cleanup |
| | | or bwd_cleanup. This property is |
| | | redirected to the SEQ subordinate. |
| | | The default values are EV_NULL. |

4. Environmental Dependencies

4.1 Encapsulated Interactions

None.

4.2 Other Environmental Dependencies

None.

5. Specification

5.1 Responsibilities

For all recognized events received from in, distribute them to out1 and out2 according to their corresponding discipline (parameterized through properties).

Allow only synchronous completion of the distributed events.

Forward unrecognized events received from in to aux.

6. Notes SSEQ does not allow self-owned events (ZEVT_A_SELF_OWNED) to be distributed through its terminals. Upon receiving such an event, SSEQ fails with ST_REFUSE.

### SWB—Switch On A Boolean Data Item

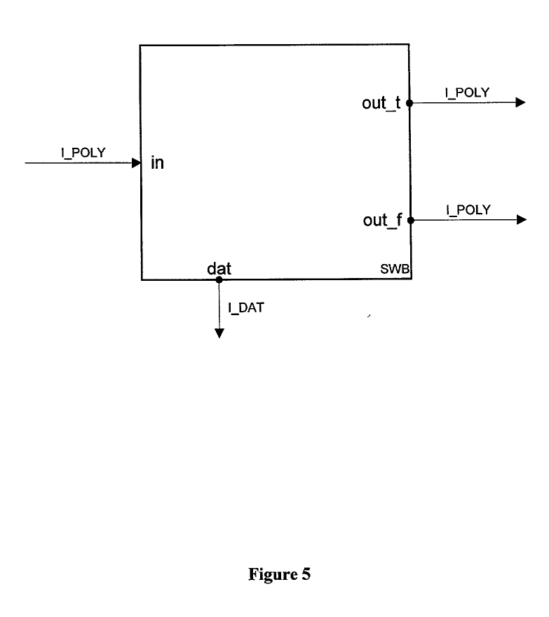

FIG. 5 illustrates the boundary of part, Switch On A Boolean Data Item (SWB)

1. Functional Overview

SWB is a data manipulation part that splits the operation flow received on its in terminal.

The operation flow split depends upon whether the data item value, obtained through the dat terminal, is FALSE or not.

When the incoming data item is FALSE (zero), the incoming call is sent out through out_f terminal. When the data item value is not FALSE (i.e., the data item is non-zero), the incoming call is sent out through out_t terminal.

SWB obtains the value of the predefined data item by submitting bind and get requests through dat terminal. If any of the requests fails, SWB completes the incoming call with the status returned on the dat terminal.

The name of the data item is specified through a property. SWB fails its creation if there is no data item specified (i.e., when the data item name is an empty string).

SWB does not monitor or modify the content of the operations passing through it.

SWB provides a way to direct a flow of operations through different paths, depending on the current value of a data item.

2. Boundary

2.1 Terminals

| Name | Dir | Interface | Notes |
|---|---|---|---|
| in | in | I_POLY | SWB receives an operation call. Depending |
| | | | on the value of the specified data item, the |
| | | | operation call is forwarded through one of the |
| | | | output terminals: out_f and out_t. |
| | | | This terminal is unguarded. |
| out_f | out | I_POLY | Operation calls received on the in terminal are |
| | | | passed through this terminal when the value of |
| | | | the specified data item is FALSE (zero). |
| out_t | out | I_POLY | Operation calls received on the in terminal |
| | | | are passed through this terminal when the value |
| | | | of the specified data item is not FALSE |
| | | | (i.e. non-zero). |
| dat | out | I_DAT | SWB invokes bind and get operations out this |
| | | | terminal to retrieve the data item value. |

2.2 Properties

| Property name | Type | Notes |
|---|---|---|
| item.name | asciz | Name of the predefined data item whose value is |
| | | used to determine which terminal the operation |
| | | is sent out. The data item type must be |
| | | DAT_T_UINT32. The value of this property |
| | | cannot be an empty string. This property is |
| | | mandatory. |

3. Events and Notifications

None.

3.1 Special Events, Frames, Commands or Verbs

None.

3.2 Encapsulated Interaction

None.

4. Specification

4.1 Responsibilities

Retrieve the data value by invoking the bind and get operations through the dat terminal.

Fail the incoming call if the data item value cannot be retrieved.

Sent the event out through out_f or out_t terminals depending on value of the specified data item.

4.2 Theory of Operation

4.2.1 State Machines

None.

4.2.2 Mechanisms

None.

### SWE and SWEB—Event-Controlled Switches

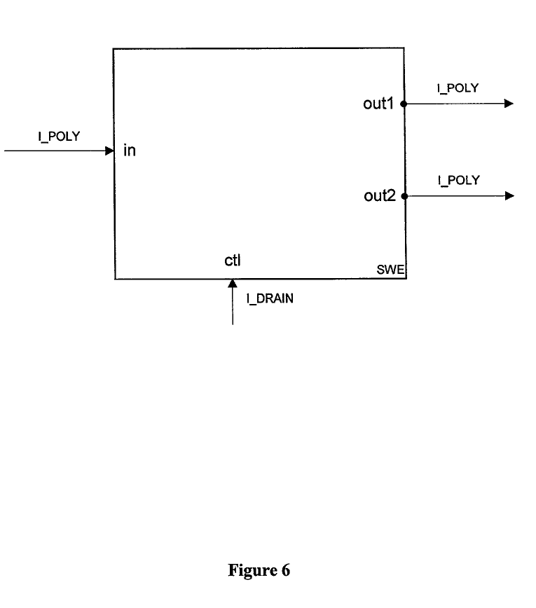

FIG. 6 illustrates the boundary of part, Event-Controlled Switch (SWE)

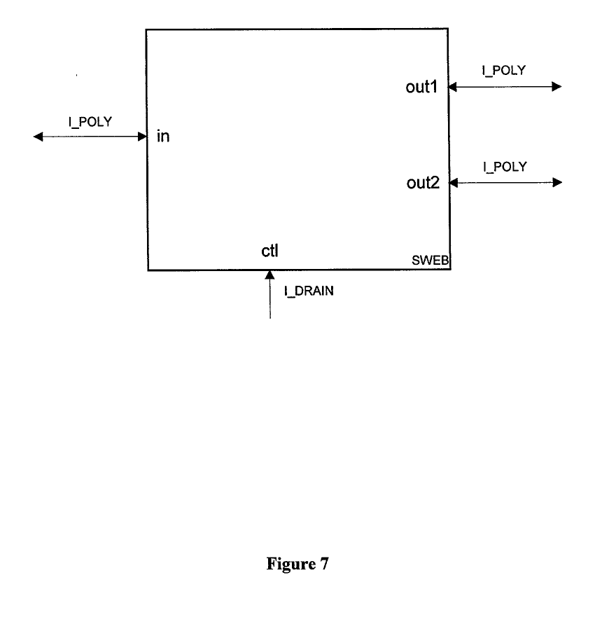

FIG. 7 illustrates the boundary of part, Bi-directional Event-Controlled Switch (SWEB)

1. Functional Overview

The event-controlled switches forward operations received on the in input to one of their outputs (out1 or out2), depending on the current state of the part. The state of the switch is controlled by three events that are received on the ctl terminal.

The parts are parameterized with the three events via properties. One event switches outgoing operations to out1, one event switches outgoing operations to out2, and the last event toggles the outgoing operation terminal (i.e., out1 if out2 is selected and out2 if out1 is selected)

In the initial state, operations received its in terminal to the out1 terminal.

SWEB is a bi-directional version of SWE. In the in to out direction it operates exactly as SWE. It forwards all operations received on its out1 and out2 terminals to the in terminal.

SWE/SWEB may be used at interrupt time.

2. Boundary

2.1 Terminals (SWE)

| Name | Dir | Interface | Notes |
|---|---|---|---|
| in | in | I_POLY | Operations received are forwarded to either out1 |
| | | | or out2. |
| out1 | out | I_POLY | Output for forwarded operations. This terminal |
| | | | may be left unconnected. |
| out2 | out | I_POLY | Output for forwarded operations. This terminal |
| | | | may be left unconnected. |
| ctl | in | I_DRAIN | Receive events that control the switch state. |

2.2 Terminals (SWEB)

| Name | Dir | Interface | Notes |
|---|---|---|---|
| in | bi | I_POLY | Operations received are forwarded to either out1 |
| | | | or out2. |
| out1 | bi | I_POLY | Output for forwarded operations. |
| | | | Operations received on this terminal are for- |
| | | | warded to in. |
| | | | This terminal may be left unconnected. |
| out2 | bi | I_POLY | Output for forwarded operations. |
| | | | Operations received on this terminal are for- |
| | | | warded to in. |
| | | | This terminal may be left unconnected. |
| ctl | in | I_DRAIN | Receive events that control the switch state. |

2.3 Properties

| Property name | Type | Notes |
|---|---|---|
| ev_out1 | uint32 | Event ID to switch to out1. |
| | | If the value is EV_NULL, this functionality |
| | | is disabled. |
| | | The default is EV_REQ_ENABLE. |
| ev_out2 | uint32 | Event ID to switch to out2. |
| | | If the value is EV_NULL, this functionality |
| | | is disabled. |
| | | The default is EV_REQ_DISABLE. |
| ev_toggle | uint32 | Event ID to switch to the other output (i.e., |
| | | out1 if out2 is selected and out2 if out1 is |
| | | selected). |
| | | If the value is EV_NULL, this functionality |
| | | is disabled. |
| | | The default is EV_NULL. |

3. Events and Notifications

The events recognized by SWE/SWEB on the ctl terminal are specified by the ev_out1, ev_out2 and ev_toggle properties.

3.1 Special Events, Frames, Commands or Verbs

None.

3.2 Encapsulated Interaction

None.

4. Specification

4.1 Responsibilities

Forward operations received on in to out1 or out2 based upon control events received on ctl terminal.

(SWEB) Forward operations received on out1 and out2 to in.

4.2 Theory of Operation

4.2.1 State Machines

The part keeps state as to which outx terminal it is to forward operations received on its in terminal to. The state is controlled by the events it receives on its ctl input. An atomic “exchange” operation is used to change the part's state, allowing it to operate in any execution context, including interrupt time. The initial state is “direct output to out1”.

4.2.2 Mechanisms

None.

4.3 Use Cases

None.

### XDL—Concurrency

### ACTS—Selective Asynchronous Completer

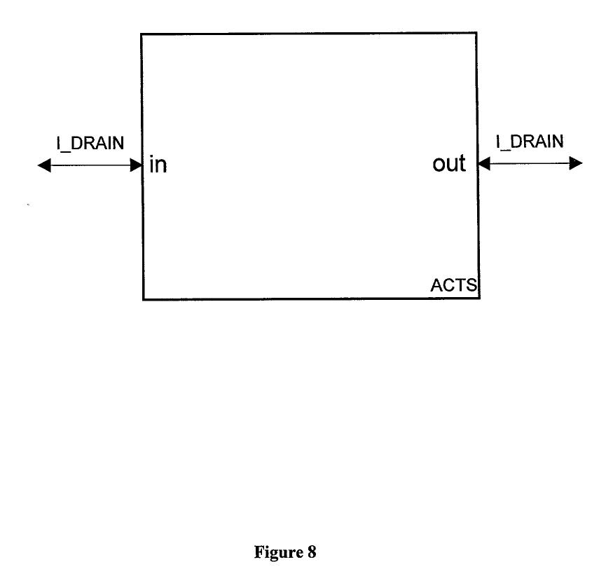

FIG. 8 illustrates the boundary of part, Selective Asynchronous Completer (ACTS)

1. Functional Overview

ACTS is a synchronization part that simulates asynchronous completion for a specified range of events received on its input and that complete synchronously on its output.

ACTS forwards all incoming events received on in to out. ACTS always completes the events received through in asynchronously. If the event sent through out completes synchronously, ACTS updates the completion status and completes the event by sending the same event back through in with the ZEVT_A_COMPLETED attribute set.

Events that complete asynchronously on out are simply passed through with no modification.

All events received on out are passed to in without modification.

The range of events considered by ACTS is parameterized through properties. Events not in the specified range are passed through out without modification (in this case ACTS acts as a pass-through channel).

ACTS is typically used in situations where asynchronous completion is required for only a selected range of events.

ACTS is not guarded and may be used at interrupt time.

2. BOUNDARY

2.1 Terminals

| Name | Dir | Interface | Notes |
|---|---|---|---|
| in | bi | I_DRAIN | Incoming events are received here. |
| | | | If the event is not in the specified range, it is |
| | | | passed through the out terminal without |
| | | | modification. |
| out | bi | I_DRAIN | Outgoing events are sent through here. |
| | | | All events received through this terminal are |
| | | | passed through the in terminal without modifi- |
| | | | cation. |

2.2 Properties

| Property name | Type | Notes |
|---|---|---|
| ev_min | uint32 | Specifies the lowest event ID value (inclusive) |
| | | that will be considered by ACTS. |
| | | If ev_min is EV_NULL, ACTS considers all |
| | | events if their event ids are less than ev_max. |
| | | If both ev_min and ev_max are EV_NULL, |
| | | all events are considered by ACTS. |
| | | Default: EV_NULL. |
| ev_max | uint32 | Specifies the highest event ID (inclusive) of |
| | | events that should be considered by ACTS. |
| | | If ev_max is EV_NULL, ACTS considers |
| | | all events if their event ids are greater than |
| | | ev_min. |
| | | If both ev_min and ev_max are EV_NULL, |
| | | all events are considered by ACTS. |
| | | Default: EV_NULL. |
| enforce_async | uint32 | Boolean. |
| | | Set to TRUE to enforce that the incoming |
| | | events (in the specified range) allow asyn- |
| | | chronous completion. |
| | | If TRUE and the incoming event does not |
| | | allow asynchronous completion, ST_REFUSE |
| | | is returned as an event distribution status. |
| | | If FALSE, ACTS forwards the event through |
| | | out without interpretation. |
| | | Default is FALSE. |

3. Events and Notifications

ACTS accepts any Dragon event.

4. Environmental Dependencies

4.1 Encapsulated Interaction

None.

5. Specification

5.1 Responsibilities

If the incoming events on in are not in the specified range, pass through the out terminal without modification.

For events received on the in terminal that are in the specified range, transform synchronous completion of the outgoing event into asynchronous completion of the incoming event that generated the former.

Pass all events received through the out terminal through the in terminal without modification.

5.2 External States

None.

5.3 Use Cases

5.3.1 Transformation of Synchronous Completion to Asynchronous one

Sending a completion event back to the channel that originated the event within the input call simulates asynchronous completion.

This feature is used by ACTS to transform synchronous completion of events on its out terminal to events completing asynchronously on in.

ACTS passes all incoming events through its out terminal. For those events that are in the specified range and return a status other than ST_PENDING (synchronous completion), ACTS stores the status in the completion status field of the event bus (the same one passed on in) and sends the same event back through the in terminal with the ZEVT_A_COMPLETED attribute set.

For events that, when passed to out, naturally complete asynchronously (by returning ST_PENDING), ACT does not do anything and is only a pass-through channel.

### XDL—Property Space Support

### PHLD—Property Holder

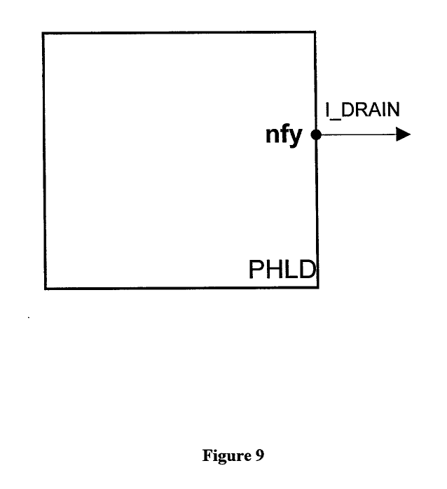

FIG. 9 illustrates the boundary of part, Property Holder (PHLD)

1. Functional Overview

PHLD is a magic part that implements a virtual property container where the properties within the container are exposed as if they were actual properties of PHLD itself.

PHLD does not enforce any limit as to the number of properties it can maintain. The set of properties maintained by PHLD may be accessed using any valid Z-Force property mechanism.

PHLD supports the entire set of property operations (i.e., get, set, chk, and enumeration) on the virtual properties. However, PHLD own properties (.xxx) are excluded from enumeration.

All properties within the container have attributes as specified by one of PHLD's properties and these attributes are returned on property get_info requests. This is due to the fact that there is no other mechanism by which to specify attributes for specific properties.

PHLD has the option of sending a notification event either before and/or after a property value is about to be changed (i.e., property set operation). The event Ids are specified via properties and the generated event contains, as data a B_PROP structure as specified in the I_PROP interface. The notifications are sent within a critical section region therefore a possible deadlock may occur.

PHLD can be used as a placeholder for properties exposed on an assembly boundary and are not implemented by other subordinates within the assembly.

2. Boundary

2.1 Terminals

| Name | Dir | Interface | Notes |
|---|---|---|---|
| nfy | Out | I_DRAIN | PHLD sends an event out this terminal either |
| | | | before and/or after a property is set. |
| | | | This terminal may remain unconnected. |

2.2 Properties

| Property | | |
|---|---|---|
| name | Type | Notes |
| .prop_type | uint32 | Property type that is returned when the Z-Force |
| | | engine retrieves the information about an |
| | | unknown property. |
| | | Default value is ZPRP_T_NONE. |
| .prop_attr | uint32 | Property attributes that are returned when the |
| | | Z-Force engine retrieves the information about |
| | | an unknown property. |
| | | Default value is ZPRP_A_NONE. |
| .max_sz | uint32 | Maximum size of storage for each property |
| | | value (specified in bytes). |
| | | On a property set operation (invoked through |
| | | the engine), if the length of the property value |
| | | exceeds the maximum size, PHLD fails the |
| | | operation. |
| | | If the value is 0, there is no limit. PHLD is |
| | | limited only by the amount of available |
| | | memory. |
| | | Default value is 0. |
| .pre_ev | uint32 | ID of event to generate out nfy prior to a |
| | | property value being set. |
| | | If EV_NULL, no event is generated. |
| | | The default is EV_NULL. |
| .post_ev | uint32 | ID of event to generate out nfy after a |
| | | property has been set. |
| | | If EV_NULL, no event is generated. |
| | | The default is EV_NULL. |

3. Events and Notifications

3.1 Terminal: nfy

| Event | Dir | Bus | Notes |
|---|---|---|---|
| (.pre_ev) | out | B_PROP | This event is generated just prior to setting |
| | | | a property. |
| (.post_ev) | out | B_PROP | This event is generated after a property has |
| | | | been successfully set. |

4. Environmental Dependencies

4.1 Encapsulated Interaction

None.

4.2 Other Environmental Dependencies

None.

5. Specification

5.1 Responsibilities

Maintain a set of virtual properties (like the part array—ARR). The properties can be parameterized using any valid Z-Force property mechanism.

Return the parameterized property type (.prop_type) and attributes (.prop_attr) on get info operations for unknown properties; otherwise return the appropriate information.

On a property set operation, if the specified property does not exist, create the property and store its value.

On a property get operation, if the specified property does not exist, return an empty value.

Generate notification out nfy terminal just prior to setting a property if (.pre_ev) is not EV_NULL.

Generate notification out nfy terminal after a property has been successfully modified if (.post_ev) is not EV_NULL.

Implement property enumeration over the virtual properties.

5.2 External States

None.

5.3 Use Cases

There are three possible use cases for PHLD:

The assembly that uses PHLD knows the properties it needs to store in the property holder. It uses the paramT macro in order to parameterize PHLD with the properties specifying the property type. In this case the assembly knows the names and types of the properties it needs to expose.

The assembly uses the param macro in order to parameterize PHLD with the properties; the property type is specified by PHLD's .prop_type property.

The assembly redirects some properties to PHLD, but does not provide default values for them. These properties will all have their type defined when they are first set from outside.

6. Typical Usage

None.

7. Notes

When using PHLD within an assembly, the assembly should not redirect properties maintained by PHLD to other subordinates.

For the implementation of the virtual properties, see the part array—ARR.

### PRCCONST—Property Container for Constants

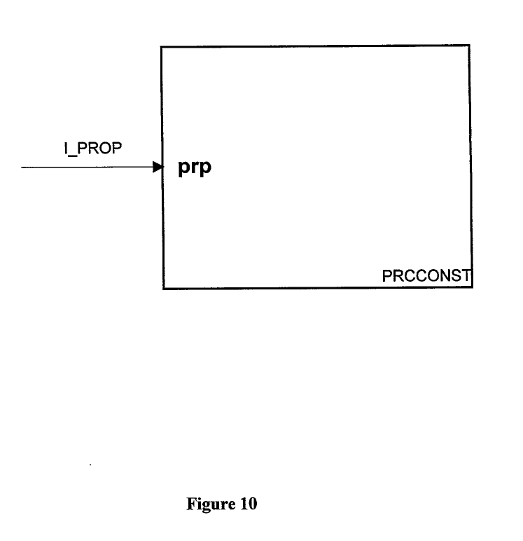

FIG. 10 illustrates the boundary of part, PRCCONST

1. Functional Overview

PRCCONST is a magic part implementing a virtual property container that makes it possible to define a set of named data constants. The named data constants are set as if they are actual properties of PRCCONST. The number of properties maintained by PRCCONST is limited only by the amount of available memory.

The set of properties maintained by PPRCCONST may be accessed using any valid Z-Force Property mechanism or through the prp terminal. All properties maintained by PRCCONST are non-modifiable (i.e., property set and chk requests are not allowed after part activation).

PRCCONST exposes only the properties within the container upon property enumeration.

Property get_info requests received through the Z-Force engine return the attributes specified by one of the PRCPROP's properties. This is due to the fact that there is no mechanism by which property attributes may be specified.

PRCCONST is typically used to hold the hard-parameterized values for parts that require parameterization during run-time such a part contained in a part array (ARR.)

PRCCONST must be guarded. The part cannot be used in an interrupt context.

2. Boundary

2.1 Terminals

| Name | Dir | Interface | Notes |
|---|---|---|---|
| prp | in | I_PROP | This terminal is used to get, and enumerate |
| | | | properties in the container. |

2.2 Properties

| Property name | Type | Notes |
|---|---|---|
| .prop_type | uint32 | Property type that is returned when the Z-Force |
| | | engine retrieves the information about an |
| | | unknown property. |
| | | Default value is ZPRP_T_NONE. |
| .prop_attr | uint32 | Property attributes that are returned when the |
| | | Z-Force engine retrieves the information about |
| | | an unknown property. |
| | | Default value is ZPRP_A_NONE. |
| (Any) | (Any) | Virtual properties declared in the assembly |
| | | declaration of the assembly containing this part. |

3. Events and Notifications

None

4. Environmental Dependencies

4.1 Encapsulated Interaction

None

5. Specification

5.1 Responsibilities

Maintain a set of virtual properties. The properties can be parameterized using any valid Z-Force property mechanism.

Return the parameterized property type (.prop_type) and attributes (.prop_attr) on get_info operations received from the Z-Force engine for unknown properties; otherwise return the appropriate information.

On a property set operation received from the Z-Force engine and if the specified property does not exist, create the property and store its value.

On a property get operation received from the Z-Force engine and if the specified property does not exist, return an empty value.

Implement property enumeration over the virtual properties only.

Refuse all set and chk operations after part activation.

Return ST_INVALID on any attempt to open a query with a query string other than “*”. See note 2.

5.2 External States

none

5.3 Use Cases

There are two possible use cases for PRCCONST:

The assembly that uses PRCCONST knows the properties it needs to hard-parameterize in the property holder. It uses the paramT macro to parameterize PRCCONST with the properties specifying the property type. In this case, the assembly knows the names and types of the properties it needs to expose. After activation, the properties are enumerable and their values readable on the prp terminal

Similar to Use Case 1 except the assembly uses the param macro in order to parameterize PRCCONST with properties. The property type is specified by PRCCONST's . prop_type property.

6. Typical Usage

6.1 De-serializing a Part Array Element from “Factory Settings”

This use case demonstrates how PRCCONST can be used to provide “factory-default” settings for the de-serialization of elements of a part array.

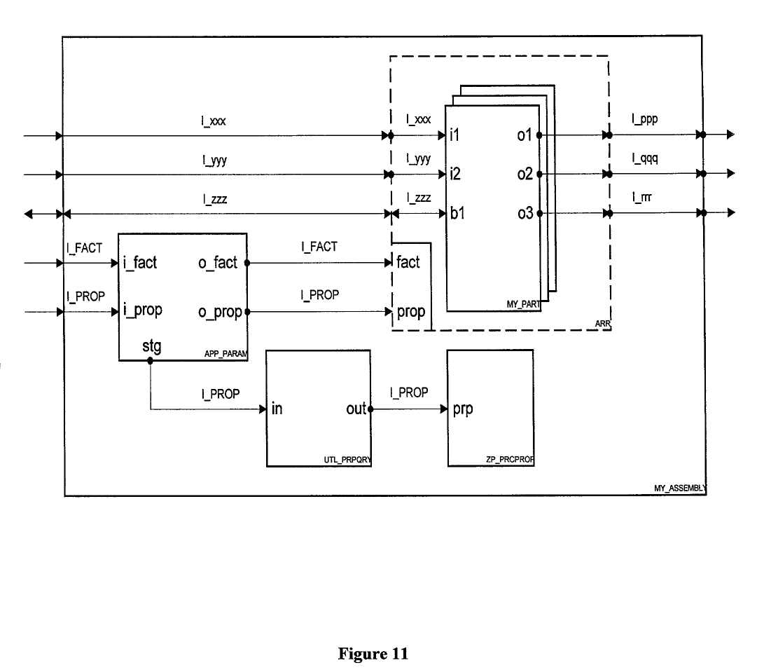

FIG. 11 illustrates an advantageous use of part, PRCCONST This example has PRCCONST connected to UTL_PRPQRY for the purpose of de-serializing component elements within ARR. In the assembly declaration for MY_ASSEMBLY, properties intended for the parameterization of MY_PART are declared using the paramT macro under the part declaration for PRCCONST. When APP_PARAM is triggered, de-serialization begins with the enumeration of properties out of PRCCONST. Properties declared on PRCCONST are enumerated and provided for the parameterization of MY_PART within the part array.

7. Document References

None.

8. Unresolved Issues

None

9. Notes

When using PRCCONST within an assembly, the assembly should not redirect properties maintained by PRCCONST to other subordinates. If specific attributes are desired in order to filter properties during enumeration, the assembly into which PRCCONST is placed must override the attributes of properties maintained by PRCCONST.

UTL_PRPQRY may be used in front of PRCCONST in order to support more complex property queries.

### XDL—Event Manipulation

### EFS—Event Field Stamper

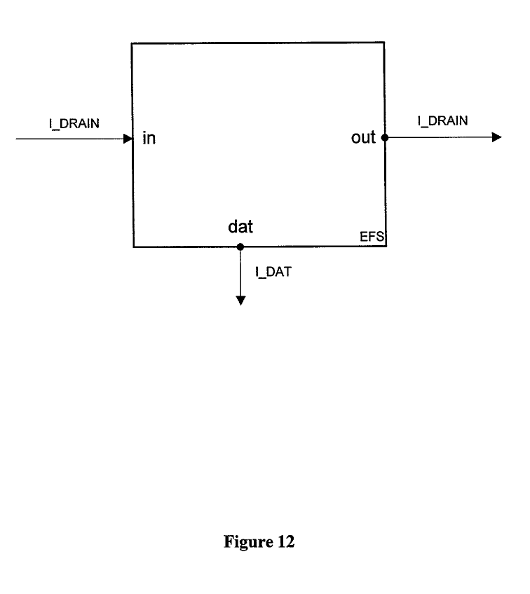

FIG. 12 illustrates the boundary of part, Event Field Stamper (EFS)

1. Functional Overview

EFS is an event manipulation part that stamps a specified value into a specified event field (event ID, attributes, size or completion status) of events passing from in to out. The value can be stamped either before or after the event is forwarded through the out terminal.

The value that EFS stamps into the event may be specified through either a property (defined on the boundary of EFS) or a data item retrieved through the dat terminal.

EFS modifies the value before stamping it into the event using a bit-wise AND mask. The mask, value to stamp and which event field to update, are programmed through properties.

EFS is typically used in assemblies to initialize a generated event that needs to be sent. EFS parts are usually chained together in order to initialize multiple fields in a event.

2. Boundary

2.1 Terminals

| Name | Dir | Interface | Notes |
|---|---|---|---|
| In | in | I_DRAIN | EFS stamps the specified value in the specified |
| | | | event field of events received on this terminal |
| | | | before or after the event is forwarded through |
| | | | the out terminal. |
| | | | This terminal can be used during interrupt time. |
| | | | Note that EFS uses the dat terminal in the |
| | | | execution context of the in operation. |
| out | out | I_DRAIN | Events received from the in terminal are passed |
| | | | through this terminal either before or after the |
| | | | specified value has been stamped into the |
| | | | event. |
| dat | Out | I_DAT | EFS invokes the bind and get operations |
| | | | through this terminal to retrieve the data value |
| | | | to stamp. This terminal is floating (does |
| | | | not have to be connected). |

2.2 Properties

| Property name | Type | Notes |
|---|---|---|
| field | asciz | Event field to stamp the specified value in. Can |
| | | be one of the following values: |
| | | “id”: event ID |
| | | “size”: event size |
| | | “attr”: event attributes |
| | | “stat”: event completion status |
| | | Default value is “id” (event ID). |
| mask | uint32 | Bitwise mask that defines which bits are |
| | | affected in the event field that the value is |
| | | stamped. |
| | | EFS ANDs this mask with the retrieved |
| | | value and also ANDs the complement of |
| | | this mask with the value of the specified |
| | | event field. |
| | | If field is “attr”, this property may not |
| | | contain event creation attributes (ZEVT_{—} |
| | | A_SHARED and ZEVT_A_SAFE) in |
| | | checked build. |
| | | Default value is 0xFFFFFFFF. |
| stamp_pre | uint32 | Boolean. If TRUE, the specified value is |
| | | stamped before the incoming event is passed |
| | | through the out terminal; otherwise the value is |
| | | stamped after the event is passed through the |
| | | out terminal. |
| | | Note: Care should be taken when stamping the |
| | | value after (post) passing the event through out. |
| | | The recipient on the out terminal may destroy |
| | | the event. |
| | | Default value is TRUE. |
| val | uint32 | Value that should be stamped into the incoming |
| | | event. Used only if the name property is “”. |
| | | If field is “attr”, this property may not contain |
| | | event creation attributes (ZEVT_A_SHARED |
| | | or ZEVT_A_SAFE) in checked build. |
| | | This property is active-time. |
| | | Default value is 0. |
| name | asciz | Name of the data item that stores the value that |
| | | should be stamped into the incoming event. |
| | | If this property is empty (“”), EFS stamps the |
| | | value of the val property into the incoming |
| | | event. |
| | | Default value is “”. |
| type | uint32 | Data type of the data item [DAT_T_XXX]. |
| | | Valid values for this property are: DAT_T_{—} |
| | | BYTE, DAT_T_UINT32 and DAT_T_{—} |
| | | SINT32. |
| | | Default value is DAT_T_UINT32. |
| restore | Uint32 | Boolean. If TRUE, EFS restores the modified |
| | | event field to its original value after passing |
| | | the event through the out terminal. |
| | | Used only if stamp_pre iS TRUE. |
| | | Note: Care should be taken when restoring the |
| | | value after (post) passing the event through out. |
| | | The recipient on the out terminal may destroy |
| | | the event. |
| | | Default value is FALSE. |

3. Events and Notifications

EFS accepts any event through the in terminal. EFS does not modify or interpret the event data.

3.1 Special Events, Frames, Commands or Verbs

None.

3.2 Encapsulated Interaction

None.

4. Specification

4.1 Responsibilities

Stamp the specified value into the specified event field either before or after forwarding the event through out as specified by the stamp_pre property.

Retrieve the value to stamp either from the val property or from a data item (by invoking the bind and get operations through the dat terminal). Update only the bits in the event field as specified by the mask property.

Restore the original value of the modified event field after forwarding the event through the out terminal (only if the stamp_pre and restore properties are TRUE).

4.2 Theory of Operation 4.2.1 Mechanisms

### Value Retrieval

EFS retrieves the value to stamp either from the val property or from the specified data item. If the name property is empty (“”), the value is retrieved from the val property. Otherwise, EFS first invokes the bind operation (through dat) to retrieve the data item handle associated with the data item name. Next, EFS invokes the get operation to retrieve the value of the data item.

If EFS fails to bind to the data item or retrieve its value, EFS displays an error message to the debug console (checked builds only) and fails the call.

Note that if the incoming event pointer is NULL, EFS passes the event through the out terminal.

### Modification of Event Field Values

After the value to stamp is retrieved, as described above, EFS ANDs (bitwise) the value with the mask property value. Next, EFS ANDs (bitwise) the event field value with the complement of the mask property value. Finally, the two resulting values are ORed together. Below is the formula used by EFS to update the specified event field in the incoming event:

event field value=(event field value & ˜mask)|(value & mask)

If the stamp_pre and restore properties are TRUE, EFS restores the event field to its original value after forwarding the event through out.

Note that if an incoming event is constant (the ZEVT_A_CONST attribute is set), EFS fails and returns ST_REFUSE.

4.3 Use Cases

4.3.1 Stamping Event IDs

The use case presented below updates the event ID field of the incoming events with the value of a data item named “event_id”. The dat terminal of EFS should be connected to a data item container used to store the data items.

Typically, this is used in assemblies where an event needs to be generated with specific fields. A chain of EFSes is strung together to initialize all the fields of a particular event.

EFS is parameterized with the following:

field=“id” (event ID)

mask=0xFFFFFFFF (no change)

stamp_pre=TRUE

name=“event id”

type=DAT_T_UINT32

restore=FALSE

An event is received through EFS's in terminal.

EFS retrieves the “event_id” data item value using the dat terminal.

Next, EFS ANDs the event ID data item value with 0xFFFFFFFF (no change). The event ID of the incoming event is ANDed with the complement of 0xFFFFFFFF to clear its value.

EFS updates the event ID of the incoming event and forwards the event through the out terminal.

The event may travel through multiple EFS parts in order to initialize its fields.

EFX—Event Field Extractor

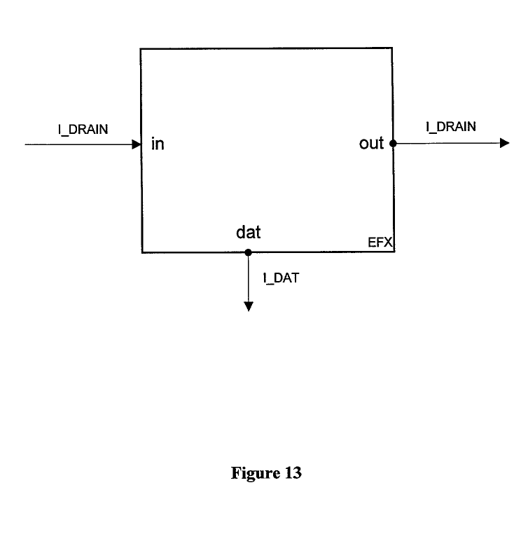

FIG. 13 illustrates the boundary of part, Event Field Extractor (EFX)

1. Functional Overview

EFX is an event manipulation part that extracts an event field value (event ID, attributes, size or completion status) from an event passing from in to out and stores it in two places: as a data item out the dat terminal and in a read-only property defined on EFX's boundary.

EFX modifies the event field value before storing it using a bit-wise AND mask.

The event field value may be extracted either before or after passing the event through the out terminal.

The event field to extract, AND mask and the name of the data item to set are all specified through properties.

EFX is typically used in assemblies where one or more of the event fields need to be saved for use in the creation of a new event.

2. Boundary

2.1 Terminals

| Name | Dir | Interface | Notes |
|---|---|---|---|
| in | in | I_DRAIN | Event field data is extracted from the events |
| | | | received on this terminal as specified by EFX's |
| | | | properties (before or after the event is |
| | | | forwarded through the out terminal). |
| | | | This terminal may be used during interrupt |
| | | | time. Note that EFX uses the dat terminal in the |
| | | | execution context of the in operation. |
| out | out | I_DRAIN | Events received from the in terminal are passed |
| | | | through this terminal either before or after the |
| | | | event field data has been extracted from the |
| | | | event. |
| dat | out | I_DAT | EFX invokes the bind and set operations |
| | | | through this terminal to store the extracted |
| | | | event field data value (bind and set are called |
| | | | every time for each event received through in). |
| | | | This terminal is floating (does not have to be |
| | | | connected). |

2.2 Properties

| Property name | Type | Notes |
|---|---|---|
| field | asciz | Event field to extract from events received |
| | | through the in terminal. Can be one of the |
| | | following values: |
| | | “id”: event ID |
| | | “size”: event size |
| | | “attr”: event attributes |
| | | “stat”: event completion status |
| | | Default value is “id”(event ID). |
| mask | uint32 | Bitwise mask ANDed with the specified event |
| | | field value extracted from the incoming event. |
| | | EFX masks the extracted value before storing |
| | | the value in the val property or in a data item. |
| | | Default value is 0xFFFFFFFF (no change). |
| extract_pre | uint32 | Boolean. If TRUE, the event field value is |
| | | extracted before the event is passed through the |
| | | out terminal; otherwise the event field value is |
| | | extracted after the event is passed through the |
| | | out terminal. |
| | | Note: Care should be taken when extracting |
| | | the value after (post) passing the event through |
| | | out. The recipient on the out terminal may |
| | | destroy the event. |
| | | Default is TRUE. |
| val | uint32 | Value of the event field extracted from the |
| | | incoming event. |
| | | EFX initializes this property to zero on |
| | | construction. |
| | | This property is read-only. |
| name | asciz | Name of the data item into which to store the |
| | | extracted event field value. |
| | | If this property is empty (“”), EFX only |
| | | updates the val property with the extracted |
| | | value. In this case the dat terminal is not used. |
| | | Default value is “”. |
| Type | uint32 | Data type of the data item [DAT_T_XXX]. |
| | | Valid values for this property are: DAT_T_{—} |
| | | BYTE, DAT_T_UINT32 and DAT_T_{—} |
| | | SINT32. |
| | | The default is DAT_T_UINT32. |

3. Events and Notifications

EFX accepts any event through the in terminal. EFX does not modify or interpret the event data.

3.1 Special Events, Frames, Commands or Verbs

None.

3.2 Encapsulated Interaction

None.

4. Specification

4.1 Responsibilities

Extract the event field value from the event bus either before or after forwarding the event through out as specified by the extract_pre property.

Modify the extracted value as specified by the mask property.

Store the extracted value in the val property and as a data item (if the name property is not “”).

4.2 Theory of Operation

4.2.1 State Machines

None.

4.2.2 Mechanisms

### Event Field Value Extraction and Storage

EFX extracts the value from the event based on the field property (using the provided Z-Force event macros). The extracted value is then ANDed (bitwise) with the mask property value. The value is extracted based on the extract_pre property (either before or after forwarding the event through the out terminal).

The resulting value is first stored in the val read-only property. Next, if the name property is not empty (“”), EFX stores the value as a data item using the dat terminal.

EFX first invokes the bind operation to retrieve the data item handle (associated with the data item name). Next, EFX invokes the set operation to set the value of the data item.

If EFX fails to bind to the data item or set its value, EFX only displays an error message to the debug console (checked builds only). The incoming event is always forwarded through the out terminal.

Note that in all cases, EFX extracts the specified value and stores it (even if passing the incoming event through out fails).

4.3 Use Cases

4.3.1 Extracting Event IDs

This use case extracts the event ID from the incoming event and stores it in a data item named “event_id”. The dat terminal of EFX should be connected to a data item container used to store the data items.

EFX is parameterized with the following:

field=“id” (event_ID)

mask=0xFFFFFFFF (no change)

extract_pre=TRUE

name=“event id”

type=DAT_T_UINT32

An event is received through EFX's in terminal.

EFX extracts the event ID and ANDs the ID with 0xFFFFFFFF (no change).

EFX updates the val property with the event ID and then sets the “event_id” data item through the dat terminal (after binding to the data item handle).

At a later time, the “event_id” data item may be read from the data container to create a new event with the same ID (using EFS).

### ERC—Event Recoder

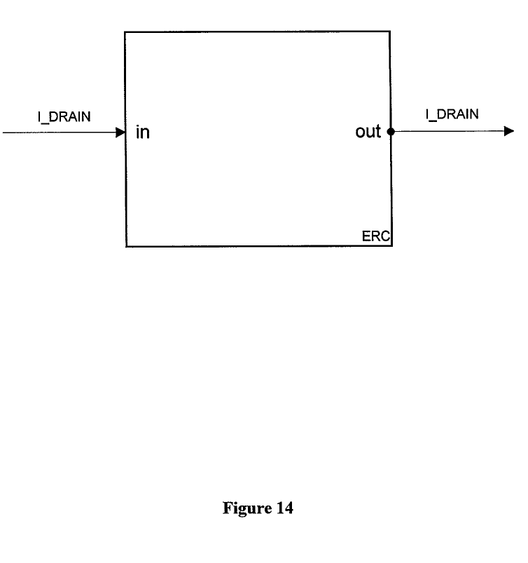

FIG. 14 illustrates the boundary of part, Event Recoder (ERC)

1. Functional Overview

ERC is an event manipulation part used to recode event fields (event ID, attributes, size or completion status) in an event flow. ERC recodes the specified event field in incoming events by either adding or subtracting a specific value to the field. The event field to recode and the value to add or subtract from the field are programmed through properties.

ERC may be parameterized to recode the event either before or after forwarding the event through the out terminal.

ERC has an option to restore the modified field to its original value before returning.

ERC restores the event bus only if it had originally modified the bus contents.

2. Boundary

2.1 Terminals

| Name | Dir | Interface | Notes |
|---|---|---|---|
| In | In | I_DRAIN | The incoming events received through this |
| | | | terminal are recoded (if needed) and are |
| | | | passed though out. |
| | | | This terminal may be used during interrupt |
| | | | time. |
| out | Out | I_DRAIN | Events received from the in terminal are |
| | | | recoded (if needed) and are passed through |
| | | | this terminal. |

2.2 Properties

| Property name | Type | Notes |
|---|---|---|
| field | asciz | Event field to recode. Can be one of the |
| | | following values: |
| | | “id”: event ID |
| | | “size”: event size |
| | | ”attr”: event attributes |
| | | “stat”: event completion status |
| | | Default value is “id” (event ID). |
| val | uint32 | Integer value that is either added to or |
| | | subtracted from the specified event field. |
| | | If field is “attr”, this property may not |
| | | contain event creation attributes (ZEVT_A_{—} |
| | | SHARED or ZEVT_A_SAFE) in checked |
| | | build. |
| | | Default value is 0 (no change). |
| add | uint32 | Boolean. If TRUE, the val property is added |
| | | to the specified event field; otherwise the |
| | | val property is subtracted from the field. |
| | | Default value is TRUE. |
| recode_pre | uint32 | Boolean. If TRUE, the specified event field |
| | | is recoded before the incoming event is |
| | | passed through the out terminal; otherwise |
| | | it is recoded after the event is passed |
| | | through the out terminal. |
| | | Note: Care should be taken when recoding the |
| | | event after (post) passing the event through |
| | | out. The recipient on the out terminal may |
| | | destroy the event. |
| | | Default value is TRUE. |
| restore | uint32 | Boolean. If TRUE, ERC restores the recoded |
| | | event field to its original value before |
| | | returning. Used only if the recode_pre |
| | | property is TRUE. |
| | | Note: Care should be taken when restoring the |
| | | event after passing it through out. The |
| | | recipient on the out terminal may destroy the |
| | | event. |
| | | Default value is FALSE. |

3. Events and Notifications

ERC accepts any Dragon event through the in terminal. ERC does not modify or interpret the event data (except for the specified event field to be recoded).

3.1 Special Events, Frames, Commands or Verbs

None.

3.2 Encapsulated Interaction

None.

4. Specification

4.1 Responsibilities

Recode the incoming event as specified by properties. Recode the event either before or after passing the event through the out terminal.

Restore the modified event field to its original value before returning (only if the restore and recode_pre properties are TRUE).

4.2 Theory of Operation

4.2.1 Mechanisms

### Recoding an Event Field

The event field to recode is specified through the field property. ERC retrieves the value of this field and either adds or subtracts the val property from this value.

ERC recodes the event either before or after the event is forwarded through the out terminal (depending on the recode_pre property).

ERC may be parameterized to restore the recoded field to its original value after forwarding the event. In this case after the event is recoded and passed through out, ERC restores the field to its original value and returns. This applies only when the event is recoded before passing the event through out (recode_pre is TRUE).

Note that if an incoming event is constant (the ZEVT_A_CONST attribute is set), ERC fails and returns ST_REFUSE.

4.3 Use Cases

4.3.1 Recoding and Event ID

The following use case recodes the event ID of all the incoming events by adding 1 to the ID. This can apply to any of the supported event fields: event ID, attributes, size or completion status.

ERC is created and parameterized with the following:

field=“id”

val=1

add=TRUE

recode_pre=TRUE

restore=FALSE

An event with the ID of 0x222 is passed to ERC through its in terminal.

ERC recodes the event ID to 0x223 (adds 1 to the event ID) and passes the event through the out terminal.

### ERCB—Bi-directional Event Recoder

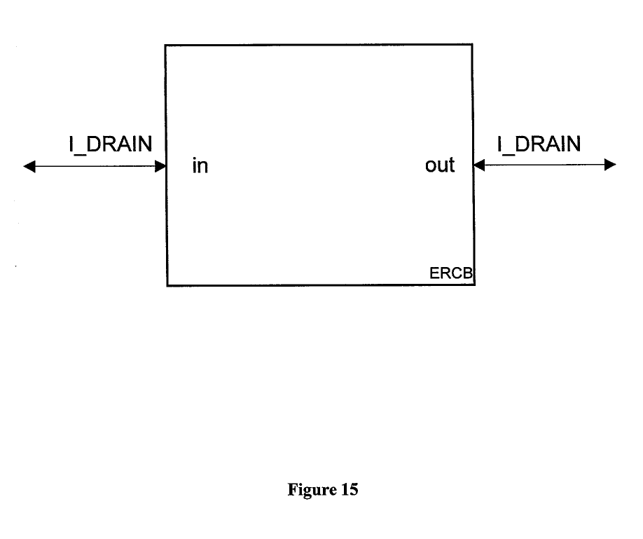

FIG. 15 illustrates the boundary of part, Bi-directional Event Recoder (ERCB)

1. Functional Overview

ERCB is an event manipulation part used to recode event fields (event ID, attributes, size or completion status) in an event flow. ERCB recodes the specified event field in incoming events (received through the in terminal) by either adding or subtracting a specific value to the field. The event field to recode and the value to add or subtract from the field are programmed through properties.

ERCB may be parameterized to recode the event either before or after forwarding the event through the out terminal.

ERCB has an option to restore the modified field to its original value before returning.

ERCB restores the event bus only if it had originally modified the bus contents.

Events received through the out terminal are forwarded through in without modification.

2. Boundary

2.1 Terminals

| Name | Dir | Interface | Notes |
|---|---|---|---|
| In | in | I_DRAIN | The incoming events received through this |
| | | | terminal are recoded (if needed) and are |
| | | | passed through out. |
| | | | This terminal may be used during interrupt |
| | | | time. |
| out | out | I_DRAIN | Events received from the in terminal are |
| | | | recoded (if needed) and are passed through |
| | | | this terminal. |
| | | | All events sent through this terminal are passed |
| | | | directly through in without modification. |

2.2 Properties

| Property name | Type | Notes |
|---|---|---|
| field | asciz | Event field to recode. Can be one of the |
| | | following values: |
| | | “id”: event ID |
| | | “size”: event size |
| | | “attr”: event attributes |
| | | “stat”: event completion status |
| | | Default value is “id” (event ID). |
| val | uint32 | Integer value that is either added to or |
| | | subtracted from the specified event field. |
| | | If field is “attr”, this property may not contain |
| | | event creation attributes (ZEVT_A_{—} |
| | | SHARED or ZEVT_A_SAFE) in checked |
| | | build. |
| | | Default value is 0 (no change). |
| add | uint32 | Boolean. If TRUE, the val property is added |
| | | to the specified event field; otherwise the val |
| | | property is subtracted from the field. |
| | | Default value is TRUE. |
| recode_pre | uint32 | Boolean. If TRUE, the specified event field is |
| | | recoded before the incoming event is passed |
| | | through the out terminal; otherwise it is |
| | | recoded after the event is passed through |
| | | the out terminal. |
| | | Note: Care should be taken when recoding |
| | | the event after (post) passing the event |
| | | through out. The recipient on the out |
| | | terminal may destroy the event. |
| | | Default value is TRUE. |
| restore | uint32 | Boolean. If TRUE, ERCB restores the |
| | | recoded event field to its original value |
| | | before returning. Used only if the recode_pre |
| | | property is TRUE. |
| | | Note: Care should be taken when restoring |
| | | the event after passing it through out. The |
| | | recipient on the out terminal may destroy the |
| | | event. |
| | | Default value is FALSE. |

3. Events and Notifications

ERCB accepts any event through its inputs. ERCB does not modify or interpret the event data (except for the specified event field to be recoded).

3.1 Special Events, Frames, Commands or Verbs

None.

3.2 Encapsulated Interaction

None.

4. Specification

4. 1 Responsibilities

Recode the incoming event as specified by properties. Recode the event either before or after passing the event through the out terminal.

Restore the modified event field to its original value before returning (only if the restore and recode_pre properties are TRUE).

Pass all events received from out through in without modification.

4.2 Theory of Operation

4.2.1 Mechanisms

### Recoding an Event Field

The event field to recode is specified through the field property. ERCB retrieves the value of this field and either adds or subtracts the val property from this value.

ERCB recodes the event either before or after the event is forwarded through the out terminal (depending on the recode_pre property).

ERCB may be parameterized to restore the recoded field to its original value after forwarding the event. In this case after the event is recoded and passed through out,

ERCB restores the field to its original value and returns. This applies only when the event is recoded before passing the event through out (recode_pre is TRUE).

Note that if an incoming event is constant (the ZEVT_A_CONST attribute is set), ERCB fails and returns ST_REFUSE.

4.3 Use Cases

4.3.1 Recoding and Event ID

The following use case recodes the event ID of all the incoming events by adding 1 to the ID. This can apply to any of the supported event fields: event ID, attributes, size or completion status.

ERCB is created and parameterized with the following:

field=“id”

val=1

add=TRUE

recode_pre=TRUE

restore=FALSE

An event with the ID of 0x222 is passed to ERCB through its in terminal.

ERCB recedes the event ID to 0x223 (adds 1 to the event ID) and passes the event through the out terminal.

Any events received through the out terminal are passed through in without modification.

### XDL—Data Manipulation

### FDC—Fast Data Container

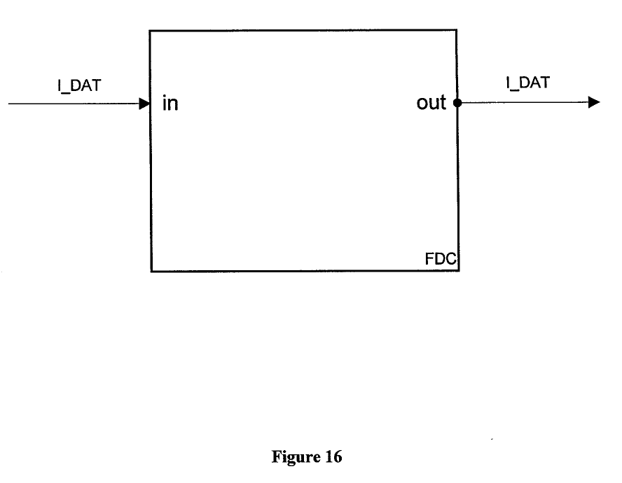

FIG. 16 illustrates the boundary of part, Fast Data Container (FDC)

1. Functional Overview

FDC implements a container for data items; data items are typically used in assemblies to keep track of state variables and other information. The container can hold up to 16 data items.

The data items are identified by a data item handle (as defined by the I_DAT interface; please see the documentation of this interface for more information). The data item handle is used by FDC for fast data item identification and access.

Operations on the contained data items include: binding to a data item handle by name (in.bind), retrieving information about the data item (in.get_info), retrieving the data item value (in.get) and modifying the data item value (in.set).

The data item names, types and default values are specified through properties. On construction, FDC initializes each data item to its specified default value. FDC supports all the data item types and operations as defined by the I_DAT interface.

FDC may be cascaded (several FDCs connected together) in order to support more then 16 data items. When an operation is invoked through the in terminal for an unrecognized data item, FDC forwards the operation through its out terminal to the next container in the chain.

FDC is unguarded does not provide any protection of the data it stores. If FDC is to be used in an environment where it may be entered from multiple threads, an external guard or critical section should be used.

2. Boundary

2.1 Terminals

| Name | Dir | Interface | Notes |
|---|---|---|---|
| in | in | I_DAT | This terminal is used to access the data items |
| | | | that are stored in the container. FDC supports |
| | | | all the operations defined by the I_DAT |
| | | | interface. |
| out | out | I_DAT | FDC forwards the incoming operations through |
| | | | this terminal for data items that are not found in |
| | | | the container. |
| | | | This terminal is used for cascading FDC so |
| | | | more then 16 data items can be supported. |
| | | | This terminal may be left unconnected |
| | | | (floating). |

2.2 Properties

| Property name | Type | Notes |
|---|---|---|
| name [0]- | asciz | Names of the data items that are stored in the data container. |
| name [15] | | Each name may contain up to 16 characters (including the |
| | | terminating string character). |
| | | FDC supports up to 16 data items. Use cascaded FDCs to |
| | | support more data items. |
| | | If the name is an empty string (“”), it is ignored. |
| | | The default values for each name is “” (not used). |
| type [0]- | uint32 | Types of the data items [DAT_T_XXX]. |
| type [15] | | The default value for each type is DAT_T_UINT32. |
| dflt_val [0]- | uint32 | Depending on the data item type, these properties contain |
| dflt_val [15] | | either the default value for the data item or the size of the |
| | | data item value storage. |
| | | For all property types except for fixed/variable-sized binary, |
| | | these properties contain the default value for the data item. |
| | | For asciz, unicoded and context types, these properties |
| | | contain a pointer to the default value. |
| | | For fixed/variable sized binary types, these properties |
| | | contain the initial size of the storage in the container for the |
| | | data item value. No default value can be specified for |
| | | binary types. |
| | | The default values are 0. |
| base | uint32 | Data item handle base. |
| | | FDC uses this value as the base value for data item handles. |
| | | Data item handles are calculated by adding the data item |
| | | index (0 . . . 15) to the value of this property. |
| | | When cascading several FDCs, the base value can be used to |
| | | identify the contents that holds a specific data item. |
| | | The base value must be between 1 and 0×FFFFFFF0. |
| | | The default value is 1. |

3. Events and Notifications

None.

3.1 Special Events, Frames, Commands or Verbs

None.

3.2 Encapsulated Interaction

None.

4. Specification

4.1 Responsibilities

Maintain a static container for data item values (maximum of 16 data items).

On construction, allocate an array of entries used to store the data item values.

Initialize all data item values to their corresponding default values as specified through properties.

On the in.bind operation, search for the specified data item in the name property array and pass back the corresponding data item handle (handle=data item name index+the value of the base property).

On the in.get_info operation, pass back the type of the specified data item.

On the in.get operation, pass back the data item value for the specified data item.

On the in.set operation, update the specified data item value in the container.

On any of the I_DAT operations, if the specified data item is not found, forward the operation through the out terminal. Do not modify the operation bus.

4.2 Theory of Operation

4.2.1 State Machines

None.

4.2.2 Mechanisms

### Data Item Value Storage

On construction, FDC allocates an array of entries that are used to store the data item values and any other information needed by the container. The array is indexed in the same manner as the data item properties (0..15). On the in. get and in. set operations, FDC uses this array to retrieve and modify the data item values.

### Data Item Binding and Identification

Data item handles identify data items. A data item handle is made up of the data item entry index (0..15) and the data item handle base (value of the base property). A data item handle is calculated by adding the data item entry index to the data item handle base.

Data item handles are retrieved using the bind operation. The operation bus specifies the data item name that FDC uses to calculate the corresponding data item handle. The data item handle is used in the rest of the operations for fast data item identification and access.

### Data Container Cascading

FDC can only contain up to 16 data items. This limit can be overcome by cascading FDC.

If FDC receives a request for a data item that it does not contain, FDC passes the request through its out terminal. This allows multiple FDCs to be connected together in order to support more then 16 data items. The base property may be used to distinguish between which container a data item belongs to.

4.3 Use Cases

### 4.3.1 Cascading Data Containers

This use case describes how to cascade multiple data containers together in order to support more then 16 data items. This example presents two FDC's connected together, each one containing one data item for simplicity.

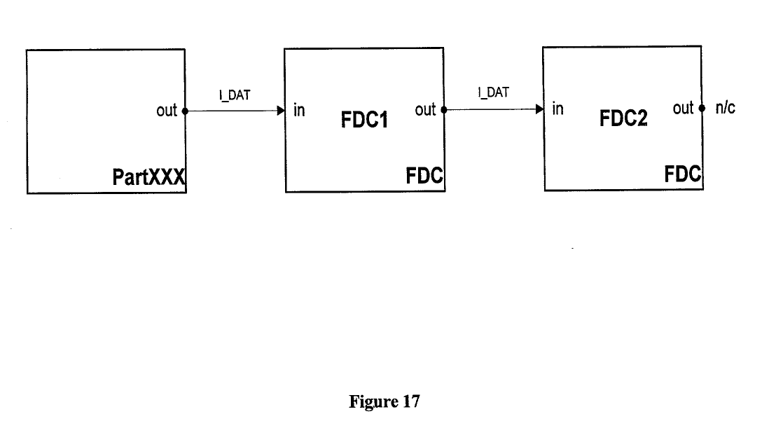

FIG. 17 illustrates Cascading FDC

PartXXX is a part that uses the services of FDC to maintain several state variables. The first variable is named “dat_item1” which is stored in FDC1. The second variable is named “dat_item2” which is stored in FDC2. PartXXX may use up to 32 variables: 16 stored in FDC1 and 16 stored in FDC2.

FDC1 of class FDC is created and parameterized with the following:

a. name [0]=“data_item1”

b. type [0]=DAT_T_UINT32

c. dflt_val [0]=10

d. base=1

FDC2 of class FDC is created and parameterized with the following:

a. name [0]=“data_item2”

b. type [0]=DAT_T_UINT32

c. dflt_val [0]=20

d. base=10

All parts are activated. FDC1 and FDC2 create a data item entry array and initialize the first entries (index 0) with the specified default values for the data items: “dat_item1”=10 and “dat_item2”=20.

FDC1 receives a request from PartXXX to bind to the “dat_item1” data item. FDC1 searches for the data item in the name array and finds it at index 0. FDC1 creates the data handle (index 0+base 1) and returns it to the caller (data item handle is 1).

FDC1 receives a request from PartXXX to bind to the “dat_item2” data item. FDC1 searches for the data item in the name array and does not find it. FDC1 passes the call through the out terminal to FDC2.

FDC2 receives a request from FDC1 to bind to the “dat_item2” data item. FDC2 searches for the data item in the name array and finds it at index 0. FDC2 creates the data handle (index 0+base 10) and returns it to the caller (data item handle is 10). The bind operation call returns back to PartXXX with the data item handle for “dat_item2”.

PartXXX may then get and set the data item values using the supplied data item handles.

5. Notes

FDCs access through the dat terminal is non-atomic. Therefore, an assembly using this part may need to use external guarding.

For non-integral data item types, FDC does not provide conversion between different types of data items. When retrieving or modifying a data item value, the supplied data type in the operation bus must be the same as the data item type.

### ALU—Arithmetic/Logic Unit

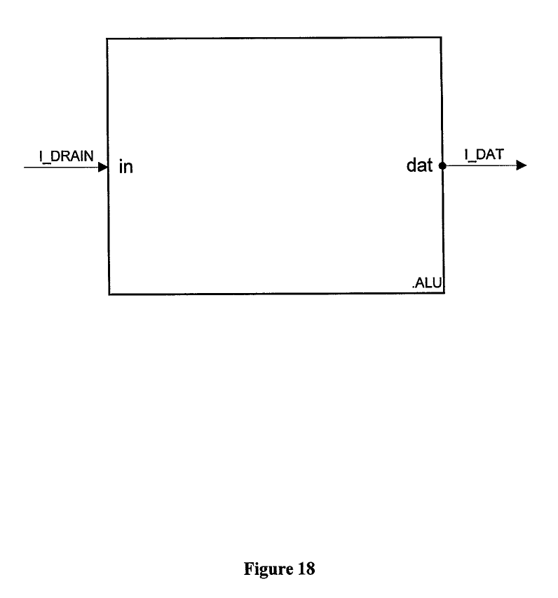

FIG. 18 illustrates the boundary of part, Arithmetic/Logic Unit (ALU)

1. Functional Overview

ALU is a data manipulation part that performs arithmetic/logic operation over integral data items when a trigger event is received.

When a trigger event is received on in terminal, ALU retrieves, through dat terminal, the value of data item(s) necessary to execute the arithmetic/logic operation. The result of the operation is sent out through dat terminal.

The trigger event, the operation type, the name and the type of operands and the name and the type of the result data item can be specified through properties.

2. Boundary

2.1 Terminals

| Name | Dir | Interface | Notes |
|---|---|---|---|
| in | in | I_DRAIN | When the trigger event is received on this terminal, ALU |
| | | | performs arithmetic/logic operation over specified data items. |
| | | | This terminal is unguarded. |
| dat | out | I_DAT | ALU invokes bind and get operations through this terminal to |
| | | | retrieve the value of the operand items. |
| | | | ALU invokes bind and set operations out this terminal to |
| | | | store the operation result in specified data item. |

2.2 Properties

| Property name | Type | Notes |
|---|---|---|
| trigger_ev | uint32 | Trigger Event ID. When this event is received, ALU |
| | | performs the specified by opcode operation. |
| | | When EV_NULL, any event received on in terminal will |
| | | trigger arithmetic/logic operation. |
| | | The default value is EV_NULL. |
| opcode | asciz | Type of arithmetic/logical operation to be executed over the |
| | | specified by op1.name and op2.name data items (operands). |
| | | This property is mandatory. |
| op1.name | asciz | Name of integral data item to be used in the arithmetic/logic |
| | | operation as a first argument. |
| | | The value of this property cannot be an empty string. |
| | | This property is mandatory. |
| op1.type | uint32 | Type of the first data operand. |
| | | The allowed values are DAT_T_BYTE, DAT_T_UINT32, |
| | | DAT_T_SINT32 and DAT_T_BOOLEAN. |
| | | This property is mandatory. |
| op2.name | asciz | Name of integral data item to be used in the arithmetic/logic |
| | | operation as a second argument. |
| | | The default value is “” (this argument is not used). |
| op2.type | uint32 | Type of the first data operand. |
| | | The allowed values are DAT_T_NONE, DAT_T_BYTE, |
| | | DAT_T_UINT32, DAT_T_SINT32 and DAT_T_BOOLEAN. |
| | | DAT_T_NONE type is used only when this argument is not |
| | | used (i.e., op2.name is en empty string) |
| | | The default value is DAT_T_NONE (this argument is not used). |
| res.name | asciz | Name of the data item used for storing the result of the |
| | | operation specified by opcode property. |
| | | The value of this property cannot be an empty string. |
| | | This property is mandatory. |
| res.type | uint32 | Type of the data item used for storing the result of the |
| | | arithmetic/logic operation. |
| | | The allowed values are DAT_T_BYTE, DAT_T_UINT32, |
| | | DAT_T_SINT32 and DAT_T_BOOLEAN. |
| | | This property is mandatory. |

3. Events and Notifications

3.1 Terminal: in

| Event | Dir | Bus | Notes |
|---|---|---|---|
| (trigger_ev) | in | any | When this event is received, ALU performs |
| | | | arithmetic/logical operation over the specified data items. |
| other | in | any | Any other event received on in terminal is completed with |
| | | | status ‘not supported’. |

3.2 Special events, frames, commands or verbs
The following table describes the operations executed by the ALU upon receiving of the
trigger event.
Note that if the result of any operation cannot be fit into 32-bit, only the lowest
significant 32-bits are used.

| Opcode | Operands | Type | Notes |
|---|---|---|---|
| “˜” | op1 | Arithmetic | Complementary operation. |
| | | | The result value is bitwize complement of the |
| | | | value of the first operand. I.e., inverting all |
| | | | operand bits creates the result. |
| “NEG” | op1 | Arithmetic | Negative Operation. |
| | | | This operation converts negative numbers into |
| | | | positive and vice-versa. |
| | | | For unsigned values, subtracting the operand from |
| | | | zero produces the result. |
| “−” | op1 | Arithmetic | Negative Operation. (Same as “NEG”) |
| | (no op2 | | This operation converts negative numbers into |
| | specified) | | positive and vice-versa. |
| | | | For unsigned values, subtracting the operand from |
| | | | zero produces the result. |
| “++” | op1 | Arithmetic | Increment by one. |
| | | | The result of this operation is equal to the value of |
| | | | the first operand incremented by one. |
| “−−” | op1 | Arithmetic | Decrement by one. |
| | | | The result of this operation is equal to the value of |
| | | | the first operand decremented by one. |
| “+” | op1, op2 | Arithmetic | Addition. |
| | | | The result of this operation is equal to the sum of |
| | | | the operands. |
| “−” | op1, op2 | Arithmetic | Subtraction. |
| | | | Subtracting the second operand from the first one |
| | | | creates the result of this operation. |
| “*” | op1, op2 | Arithmetic | Multiplication. |
| | | | Multiplying both operands creates the result of |
| | | | this operation. |
| “/” | op1, op2 | Arithmetic | Division. |
| | | | Dividing the first operand by the second one |
| | | | creates the result of this operation. |
| | | | When two signed operands are divided and only |
| | | | one of them has a negative value, the division is |
| | | | made by using operand's absolute values and |
| | | | inverting the result sign. |
| | | | Note that the second operand cannot be equal to |
| | | | zero. (No division by zero is allowed.) |
| “%” | op1, op2 | Arithmetic | Modulus (Division Reminder). |
| | | | The result is the reminder when the first operand |
| | | | is divided by the second operand. |
| | | | When both operands are signed, the operation is |
| | | | executed over their absolute values. The result |
| | | | sigh is equal to the sign of the first operand. |
| | | | Note that the second operand cannot be equal to |
| | | | zero. (No division by zero is allowed.) |
| “\|” | op1, op2 | Arithmetic | Bitwise (Inclusive) OR |
| | | | The result has its bit set when any of the operands |
| | | | have their correspondent bit set. The result bit is |
| | | | clear when both operands have their |
| | | | correspondent bit clear. |
| “&” | op1, op2 | Arithmetic | Bitwise AND |
| | | | The result has its bit set when both operands have |
| | | | their correspondent bit set. The result bit is clear |
| | | | when any of the operands have their |
| | | | correspondent bit clear. |
| “\hat{ }” | op1, op2 | Arithmetic | Bitwise Exclusive OR |
| | | | (Sum Modulo Two) |
| | | | The result bit is set when correspondent operand |
| | | | bits are different (e.g., one of them is set, the other |
| | | | is clear). The result has its bit clear when the |
| | | | correspondent bits (in both operands) are equal. |
| “<<” | op1, op2 | Arithmetic | Bitwise Left Shift |
| | | | The result is produced by shifting left the first |
| | | | operand by the number of positions specified by |
| | | | the second operand. This is equivalent to |
| | | | multiplying the first operand by 2 raised to the |
| | | | power of the second operand. |
| | | | Note that the value of the second operand must be |
| | | | greater or equal than zero. |
| “>>” | op1, op2 | Arithmetic | Bitwise Right Shift |
| | | | The result is produced by shifting right the first |
| | | | operand by the number of positions specified by |
| | | | the second operand. This is equivalent to dividing |
| | | | the first operand by 2 raised to the power of the |
| | | | second operand. |
| | | | Note that the value of the second operand must be |
| | | | greater or equal than zero. |
| “!” | op1 | Logical | Logical Negation (logical-NOT). |
| | | | When the operand is TRUE (non-zero), the result |
| | | | is equal to FALSE (zero). When the operand is |
| | | | FALSE (zero), the result is equal to TRUE (one). |
| “∥” | op1, op2 | Logical | Logical OR. |
| | | | When the value of any of the operands is TRUE |
| | | | (non-zero), the result is equal to TRUE (one). |
| | | | When both operands are FALSE (zero), the result |
| | | | is equal to FALSE (zero). |
| “&&” | op1, op2 | Logical | Logical AND. |
| | | | When the values of both operands are TRUE |
| | | | (non-zero), the result is equal to TRUE (one). |
| | | | When any of the operands is FALSE (zero), the |
| | | | result is equal to FALSE (zero). |
| “\hat{ }\hat{ }” | op1, op2 | Logical | Logical Exclusive OR. |
| | | | The result is TRUE (one), when one of the |
| | | | operands is TRUE (non-zero) and the other |
| | | | operand is FALSE (zero). Otherwise the result is |
| | | | FALSE (zero). |
| “==” | op1, op2 | Logical | Equality. |
| | | | The result is TRUE (one), when the values of both |
| | | | operands are equal. Otherwise the result is FALSE |
| | | | (zero). |
| “!=” | op1, op2 | Logical | Not-Equality. |
| | | | The result is FALSE (zero), when the values of |
| | | | both operands are different. Otherwise the result is |
| | | | TRUE (one). |
| “>” | op1, op2 | Logical | Greater (first operand). |
| | | | The result is TRUE (zero), when the value of the |
| | | | first operand is greater than the value of the |
| | | | second operand. Otherwise the result is FALSE |
| | | | (zero). |
| “<” | op1, op2 | Logical | Less (smaller first operand). |
| | | | The result is TRUE (zero), when the value of the |
| | | | first operand is smaller than the value of the |
| | | | second operand. Otherwise the result is FALSE |
| | | | (zero). |
| “>=” | op1, op2 | Logical | Greater-or-Equal (first operand). |
| | | | The result is TRUE (zero), when the value of the |
| | | | first operand is greater or equal to the value of the |
| | | | second operand. Otherwise the result is FALSE |
| | | | (zero). |
| “<=” | op1, op2 | Logical | Less or Equal (smaller or equal first operand). |
| | | | The result is TRUE (zero), when the value of the |
| | | | first operand is smaller or equal to the value of the |
| | | | second operand. Otherwise the result is FALSE |
| | | | (zero). |

For all operations listed bellow, ALU converts the signed operand to unsigned, if one of the operands is a signed integer and the other operand is not. The operand conversion does not change the operands bit-pattern.:

“+”—Addition.

“−”—Subtraction.

“*”—Multiplication.

“/”—Division.

“%”—Modulus (Division Reminder).

“|”—Bitwise (Inclusive) OR

“&”—Bitwise AND

“ˆ ”—Bitwise Exclusive OR (Sum Modulo Two)

“==”—Equality.

“!=”—Not-Equality.

“>”—Greater (first operand).

“<”—Less (smaller first operand).

“>=”—Greater-or-Equal (first operand).

“<=”—Less or Equal (smaller or equal first operand).

3.3 Encapsulated Interaction

None.

4. Specification

4.1 Responsibilities

Fail all unrecognized events received on in terminal.

When the trigger event is received, retrieve the values of the data operands by invoking the bind and get operations through the dat terminal.

Execute the arithmetic/logic operation specified by opcode property.

Ensure that the ‘boolean’ type result has only two values: one (TRUE) and zero (FALSE)

Store the result in the result data item (res.name) by invoking the bind and set operations through the dat terminal.

Fail the trigger event if an error occurs.

4.2 Theory of Operation

4.2.1 State Machines

None.

4.2.2 Mechanisms

None.

### CAT—Data Concatenator

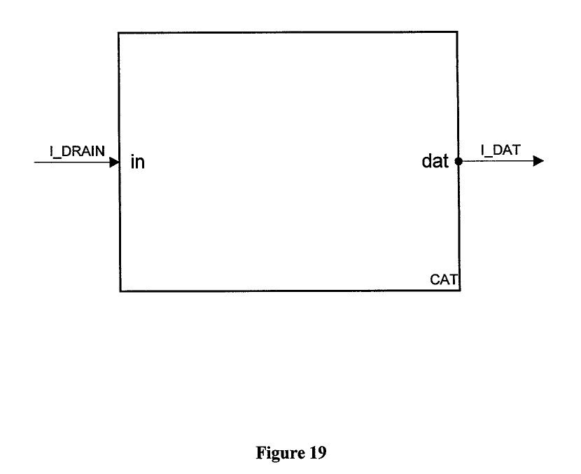

FIG. 19 illustrates the boundary of part, Data Concatenator (CAT)

1. Functional Overview

CAT is a data manipulation part that concatenates string or binary data on a trigger event.

When a trigger event is received on in terminal, CAT retrieves the value of two data items, concatenates them and stores the result in a third data item.

CAT utilizes dat terminal for retrieving the operand data and storing the result in the specified data item. If any of the requests sent out through dat terminal fails, CAT completes the trigger event with the status returned on the dat terminal.

If the type of the operands doesn't match, CAT converts them to a common type before concatenating them. When the result type and the result data item type, doesn't match, CAT converts the result to match the type of the data item.

The trigger event, the name and type of the data items and the maximum result size can be specified through properties.

CAT provides a way to concatenate two data items. It can also be used for modifying the size of a data item or modify the data item type.

2. Boundary

2.1 Terminals

| Name | Dir | Interface | Notes |
|---|---|---|---|
| in | in | I_DRAIN | When the trigger event is received on this terminal, CAT |
| | | | concatenates two data items and stores the result in a third data |
| | | | item. |
| | | | This terminal is unguarded. |
| dat | out | I_DAT | CAT invokes bind and get operations out this terminal to |
| | | | retrieve the value of the operand items. |
| | | | CAT invokes bind and set operations out this terminal to |
| | | | store the concatenation result in the specified data item. |

2.2 Properties

| Property name | Type | Notes |
|---|---|---|
| trigger_ev | uint32 | Trigger Event ID. When this event is received, CAT |
| | | concatenates two data items and stores the result in another |
| | | data item. |
| | | When EV_NULL, any event received on in terminal will |
| | | trigger data item concatenation. |
| | | The default value is EV_NULL. |
| op1.name | asciz | Name of the data item used as first operand in data |
| | | concatenation. |
| | | When no name specified, this operand is not used. |
| | | The default value is “” (this operand is not used). |
| op1.type | uint32 | Type of the first data concatenation operand. |
| | | The allowed values are DAT_T_NONE, DAT_T_ASCIZ, |
| | | DAT_T_UNICODEZ, DAT_T_BIN_FIXED and DAT_T_BIN_VAR. |
| | | DAT_T_NONE type is used only when no operand name is |
| | | specified (e.g., op1.name is en empty string) |
| | | The default value is “” (this operand is not used). |
| op2.name | asciz | Name of the data item used as second operand in data |
| | | concatenation. |
| | | When no name specified, this operand is not used. |
| | | The default value is “” (this operand is not used). |
| op2.type | uint32 | Type of the second data concatenation operand. |
| | | The allowed values are DAT_T_NONE, DAT_T_ASCIZ, |
| | | DAT_T_UNICODEZ, DAT_T_BIN_FIXED and DAT_T_BIN_VAR. |
| | | DAT_T_NONE type is used only when no operand name is |
| | | specified (e.g., op2.name is en empty string) |
| | | The default value is “” (this operand is not used). |
| res.name | asciz | Name of the data item used for storing the result of the data |
| | | concatenation. |
| | | The value of the data item specified by op2.name property is |
| | | attached at the end of the value of the data item specified by |
| | | op1.name added. The result is stored in the data item specified |
| | | by res.name property. |
| | | The value of this property cannot be an empty string. |
| | | This property is mandatory. |
| res.type | uint32 | Type of the data item used for storing the result of the data |
| | | concatenation. |
| | | The allowed values are DAT_T_ASCIZ, DAT_T_UNICODEZ, |
| | | DAT_T_BIN_FIXED and DAT_T_BIN_VAR. |
| | | The default value is DAT_T_BIN FIXED |
| res.max_sz | uint32 | Specifies the maximum size, in bytes, of the data concatenation |
| | | result. |
| | | When zero (0), there is no limitation in the result size. |
| | | The default value is 0 (no maximum). |

3. Events and Notifications

3.1 Terminal: in

| Event | Dir | Bus | Notes |
|---|---|---|---|
| (trigger_ev) | in | any | When this event is received, CAT executes data item |
| | | | concatenation. |
| other | in | any | Any other event received on in terminal is completed with |
| | | | status ‘not supported’. |

3.2 Special Events, Frames, Commands or Verbs

None.

3.3 Encapsulated Interaction

None.

4. Specification

4.1 Responsibilities

When the trigger event is received, retrieve the values of the data concatenation operands by invoking the bind and get operations through the dat terminal.

If necessary convert data operands to the type used during data concatenation.

Concatenate two data items by attaching the second operand at the end of the first operand.

Convert the result to res.type.

If necessary, limit the size of the result to the value specified in res.max_sz.

Store the result in the result data item (res.name) by invoking the bind and set operations through the dat terminal.

Fail the trigger event if an error occurs.

4.2 Theory of Operation

4.2.1 State Machines

None.

4.2.2 Mechanisms

### Operand Type Conversion

The data concatenation is always executed over the operands with equal type. The following table displays type to which both operands are converted before concatenating them. Note that not all combinations are supported.

| Operand 1 Type | Operand 2 Type | Concatenation Type |
|---|---|---|
| none | none | none |
| none | asciz | asciz |
| none | unicodez | unicodez |
| none | binary fixed | binary fixed |
| none | binary variable | binary variable |
| asciz | none | asciz |
| asciz | asciz | asciz |
| asciz | unicodez | unicodez |
| asciz | binary fixed | (bad type combination) |
| asciz | binary variable | (bad type combination) |
| unicodez | none | unicodez |
| unicodez | asciz | unicodez |
| unicodez | unicodez | unicodez |
| unicodez | binary fixed | (bad type combination) |
| unicodez | binary variable | (bad type combination) |
| binary fixed | none | binary |
| binary fixed | asciz | (bad type combination) |
| binary fixed | unicodez | (bad type combination) |
| binary fixed | binary fixed | binary |
| binary fixed | binary variable | binary |
| binary variable | none | binary |
| binary variable | asciz | (bad type combination) |
| binary variable | unicodez | (bad type combination) |
| binary variable | binary fixed | binary |
| binary variable | binary variable | binary |

### Converting Concatenation Result

When the type of the concatenation result is different than the type of the data item used to store the result, CAT converts the result type to the item type. The binary (fixed or variable size) type result can be converted only to a binary type.

### Limiting the Concatenation Result Size

When the result size is bigger than the value of res.max_sz property, CAT reduces the result size to be no greater than the specified value. The cut off point is always at the end of a data item element_the bytes that build a single element cannot be separated. Note that the size of the result can be different than the value of res.max_sz property.

### ICS—Integer Constant Stamper

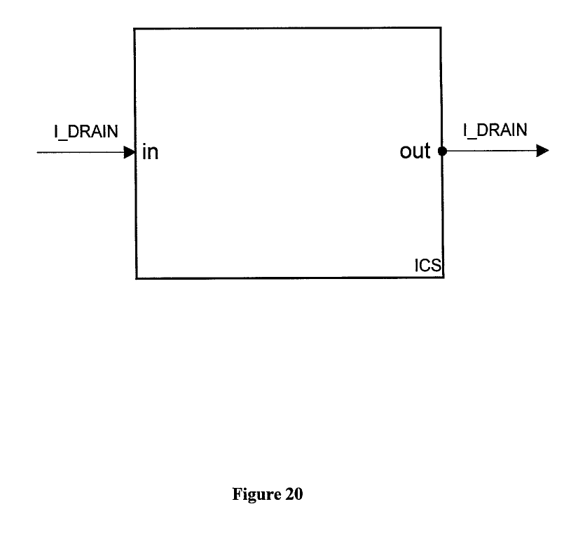

FIG. 20 illustrates the boundary of part, Integer Constant Stamper (ICS)

1. Functional Overview

ICS is used to stamp an integer constant value into an integer field in the events received through the in terminal. After modification, the events are forwarded through the out terminal.

The integer value can be stored into the bus in any byte order (specified by a property)—either the CPU's natural order or fixed MSB-first or LSB-first order. This feature can be used in processing network packets or other data with a fixed byte order that may or may not match the host CPU's natural byte order.

The integer field may be 1, 2, 3 or 4 bytes long; specified through the size property.

ICS may be parameterized to restore the modified field to its original value after forwarding the event through the out terminal.

2. Boundary

2.1 Terminals

| Name | Dir | Interface | Notes |
|---|---|---|---|
| in | in | I_DRAIN | The events received through this terminal are modified |
| | | | according to ICS's properties and are forwarded through out. |
| out | out | I_DRAIN | Events received from the in terminal are passed through this |
| | | | terminal after modification. |

2.2 Properties

| Name | Type | Notes |
|---|---|---|
| offset | uint32 | Specifies the location of the integer field in the |
| | | incoming event that ICS should modify |
| | | (specified in bytes). |
| | | Default is 0. |
| offset_neg | uint32 | Boolean. If TRUE, the offset is event size—the |
| | | value of the offset property; otherwise, the offset |
| | | is calculated from the beginning of the event. |
| | | The default is FALSE. |
| offset_neg | uint32 | Boolean. If TRUE, the offset specified by the |
| | | offset property is calculated from the end of the |
| | | event; otherwise, the offset is calculated from the |
| | | beginning of the event. |
| | | The default is FALSE. |
| size | uint32 | Specifies the size of the integer field in the |
| | | incoming event identified by offset (specified |
| | | in bytes). The size can be one of the following: |
| | | 1, 2, 3, or 4. |
| | | Default is 4 (size of uint32) |
| byte_order | sint32 | Specifies the byte order of the integer field |
| | | (identified by offset) in the incoming event. |
| | | Can be one of the following values: |
| | | Can be one of the following values: |
| | | 0 Native machine format |
| | | 1 MSB—Most-significant byte first |
| | | −1 LSB—Least-significant byte first |
| | | Default is 0 (Native machine format). |
| aligned | uint32 | Specifies whether the data field defined by the |
| | | offset property is correctly aligned. Set this |
| | | property to FALSE if ICS is used to process net- |
| | | work packets or other similar cases when offset |
| | | does not specify a valid uint16 or uint32 field |
| | | in the data bus. |
| | | Default value: TRUE. |
| value | uint32 | Constant value that ICS pastes into the specified |
| | | field in the incoming event. |
| | | Default is 0. |
| restore | uint32 | Boolean. If TRUE, ICS restores the modified |
| | | event field to its original value after passing the |
| | | event through the out terminal. |
| | | Note: Care should be taken when restoring the |
| | | value after (post) passing the event through out. |
| | | The event may be destroyed by the recipient on |
| | | the out terminal. In this case, ICS displays |
| | | a warning on the debug console and returns |
| | | without restoring the original field value |
| | | Default is FALSE. |

3. Events and Notifications

ICS accepts any Dragon event on its input.

3.1 Special Events, Frames, Commands or Verbs

None.

3.2 Encapsulated Interaction

None.

4. Specification

4.1 Responsibilities

Update the specified field with the constant value identified by the value property of all incoming events, and forward the events through the out terminal.

Before modifying the field value, convert the value using the proper byte order (as specified by the byte_order property).

After forwarding the event through the out terminal, if the restore property is TRUE, restore the modified field to its original value.

4.2 Theory of Operation

4.2.1 State Machines

None.

4.2.2 Main data structures

None.

4.2.3 Mechanisms

### Calculating the Data Offset

ICS uses the following formula to calculate the data offset:

offset_neg?ev_sz(bp)−offset: offset

4.3 Use Cases

This use case uses the following event definition:

typedef struct B_EV_SAMPLE

{
uint32 value;
} B_EV_SAMPLE;

In this case, ICS is used to stamp the constant value 1234 in the value field of B_EV_SAMPLE.

ICS is parameterized as follows:

offset=offset of the value field of B_EV_SAMPLE (0 bytes)

size=size of the value field of B_EV_SAMPLE (4 bytes)

byte_order=−1 (LSB)

value=1234 (constant value)

ICS receives an event through the in terminal (B_Ev_SAMPLE).

ICS updates the value field to 1234.

ICS forwards the event through the out terminal.

The event now contains the constant value 1234 in the value field.

### ITM—Integer Transmogrifier

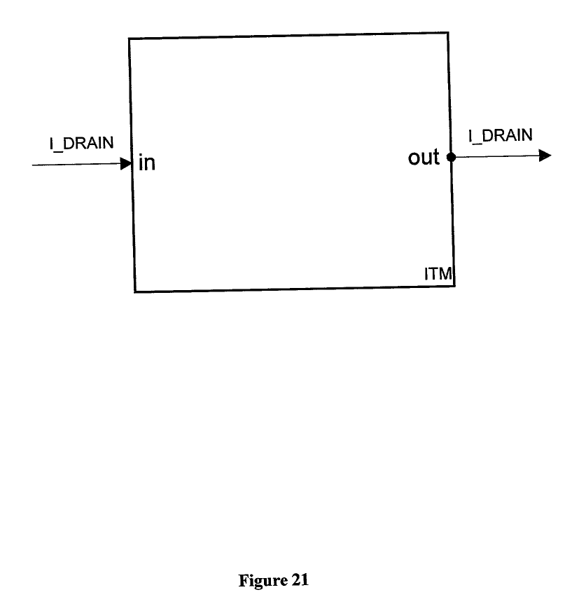

FIG. 21 illustrates the boundary of part, Integer Transmogrifier (ITM)

1. Functional Overview

ITM is used to modify a single integer field in the events received through the in terminal. After modification, the events are forwarded through the out terminal. ITM cannot modify the Z-force event object fields (evt_id, evt_sz, evt_attr and evt_stat). Use ERC to modify these fields.

ITM modifies the integer value using three masks: bit-wise AND mask, bit-wise OR mask, and bit-wise XOR mask. These masks are specified through properties.

The integer value can be stored in the bus in any byte order (specified by a property)—either the CPU's natural order or fixed MSB-first or LSB-first order. This feature can be used in processing network packets or other data with a fixed byte order that may or may not match the host CPU's natural byte order.

The integer field may be 1, 2, 3 or 4 bytes long; specified through the size property.

ITM may be parameterized to restore the modified field to its original value after forwarding the event through the out terminal.

ITM can be invoked at interrupt time.

2. Boundary

2.1 Terminals

| Name | Dir | Interface | Notes |
|---|---|---|---|
| in | in | I_DRAIN | The events received through this terminal |
| | | | are modified according to ITM's properties |
| | | | and are forwarded through out. |
| out | out | I_DRAIN | Events received from the in terminal are |
| | | | passed through this terminal after modification. |

2.2 Properties

| Property | | |
|---|---|---|
| name | Type | Notes |
| offset | uint32 | Specifies the location of the integer field in the |
| | | incoming event that ITM should modify. |
| | | (Specified in bytes). |
| | | Default is 0. |
| offset_neg | uint32 | Boolean. If TRUE, the offset is event |
| | | size—the value of the offset property; otherwise, |
| | | the offset is calculated from the beginning of the |
| | | event. |
| | | The default is FALSE. |
| size | uint32 | Specifies the size of the integer field in the |
| | | incoming event identified by offset (specified |
| | | in bytes). |
| | | The size can be one of the following: 1, 2, 3, or 4. |
| | | Default is 4 (size of uint32) |
| byte_order | sint32 | Specifies the byte order of the integer field |
| | | (identified by offset) in the incoming event. |
| | | Can be one of the following values: |
| | | 0 Native machine format |
| | | 1 MSB—Most significant byte first |
| | | −1 LSB—Least-significant byte first |
| | | Default is 0 (Native machine format). |
| aligned | uint32 | Specifies whether the data field defined by the |
| | | offset property is correctly aligned. Set this |
| | | property to FALSE if ITM is used to process |
| | | network packets or other similar cases when |
| | | offset does not specify a valid uint16 or |
| | | uint32 field in the data bus. |
| | | Default value: TRUE. |
| and_mask | uint32 | Mask that is bit-wise ANDed with the field value. |
| | | Default is OxFFFFFFFF (no change). |
| or_mask | uint32 | Mask that is bit-wise ORed with the field value. |
| | | Default is 0 (no change). |
| xor_mask | uint32 | Mask that is bit-wise XORed with the field value. |
| | | Default is 0 (no change). |
| restore | uint32 | Boolean. If TRUE, ITM restores the modified |
| | | event field to its original value after |
| | | passing the event through the out terminal. |
| | | Note: Care should be taken when restoring the |
| | | value after (post) passing the event through |
| | | out. The event may be destroyed by the |
| | | recipient on the out terminal. In this case, |
| | | ITM displays a warning on the debug console |
| | | and returns without restoring the original |
| | | field value. Default is FALSE. |

3. Events and Notifications

ITM accepts any event on its input.

3.1 Special Events, Frames, Commands or Verbs

None.

3.2 Encapsulated Interaction

None.

4. Specification

4.1 Responsibilities

Modify the integer field (identified by the offset and size properties) of all incoming events according to the and_mask, or_mask and xor_mask properties and forward the event through the out terminal.

Before modifying the field value, convert the value using the proper byte order (as specified by the byte_order property). After modifying the value and storing it back into the field, convert the value back to the original byte order.

Modify the field value in the following order: bit-wise AND, bit-wise OR, bit-wise XOR. Pass the event through the out terminal.

After forwarding the event through the out terminal, if the restore property is TRUE, restore the modified field to its original value.

4.2 Theory of Operation

4.2.1 State Machines

None.

4.2.2 Main Data Structures

None.

4.2.3 Mechanisms

### Calculating the Data Offset

ITM uses the following formula to calculate the data offset:

offset_neg?ev_sz(bp)−offset: offset

### Modifying a Field in the Incoming Event

Upon receiving an event from the in terminal, ITM modifies the integer field at the specified offset. The offset is calculated from the beginning or the end of the event depending on whether the offset value is positive or negative.

After the field value is retrieved from the event, if needed, ITM converts the value according to the specified byte order.

ITM then modifies the field value according to the and_mask, or_mask and xor_mask values. After the field is modified, ITM forwards the event through the out terminal.

Note that ITM fails the incoming event with ST_INVALID if the specified field overflows the event (field offset plus field size exceeds the size of the event).

4.3 Use Cases

This use case uses the following event definition:

typedef struct B_EV_SAMPLE

{
dword value;
} B_EV_SAMPLE;

In this case, ITM is used to stamp the constant value 1234 in the value field of B_EV_SAMPLE.

ITM is parameterized as follows:

offset=offset of the value field of B_EV_SAMPLE (0 bytes)

size=size of the value field of B_EV_SAMPLE (4 bytes)

byte_order=−1 (LSB)

and_mask=0 (clear out previous value of field)

or_mask=1234 (constant value)

xor_mask=0 (no change)

ITM receives an event through the in terminal (B₁₃ EV_SAMPLE).

ITM retrieves the DWORD value of the value field and applies the masks to it.

ITM forwards the event through the out terminal.

The event now contains the constant value 1234 in the value field.

5. Notes

ITM works only with memory-aligned buses.

The byte_order property applies only to the field in the incoming bus identified by the offset property. All property values are expected to be specified in the native machine format.

### SCS—Status Code Stamper

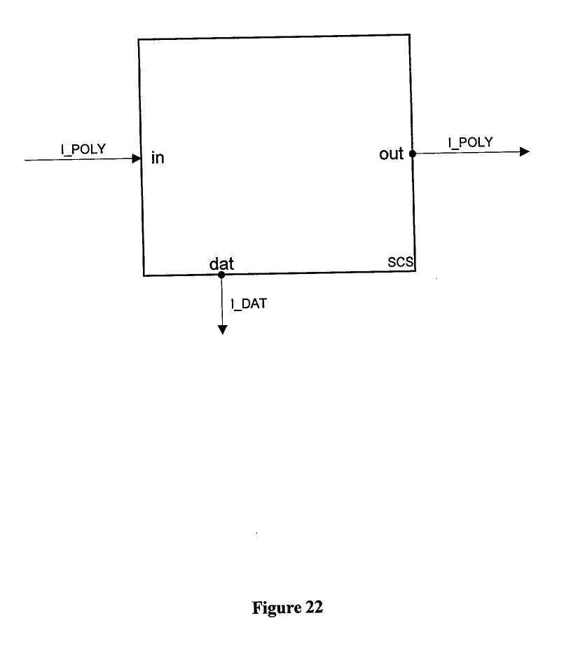

FIG. 22 illustrates the boundary of part, Status Code Stamper (SCS)

1. Functional Overview

SCS is a data manipulation part that retrieves the value of an integral data item and uses it as a return status for the passing operation.

SCS does not monitor or modify the content of the operations passing through it.

SCS uses its dat terminal for binding to the data item and retrieving the operation completion status from the specified data item.

The name of the data item is specified through a property. SCS does not submit any requests through its dat terminal if there is no data item specified (i.e., when the data item name is an empty string).

SCS can be used, in combination with other parts, to complete any operation by stamping the operation completion status in the operation bus.

NOTE: care should be taken when this part is used with an I_DRAIN connection that carries notification events (self-owned events), because the return status from such events indicates whether the event was accepted (destroyed) or rejected (not destroyed) by the recipient. If the status is recoded from or to ST_OK, this may cause an attempt to double free the event, or the event will not be freed at all.

2. Boundary

2.1 Terminals

| Name | Dir | Interface | Notes |
|---|---|---|---|
| in | in | I_POLY | Calls received from this terminal are forwarded |
| | | | through out terminal. |
| | | | SCS completes the call with the value of the |
| | | | integral data item specified through item.name |
| | | | property. |
| | | | Note that a terminal with any contract can be |
| | | | connected to this output. It is the user's |
| | | | responsibility to ensure that the contract used |
| | | | on both sides of SCS is the same. |
| | | | This terminal is unguarded. |
| out | out | I_POLY | Calls received through the in terminal are |
| | | | forwarded through this terminal. |
| | | | Note that a terminal with any contract can be |
| | | | connected to this output. It is the user's |
| | | | responsibility to ensure that the contract used on |
| | | | both sides of SCS is the same. |
| dat | out | I_DAT | SCS invokes bind and get operations out this |
| | | | terminal to retrieve the completion status of the |
| | | | operation received on in terminal. |

2.2 Properties

| Property | | |
|---|---|---|
| name | Type | Notes |
| item.name | asciz | Name of the predefined data item whose value is used |
| | | as a completion status of the operation received on in |
| | | terminal. The data item type must be |
| | | DAT_T_UINT32. |
| | | If the value of this property is an empty string, SCS |
| | | does not send any requests out through dat terminal. |
| | | The default value is “” |

2.3 Events and Notifications

None.

2.4 Special Events, Frames, Commands or Verbs

None.

2.5 Encapsulated Interaction

None.

3. Specification

3.1 Responsibilities

Forward all calls received on in terminal through out terminal without modifications.

If data item name is specified, bind to it and get the data item value and use it as a completion of the call received on in terminal.

If data item name is not specified, complete the incoming calls with the status returned on out terminal.

3.2 Theory of Operation

3.2.1 State Machine

None.

3.2.2 Mechanisms

None.

3.3 Use Cases

3.3.1 Assembling a Status Recoder

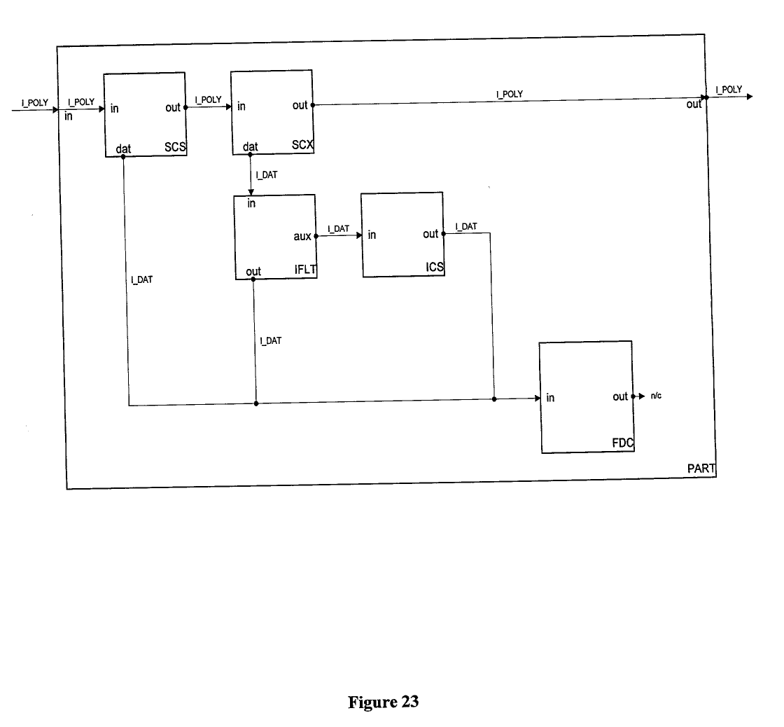

FIG. 23 illustrates an advantageous use of part, SCS

The figure illustrates how SCS can be used to assemble a status recoder.

The status returned on PART's out terminal is sent out through SCX's dat terminal as an I_DAT::set request. IFLT compares the operation completion status (stored in the operation bus) with the expected return status. If the status is the expected one, IFLT passes the operation to ICS, which recodes the stored completion status to the desired completion status. Finally the operation completion status (modified or unmodified) is stored in the fast data container (FDC). SCS retrieves the actual completion status from FDC and uses it as a completion status for the call received on PART's in terminal.

Note that PART is not protected from reentrancy.

### SCX—Status Code Extractor

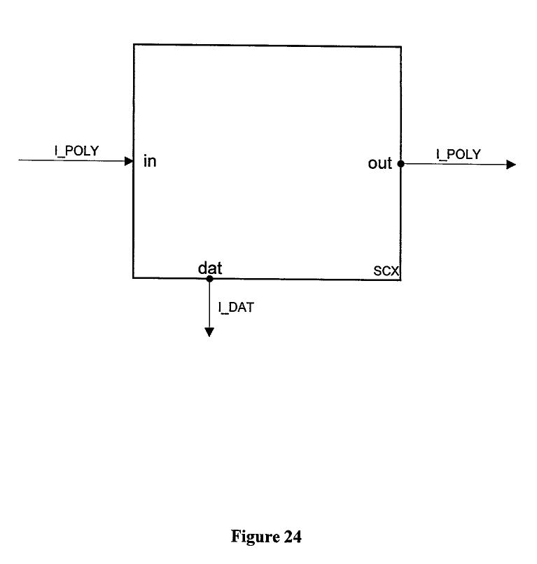

FIG. 24 illustrates the boundary of part, Status Code Extractor (SCX)

1. Functional Overview

SCX is a data manipulation part that extracts the completion status of the operations passing through its out terminal and stores it into an integral data item.

SCX does not monitor or modify the content of the operations passing through it.

SCX uses its dat terminal for binding to the data item and storing the operation completion status in the specified data item.

The name of the data item is specified through a property. SCX does not submit any requests through its dat terminal if there is no data item specified (i.e., when the data item name is an empty string).

SCX can be used, in combination with other parts, to stamp the operation completion status in the operation bus.

2. Boundary

2.1 Terminals

| Name | Dir | Interface | Notes |
|---|---|---|---|
| in | in | I_POLY | Calls received from this terminal are forwarded |
| | | | through out terminal. |
| | | | Note that a terminal with any contract can be |
| | | | connected to this output. It is the user's |
| | | | responsibility to ensure that the contract used |
| | | | on both sides of SCX is the same. |
| | | | This terminal is unguarded. |
| out | out | I_POLY | Calls received through the in terminal are |
| | | | forwarded through this terminal. |
| | | | When the call completes, SCX stores the |
| | | | completion status in a data item specified |
| | | | through properties. |
| | | | Note that a terminal with any contract can |
| | | | be connected to this output. It is the |
| | | | user's responsibility to ensure that the |
| | | | contract used on both sides of SCX is |
| | | | the same. |
| dat | out | I_DAT | SCX invokes bind and set operations out |
| | | | this terminal to store the completion status of |
| | | | the operation sent through out terminal. |

2.2 Properties

| Property | | |
|---|---|---|
| name | Type | Notes |
| item.name | asciz | Name of the predefined data item whose value is to set |
| | | to the completion status of the operation forwarded |
| | | through out terminal. The data item type must be |
| | | DAT_T_UINT32. If the value of this property |
| | | is an empty string, SCX does not send any requests out |
| | | through dat terminal. |
| | | The default value is “”. |

3. Events and Notifications

None.

3.1 Special Events, Frames, Commands or Verbs

None.

3.2 Encapsulated Interaction

None.

4. Specification

4.1 Responsibilities

Forward all calls received on in terminal through out terminal without modifications.

Complete the incoming calls with the status returned on out terminal.

If data item name is specified, bind to it and set the data item value to the status returned on out terminal.

4.2 Theory of Operation

4.2.1 State Machines

None.

4.2.2 Mechanisms

None.

4.3 Use Cases

4.3.1 Storing the Status in the Operation Bus

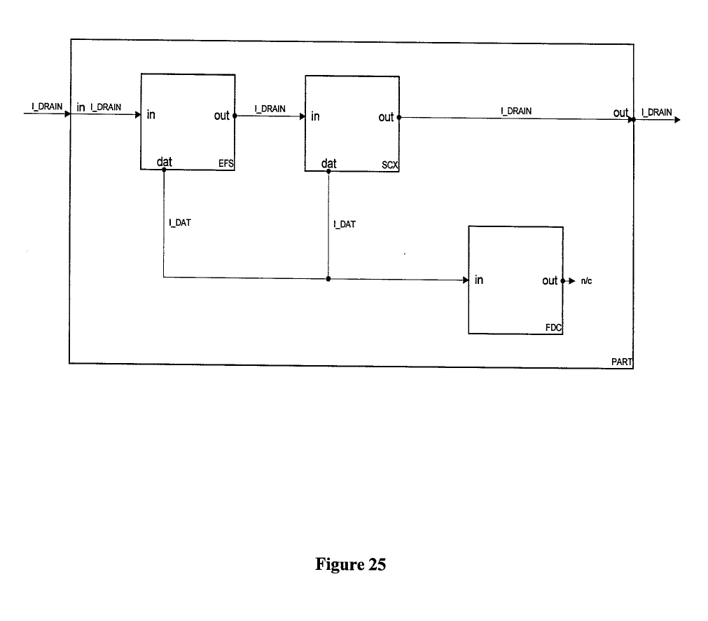

FIG. 25 illustrates an advantageous use of part, SCX

The figure illustrates how SCX can be used to stamp the returned status in the event bus.

The event field stamper forwards to SCX the event received on its in terminal. SCX forwards it out through PART's out terminal. When the event completes, SCX extracts the status returned on its out terminal and stores it into the fast data container (FDC). EFS extracts the event completion status from the FDC and stamps it in the “stat” event field.

Note that PART cannot be used with self-owned events, because the recipient on the out terminal could destroy the event and the EFS will stamp the status value in an undefined place.

### IDFC—Integral Data Field Comparator

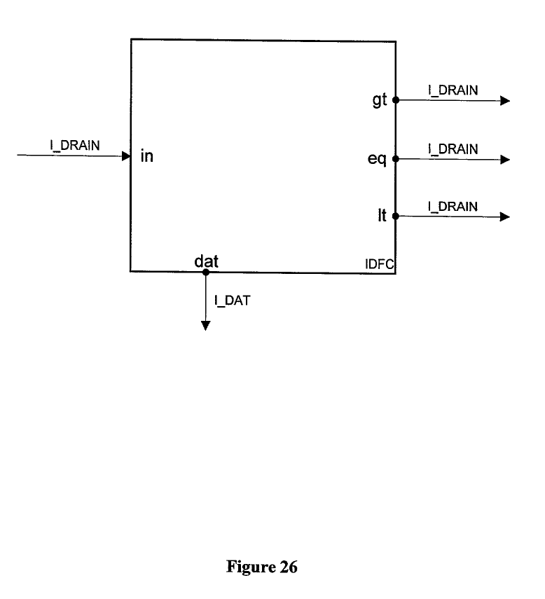

FIG. 26 illustrates the boundary of part, Integral Data Field Comparator (IDFC)

1. Functional Overview

IDFC is a data manipulation part that splits the event flow received on its in terminal. The event flow split depends upon whether the data item value (contained in the incoming event) is greater, equal or less than a predefined data item¹. ¹Note that the ZP_IDFC compares only data item values of integral type e.g., ‘byte’, ‘boolean’, ‘signed integer’, and ‘unsigned integer’ types.

When the incoming data item is greater than the predefined one, the event is sent out through gt terminal. When the data item values are equal the event is sent out through eq terminal. When the incoming data item is less than the predefined data item, the event is sent out through lt terminal.

IDFC obtains the value of the predefined data item by submitting a request through dat terminal. If the request fails, IDFC completes the incoming event with the status returned on the dat terminal.

If the compared data items have different types, the value types are equalized before the item comparison.

IDFC modifies the incoming data item value, before the comparison, using a bit-wise AND mask and performing a SHIFT operation on the data. The mask and the number of bits to shift are specified as properties.

If needed, IDFC converts the incoming data item value according to the specified byte order (i.e., MSB first or LSB first).

The field into which the incoming data item is stored may be 1, 2, 3 or 4 bytes long. IDFC always converts the data items to 4 bytes, by adding the necessary padding, before executing the item comparison.

2. Boundary

2.1 Terminals

| Name | Dir | Interface | Notes |
|---|---|---|---|
| in | in | I_DRAIN | IDFC receives an event containing a data item |
| | | | to be compared. Depending on the result of the |
| | | | comparison, the event is forwarded through one |
| | | | of the output terminals: gt, eq and it. |
| | | | This terminal is unguarded. |
| gt | out | I_DRAIN | Events received from the in terminal are passed |
| | | | through this terminal when the value of the |
| | | | incoming data item is greater than the predefined |
| | | | data item value. |
| eq | out | I_DRAIN | Events received from the in terminal |
| | | | are passed through this terminal when the value |
| | | | of the incoming data item is equal to the |
| | | | predefined data item value. |
| it | out | I_DRAIN | Events received from the in terminal are passed |
| | | | through this terminal when the value of the |
| | | | incoming data item is smaller than the predefined |
| | | | data item value. |
| dat | out | I_DAT | IDFC invokes bind and get operations out this |
| | | | terminal to retrieve the data value to compare. |

2.2 Properties

| Property | | |
|---|---|---|
| name | Type | Notes |
| item.name | asciz | Name of the predefined data item whose value is |
| | | to be compared with the value contained within |
| | | the incoming event. |
| | | If this property is empty, IDFC does not execute |
| | | any comparison; the incoming event is sent out |
| | | through the eq terminal. |
| | | The default value is “”. |
| item.type | uint32 | Type of data item [DAT_T_XXX]. Valid values |
| | | for this property are: DAT_T_BYTE, |
| | | DAT_T_UINT32, DAT_T_SINT32, |
| | | and DAT_T_BOOLEAN |
| | | The default value is DAT_T_UINT32. |
| val.type | uint32 | Type of data item [DAT_T_XXX] |
| | | placed in the incoming event. Valid values |
| | | for this property are: DAT_T_BYTE, |
| | | DAT_T_UINT32, DAT_T_SINT32, |
| | | and DAT_T_BOOLEAN |
| | | The default value is DAT_T_UINT32. |
| val.offs | uint32 | Specifies the location in the incoming event that |
| | | IDFC should compare with the value of the data |
| | | item specified in item.name. |
| | | If this value is >=0, the offset is from the |
| | | beginning of the event. If this value is <0, |
| | | the offset is from the end of the event |
| | | (−1 specifies the last byte). |
| | | The default value is 0 (first field of the event). |
| val.offs_neg | uint32 | Boolean. If TRUE, the offset is event size— |
| | | the value of the val.offs property; otherwise, |
| | | the offset is calculated from the beginning of |
| | | the event. |
| | | The default is FALSE. |
| val.sz | uint32 | Specifies the size of the field in the incoming |
| | | event identified by val.offs (specified in bytes). |
| | | The size can be one of the following: 1, 2, 3, or 4. |
| | | The default value is 4 (size of DWORD) |
| val.order | sint32 | Specifies the byte order of the value that is to |
| | | be stamped in the field (identified by val.offs) |
| | | in the incoming event. |
| | | Can be one of the following values: |
| | | 0 Native machine format |
| | | 1 MSB—Most-significant byte first (Motorola) |
| | | −1 LSB—Least-significant byte first (Intel) |
| | | The default value is 0 (Native machine format). |
| val.sgnext | uint32 | Boolean. If TRUE, values smaller than 4 bytes |
| | | are sign extended before the value is operated |
| | | on using val.mask and val.shift properties. |
| | | The default value is FALSE. |
| val.mask | uint32 | Mask that is bit-wise ANDed with the incoming |
| | | value before comparing it to the data item re- |
| | | turned on dat terminal. |
| | | The default value is OxFFFFFFFF (no change). |
| val.shift | sint32 | Number of bits to shift the incoming value before |
| | | comparing it to the data item returned on dat |
| | | terminal. If the value is positive (greater than 0), |
| | | the value is shifted to the right. If the value is |
| | | negative (lesser than 0), the value is shifted |
| | | to the left. |
| | | The default value is 0 (no change) |

3. Events and Notifications

IDFC accepts any Dragon event through the in terminal. The event size must be enough to hold the specified data item.

3.1 Special Events, Frames, Commands or Verbs

None.

3.2 Encapsulated Interaction

None.

4. Specification

4.1 Responsibilities

Retrieve the data value by invoking the bind and get operations through the dat terminal.

Sign extend data values with size less than 4 bytes when the val.sgnext property is TRUE.

Modify the data value as specified by the val.mask and val.shift properties.

Compare the incoming data value with the value obtained through dat terminal.

Sent the event out through It, eq or gt terminals depending on the comparison result.

5. Theory of Operation

5.1 State Machine

None.

5.2 Mechanisms

5.2.1 Calculating the Data Offset

IDFC uses the following formula to calculate the data offset:

val.offs_neg?ev_sz(bp)−val.offs: val.offs

5.2.2 Data Item Comparison

Before comparing the data item values, IDFC performs the following operations on the data value in the following order:

If necessary, IDFC converts the data value according to the specified byte order

If necessary, IDFC sign extends the data value if the val.sgnext property is TRUE.

ANDs the val .mask property with the data value.

Performs the SHIFT operation on the data value as specified by the val . shift property.

If necessary, IDFC extends the byte data value received on dat terminal. The byte value is always extended to a non-negative value.

Execute value comparison. Note that signed comparison is executed only when both, the incoming value and the value received on dat terminal are of values of signed type.

IDFC assumes that all values retrieved from the dat terminal were stored in the native machine format.

### IDFS—Integral Data Field Stamper

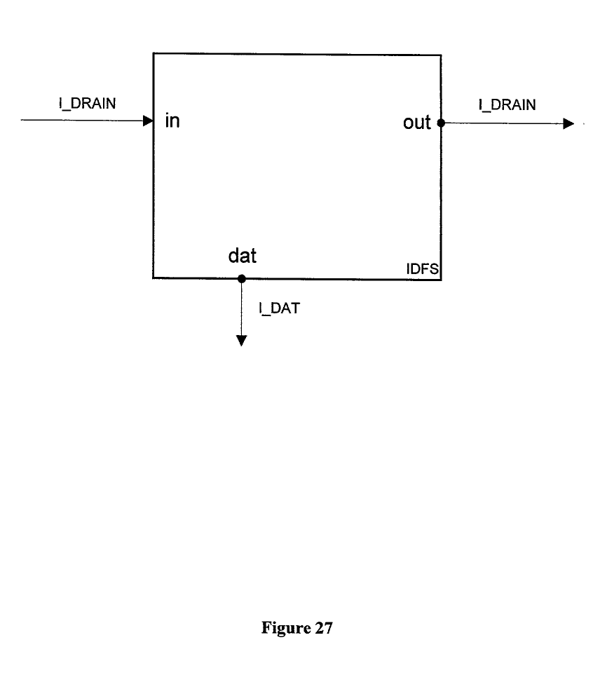

FIG. 27 illustrates the boundary of part, Integral Data Field Stamper (IDFS)

1. Functional Overview

IDFS is a data manipulation part that retrieves a data item value (obtained through the dat terminal) and stamps the value into a field of the event received through the in terminal. After IDFS updates the event field with the retrieved data item value, the event is forwarded through the out terminal.

The location and size of the field in the incoming event into which the retrieved data item value is stamped is parameterized through properties. The location of the field in the incoming event may vary.

The data item value can be retrieved and stamped into the incoming event either before or after the event is forwarded through the out terminal.

Before stamping the retrieved data item value into the event, IDFS modifies the retrieved value using a bit-wise AND mask and performing a SHIFT operation on the value. The AND mask and the number of bits to shift the value by are specified through properties.

IDFS converts the retrieved data item value according to the specified byte order (i.e., MSB first or LSB first) after modifying the value as described above and before stamping the value into the event.

2. Boundary

2.1 Terminals

| Name | Dir | Interface | Notes |
|---|---|---|---|
| in | in | I_DRAIN | For each event received through this terminal, |
| | | | IDFS stamps the value of the specified data item |
| | | | into the specified field of the event. |
| | | | This terminal is unguarded. |
| out | out | I_DRAIN | Events received from the in terminal are passed |
| | | | through this terminal either before or after the |
| | | | specified data item value has been stamped into |
| | | | the event. |
| dat | out | I_DAT | IDFS invokes the bind and get operations through |
| | | | this terminal to retrieve the data item value to |
| | | | stamp into the incoming event. |

2.2 PROPERTIES

| | | |
|---|---|---|
| Property Name | Type | Notes |

The following properties identify the data item that
IDFS retrieves and stamps into the
event received through the in terminal:

| | | |
|---|---|---|
| item.name | asciz | Name of the data item whose value |
| | | is to be retrieved and |
| | | stamped into the incoming event. |
| | | If this property is empty (“”), IDFS |
| | | forwards the event |
| | | through the out terminal without |
| | | modification. |
| | | The default value is“”. |
| item.type | uint32 | Type of the data item [DAT_T_XXX]. |
| | | Valid values for this property are: |
| | | DAT_T_BYTE, |
| | | DAT_{—T}_UINT32, DAT_T_SINT32, |
| | | and DAT_T_BOOLEAN |
| | | (integral types only). |
| | | The default value is DAT_T_UINT32. |

The following properties identify the location
and size of the field in the incoming event which
IDFS updates with the retrieved data item value:

| | | |
|---|---|---|
| val.offs | uint32 | Specifies the location of the |
| | | field in the incoming |
| | | event where IDFS should stamp the |
| | | retrieved data item |
| | | value (specified in bytes). |
| | | The default value is 0 |
| | | (first field of the event). |
| val.offs_neg | uint32 | Boolean. If TRUE, the offset is |
| | | event size—the value |
| | | of the val.offs property; |
| | | otherwise, the offset is |
| | | calculated from the beginning |
| | | of the event. |
| | | The default is FALSE. |
| val.offs_adj_name | asciz | Specifies the name of the data |
| | | item whose value is |
| | | added to the offset derived |
| | | from val.offs. |
| | | If the value of this property is “”, |
| | | the offset derived |
| | | from val.offs is not adjusted. |
| | | The data type of the specified data |
| | | item is expected to |
| | | be DAT_T_SINT32. |
| | | The default value is “”(not used). |
| val.sz | uint32 | Specifies the size of the field |
| | | in the incoming event |
| | | identified by val.offs (specified in bytes). |
| | | The size can be one of the following: |
| | | 1, 2, 3, or 4 bytes. |
| | | The default value is 4 (size of DWORD) |

The following properties describe the
modifications that IDFS makes to the retrieved
data item value before stamping the
value into the incoming event:

| | | |
|---|---|---|
| val.order | sint32 | Specifies the byte order of the value |
| | | that is to be stamped |
| | | into the field (identified by val.offs) |
| | | of the incoming event. |
| | | Can be one of the following values: |
| | | 0 Native machine format |
| | | 1 MSB—Most-significant byte |
| | | first (Motorola) |
| | | -1 LSB—Least-significant byte |
| | | first (Intel) |
| | | The default value is 0 (Native |
| | | machine format). |
| val.sgnext | uint32 | Boolean. If TRUE, retrieved data |
| | | item values smaller |
| | | than 4 bytes are sign extended |
| | | before the value is |
| | | operated on using the val.mask and |
| | | val.shift properties. |
| | | The default value is FALSE |
| | | (no sign extension). |
| val.mask | uint32 | Mask that is bit-wise ANDed with |
| | | the retrieved data |
| | | item value after sign extension and |
| | | before shifting. |
| | | The default value is 0xFFFFFFFF |
| | | (no change). |
| val.shift | sint32 | Number of bits to shift the retrieved |
| | | data item value after |
| | | applying the AND mask. |
| | | If the value is >0, the value is |
| | | shifted to the right. If the |
| | | value is <0, the value is shifted to the left. |
| | | The default value is 0 (no shift) |

The following properties describe when IDFS should
retrieve and stamp the data item
value into the incoming event:

| | | |
|---|---|---|
| get_first | uint32 | Boolean. If TRUE, the data item value |
| | | is retrieved |
| | | before the event is passed through the |
| | | out terminal. |
| | | Otherwise, the data item value is retrieved |
| | | after the |
| | | event is passed through the out terminal. |
| | | The default value is TRUE. |
| stamp_pre | uint32 | Boolean. If TRUE, the retrieved data |
| | | item value is |
| | | stamped into the event field |
| | | before the event is passed |
| | | though the out terminal; otherwise the data |
| | | item value |
| | | is stamped in the event field after |
| | | the event is passed |
| | | through the out terminal. |
| | | This property is valid only when |
| | | get_first is TRUE; |
| | | otherwise it is ignored. |
| | | The default value is TRUE. |

3. Events and Notifications

IDFS accepts any Dragon event through the in terminal.

3.1 Special Events, Frames, Commands or Verbs

None.

3.2 Encapsulated Interaction

None.

4. Specification

4.1 Responsibilities

Retrieve the specified data item value (by invoking the bind and get operations through the dat terminal) either before or after forwarding the event through out as specified by the get_first property.

Sign extend the retrieved data item values with size less than 4 bytes when the val.sgnext property is TRUE.

Modify the retrieved data item value as specified by the val.mask and val.shift properties.

Convert the data item value to the proper byte order.

Calculate the offset to the field in the incoming event where the value is stamped by retrieving the value of the val.off_adj_name data item and adding its value to the offset derived from val.offs.

Stamp the data item value into the calculated field of the incoming event either before or after forwarding the event through out as specified by the stamp_pre property.

4.2 Theory of Operation

4.3 State Machine

None.

4.4 Mechanisms

4.5 Calculating the Data Offset

IDFS uses the following formula to calculate the data offset:

val.offs neg?ev sz(bp)−val.offs: val.offs

4.6 Modification of the Retrieved Data Item Values

Before stamping the retrieved data item value into the specified field of the incoming event, IDFS performs the following modifications to the retrieved value (in order):

IDFS sign extends the retrieved data item value if the val.sgnext property is TRUE and the size of the value is less then 4 bytes.

ANDs the val.mask property with the retrieved data item value

Performs a SHIFT operation on the retrieved data item value as specified by the val.shift property.

IDFS converts the retrieved data item value according to the specified byte order.

IDFS assumes that all of the data item values retrieved through the dat terminal are stored in the native machine format.

5. Notes

IDFS's access through the dat terminal is non-atomic. Therefore, an assembly using this part may need to use external guarding.

IDFS zero-initializes the specified field of the incoming event before stamping the data item value into it.

### IDFX—Integral Data Field Extractor

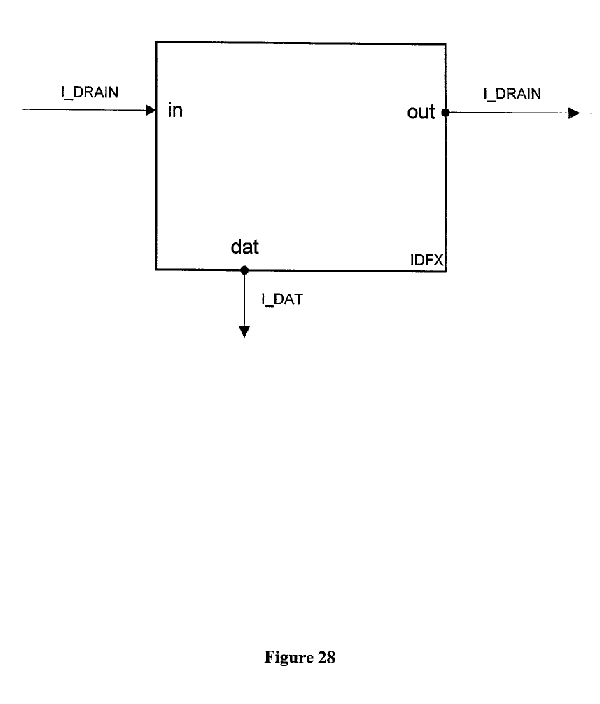

FIG. 28 illustrates the boundary of part, Integral Data Field Extractor (IDFX)

1. Functional Overview

IDFX is a data manipulation part that extracts an integral data value from the bus of events passing from in to out and stores it as a data item out the dat terminal. The location of the field whose value is extracted from the incoming event may vary.

IDFX modifies the data value before storing it using a bit-wise AND mask and by performing a SHIFT operation on the data. The mask and the number of bits to shift are specified as properties.

If needed, IDFX converts the data item value according to the specified byte order (i.e., MSB first or LSB first).

The field in the bus may be 1, 2, 3 or 4 bytes long; specified through the val . sz property.

2. Boundary

2.1 Terminals

| Name | Dir | Type | Notes |
|---|---|---|---|
| in | In | I_DRAIN | Data is extracted from events received |
| | | | on this terminal as |
| | | | specified by IDFX's properties before |
| | | | or after the event is |
| | | | forwarded to the out terminal. |
| | | | This terminal is unguarded. |
| out | Out | I_DRAIN | Events received from the in terminal |
| | | | are passed through this |
| | | | terminal either before or after the |
| | | | data has been extracted |
| | | | from the event. |
| dat | Out | I_DAT | IDFX invokes bind and set operations |
| | | | out this terminal to |
| | | | store the extracted data value. |

2.2 Properties

| Property name | Type | Notes |
|---|---|---|
| item.name | ASCIZ | Name of data item into which |
| | | to store the extracted |
| | | value. |
| | | If this property is empty, IDFX |
| | | does not extract any |
| | | value. |
| | | The default is “”. |
| item.type | uint32 | Type of data item [DAT_T_XXX]. |
| | | Valid values for this |
| | | property are: DAT_T_BYTE, |
| | | DAT_T_UINT32, |
| | | DAT_T_SINT32,and |
| | | DAT_T_BOOLEAN |
| | | The default is DAT_T_UINT32. |
| val.offs | uint32 | Specifies the location of the value |
| | | in the incoming |
| | | event that IDFX should extract. |
| | | (Specified in bytes). |
| | | Default is 0 (first field in event). |
| val.offs_neg | uint32 | Boolean. If TRUE, the offset is |
| | | event size—the value |
| | | of the val.offs property; otherwise, |
| | | the offset is |
| | | calculated from the beginning of the event. |
| | | The default is FALSE. |
| val.offs_adj_name | asciz | Specifies the name of the data item |
| | | whose value is |
| | | added to the offset derived from val.offs. |
| | | If the value of this property is “”, |
| | | the offset derived |
| | | from val.offs is not adjusted. |
| | | The data type of the specified data |
| | | item is expected to be DAT_T_SINT32. |
| | | The default value is “”(not used). |
| val.sz | uint32 | Specifies the size of the value field |
| | | in the incoming |
| | | event identified by val.offs |
| | | (specified in bytes). |
| | | The size can be one of the following: |
| | | 1, 2, 3, or 4. |
| | | Default is 4 (size of DWORD) |
| val.order | sint32 | Specifies the byte order of the field |
| | | (identified by |
| | | val.offs) in the incoming event. |
| | | Can be one of the following values: |
| | | 0 Native machine format |
| | | 1 MSB—Most-significant byte |
| | | first (Motorola) |
| | | -1 LSB—Least-significant byte |
| | | first (Intel) |
| | | Default is 0 (Native machine format). |
| val.sgnext | uint32 | Boolean. If TRUE, values smaller |
| | | than 4 bytes are sign |
| | | extended before the value is |
| | | operated on using |
| | | val.mask and val.shift properties. |
| | | The default is FALSE. |
| val.mask | uint32 | Mask that is bit-wise ANDed with |
| | | the field value |
| | | before being stored. |
| | | Default is 0xFFFFFFFF (no change). |
| val.shift | sint32 | Number of bits to shift the field |
| | | value before being stored. If the |
| | | value is >0, the value is shifted |
| | | to the right. If the value is <0, |
| | | the value is shifted to the left. |
| | | Default is 0 (no change) |
| extract_first | uint32 | Boolean. If TRUE, the data value is |
| | | extracted before |
| | | the event is passed to the out |
| | | terminal; otherwise the |
| | | data value is extracted after the |
| | | event is passed to the |
| | | out terminal. |
| | | Default is TRUE. |
| set_first | uint32 | Boolean. If TRUE, the data value |
| | | is stored before the |
| | | event is passed to the out terminal. |
| | | This property is valid only when |
| | | extract_first is |
| | | TRUE; otherwise it is ignored. |
| | | Default is TRUE. |

3. Events and Notifications

IDFX accepts any Dragon event.

3.1 Special Events, Frames, Commands or Verbs

None.

3.2 Encapsulated Interaction

None.

4. Specification

4.1 Responsibilities

Calculate the offset to the field in the incoming event where the value is extracted by retrieving the value of the val.off_adj_name data item and adding its value to the offset derived from val.offs.

Extract the data field from bus using the calculated offset either before or after forwarding the event through out as specified by the extract_first property.

Sign extend data values with size less than 4 bytes when val.sgnext property is TRUE.

Modify the extracted value as specified by the val.mask and val.shift properties.

Store the data item value by invoking bind and set operations out the dat terminal as specified by the set_first property

4.2 Theory of Operation

4.2.1 State Machines

None.

4.2.2 Mechanisms

### Calculating the Data Offset

IDFX uses the following formula to calculate the data offset:

val.offs_neg?ev_sz(bp)−val.offs: val.offs

### Modification of Data Values

Before storing a data value out the dat terminal, IDFX performs the following operations on the extracted data value:

If necessary, IDFX converts the data value according to the specified byte order

IDFX sign extends the data value if the val.sgnext property is TRUE

ANDs the val.mask property with the data value

Performs the SHIFT operation on the data value as specified by the val.shift property

IDFX stores all data values in native machine format.

UDFC—Universal Data Field Comparator

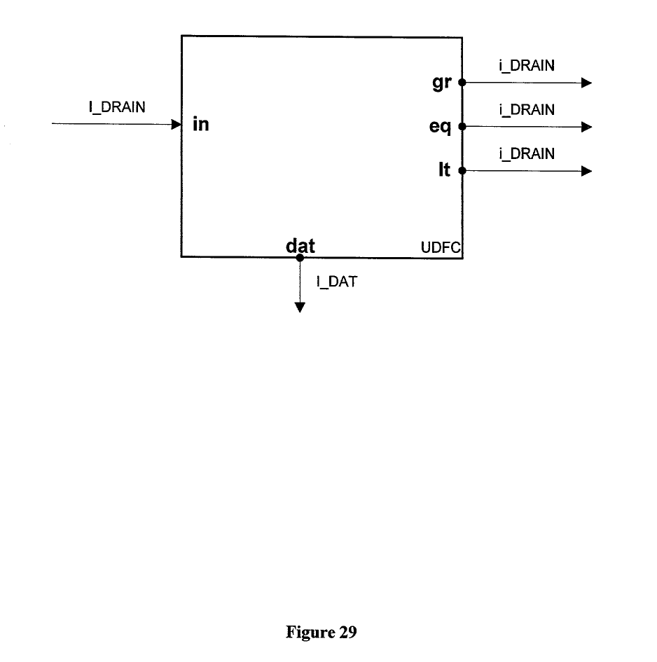

FIG. 29 illustrates the boundary of part, Universal Data Field Comparator (UDFC)

1. Functional Overview

UDFC is a data manipulation part that splits the event flow received on its in terminal. The event flow split depends upon whether the data item value is greater, equal or less than a predefined data item.

UDFC can compare integral data items (of type ‘byte’, ‘unsigned integer’, ‘signed integer’ and ‘Boolean’) and non-integral data items.

When the incoming data item is greater than the predefined one, the event is sent out through gt terminal. When the data item values are equal the event is sent out through eq terminal. When the incoming data item is less than the predefined data item, the event is sent out through lt terminal.

The length of the incoming value item can be a predefined constant, can be contained within the incoming event or obtained through a pointer, placed in the incoming event.

The incoming value item can be contained within the incoming event or obtained through a pointer, placed in the incoming event.

UDFC obtains the value of the predefined data item by submitting a request through dat request. If the request fails, UDFC completes the incoming event with the status returned on the dat terminal.

If the compared integral data items have different types, the value types are equalized before the item comparison. No conversion is applied if at least one of the data items is of non-integral type.

UDFC modifies the incoming integral item value, before the comparison, using a bit-wise AND mask and performing a SHIFT operation on the data. The mask and the number of bits to shift are specified as properties.

If needed, UDFC converts the incoming integral data item value according to the specified byte order (i.e., MSB first or LSB first).

2. Boundary

2.1 Terminals

| Name | Dir | Interface | Notes |
|---|---|---|---|
| in | in | I_DRAIN | UDFC receives an event containing a |
| | | | data item or a |
| | | | description of a data item to be |
| | | | compared. Depending on the |
| | | | result of the comparison, the event |
| | | | is forwarded through one of |
| | | | the output terminals: gt, eq and lt. |
| | | | This terminal is unguarded. |
| gt | out | I_DRAIN | Events received from the in terminal |
| | | | are passed through this |
| | | | terminal when the value defined by the |
| | | | incoming data item is |
| | | | greater than the predefined data item value. |
| eq | out | I_DRAIN | Events received from the in terminal |
| | | | are passed through this |
| | | | terminal when the value defined by the |
| | | | incoming data item is |
| | | | equal to the predefined data item value. |
| | | | When no item is specified (item.name is an |
| | | | empty string), all |
| | | | events received on in terminal are passed |
| | | | through this |
| | | | terminal. |
| lt | out | I_DRAIN | Events received from the in terminal are |
| | | | passed through this |
| | | | terminal when the value defined by the |
| | | | incoming data item is |
| | | | slammer than the predefined data item value. |
| dat | out | I_DAT | UDFC invokes bind and get operations |
| | | | out this terminal to |
| | | | retrieve the data value to compare. |

2.2 Properties

| Property name | Type | Notes |
|---|---|---|
| item.name | asciz | Name of the predefined data item whose |
| | | value is to be |
| | | compared with the value contained |
| | | within the incoming event. |
| | | If this property is empty, UDFC |
| | | does not execute any |
| | | comparison; the incoming event is |
| | | sent out through the eq terminal. |
| | | The default value is “”. |
| item.type | uint32 | Type of data item |
| | | [DAT_T_XXX]. |
| | | The default value is |
| | | DAT_T_UINT32. |
| var_sz | uint32 | Boolean. |
| | | If TRUE, the value item has a |
| | | variable size specified |
| | | through len.xxx properties. |
| | | If FALSE, the value item has a |
| | | constant size specified |
| | | through val.sz property. |
| | | The default value is FALSE |
| | | (the value item size is a constant). |
| val.type | uint32 | Type of data item [DAT_T_XXX] |
| | | placed in the incoming event. |
| | | The default value is DAT_T_UINT32. |
| val.by_ref | uint32 | Boolean. |
| | | If TRUE, a reference pointer contained |
| | | within the event |
| | | identifies the value item. The offset of |
| | | the reference pointer |
| | | is specified by |
| | | val.ptr_offs property. |
| | | If FALSE, the value item is contained |
| | | within the event. |
| | | The offset of the value item is |
| | | specified by val.offs property. |
| | | The default value is FALSE |
| | | (the value item is contained |
| | | within the event). |
| val.ptr_offs2 | uint32 | When val.by_ref property |
| | | is TRUE, val.ptr_offs |
| | | specifies the location (in the |
| | | incoming event) of the pointer |
| | | to the value that UDFC should |
| | | compare with the value of |
| | | the data item specified in item.name. |
| | | The default value is 0 (first |
| | | field of the event). |
| val.offs | uint32 | When val.by_ref property is |
| | | FALSE, val.offs specifies |
| | | the location in the incoming |
| | | event that UDFC should |
| | | compare with the value of the |
| | | data item specified in item.name. |
| | | The default value is 0 |
| | | (first field of the event). |
| val.offs_neg | uint32 | Boolean. If TRUE, the offset is |
| | | event size—the value of |
| | | the val.offs property; otherwise, |
| | | the offset is calculated |
| | | from the beginning of the event. |
| | | The default is FALSE. |
| val.sz | uint32 | When var_sz property is |
| | | FALSE, val.sz specifies the size |
| | | of the field in the incoming event |
| | | identified by val.offs |
| | | (specified in bytes). |
| | | The size can be one of the following: |
| | | 1, 2, 3, or 4. |
| | | The default value is 4 (size of DWORD) |
| val.order | sint32 | Specifies the byte order of the |
| | | value that is to be stamped in |
| | | the field (identified by val.offs) |
| | | in the incoming event. |
| | | Can be one of the following values: |
| | | 0 —Native machine format |
| | | 1 —MSB—Most-significant byte |
| | | first (Motorola) |
| | | -1 —LSB—Least-significant byte |
| | | first (Intel) |
| | | The default value is 0 |
| | | (Native machine format). |
| val.sgnext | uint32 | Boolean. |
| | | If TRUE, integral values smaller |
| | | than 4 bytes are sign |
| | | extended before the value is |
| | | operated on using val.mask |
| | | and val.shift properties. |
| | | The default value is FALSE. |
| val.mask | uint32 | Mask that is bit-wise ANDed with |
| | | the incoming integral |
| | | value before comparing it to the |
| | | data item returned on dat terminal. |
| | | The default value is 0xFFFFFFFF |
| | | (no change). |
| val.shift | sint32 | Number of bits to shift the incoming |
| | | integral value before |
| | | comparing it to the data item returned |
| | | on dat terminal. |
| | | If the value is positive (greater than 0), |
| | | the value is shifted |
| | | to the right. If the value is negative |
| | | (lesser than 0), the |
| | | value is shifted to the left. |
| | | The default value is 0 (no change) |
| len.by_ref | uint32 | Boolean. |
| | | Used only when var_sz |
| | | property is TRUE. |
| | | If TRUE, a reference pointer contained |
| | | within the event |
| | | identifies the length of the value |
| | | item. The offset of the |
| | | length pointer (in the event) is |
| | | specified by len.ptr_offs |
| | | property. |
| | | If FALSE, the value length is |
| | | contained within the event. |
| | | The offset of the value length is |
| | | specified by len.offs property. |
| | | The default value is FALSE (the |
| | | value item is contained |
| | | within the event). |
| len.ptr_offs3 | uint32 | When len.by_ref property is |
| | | TRUE, len.ptr_offs |
| | | specifies the location (in the incoming |
| | | event) of the pointer |
| | | to the value length. |
| | | The default value is 0 (first field |
| | | of the event). |
| len.offs | uint32 | When len.by_ref property is |
| | | FALSE, len.offs specifies |
| | | the location (in the incoming event) |
| | | at which the value item |
| | | length is stored. |
| | | The default value is 0 (first |
| | | field of the event). |
| len.sz | uint32 | Specifies the size of the field that |
| | | specifies the value length. |
| | | The length field is specified through |
| | | len.ptr_offs or |
| | | len.offs properties. |
| | | The size can be one of the following: |
| | | 1, 2, 3, or 4. |
| | | The default value is 4 (size of DWORD) |
| len.order | sint32 | Specifies the byte order of the |
| | | value length. The length field |
| | | is specified through |
| | | len.ptr_offs or len.offs properties. |
| | | Can be one of the following values: |
| | | 0 —Native machine format |
| | | 1 —MSB—Most-significant byte |
| | | first (Motorola) |
| | | -1 —LSB—Least-significant byte |
| | | first (Intel) |
| | | The default value is 0 (Native |
| | | machine format). |
| len.mask | uint32 | Mask that is bit-wise ANDed with the |
| | | value |
| | | specified |
| | | through len.ptr_offs or len.offs |
| | | properties in order to |
| | | calculate the actual value length. |
| | | The default value is 0xFFFFFFFF (no |
| | | length change). |
| len.shift | sint32 | Number of bits to shift the value specified |
| | | through |
| | | len.ptr_offs or len.offs properties |
| | | in order to calculate |
| | | the actual value length. |
| | | If the value is positive (greater than 0), |
| | | the value is shifted |
| | | to the right. If the value is negative |
| | | (lesser than 0), the |
| | | value is shifted to the left. |
| | | The default value is 0 (no change) |

² Note that the reference pointer is always stored in the processor native format. Its size may vary, depending on the system implementation.
³ Note that the reference pointer is always stored in the processor native format. Its size may vary, depending on the system implementation.

3. Events and Notifications

UDFC accepts any Z-Force event through the in terminal. The event size must be enough to hold the specified data item.

3.1 Special Events, Frames, Commands or Verbs

None.

3.2 Encapsulated Interaction

None.

4. Specification

4.1 Responsibilities

Retrieve the data value by invoking the bind and get operations through the dat terminal.

Calculate the value length depending on len.xxx properties.

Sign extend integral data values with size less than 4 bytes when the val.sgnext property is TRUE.

Modify the integral data value as specified by the val.mask and val.shift properties.

Compare the incoming data value with the value obtained through dat terminal.

Sent the event out through lt, eq or gt terminals depending of the comparison result.

4.2 Theory of Operation

4.2.1 State Machines

None.

4.2.2 Mechanisms

### Calculating the Data Offset

UDFC uses the following formula to calculate the data offset:

val.offs_neg?ev_sz(bp)−val.offs: val.offs

### Handling Incoming Events

When an event is received on in terminal, UDFC performs the following operations (in order):

If no item name is specified, the event is forwarded through eq terminal.

The checked version of the UDFC validates the incoming event against the property set.

Obtain a pointer to the data item value.

Calculate the value length.

Retrieve the data item through dat terminal.

Compare the values of the data items.

Forward the event out, depending on the result.

### Integral Data Items Comparison

Before comparing the data item values, UDFC performs the following operations on the data value in the following order:

If necessary, UDFC converts the data value according to the specified byte order

If necessary, UDFC sign extends the data value if the val.sgnext property is TRUE.

ANDs the val.mask property with the data value.

Performs the SHIFT operation on the data value as specified by the val.shift property.

If necessary, UDFC extends the byte data value received on dat terminal. The byte value is always extended to a non-negative value.

Execute value comparison. Note that signed comparison is executed only when both the incoming value and the value received on dat terminal are of values of signed type.

UDFC assumes that all integral values retrieved from the dat terminal were stored in the native machine format.

### UDFS—Universal Data Field Stamper

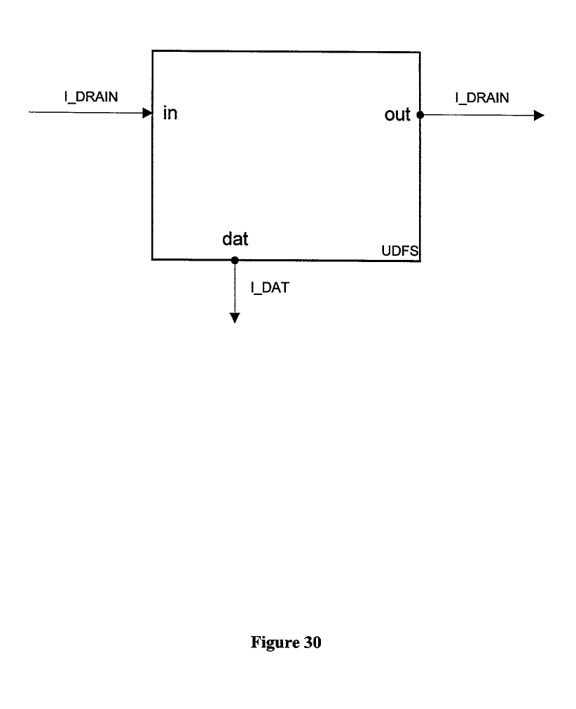

FIG. 30 illustrates the boundary of part, Universal Data Field Stamper (UDFS)

1. Functional Overview

UDFS is a data manipulation part that stamps any type of data item value into the bus of events passing from in to out. The data item can be stamped either before or after the event is forwarded through the out terminal.

For integral data types, UDFS modifies the data item value, before stamping it into the bus, using a bit-wise AND mask and performing a SHIFT operation on the data. The mask and the number of bits to shift are specified as properties. If needed, UDFS converts the data item value according to the specified byte order (i.e., MSB first or LSB first) before stamping the value into the bus.

The size of the storage for the data item value or the storage for the data item value length can be a predefined constant, can be contained within the incoming event or obtained through a pointer, placed in the incoming event.

If the data types of the data item and the event field (into which the data item value is stamped) are not compatible, UDFS fails the incoming event (UDFS does not provide any data type conversion except for integral types).

2. Boundary

2.1 Terminals

| Name | Dir | Interface | Notes |
|---|---|---|---|
| in | in | I_DRAIN | UDFS stamps the value of a data |
| | | | item into the bus of events |
| | | | received on this terminal |
| | | | before or after the event is forwarded |
| | | | to the out terminal. |
| | | | This terminal is unguarded. |
| out | out | I_DRAIN | Events received from the in terminal are |
| | | | passed through this |
| | | | terminal either before or after the data |
| | | | value has been stamped |
| | | | into the bus. |
| dat | out | I_DAT | UDFS invokes the bind and get operations |
| | | | through this |
| | | | terminal to retrieve the data |
| | | | value to stamp. |

2.2 Properties

| Property name | Type | Notes |
|---|---|---|
| item.name | asciz | Name of the data item whose value is |
| | | to be stamped into the event bus. |
| | | If this property is empty, UDFS does |
| | | not modify the event |
| | | bus. |
| | | The default value is “”. |
| item.type | uint32 | Type of the data item |
| | | [DAT_T_XXX]. |
| | | The default value is |
| | | DAT_T_UINT32. |
| stamp_pre | uint32 | Boolean. If TRUE, the data item |
| | | value is stamped before the |
| | | event is passed to the out terminal; |
| | | otherwise the data value |
| | | is stamped after the event is passed |
| | | to the out terminal. |
| | | The default value is TRUE. |
| get_first | uint32 | Boolean. If TRUE, the data item value |
| | | is retrieved before the |
| | | event is passed to the out terminal. |
| | | This property is valid only when |
| | | stamp_pre is FALSE; |
| | | otherwise it is ignored. |
| | | The default value is TRUE. |
| var_sz | uint32 | Boolean. |
| | | If TRUE, the storage for the stamped |
| | | data item value has a |
| | | variable size specified through the |
| | | buf_sz.xxx properties. |
| | | If FALSE, the storage has a constant size |
| | | specified through val.sz property. |
| | | The default value is FALSE (the |
| | | storage size is constant). |
| val.type | uint32 | Type of data item |
| | | [DAT_T_XXX] placed |
| | | in the incoming event. |
| | | The default value is |
| | | DAT_T_UINT32. |
| val.by_ref | uint32 | Boolean. |
| | | If TRUE, a reference pointer contained |
| | | within the event |
| | | identifies the storage for the stamped |
| | | data item value. The |
| | | offset of the reference pointer is |
| | | specified by |
| | | val.ptr_offs property. |
| | | If FALSE, the storage is contained |
| | | within the event. The |
| | | offset of the value item is specified |
| | | by val.offs property. |
| | | The default value is FALSE (the storage |
| | | is contained within the event). |
| val.ptr_offs4 | uint32 | When the val.by_ref property |
| | | is TRUE, val.ptr_offs |
| | | specifies the location (in the |
| | | incoming event) of the pointer |
| | | to the storage that UDFS uses to store |
| | | the value of the data |
| | | item specified by item.name. |
| | | The default value is 0 (first field |
| | | of the event). |
| val.offs | uint32 | When the val.by_ref |
| | | property is FALSE, val.offs |
| | | specifies the location in the |
| | | incoming event that UDFS uses |
| | | to store the value of the data item |
| | | specified in item.name. |
| | | The default value is 0 (first |
| | | field of the event). |
| val.offs_neg | uint32 | Boolean. If TRUE, the offset is |
| | | event size—the value of |
| | | the val.offs property; otherwise, |
| | | the offset is calculated |
| | | from the beginning of the event. |
| | | The default is FALSE. |
| val.sz | uint32 | When the var_sz property |
| | | is FALSE, val.sz specifies the |
| | | size of the field in the incoming |
| | | event identified by |
| | | val.offs (specified in bytes). |
| | | The default value is 4 (size of DWORD) |
| val.order | sint32 | Specifies the byte order of the |
| | | value that is to be stamped in |
| | | the field (identified by val.offs) |
| | | in the incoming event. |
| | | Can be one of the following values: |
| | | 0 —Native machine format |
| | | 1 —MSB—Most-significant byte |
| | | first (Motorola) |
| | | -1 —LSB—Least-significant byte |
| | | first (Intel) |
| | | This property is valid for integral |
| | | data items only. |
| | | The default value is 0 (Native |
| | | machine format). |
| val.sgnext | uint32 | Boolean. |
| | | If TRUE, integral values smaller |
| | | than 4 bytes are sign |
| | | extended before the data item value is |
| | | operated on using |
| | | val.mask and val.shift properties. |
| | | This property is valid for integral |
| | | data items only. |
| | | The default value is FALSE. |
| val.mask | uint32 | Mask that is bit-wise ANDed |
| | | with the data item value |
| | | before it is stamped in the |
| | | incoming event. |
| | | This property is valid for integral |
| | | data items only. |
| | | The default value is 0xFFFFFFFF |
| | | (no change). |
| val.shift | sint32 | Number of bits to shift the data |
| | | item value before it is |
| | | stamped in the incoming event. |
| | | If the value is positive (greater |
| | | than 0), the value is shifted |
| | | to the right. If the value is negative |
| | | (lesser than 0), the |
| | | value is shifted to the left. |
| | | This property is valid for integral |
| | | data items only. |
| | | The default value is 0 (no change) |

⁴ Note that the reference pointer is always stored in the processor native format. Its size may vary, depending on the system implementation.

The following properties are used to specify where to store the length of the stamped data item value in the incoming event. These properties are used only if the var_sz property is TRUE (variable size data values).

| Property name | Type | Notes |
|---|---|---|
| len.by_ref | uint32 | Boolean. |
| | | If TRUE, a reference pointer |
| | | contained within the incoming |
| | | event identifies the storage for |
| | | the length of the stamped |
| | | data item value. The offset of the |
| | | length pointer (in the |
| | | event) is specified by len.ptr offs |
| | | property. |
| | | If FALSE, the storage for the data |
| | | item value length is |
| | | contained within the event. The offset |
| | | of the storage is |
| | | specified by the len.offs property. |
| | | The default value is FALSE (the storage |
| | | is contained within the event). |
| len.ptr_offs5 | uint32 | When the len.by_ref property |
| | | is TRUE, len.ptr_offs |
| | | specifies the location (in the incoming |
| | | event) of the pointer |
| | | to where the stamped data item value |
| | | length should be stored. |
| | | The default value is 0 (first |
| | | field of the event). |
| len.offs | uint32 | When the len.by_ref |
| | | property is FALSE, len.offs |
| | | specifies the location (in the |
| | | incoming event) at which the |
| | | data item value length is stored. |
| | | The default value is 0 (first field |
| | | of the event). |
| len.sz | uint32 | Specifies the size of the field used to |
| | | store the data item |
| | | value length. The length field is |
| | | specified through the |
| | | len.ptr_offs or len.offs properties. |
| | | The size can be one of the following: |
| | | 1, 2, 3, or 4. |
| | | The default value is 4 (size of DWORD) |
| len.order | sint32 | Specifies the byte order of the data |
| | | item value length. The |
| | | length field is specified through the |
| | | len.ptr_offs or |
| | | len.offs properties. |
| | | Can be one of the following values: |
| | | 0 —Native machine format |
| | | 1 —MSB—Most-significant byte |
| | | first (Motorola) |
| | | -1 —LSB—Least-significant byte |
| | | first (Intel) |
| | | The default value is 0 (Native |
| | | machine format). |
| len.mask | uint32 | Mask that is bit-wise ANDed with the |
| | | data item value |
| | | length before it is stored in the |
| | | incoming event. |
| | | The default value is 0xFFFFFFFF |
| | | (no length change). |
| len.shift | sint32 | Number of bits to shift the data item |
| | | value length before it |
| | | is stored in the incoming event. |
| | | If the value is positive (greater |
| | | than 0), the value is shifted |
| | | to the right. If the value is negative |
| | | (lesser than 0), the |
| | | value is shifted to the left. |
| | | The default value is 0 (no change) |

⁵ Note that the reference pointer is always stored in the processor native format. Its size may vary, depending on the system implementation.

The following properties are used to specify the size of the storage for the data item value in the incoming event. These properties are used only if the var_sz property is TRUE (variable size data values).

| Property name | Type | Notes |
|---|---|---|
| buf_sz.val | uint32 | Specifies the size of the storage |
| | | in the incoming event |
| | | that is used to store the retrieved |
| | | data item value. |
| | | When this property is zero, the |
| | | rest of the buf_sz |
| | | properties are used to describe |
| | | the size of the storage in |
| | | the incoming event. |
| | | The default value is 0. |
| buf_sz.ptr_offs6 | uint32 | When the |
| | | buf_sz.by_ref |
| | | property is TRUE, |
| | | buf_sz.ptr_offs |
| | | specifies the location (in the |
| | | incoming event) of the pointer |
| | | to the storage size. |
| | | The default value is 0 (first |
| | | field of the event). |
| buf_sz.offs | uint32 | When the buf_sz.by_ref |
| | | property is FALSE, |
| | | buf_sz.offs specifies |
| | | the location (in the incoming |
| | | event) of the field that contains |
| | | the size of the storage |
| | | used to store the data item value. |
| | | The default value is 0 (first |
| | | field of the event). |
| buf_sz.sz | uint32 | Specifies the size of the field |
| | | that specifies the storage |
| | | size. The storage field is specified |
| | | through |
| | | buf_sz.ptr_offs |
| | | or buf_sz.offs properties. |
| | | The size can be one of the following: |
| | | 1, 2, 3, or 4. |
| | | The default value is 4 (size of DWORD) |
| buf_sz.order | sint32 | Specifies the byte order of the |
| | | storage size field. The |
| | | storage size field is specified |
| | | through the |
| | | buf_sz.ptr_offs |
| | | Or buf_sz.offs properties. |
| | | Can be one of the following values: |
| | | 0 —Native machine format |
| | | 1 —MSB—Most-significant byte |
| | | first (Motorola) |
| | | -1 —LSB—Least-significant byte |
| | | first (Intel) |
| | | The default value is 0 (Native machine |
| | | format). |
| buf_sz.mask | uint32 | Mask that is bit-wise ANDed with |
| | | the value specified |
| | | through the buf_sz.ptr_offs |
| | | Or buf_sz.offs |
| | | properties in order to calculate |
| | | the actual storage size. |
| | | The default value is 0xFFFFFFFF |
| | | (no length change). |
| buf_sz.shift | sint32 | Number of bits to shift the value |
| | | specified through the |
| | | buf_sz.ptr_offs or |
| | | buf_sz.offs properties in order |
| | | to calculate the actual storage size. |
| | | If the value is positive |
| | | (greater than 0), the value is |
| | | shifted to the right. If the value |
| | | is negative (lesser than |
| | | 0), the value is shifted to the left. |
| | | The default value is 0 (no change) |

⁶ Note that the reference pointer is always stored in the processor native format. Its size may vary, depending on the system implementation.

3. Events and Notifications

UDFS accepts any Dragon event through the in terminal. The event size must be large enough to store the specified data item value.

3.1 Special Events, Frames, Commands or Verbs

None.

3.2 Encapsulated Interaction

None.

4. Specification

4.1 Responsibilities

Retrieve the data item value by invoking the bind and get operations through the dat terminal.

Calculate the data item storage location and size depending on the var_sz, val.xxx and buf_sz.xxx properties.

Calculate where to store the data item length in the incoming event depending on the len.xxx properties.

Modify the data item value as specified by the val.mask and val.shift properties.

Sign extend data item values with size less than 4 bytes when the val.sgnext property is TRUE.

Stamp the data item value into the event bus either before or after forwarding the event through out as specified by the stamp_pre and get_first properties (zero initialize the storage buffer first before stamping the value into it).

If needed, stamp the length of the data item value into the event at the specified location (modify the length based on the len.xxx properties before updating the event).

4.2 Theory of Operation

4.2.1 State Machines

None.

4.2.2 Mechanisms

### Calculating the Data Offset

UDFS uses the following formula to calculate the data offset:

val.offs_neg?ev_sz(bp)−val.offs: val.offs

### Handling Incoming Events

When an event is received through the in terminal, UDFS performs the following operations (in order):

If no data item name is specified, the event is forwarded through the out terminal and UDFS returns control back to the original caller.

Retrieve the data item value through the dat terminal.

Validate the incoming event against the property set (checked versions of UDFS only).

Obtain a pointer to the data item value storage and the data item value length storage in the incoming event.

Stamp the data item value into the event.

Store the data item value length in the event.

Forward the event through the out terminal.

Note that if UDFS is parameterized to stamp the data item value after the event has been forwarded through out, it will stamp the value only under the following conditions depending on the attributes of the incoming event:

If the event is self owned and the return status is not equal to ST_OK.

If the event is asynchronously completable and the return status is not equal to ST_PENDING.

If the event is not self owned or asynchronously completable (return status is not taken into account).

If the condition for the incoming event is not met, UDFS fails the event.

### Modification of Data Item Values

Before stamping a data item value into the event bus, UDFS performs the following operations on the data value (in order):

ANDs the val.mask property with the data value.

Performs the SHIFT operation on the data value as specified by the val.shift property.

UDFS sign extends the data value if the val.sgnext property is TRUE.

UDFS converts the data value according to the specified byte order.

UDFS assumes that all values retrieved from the dat terminal are stored in the native machine format.

### Modification of Value Lengths

UDFS performs the following operations on the value length before updating the incoming event (in order):

ANDs the len.mask property with the value.

Performs the SHIFT operation on the value as specified by the len.shift property.

UDFS converts the value to the native machine format.

### Modification of Value Storage Sizes

UDFS performs the following operations on the value storage size read from the incoming event (in order):

UDFS converts the value to the native machine format.

ANDs the buf_sz.mask property with the value.

Performs the SHIFT operation on the value as specified by the buf_sz.shift property.

### Data Type Conversion

Depending on the specified data types for the data item and the event field (where the data item value is stored), UDFS may need to convert one type to another. The following rules define how UDFS converts between different types:

If one type is non-integral and the other type is integral, UDFS fails the incoming event (no conversion possible).

If both types are non-integral, the types must be identical (if not UDFS fails the incoming event).

If both types are integral, UDFS converts between the two types. Integral types include DAT_T_BYTE,DAT_T_UINT32,DAT₁₃ T_SINT32 and DAT_T_BOOLEAN.

4.3 Use Cases

4.3.1 Stamping Integral Values: Self-contained Storage, Constant Size

The following use case describes how to stamp an unsigned 32-bit integer into a field of an event (although any integral data type may be used). In this case, the event contains a 4-byte field used to store the data item value. The size of the field is fixed (4 bytes). Note that the data item value length does not need to be stored in the event for constant size values.

Below is a definition of the event bus used in this example:

typedef struct B_EV_TESTtag

{
uint32 value; // storage for data item value
} B_EV_TEST;

The steps below describe how to stamp an integer value into the B_EV_TEST event bus:

UDFS is created and parameterized with the following:

item.name=“my_uint32” (including terminating character)

item.type=DAT_T_UINT32

var_sz=FALSE (constant size)

val.type=DAT_T_UINT32

val.offs=0 (first field in B_EV_TEST bus)

val.sz=size of uint32 (4 bytes)

An EV_TEST event is received on UDFS's in terminal.

UDFS retrieves the “my_uint32” data item value through the dat terminal and copies the value into the value field of the EV_TEST event bus.

The event is forwarded through the out terminal.

Optionally, the data item value may be modified according to the val.order, val.sgnext, val.mask and val.shift properties. By default, UDFS does not modify the value before stamping it into the event bus.

4.3.2 Stamping ASCII string values: self-contained storage, variable size

The following use case describes how to stamp an ASCII string into a field of an event. In this case, the event has a self-contained field used to store the retrieved string. The length of the string is variable and is stored in a special field in the event. Below is a definition of the event bus used in this example:

typedef struct B_EV_TESTtag

{
char str [256]; // storage for the string
uint32 len ; // length of the string
} B_EV_TEST;

The steps below describe how to stamp an ASCII string into the B_EV-TEST event bus:

UDFS is created and parameterized with the following:

item.name=“my_string” (including terminating character)

item.type=DAT_T_ASCIZ

var_sz=TRUE (variable size)

val.type=DAT_T_ASCIZ

val.offs=0 (first field in B_EV_TEST bus)

len.offs=offset of len field in B_EV_TEST bus (256 bytes)

len.sz=size of uint32 (4 bytes)

buf_sz.val=size of the str field (256 bytes)

An EV_TEST event is received on UDFS's in terminal.

UDFS retrieves the “my_string” data item value through the dat terminal and copies the value into the str field of the EV_TEST event bus.

UDFS stores the length of the retrieved data item value and stores it in the len field of the EV_TEST event bus.

The event is forwarded through the out terminal.

4.3.3 Stamping ASCII string values: referenced storage, variable size

The following use case describes how to stamp an ASCII string into a field of an event. In this case, the event contains a reference to the buffer that contains the storage for the retrieved string. The length of the string is variable. The size and length for the string are stored in special fields in the event.

Below is a definition of the event bus used in this example:

typedef struct B_EV_TESTtag

{
uint32 sz ; // size of the storage buffer
char *strp; // storage for the string
uint32 len ; // length of the string
} B_EV_TEST;

The steps below describe how to stamp an ASCII string into the B_EV_TEST event bus:

UDFS is created and parameterized with the following:

item.name=“my_string” (including terminating character)

item.type=DAT_T_ASCIZ

var_sz=TRUE (variable size)

val.type=DAT_T_ASCIZ

val.by_ref=TRUE

val.ptr_offs=offset of strp field in B_EV_TEST bus (4 bytes)

len.offs=offset of len field in B_EV_TEST bus (256 bytes)

len.sz=size of uint32 (4 bytes)

buf_sz.val=0

buf_sz.offs=offset of sz field in B_EV_TEST bus (256 bytes)

buf_sz.sz=size of uint32 (4 bytes)

a An EV_TEST event is received on UDFS's in terminal (the sz field contains the size of the buffer pointed to by strp).

UDFS retrieves the “my string” data item value through the dat terminal and copies the value into the buffer pointed to by the strp field of the EV_TEST event bus.

UDFS stores the length of the retrieved data item value and stores it in the len field of the EV_TEST event bus.

The event is forwarded through the out terminal.

5. Notes

UDFS's access through the dat terminal is non-atomic. Therefore, an assembly using this part may need to use external guarding.

### UDFX—Universal Data Field Extractor

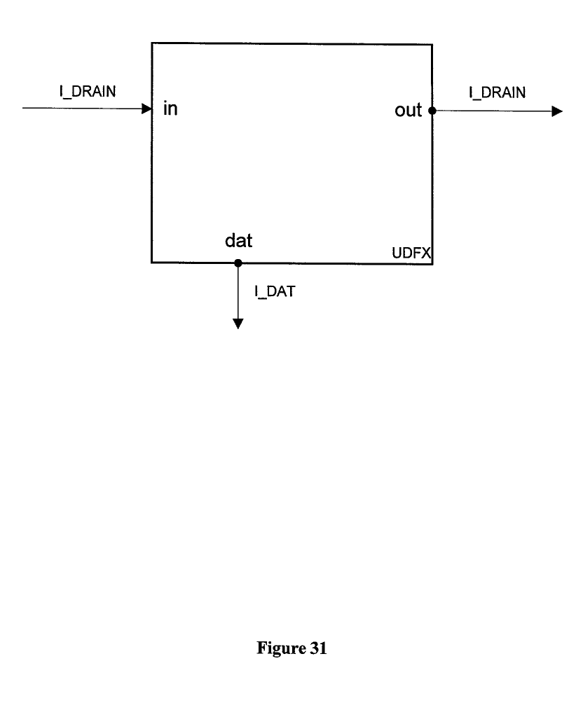

FIG. 31 illustrates the boundary of part, Universal Data Field Extractor (UDFX)

1. Functional Overview

UDFX is a data manipulation part that extracts data from the bus of events passing from in to out and updates the specified data item with the extracted value. The data can be extracted either before or after the event is forwarded through the out terminal.

For integral data types, UDFX modifies the extracted value before updating the specified data item. UDFX applies a bit-wise AND mask and performs a SHIFT operation on the value. The mask and the number of bits to shift are specified as properties. If needed, UDFX converts the value according to the specified byte order (i.e., MSB first or LSB first) before modifying the value and updating the data item.

The length of the value to extract from the event can be a predefined constant, contained within the incoming event or obtained through a pointer, placed in the incoming event.

If the data types of the extracted value and the data item are not compatible, UDFX fails the incoming event (UDFX does not provide any data type conversion except for integral types).

2. Boundary

2.1 Terminals

| Name | Dir | Interface | Notes |
|---|---|---|---|
| in | in | I_DRAIN | UDFX extracts the value from |
| | | | the bus of events received on |
| | | | this terminal and updates the |
| | | | specified data item. |
| | | | This terminal is unguarded. |
| out | out | I_DRAIN | Events received from the in |
| | | | terminal are passed through this |
| | | | terminal either before or after |
| | | | the value has been extracted |
| | | | from the bus. |
| dat | out | I_DAT | UDFX invokes the bind and set |
| | | | operations through this |
| | | | terminal to update the specified data item. |

2.2 Properties

| Property name | Type | Notes |
|---|---|---|
| item.name | asciz | Name of the data item that is updated with the extracted |
| | | value from the incoming event bus. |
| | | If this property is empty, UDFX does not modify the event |
| | | bus or update the data item. |
| | | The default value is “” |
| item.type | uint32 | Type of the data item [DAT_T_XXX]. |
| | | The default value is DAT_T_UINT32. |
| set_first | uint32 | Boolean. If TRUE, extract and update the data item value |
| | | before passing the event through the out terminal. |
| | | If FALSE, set the data item value after passing the event |
| | | through the out terminal. In this case, use the |
| | | extract_first property to control when the value is |
| | | actually extracted from the event. |
| | | The default value is TRUE. |
| extract_first | uint32 | Boolean. If TRUE, extract the value from the incoming |
| | | event before passing the event through the out terminal; |
| | | otherwise the value is extracted after the event is passed |
| | | through the out terminal |
| | | This property is valid only when set_first is FALSE |
| | | otherwise it is ignored. |
| | | The default value is TRUE. |
| var_sz | uint32 | Boolean. |
| | | If TRUE, the length of the value to extract from the incoming |
| | | event has a variable size specified through the len. xxx |
| | | properties. |
| | | If FALSE, the value has a constant size specified through |
| | | val.sz property. |
| | | The default value is FALSE (the length is constant). |
| val.type | uint32 | Type of the value [DAT_T_XXX] in the incoming event. |
| | | The default value is DAT_T_UINT32. |
| val.by_ref | uint32 | Boolean. |
| | | If TRUE, the value to extract from the event is identified by a |
| | | reference pointer contained within the event. The offset of |
| | | the reference pointer is specified by val.ptr_offs |
| | | property. |
| | | If FALSE, the value is contained within the event. The offset |
| | | of the value is specified by val.offs property. |
| | | The default value is FALSE (the value is contained within |
| | | the event). |
| val.ptr_offs7 | uint32 | When the val.by_ref property is TRUE, val.ptr_offs |
| | | specifies the location (in the incoming event) of the pointer |
| | | to the value that UDFX extracts from the event. |
| | | The default value is 0 (first field of the event). |
| val.offs | uint32 | When the val.by_ref property is FALSE, val.offs |
| | | specifies the location in the incoming event that contains |
| | | the value that UDFX extracts from the event. |
| | | The default value is 0 (first field of the event). |
| val.offs_neg | uint32 | Boolean. If TRU7E, the offset is event size - the value of |
| | | the val.offs property; otherwise, the offset is calculated |
| | | from the beginning of the event. |
| | | The default is FALSE. |
| val.sz | uint32 | When the var_sz property is FALSE, val.sz specifies the |
| | | length of the value in the incoming event identified by |
| | | val.offs (specified in bytes). |
| | | The default value is 4 (size of DWORD) |
| val.order | sint32 | Specifies the byte order of the value that is to be extracted |
| | | (identified by val.offs) from the incoming event. |
| | | Can be one of the following values: |
| | | 0 -Native machine format |
| | | 1 -MSB-Most-significant byte first (Motorola) |
| | | −1 -LSB-Least-significant byte first (Intel) |
| | | This property is valid for only integral values. |
| | | The default value is 0 (Native machine format). |
| val.sgnext | uint32 | Boolean. |
| | | If TRUE, integral values smaller than 4 bytes are sign |
| | | extended before the extracted value is operated on using the |
| | | val.mask and val.shift properties. |
| | | This property is valid for only integral values. |
| | | The default value is FALSE. |
| val.mask | uint32 | Mask that is bit-wise ANDed with the extracted value |
| | | before updating the specified data item. |
| | | This property is valid for only integral values. |
| | | The default value is 0×FFFFFFFF (no change). |
| val.shifts | int32 | Number of bits to shift the extracted value before updating |
| | | the specified data item. |
| | | If the value is positive (greater than 0), the value is shifted |
| | | to the right. If the value is negative (lesser than 0), the |
| | | value is shifted to the left. |
| | | This property is valid for only integral values. |
| | | The default value is 0 (no change) |

⁷Note that the reference pointer is always stored in the processor native format. Its size may vary, depending on the system implementation.

The following properties are used to specify where the value length is stored in the incoming event. These properties are used only if the var_sz property is TRUE (variable size data values).

| Property name | Type | Notes |
|---|---|---|
| len.by_ref | uint32 | Boolean. |
| | | If TRUE, a reference pointer contained within the event |
| | | identifies the storage for the length of the value to extract. |
| | | The offset of the length pointer (in the event) is specified by |
| | | len.ptr_offs property. |
| | | If FALSE, the storage for the value length is contained |
| | | within the event. The offset of the storage is specified by |
| | | the len.offs property. |
| | | The default value is FALSE (the storage is contained within |
| | | the event). |
| len.ptr_offs8 | uint32 | When the len.by_ref property is TRUE, len.ptr_offs |
| | | specifies the location (in the incoming event) of the pointer |
| | | to where the value length is stored. |
| | | The default value is 0 (first field of the event). |
| len.offs | uint32 | When the len.by_ref property is FALSE, len.offs |
| | | specifies the location (in the incoming event) at which the |
| | | value length is stored. |
| | | The default value is 0 (first field of the event). |
| len.sz | uint32 | Specifies the size of the field used to store the value length. |
| | | The length field is specified through the len.ptr_off s or |
| | | len.offs properties. |
| | | The size can be one of the following: 1, 2, 3, or 4. |
| | | The default value is 4 (size of DWORD) |
| len.order | sint32 | Specifies the byte order of the value length. The length field |
| | | is specified through the len.ptr_offs or len.offs |
| | | properties. |
| | | Can be one of the following values: |
| | | 0 -Native machine format |
| | | 1 -MSB Most-significant byte first (Motorola) |
| | | −1 LSB-Least- significant byte first (Intel) |
| | | The default value is 0 (Native machine format). |
| len.mask | uint32 | Mask that is bit-wise ANDed with the length value. |
| | | The default value is 0×FFFFFFFF (no length change). |
| len.shifts | int32 | Number of bits to shift the value length. |
| | | If the value is positive (greater than 0), the value is shifted |
| | | to the fight. If the value is negative (lesser than 0), the |
| | | value is shifted to the left. |
| | | The default value is 0 (no change) |

⁸Note that the reference pointer is always stored in the processor native format. Its size may vary, depending on the system implementation.

3. Events and Notifications

UDFX accepts any Dragon event through the in terminal. The event size must be large enough to store the value that UDFX extracts from the event.

3.1 Special Events, Frames, Commands or Verbs

None.

3.2 Encapsulated Interactions

None.

4. Specification

4.1 Responsibilities

Calculate the value length based on the val.sz\1en.xxx properties.

Extract the value from the incoming event based on the specified properties.

Convert the extracted value (integral values only) and value length from the specified byte order to the native machine byte order.

Modify the extracted data value (integral values only) and value length based on the specified properties.

Sign extend integral data values with sizes less than 4 bytes.

Update the specified data item with the modified extracted value by invoking the bind and set operations through the dat terminal.

4.2 Theory of Operation

4.2.1 State Machine

None.

4.2.2 Mechanisms

### Calculating the Data Offset

UDFX uses the following formula to calculate the data offset:

val.offs_neg?ev_sz(bp)−val.offs:val.offs

### Handling Incoming Events

When an event is received through the in terminal, UDFX performs the following operations (in order):

If no data item name is specified, the event is forwarded through the out terminal. UDFX returns control back to the original caller.

Validate the incoming event against the property set (checked versions of UDFX only).

Obtain a pointer to the value and length storage in the incoming event.

Extract the value from the event and modify the value according to the parameterzation.

Update the data item value with the modified value.

Forward the event through the out terminal.

Note that if UDFX is parameterized to extract the value after the event has been forwarded through out, it will extract the value and update the data item only under the following conditions depending on the attributes of the incoming event:

If the event is self owned and the return status is not equal to ST_OK.

If the event is asynchronously completable and the return status is not equal to ST_PENDING.

If the event is not self owned or asynchronously completable (return status is not taken into account).

If the condition for the incoming event is not met, UDFX fails the event.

### Modification of Extracted Values

Before updating the data item value, UDFX performs the following operations on the extracted value (in order):

UDFX converts the value to the native machine format.

ANDs the val. mask property with the value.

Performs the SHIFT operation on the value as specified by the val.shift property.

UDFX sign extends the value if the val.sgnext property is TRUE.

### Modification of value lengths

UDFX performs the following operations on the value length read from the incoming event (in order):

UDFX converts the value to the native machine format.

ANDs the len.mask property with the value.

Performs the SHIFT operation on the value as specified by the len. shift property.

4.3 Use Cases

4.3.1 Extracting Integral Values: Self-contained Storage, Constant Size

The following use case describes how to extract an unsigned 32-bit integer from a field of an event (although any integral data type may be used). In this case, the event contains a 4-byte field used to store the value. The length of the value is fixed (4 bytes). Note that the value length does not need to be stored in the event for constant size values.

Below is a definition of the event bus used in this example:

typedef struct B_EV_TESTtag

{
uint32 value; // storage for value
} B_EV_TEST;

The steps below describe how to extract an integer value from the B_EV_TEST event bus and update the specified data item:

UDFX is created and parameterized with the following:

1. item.name=“my_uint32” (including terminating character)

2. item.type=DAT_T_UINT32

3. var_sz=FALSE (constant size)

4. val.type=DAT_T_UINT32

5. val.offs=0(first field in B_EV_TEST bus)

6. val. sz=size of uint32 (4 bytes)

An EV_TEST event is received on UDFX's in terminal.

UDFX extracts the value from the value field of the event and invokes the bind and set operations through the dat output in order to update the specified data item.

The event is forwarded through the out terminal.

Optionally, the extracted value may be modified according to the val. order, val.sgnext,val.mask and val.shift properties. By default, UDFX does not modify the value before updating the data item.

4.3.2 Extracting ASCII String Values: Self-contained Storage, Variable Size

The following use case describes how to extract an ASCII string from a field of an event. In this case, the event has a self-contained field used to store the string. The length of the string is variable and is stored in a special field in the event.

Below is a definition of the event bus used in this example:

typedef struct B_EV_TESTtag

{
char str [256]; // storage for the string
uint32 len ; // length of the string
} B_EV_TEST;

The steps below describe how to extract an ASCII string from the B_EV_TEST event bus and update the specified data item:

UDFX is created and parameterized with the following:

1. item. name=“my_string” (including terminating character)

2. item.type=DAT_T_ASCIZ

3. var_sz=TRUE (variable size)

4. val.type=DAT_T_ASCIZ

5. val.offs=0(first field in B_EV_TEST bus)

6. len.offs=offset of len field in B_EV_TEST bus (256 bytes)

7. len. sz=size of uint32 (4 bytes)

An EV_TEST event is received on UDFX's in terminal.

UDFX extracts the string from the str field of the event and invokes the bind and set operations through the dat output in order to update the specified data item. The length of the string is retrieved from the len field in the event.

The event is forwarded through the out terminal.

4.3.3 Extracting ASCII String Values: Referenced Storage, Variable Size

The following use case describes how to extract an ASCII string from a field of an event. In this case, the event contains a reference to the buffer that contains the string. The length of the string is variable and is stored in a special field in the event.

Below is a definition of the event bus used in this example:

typedef struct B_EV_TESTtag

{
char *strp; // storage for the string
uint32 len ; // length of the string
} B_EV_TEST;

The steps below describe how to extract an ASCII string from the B_EV_TEST event bus and update the specified data item:

UDFX is created and parameterized with the following:

1. item.name=“my_string” (including terminating character)

2. item.type=DAT_T_ASCIZ

3. var_sz=TRUE (variable size)

4. val.type=DAT_T_ASCIZ

5. val.by_ref=TRUE

6. val.ptr_offs=offset of strp field in B_EV_TEST bus (0 bytes)

7. len.offs=offset of len field in B_EV_TEST bus (256 bytes)

8. len.sz=size of uint32 (4 bytes)

An EV_TEST event is received on UDFX's in terminal.

UDFX extracts the string from the strp field of the event and invokes the bind and set operations through the dat output in order to update the specified data item. The length of the string is retrieved from the len field in the event.

The event is forwarded through the out terminal.

5. Notes

UDFX's access through the dat terminal is non-atomic. Therefore, an assembly using this part may need to use external guarding.

### DPC—I_DAT to I_PROP Converter

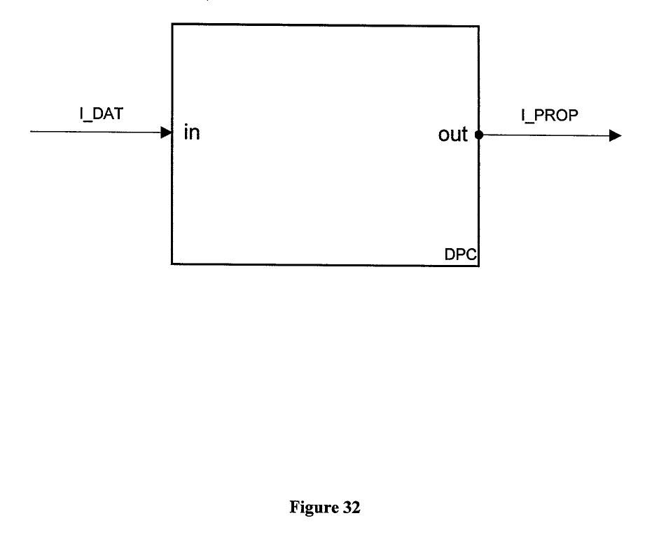

FIG. 32 illustrates the boundary of part, I_DAT to I_PROP Converter (DPC)

1. Functional Overview

DPC is an adapter that converts incoming I_DAT operation requests to I_PROP operation requests for a specific set of data items. The set of data items supported by DPC is specified via properties, as are the property names and types for each data item. DPC provides the ability for data manipulation parts to be connected to parts that implement an I_PROP interface such as property exposers and containers.

DPC, when connected to a property exposer or array, allows data values to be set as properties on other parts. Property values that were set on those parts through Parameterization or other means are made available to other data manipulation parts.

2. Boundary

2.1 Terminals

| Name | Dir | Type | Notes |
|---|---|---|---|
| in | In | I_DAT | I_DAT requests are received on this terminal. Requests not |
| | | | processed by DPC are converted into I_PROP requests and sent |
| | | | out the out terminal. |
| out | Out | I_PROP | Converted I_DAT operations are sent out this terminal. |

2.2 Properties

| Property name | Type | Notes |
|---|---|---|
| item [0 . . . | asciz | Specifies the name of a data item supported by DPC. |
| 15].name | | The default value is “”. |
| prop [0 . . . | asciz | Specifies the property name to be used in the I_PROP |
| 15].name | | request for the corresponding data item. |
| | | If this property is empty, the value of item [n]. name is |
| | | used. |
| | | The default value is “” |
| item [0 . . . | uint32 | Specifies the data type of the data item specified by |
| 15].type | | item [n].name [DAT_T_XXX]. |
| | | The default is DAT_T_NONE. |
| prop [0 . . . | uint32 | Specifies the property type of the property specified by |
| 15].type | | prop [n].name [ZPRP_T_XXX]. |
| | | DPC does not verify the validity of this property compared |
| | | to its item [n].type counterpart. |
| | | The default is ZPRP_T_NONE. |
| base | uint32 | Specifies the item handle base from which data item |
| | | handles are calculated. |
| | | This property may not have a value of 0. |
| | | The default value is 1. |

3. Events and Notifications

None.

3.1 Special Events, Frames, Commands or Verbs

None.

3.2 Encapsulated Interactions

None.

4. Specification

41 Responsibilities

Process I_DAT.bind and I_DAT.get_info requests.

Convert all other incoming data item requests to property requests and forward out the out terminal.

4.2 Theory of Operation

4.2.1 State Machine

None.

4.2.2 Mechanisms

### Calculating Data Item Handles

The handle for a specific data item is calculated by adding the value of the base property to the index of the data item property.

The opposite holds true when DPC resolves the index of a data item based on a handle (i.e., index=handle=base).

### Converting I_DAT.set Requests

When DPC is invoked on one of its I_DAT. set operation, it performs the following operations:

Resolve the data item index from the handle.

Verify data type

Initialize a B_A_PROP bus in the following manner

namep→prop [index] name or item [index].name if empty.

type→prop [index].type

bufp→address of B_DAT.val if integral type or B_DAT.p

If the data type is an integral type, DPC sets val_len to the size of B_DAT.val. If B_DAT. sz is 0 and the data item is a string, DPC sets val_len to the string length of the value plus the size of the null-terminating zero. Otherwise, DPC initializes val_len to B_DAT.sz.

DPC forwards the operation out its out terminal and returns the status from the call.

### Converting I_DAT.get requests

When DPC is invoked on one of its I_DAT. get operation, it performs the following operations:

Resolve the data item index from the handle.

Verify data type

Initialize a B_A_PROP bus in the following manner

namep→prop [index].name or item [index] .name if empty.

type→prop [index].type

bufp→address of B_DAT.val if integral type or B_DAT.p

If the data type is an integral type, DPC initializes buf_sz to size of B_DAT.val. Otherwise, DPC initializes buf_sz to B_DAT.sz. DPC forwards the operation to its out terminal. If the operation is successful DPC stores the value of B_A_PROP. val_len into B_DAT. sz. DPC returns the status from the call.

4.3 Use Cases

4.3.1 Use of DPC with Property Exposer

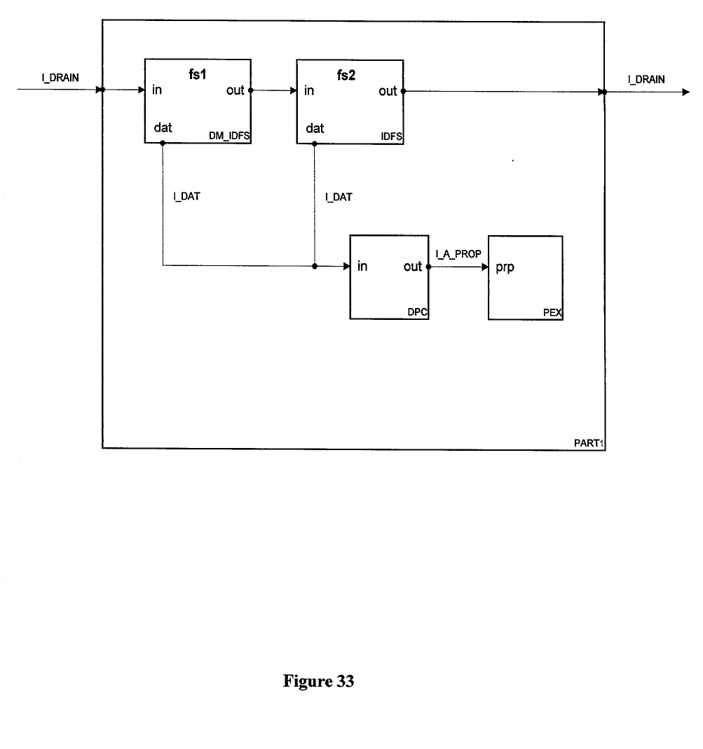

FIG. 33 illustrates an advantageous use of part DPC with Property Exposer (PEX)

The function of the PART1 assembly is to extract two fields from the event bus passing through it and exposes those fields as properties on its boundary.

The two IDFS parts each extract a field from the event bus passing through them and generate I_DAT.set requests containing the extracted value. DPC receives the requests and converts them to I_PROP.set requests, which are processed by PEX and results in the properties being set on the PART1 boundary.

4.3.2 Use of DPC with cascaded Fast Data Containers

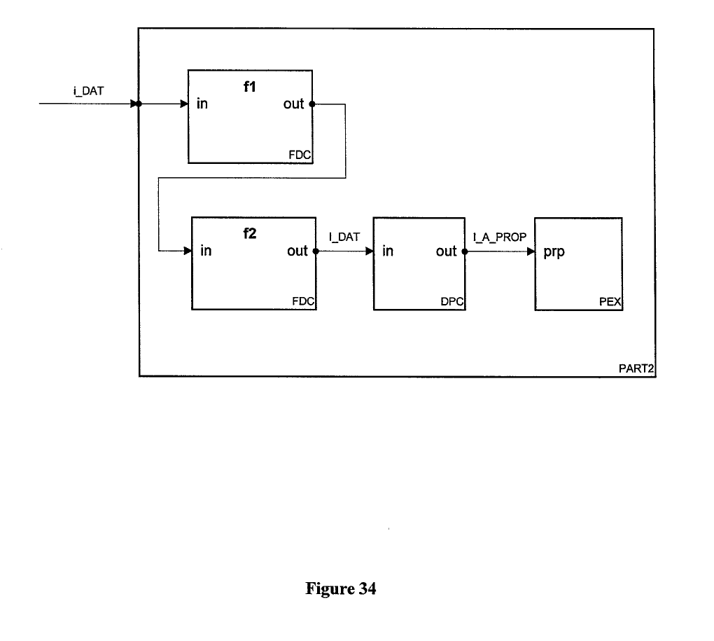

FIG. 34 illustrates an advantageous use of part DPC at end of cascaded Fast Data Containers (FDC)

The figure illustrates how DPC can be used at the end of a cascaded fast data container (FDC) chain. PART2 represents a data container that provides fast data storage for a set of data items using the FDC parts and exposes another set of properties on its part boundary using the DPC and PEX parts.

If it is desired to have PART2 expose all of the data values as properties on its boundary, then the FDC parts can be removed, leaving only DPC and PEX.

### SYS—Hardware Access

### SYSIRQ—System Interrupt Service Provider

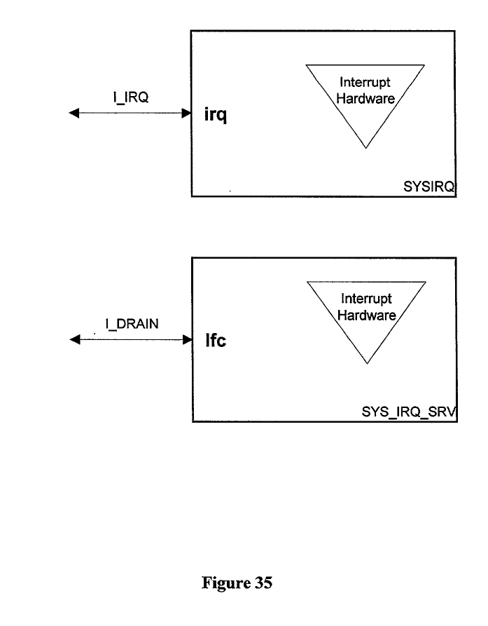

FIG. 35 illustrates the boundary of part, SYSIRQ

1. Functional Overview

SYSIRQ is an event source. It implements the basic “interrupt source” service for the standard SYS_IRQ part.

SYSIRQ is the instance name of a registered “singleton” part, it is included in assemblies “by reference”, using the part_extern( ) directive instead of the part( ) directive and does not take any properties. Other than that, it behaves as if it were a separate part instance in each assembly it is included in; i.e., in each such assembly instance “sees” its own “virtual” interrupt through the ‘irq’ terminal of SYSIRQ. This mechanism is used so that SYSIRQ can manage the interrupt vector table and the interrupt acknowledge mechanism and allow these resources to be shared among multiple clients connected to SYSIRQ.

Since SYSIRQ is accessed using the part_extern( ) directive, the actual part instance to which the name “SYSIRQ” refers must be created before any assembly that includes SYSIRQ is created. The SYSIRQ instance is created by the SYS_IRQ_SRV part. SYS_IRQ_SRV should be created and enabled before any parts that refer to SYSIRQ are created. As in Dragon all parts in a multi-level assembly are created at the same time, the only way to achieve this is to use a structure that has a “static” outer scope and a “dynamic” inner scope, which is created after the “static” scope is already in operation. See the Typical Usage section below for a working example.

The ‘tmr’ terminal can be called in interrupt context and in most cases it will call back its clients in interrupt context. The actual conditions under which the part invokes the ‘tmr’ terminal depends on the embedded ‘time base’, which is usually the system's interval timer.

The ‘irq’ input may not be invoked at interrupt time. The part will call its clients in interrupt time.

2. Boundary

2.1 Terminals (SYSIRQ)

| Name | Dir | Interface | Notes |
|---|---|---|---|
| irq | i/ | I_IRQ | Interrupt control terminal. This is a multiple-cardinality |
| | o | | terminal. Each connection to this terminal is associated with |
| | | | one “interrupt connection” object. The input side of each |
| | | | connection is used to attach and detach the “interrupt |
| | | | connection” object to a hardware interrupt line. SYSIRQ calls |
| | | | the output when the hardware interrupt occurs. If there are |
| | | | multiple “connection” objects associated with the same |
| | | | interrupt, SYSIRQ executes a call for each of them. |
| | | | The input may not be called at interrupt time, in particular it |
| | | | should not be called from within the context of an outgoing |
| | | | call coming from this same terminal. |
| | | | This terminal can be connected only after the part has been |
| | | | activated. SYSIRQ can only be used by including it “by |
| | | | reference” in another assembly, which is NOT created at the |
| | | | time when SYSIRQ is created. In practice this means that the |
| | | | instances of SYS_IRQ or other parts that use SYSIRQ should |
| | | | be inside an assembly that is created by the part array (ARR - |
| | | | see the XDL Language Reference or a similar part that can |
| | | | dynamically create and destroy parts. |

2.2 Terminals (SYS_IRQ_SRV)

| Name | Dir | Interface | Notes |
|---|---|---|---|
| Lfc | i/ | I_DRAIN | Life-cycle control terminal. This terminal is used to provide |
| | o | | initialization/cleanup events to the SYSTMR_SRV part. An |
| | | | EV_REQ_ENABLE request should be sent to this terminal |
| | | | before any assembly that contains SYSIRQ can be used. |
| | | | EV_REQ_DISABLE should be sent to this terminal before |
| | | | destroying SYS_IRQ_SRV. |
| | | | SYS_IRQ_SRV completes the EV_REQ_ENABLE/ |
| | | | DISABLE requests synchronously. The output direction of |
| | | | the ‘lfc’ terminal is not used. |

2.3 Properties

None.

3. Events and Notifications

None.

4. Environmental Dependencies

4.1 Encapsulated Interactions

SYSIRQ modifies the interrupt vector table, either directly or using OS services. SYSIRQ uses direct hardware access and/or OS services to acknowledge the hardware interrupt to the hardware and to the OS (as needed).

SYSIRQ uses direct hardware access and/or OS service to enable and disable specific hardware interrupts.

SYSIRQ may disable the CPU interrupts for short periods of time to guard access to the system hardware and to its own structures. Unless required by the OS, SYSIRQ will not disable the CPU interrupts when invoking the ‘irq’ terminal. The interrupt handler parts connected to this terminal should not make any assumptions about the state of the CPU interrupt mask.

4.2 Other Environmental Dependencies

None

5. Specification

5.1 Responsibilities

Implement an infinite-cardinality terminal; create an ‘interrupt connection’ object for each connection to the terminal, thus making the part appear as an independent instance from the viewpoint of any client connected to it.

Implement ‘connect’ and ‘disconnect’ operations on the ‘irq’ terminal. The ‘connect’ operation connects the “interrupt connection” object to a hardware interrupt and makes it active, the ‘disconnect’ operation makes the object inactive.

Accept hardware interrupts and call the ‘irq’ terminal for each “interrupt connection” object associated with the hardware interrupt that occurred.

Use low-overhead and interrupt-friendly structures to maintain the list of active “interrupt connection” objects.

5.2 External States

Each “interrupt connection” object created by SYSIRQ has state that is independent of the state of other objects. An “interrupt connection” object can be in one of the following states:

Disconnected—this is the initial state of a new object created when a connection is made to the ‘irq’ terminal.

Connected—object is active and will generate a call to the ‘irq’ terminal wherein the associated hardware interrupt occurs.

5.3 Use Cases

None.

6. Typical Usage

This part is intended primarily as the main building block for implementing the SYS_IRQ part. See the SYS_IRQ implementation design.

6.1 Document References

None.

6.2 Unresolved Issues

None.

### SYS—System Configuration

### SYS_EVPRM—Event Pool Parameterizer

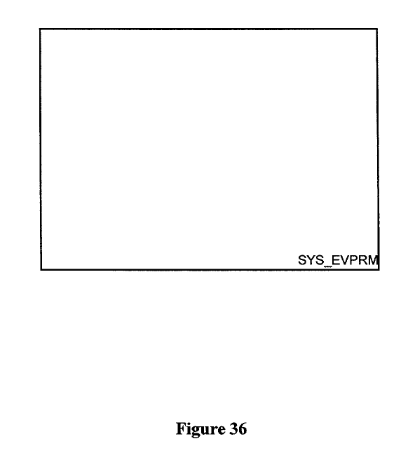

FIG. 36 illustrates the boundary of part, SYS_EVPRM

1.1 Functional Overview

The event pool parameterizer requests that the system pre-allocate a specified number of buffers in the event pool so that they are available for creating events at interrupt time. The buffer sizes and the number of buffers for each size are specified as properties. Multiple instances of this part can be used and their effect is cumulative.

Typically, SYS_EVPRM should be placed in the outermost assembly of a system. Since the pre-allocation is cumulative and cannot be undone, SYS_EVPRM should never be used in an assembly that is created and destroyed dynamically as part of the system's operation.

1.2 Boundary

1.2.1 Terminals

None.

1.2.2 Properties

| Property name | Type | Notes |
|---|---|---|
| sz1, sz2, sz3, sz4 | uint32 | Event payload sizes. Any of these properties that is |
| | | set to a non-O value specifies an event payload size |
| | | that is expected to be used at interrupt time. The |
| | | corresponding nx property specifies the number of |
| | | events of the specified size that are expected to be |
| | | allocated at the same time. |
| | | See the usage note and the typical usage examples |
| | | below. |
| | | Default value: 0 |
| n1, n2, n3, n4 | uint32 | Number of buffers to pre-allocate. The nx properties |
| | | have effect only if the corresponding S zx property |
| | | is set to a non-zero value. |
| | | Default value: 1 |
| attr | uint32 | Attributes of the events to be pre-allocated. Only the |
| | | attributes related to the event buffer allocation are |
| | | meaningful (ZEVT_A_SHARED and |
| | | ZEVT_A_SAFE). |
| | | The value of this property affects all buffers that are |
| | | pre-allocated by the part, as specified by the S zx |
| | | and nx properties. Note that if pre-allocation is |
| | | needed for different types of allocation (e.g. both for |
| | | shared and for normal memory), separate instances |
| | | of SYS_EVPRM have to be used for each type. |
| | | Default value: 0 |

1.2.3 Events and Notifications

None

1.3 Environmental Dependencies

1.3.1 Encapsulated Interactions

This part re-configures the event manager upon activation. Note that destroying the part does not reverse the changes made.

1.3.2 Other Environmental Dependencies

None.

1.3.3 Usage Note

The event manager maintains a set of buffer pools for allocating event buffers. Each pool contains buffers of a fixed size. Whenever a new event is needed, the event manager picks a buffer from the pool with the smallest buffer size that is greater or equal to the requested size, which means that events of different sizes may be allocated from the same pool. This should be taken into account when configuring the event manager with the help of SYS_EVPRM.

In the case when it is known in advance what event sizes will be used, one or more instances of SYS_EVPRM should be parameterized with all of these sizes and the corresponding number of events for each size.

In the case when it is not known in advance what the event sizes would be, some heuristics need to be applied. The following rules always apply:

The event manager will not be able to allocate an event at interrupt time if there is no pre-allocated pool for the given event size. Always pre-allocate at least one event of the maximum size that is expected to be needed at interrupt time.

If pre-allocation is specified for sizes X and Y (X<Y), all requests to create an event of size less than or equal to Y, but greater than X will be satisfied from the pool reserved for size Y.

By default, the event manager pre-allocates at least 100 buffers for events of sizes 0 to 32 bytes. To pre-allocate additional buffers for small-size events, extend this pool by setting one of the szx properties to 32 and set the corresponding nx to the desired number of buffers. It is not recommended to force the creation of a new buffer pool, say of size 16 because the overhead of the pool control blocks is likely to be larger than the space saved compared to extending the 32-byte pool.

2. Specification

2.1 Responsibilities

Re-configure the event manager to guarantee that the specified number of events of the specified sizes (configured through properties) is available for allocation at interrupt time.

2.2 External States

None.

2.3 Use Cases

None; this part has no inputs and performs no operations.

3. Typical Usage

All examples below assume that one instance of SYS_EVPRM is placed in the outermost system assembly.

3.1 Configuration for an Image-processing Application

This example assumes that the system will use events of one size only—the size needed to store one video frame (besides the control events, which will be drawn from the default pool for small events).

sz1=304128 (352*288*3=1 CIF frame in 8-bit RGB format)

n1=5 (pick this number depending on the length of the image processing pipeline, counting each de-synchronization point, e.g.: 2 for data pickup from input device, 1 for hardware color space conversion, 2 for output file buffers)

sz2=0 (default value, not used)

sz3=0 (default value, not used)

sz4=0 (default value, not used)

3.2 Configuration for a Networking Application

Assuming that events' payload buffers are used as the receive and transmit frame buffers, a networking application will use events of varying sizes—from the smallest ones that carry only network headers up to the largest frame that can be carried by the network protocol(s).

Considering that the network speed is constant, regardless of the frame size, one would expect higher frame rates for smaller frame sizes and lower frame rates for larger frame sizes.

The simplest solution of course will be to pre-allocate enough buffers of the largest possible size, but there may not be enough system memory for that. The table below shows a possible compromise assuming a random spread of the frame sizes:

| sz | n |
|---|---|
| sz1 = 100000 | n1 = 3 |
| sz2 = 30000 | n2 = 10 |
| sz3 = 10000 | n3 = 30 |

For the same average number of buffered frames, the total amount of pre-allocated memory is about 10 times less than what would be needed if all the buffers were allocated with the largest size (100K).

4. Document References

None

5. Unresolved Issues

None

### SYS—Debugging and Instrumentation

### SYS_LOG—Log File Output

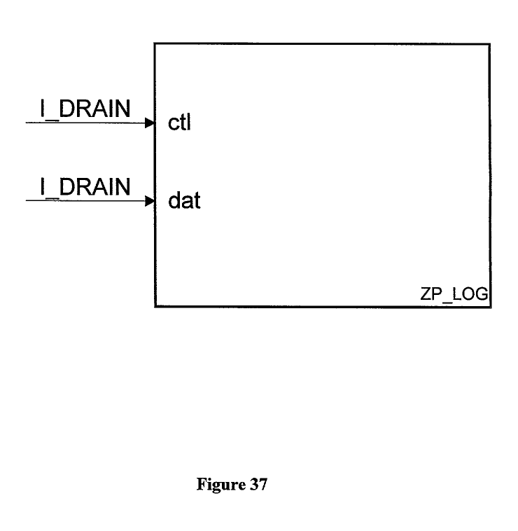

FIG. 37 illustrates the boundary of part, Log File Output (SYS_LOG)

1. Functional Overview

SYS_LOG writes time-stamped data into a file. The data is provided in events received on the d a t terminal. SYS_LOG can treat the incoming data as either binary or string data. This functionality is parameterizable via a property.

SYS_LOG may statically be enabled/disabled via property before activation or dynamically during run-time via events received on its ctl terminal. The event IDs used to enable/disable SYS_LOG are provided as properties.

SYS_LOG is useful for creating log files with fixed or variable record size.

2. Boundary

2.1 Terminals

| Name | Dir | Interface | Notes |
|---|---|---|---|
| dat | in | I_DRAIN | This tenninal is used to send data to be written into the log |
| | | | file. SYS_LOG accepts any event on this input. |
| | | | If the data is binary, all data in the event bus starting from the |
| | | | offset specified by the offs property up to the size of the bus |
| | | | (specified by the sz field) is written into the log file. |
| | | | Otherwise, data is written to the file starting at offs up to the |
| | | | terminating zero. |
| ct1 | in | I_DRAIN | This terminal may be used to enable and disable the writing |
| | | | of entries in the log file. Depending on the part's |
| | | | parameterization, the “enable” and “disable” events can also |
| | | | control the opening and closing of the event log file (see the |
| | | | next section). The events that SYS_LOG accepts as “enable” |
| | | | and “disable” are programmable as properties. |
| | | | This terminal may be left unconnected. |

2.2 Properties

| Name | Type | Notes |
|---|---|---|
| file_name | asciz | The log file name. SYS_LOG provides no less than 260 |
| | | (MAX_PATH) characters of storage for this property. See the |
| | | note (*) below on using this property. |
| | | This property is mandatory. |
| append | byte | Setting this property to TRUE makes SYS_LOG append new |
| | | entries to the log file (if it already exists). Setting it to FALSE |
| | | causes SYS_LOG to erase the file each time the log is enabled. |
| | | Default value: 1 (append enabled). |
| max_log_sz | uint32 | Specifies the maximum log file size (in units of 1024 bytes). If |
| | | the log file reaches the specified size, SYS_LOG stops adding |
| | | entries to it. Setting this property to 0 disables the log file size |
| | | limit. |
| | | Default value: 0 (no file size limit) |
| safe_mode | uint32 | This property defines whether SYS_LOG should flush the log |
| | | file every time new data is written into it. This property can |
| | | take the following values: |
| | | 0 - unsafe mode (fastest). SYS_LOG keeps the log file open |
| | | whenever it is enabled and does not flush the file buffers until |
| | | it is disabled (or deactivated). |
| | | 1 - safe mode (slower). SYS_LOG flushes the file buffers |
| | | every time new data is written into the log. It may keep the log |
| | | file open. |
| | | 2 - safest mode (slowest). SYS_LOG keeps the file closed and |
| | | opens it only to write new data into it, then closes it again |
| | | before returning to the caller. |
| | | Default value: 0. |
| offs | uint32 | Defines the offset into the event bus from which to start taking |
| | | data to be written into the log file. |
| | | Default value: 0 |
| string_data | uint32 | Boolean. If TRUE, the data at offs is treated as a zero- |
| | | terminated ASCII string. Only the data up to the terminating |
| | | zero is written to the log file. |
| | | Default value: FALSE. |
| start_enabled | uint32 | If this property is set to a non-zero value, SYS_LOG will |
| | | enable the log file upon activation. Note that if the use of |
| | | control events is disabled setting this property to FALSE |
| | | completely disables SYS_LOG. |
| | | Default value: FALSE. |
| enable_id | uint32 | Specifies the event to be used as the “log enable” event. |
| | | Setting this property to EV_NULL (0) disables the use of |
| | | control events to enable and disable the log; the only way to |
| | | enable the log in this case is to set the start_enabled property |
| | | to TRUE. |
| | | Default value: EV_REQ_ENABLE. |
| disable_id | uint32 | Specifies the event to be used as the “log disable” event. If |
| | | enable_id is set to EV_NULL this property is ignored (no |
| | | events are accepted on the ct1 input in this case). |
| | | Default value: EV_REQ_DISABLE. |
| timestamp | uint32 | This property defines the format of the time stamp written with |
| | | each data block written (one variable-size data block is written |
| | | with each call to the dat terminal). |
| | | Possible values: |
| | | 0 - no time stamp |
| | | ‘B’ - long binary format. SYS_LOG writes the current system |
| | | time in the Win32 FILETIME format (an 8-byte integer |
| | | representing the number of 0.1 us units since Jan 01, 1601). |
| | | ‘X] - long hex time stamp. Same as above, but written as a 16- |
| | | digit hexadecimal number. |
| | | Default value: 0 (no time stamp). |

(*) Notes on the file_name property usage.

The file_name property must contain the full path to the file.

3. Events and Notifications

3.1 Terminal: dat

| Event | Dir | Bus | Notes |
|---|---|---|---|
| * | in | void | Any event on the dat terminal is treated as variable |
| | | | size binary data to be stored in the log file. If the log |
| | | | file is disabled, SYS_LOG will accept this message |
| | | | and return ST_OK without taking any action. |

3.2 Terminal: ctl

| Event | Dir | Bus | Notes |
|---|---|---|---|
| (enable_id) | in | void | The event ID programmed into the enable_id |
| | | | property, when sent to the ctl terminal, enables |
| | | | the writing of entries in the log file. The event |
| | | | may have any bus-SYS_LOG ignores the data |
| | | | carried by the event. |
| (disable_id) | in | void | The event ID programmed into the disable_id |
| | | | property, when sent to the ctl terminal, disables |
| | | | the writing of entries in the log file. The event |
| | | | may have any bus-SYS_LOG ignores the data |
| | | | carried by the event. |

3.3 Special Events, Frames, Commands or Verbs

None.

3.4 Encapsulated Interactions

SYS_LOG uses operating system services to perform file operations and to read the system time.

4. Specification

4.1 Responsibilities

Create and maintain the log file specified by the flle_name property.

Write data into the file specified by the file_name property, along with a formatted time stamp.

4.2 Theory of Operation

4.2.1 Mechanisms

None.

### UTL—Concurrency

### UTL_E2AR—Event to Asynchronous Request Converter

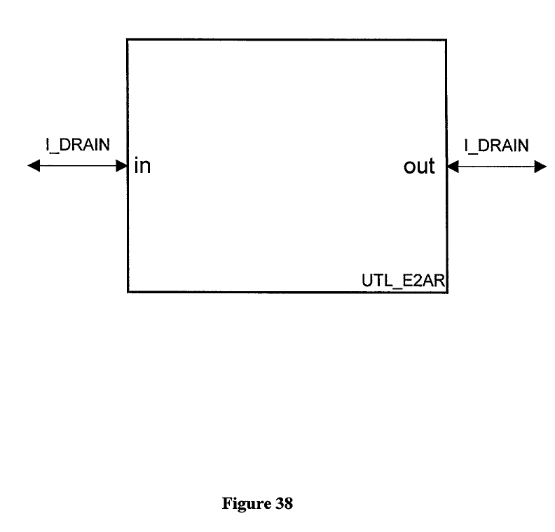

FIG. 38 illustrates the boundary of part, Event to asynchronous request converter (UTL_E2AR)

1. Functional Overview

UTL_E2AR is a plumbing part that converts an incoming notification received on the in terminal to an asynchronous request and converts a request completion received on the out terminal into a notification.

UTL_E2AR generates an asynchronous request out the out terminal when a specific event is received on the in terminal. The generated request's data bus is zero-initialized.

When a generated request completes, UTL_E2AR generates a “completed” notification and sends it back to the in terminal. The ID of the notification depends on whether the request completed successfully. The notification is always self-owned and event bus contains all the data returned in the request completion.

The incoming and outgoing request IDs and the request bus size are specified through properties.

This part can be used whenever it is necessary to generate a simple asynchronous request upon a notification or another similar event.

UTL_E2AR's terminals are unguarded and may be invoked at interrupt time.

2. Boundary

2.1 Terminals

| Name | Dir | Interface | Notes |
|---|---|---|---|
| in | bi | I_DRAIN | When the specified trigger event is received here, |
| | | | UTL_E2AR generates an asynchronous request |
| | | | through the out terminal. |
| out | Bi | I_DRAIN | UTL_E2AR sends generated asynchronous |
| | | | requests through this terminal. |
| | | | The completion of the generated request is |
| | | | received through the back channel of this |
| | | | terminal. |

2.2 Properties

| Property name | Type | Notes |
|---|---|---|
| in_req_ev_id | uint32 | ID of the trigger event received through |
| | | the in terminal. |
| | | When this event is received, |
| | | UTL_E2AR generates an asynchronous |
| | | request through the out terminal. |
| | | Default value is EV_NULL (a request |
| | | is generated on any event received |
| | | through the in terminal). |
| in_cplt_ok_ev_id | uint32 | ID of the event UTL_E2AR generates |
| | | through the in terminal when the |
| | | asynchronous request completes |
| | | successfully. |
| | | Default value is EV_NULL. |
| in_cplt_fail_ev_id | uint32 | ID of the event UTL_E2AR generates |
| | | through the in terminal when the |
| | | asynchronous request fails (completion |
| | | status ! = ST_OK). |
| | | Default value is EV_NULL. |
| out_ev_id | uint32 | ID of the asynchronous request sent |
| | | through the out terminal. |
| | | This property should always be set to |
| | | the proper event ID. |
| out_ev_sz | uint32 | Size (specified in bytes) of the |
| | | asynchronous request generated through |
| | | the out terminal. |
| | | Default is 0. |
| out_or_attr | uint32 | Attribute mask that is ORed with the |
| | | asynchronous request attributes before it |
| | | is forwarded through the out terminal. |
| | | These attributes should include only |
| | | application-specific attributes and no |
| | | attributes defined by Dragon. |
| | | Default is 0 (none). |

2.3 Events and Notifications

UTL_E2AR accepts events on its in or out terminals, as specified by its properties.

2.4 Environmental Dependencies

2.5 Encapsulated Interactions

None.

3. Specification

3.1 Responsibilities

For the specified event received on the in terminal, generate an asynchronously completable request through the out terminal.

When the asynchronous request completes (by receiving the completion event through the out terminal), depending on the completion status, generate either an in_cplt_ok_ev_id (success) or in_cplt_fail_ev_id (failure) event through the in terminal.

Fail events received on the out terminal with ST_NOT_SUPPORTED if the ZEVT_A_COMPLETED attribute is not set or the event ID is not out_ev_id.

Consume events received on in whose event ID is not in_req_ev_id and return ST_OK.

3.2 Use Cases

None.

3.3 Typical Usage

None

### UTL—Property Space Support

### UTL_PCOPY—Property Copier

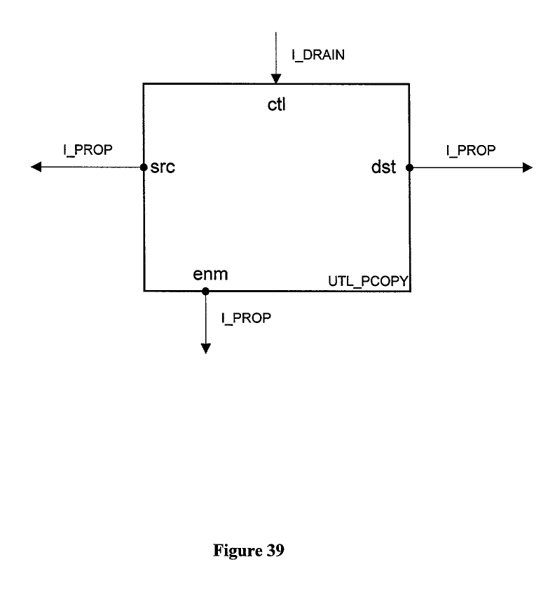

FIG. 39 illustrates the boundary of part, Property Copier part (UTL_PCOPY)

1. Functional Overview

UTL_PCOPY is a parameterization part that copies property values from a source property container to a destination property container when a trigger event is received.

When a trigger event is received, UTL_PCOPY enumerates the properties through its enm terminal and for each property found, retrieves the value through the src terminal and sets the value through the dst terminal.

UTL_PCOPY is typically used to store property values from a dynamic part container to persistent storage such as a file or database and restore property values from persistent storage.

UTL_PCOPY cannot be used in an interrupt context because memory is allocated dynamically.

2. Boundary

2.1 Terminals

| Name | Dir | Interface | Notes |
|---|---|---|---|
| ctl | in | I_DRAIN | Input for control (trigger) event that initiates the |
| | | | enumeration and copying of properties. |
| enm | out | I_PROP | UTL_PCOPY enumerates properties through this |
| | | | terminal. |
| src | out | I_PROP | UTL_PCOPY retrieves the enumerated property |
| | | | values through this terminal. |
| dst | out | I_PROP | UTL_PCOPY sets the enumerated property |
| | | | values through this terminal. |

2.2 Properties

| Property | | |
|---|---|---|
| name | Type | Notes |
| trigger_ev | uint32 | Specifies the ID of the event received through |
| | | the ctl terminal that results in UTL_PCOPY |
| | | enumerating properties through its enum |
| | | terminal retrieving the property values from the |
| | | src terminal and setting the property values |
| | | through the dst terminal. |
| | | The default value is EV_PULSE. |
| buf_sz | uint32 | Specifies the intial size in bytes of the data |
| | | buffer that is used when retrieving property |
| | | values. |
| | | The default value is 32. |
| resize | uint32 | Boolean. When TRUE, UTL_PCOPY resizes |
| | | the data buffer it uses to retrieve property value |
| | | if the property value overflows the buffer. |
| | | When FALSE and the property value overflows |
| | | the data buffer, UTL_PCOPY fails the event |
| | | with ST_OVERFLOW. |
| | | The default value is TRUE. |
| qry_string | asciz | Query string to use when enumerating |
| | | properties. |
| | | The default value is “*” (enumerate all |
| | | properties.) |
| qry_attr | uint32 | Attributes to use when enumerating properties. |
| | | The default value is ZPRP_A_PERSIST. |
| qry_attr_mask | uint32 | Attribute mask to use when enumerating |
| | | properties. |
| | | The default value is 0xFFFFFFFF. |
| enm_id | uint32 | Modifiable part instance ID to store in the ID |
| | | field of the property bus when enumerating |
| | | properties through the enm terminal. |
| | | The default value is 0 (any part.) |
| src_id | uint32 | Modifiable part instance ID to store in the ID |
| | | field of the property bus when retrieving |
| | | property values through the src terminal. |
| | | The default value is 0 (any part.) |
| dst_id | uint32 | Modifiable part instance ID to store in the ID |
| | | field of the property bus when retrieving |
| | | property values through the dst terminal. |
| | | The default value is 0 (any part.) |

3. Events and Notifications

3.1 Terminal: ctl

| Event | Dir | Bus | Notes |
|---|---|---|---|
| (trigger_ev) | in | any | When this event is received, UTL_PCOPY |
| | | | enumerates properties through its enm terminal, |
| | | | retrieving the property values from the src |
| | | | terminal and setting the property values through |
| | | | the dst terminal. |

4. Environmental Dependencies

None.

5. Specification

5.1 Responsibilities

When the trigger_ev event is received through the ctl terminal, enumerate the properties through the enm terminal and for each property found, retrieve the property value through the src terminal and set the property value through the dst terminal.

If the event received through the ctl terminal is not the trigger event, fail the event with ST_NOT_SUPPORTED.

If ST_NOT_FOUND is returned for any request that is sent through the src or dst terminals, the debug version of UTL_PCOPY will display debug output and continue with the next property.

If the property value retrieved from the src exceeds the size of initially allocated buffer, and resizing is allowed, reallocate the buffer size to fit the property value.

Otherwise, fail the event with ST_OVERFLOW.

5.2 External States

None

5.3 Use Cases

5.3.1 Serialization of Part Instance Properties to Registry

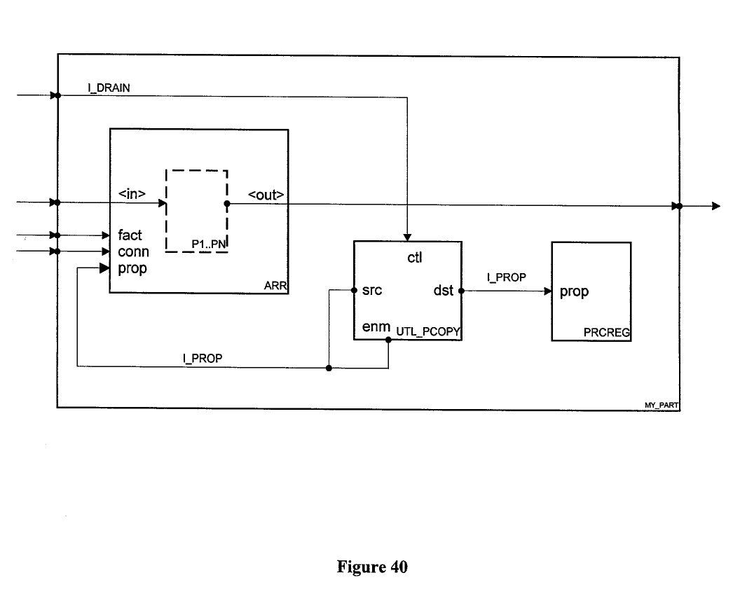

FIG. 40 illustrates an advantageous use of part, UTL_PCOPY

This use case demonstrates how to serialize properties of a part instance using UTL_PCOPY. This example has the UTL_PCOPY part connected to PRCREG and the part array ARR.

UTL_PCOPY is parameterized with the part instance ID for the part instance whose state needs to be serialized to the registry (enm_id and src_id). Next, UTL_PCOPY is parameterized with the trigger event ID used to serialize the part's state to the registry.

At some point, the trigger event is sent to UTL_PCOPY to serialize the part's properties.

UTL_PCOPY receives the trigger event and begins to enumerate the part's properties through its enm terminal.

For each enumerated property, UTL_PCOPY retrieves the value of the property through the src terminal and then sets the property through the dst terminal.

Each property that is set through the dst terminal is updated in the system's registry by PRCREG.

UTL_PCOPY continues to enumerate and copy the property values from the src to the dst terminal until all the properties are enumerated.

The properties can be deserialized from the registry to the part instance by swapping the PRCREG part with the part array ARR (PRCREG connected to the src terminal and ARR connected to the dst terminal).

6. Typical Usage

See Serialization of part instance state to registry above under Use Cases.

7. Document References

None

8. Unresolved Issues

None

### UTL_PRPQRY—Property Query Processor

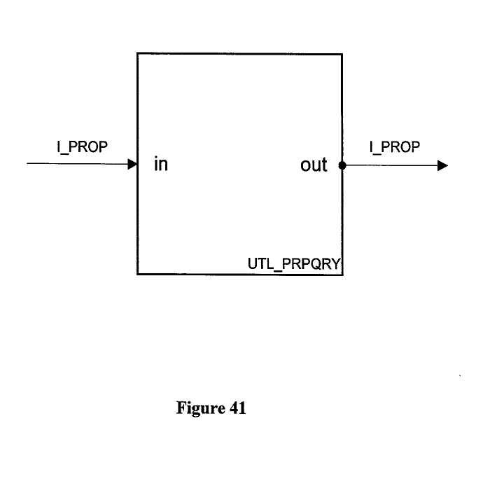

FIG. 41 illustrates the boundary of part, Property Query Processor (UTL_PRPQRY)

1. Functional Overview

UTL_PRPQRY is a parameterization part that limits the enumeration of properties to those whose name matches a specified query string, which may contain wildcard characters. This enables groups of properties that contain a specific character pattern to be enumerated.

UTL_PRPQRY processes only property enumeration requests (i.e., qry_open, qry_close, qry_first, qry_next, etc.); all other I_PROP operations are forwarded to the out terminal without modification.

UTL_PRPQRY supports only one query session at a time. A query session is the period between the opening and closing of a query. An attempt to open more than one query session will return an error status.

UTL_PRPQRY is typically used where two or more components, requiring serialization and de-serialization services, need to share a property container. UTL_PRPQRY allows each component to differentiate its own properties from others by accessing only properties with a unique string pattern in their names.

UTL_PRPQRY must be guarded.

While either the qry_first or qry_next operation is executing, UTL_PRPQRY does not allow other qry_frst or qry_next calls. Any calls received to either qry_first and qry next while either is executing will be rejected. UTL_PRPQRY will be guarded intermittently during query operations. The part cannot be used in an interrupt context when query operations are invoked. However, the part can be used in an interrupt context during get, set, chk and get_info operations.

2. Boundary

2.1 Terminals

| Name | Dir | Interface | Notes |
|---|---|---|---|
| in | in | I_PROP | UTL_PRPQRY receives I_PROP operations |
| | | | through this terminal. Operations not related to |
| | | | enumeration are forwarded through to the out |
| | | | terminal. Operations relating to enumeration |
| | | | trigger internal procedures used to enumerate |
| | | | properties through the out terminal based on a |
| | | | query string. |
| out | out | I_PROP | UTL_PRPQRY invokes I_PROP operations |
| | | | through this terminal that have been passed from |
| | | | the in terminal and operations that are used to |
| | | | enumerate properties that will be compared to a |
| | | | query string. |

2.2 Properties

| Property | | |
|---|---|---|
| name | Type | Notes |
| wildcard1 | uchar | Specifies the character to be used as the universal |
| | | wildcard character. As characters in the query string |
| | | and property name are sequentially examined for a |
| | | match, the universal wildcard character found in the |
| | | query string will match all remaining characters in |
| | | the property name |
| | | The default value is “*”. |
| wildcard2 | uchar | Specifies the character to be used as a limited |
| | | wildcard character. As characters in the query string |
| | | and enumerated property's name are sequentially |
| | | examined for a match, the limited wildcard character |
| | | found in the query string will match the remaining |
| | | characters in the property name up to the delimiter |
| | | character. |
| | | The default value is “?”. |
| delimiter | uchar | Specifies the character used to delimit hierarchical |
| | | levels in the property name. |
| | | The default value is “.” |

3. Events and Notifications

None.

4. Environmental Dependencies

4.1 Encapsulated Interactions

None.

4.2 Other Environmental Dependencies

None.

5. Specification

5.1 Responsibilities

Pass the get, set, chk, get_info calls on the in terminal through the out terminal.

Extract and save the query string from an incoming qry_open operation. Open the same query on the out terminal except with qry_string set to ‘*’.

Respond to a qry_first and qry_next calls on the in terminal by making repeated queries through the out terminal until a match with the stored query string received on the in terminal is found.

5.2 External States

None

5.3 Use Cases

5.4 Specifying Wildcards in the Query String

The query string can contain two different wildcard characters, universal (“*” by default) and limited (“?” by default.)

The universal wildcard character applies to the entire property name. For example, using the “*” as the universal wildcard character, a query string value of “Pr*” matches “Property1,” “Property.2.3”, “Proposition/a/b” or “Predictor23; 4”

The limited wildcard character applies only to characters up to a delimiter ( “.”by default.) For example, using “?” as the limited wildcard character, a query string of “property.c?.hello” matches “property.cat.hello” or “property.cello.hello” This limited wildcard mechanism allows properties to be accessed in a hierarchical fashion similar to folders and sub-folders on a personal computer hard-drive. For example, properties of different parts stored in a single property container, using names like “part1.property1”, “part1.property2”, “part2.property1” etc., can be accessed in groups of like names. A search string value of“?.property1” would enumerate all properties with “property1” after the delimiter“.”

5.5 Enumerating properties

UTL_PRPQRY receives a qry_open request on its in terminal and forwards the request to its out terminal.

UTL_PRPQRY receives a qry_first request on its in terminal.

UTL_PRPQRY invokes qry_first and one or more qry_next requests out its out terminal until a property is returned that matches the query string.

UTL_PRPQRY receives a qry_next request on its in terminal.

UTL_PRPQRY invokes one or more qry_next requests out its out terminal until a property is returned that matches the query string.

UTL_PRPQRY receives a qry_close request on its in terminal and forwards the request to its out terminal.

6. Typical Usage

6.1 De-serialization of Properties from a Property Paramaterizer to a Registry Based Property Container

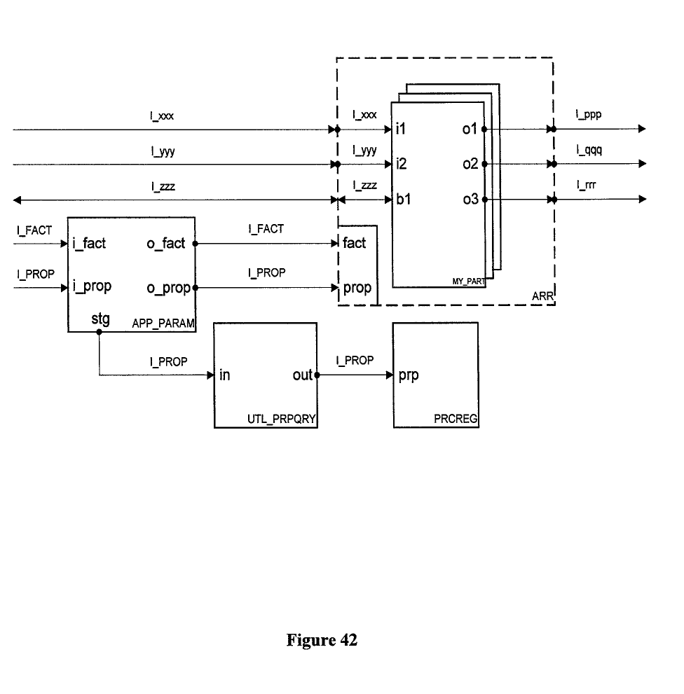

FIG. 42 illustrates an advantageous use of part, UTL_PRPQRY

This use case demonstrates how to serialize properties of multiple part instances using UTL_PRPQRY. This example has the UTL_PRPQRY part connected to APP_PARAM used to parameterize part array ARRY and PRCREG used to store serialized properties.

When APP_PARAM recognizes its triggering persistent property name on its i_prop terminal, it initiates a query through its stg terminal. The query string contains the persistent property name for example “my_part ” followed by a dot then a wildcard character such as “?” forming “my_part1.?”. As APP_PARAM continues its property enumeration, UTL_PRPQRY queries the registry through PRCREG passing back only those properties that match the “my_part1.?” query string. As each property is enumerated, APP_PARAM can get property values through UTL PRPQRY from PRCREG thereby parameterizing my_part1 within the part array ARR with only my_part1's own parameters.

7. Document References

None

8. Unresolved Issues

None.

### UTL_PRCBA—Virtual Property Container on Byte Array

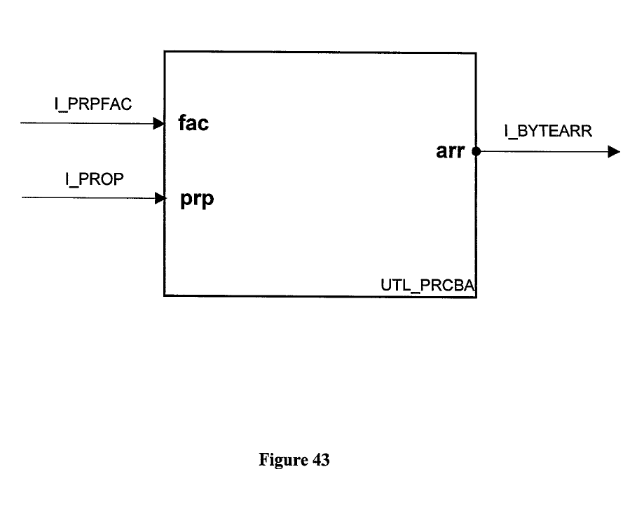

FIG. 43 illustrates the boundary of part, UTL_PRCBA

1. Functional Overview

UTL_PRCBA is a property container part that provides standard property services for virtual, dynamic properties. The properties in the container are stored in a byte array accessed through the arr terminal.

UTL_PRCBA implements all of the operations specified in the I_PROP interface and supports multiple property queries at a time. UTL_PRCBA supports all of the standard Dragon property types and has no self-imposed restriction as to the size of the property value, provided there is enough storage in the byte array.

UTL_PRCBA is typically used in assemblies to store persistent system parameters over some type of persistent storage (e.g., hard disk).

UTL_PRCBA's terminals are guarded in order to prevent data corruption in the property container. Therefore, UTL_PRCBA cannot be used in interrupt contexts.

2. Boundary

2.1 Terminals

| Name | Dir | Interface | Notes |
|---|---|---|---|
| fac | in | I_PRPFAC | This terminal is used to create, destroy and |
| | | | re-initialize properties in the container. |
| prp | in | I_PROP | This terminal is used to get, set, check and |
| | | | enumerate properties in the container. |
| arr | out | I_BYTEARR | This terminal is used to access the byte array |
| | | | that is used to store information about the |
| | | | properties in the container. |

2.2 Properties

| Property name | Type | Notes |
|---|---|---|
| initial_prp_stg_offs | uint32 | Specifies the initial offset in the byte |
| | | array where the property container |
| | | should store the property information. |
| | | The default value is 0 (beginning of |
| | | the byte array). |
| total_prp_stg_sz | uint32 | Specifies the maximum amount of byte |
| | | array storage that UTL_PRCBA is |
| | | allowed to use to store property |
| | | information (specified in bytes). On a |
| | | property create or set operation, if the |
| | | maximum storage size is reached, |
| | | UTL_PRCBA fails the operation |
| | | with ST_NO_ROOM. |
| | | If this property is set to zero, the |
| | | maximum amount of storage depends |
| | | on the available amount of storage in |
| | | the byte array. |
| | | The default value is 0. |
| max_props | uint32 | Specifies the maximum number of |
| | | properties to store in the container. |
| | | If this property is set to zero, the |
| | | maximum number of properties only |
| | | depends on the available amount of |
| | | storage in the byte array (accessed |
| | | through the arr terminal). |
| | | The default value is 64. |

3. Events and Notifications

None.

4. Environmental Dependencies

None.

4.1 Encapsulated Interactions

None.

4.2 Other Environmental Dependencies

None.

5. Specification

5.1 Responsibilities

Implement all property factory operations as defined by the I_PRPFAC interface (create,destroy,clear,get_first and get_next).

Implement all property access operations as defined by the I_PROP interface (get,set,chk, get_info,qry open,qry close,qry first, qry_next and qry_curr).

Support all Dragon property types.

Ignore all property attributes.

Support multiple property queries and querying for only all of the properties in the container (query string=“*”). PRCQRY may be used in front of UTL_PRCBA in order to support more complex property queries.

Maintain the property container over a byte array using the arr terminal. The structure of the property information is an array of records stored in the byte array.

Each record has the following structure:

<total_record_length>, <name>, <type>, <attr>, <value_length>, <value>

total_record_length: The total number of bytes in the record. This is used to enumerate the records in the array. This field is in MSB byte order. The first bit is used to determine how much storage is used for this field (either 1 byte or 4 bytes). If this bit is set, the record length field is 1 byte long. If this bit is clear, the field is 4 bytes long. This mechanism minimizes the size of each record in the byte array.

name: Name of the property, this is a zero-terminated ASCII string.

type: Property type (uint16).

attr: Property attributes (uint32).

value_length: Length of the property value (length of this field uses the same mechanism as the total_record_length field described above).

value: Property value (value_length bytes).

In addition to the property records, the first two DWORDs before the first property record contains the following information:

Number of property records in storage (first DWORD)

Total amount of storage (specified in bytes) used by property records (second DWORD)

Ignore the id field in the bus of incoming prp operation calls.

5.2 External States

None.

5.3 Use Cases

5.4 Property Creation and Access

This use case describes the basic property creation and access operation:

A part creates a new property by invoking the create operation through the fac terminal. If the number of properties in the container is equal to the max_props property, UTL_PRCBA fails the operation with ST_NO_ROOM.

UTL_PRCBA creates the new property and initializes its value to empty. The location of the property information storage depends on the initial_prp_stg_offs property.

A part sets the value of the property by invoking the set operation through the prp terminal.

UTL_PRCBA updates the value of the property in the byte array and returns.

At a later time, a part retrieves the value of the property by invoking the get operation through the prp terminal.

UTL_PRCBA retrieves the value from the byte array and returns it through the operation bus.

When the property is not needed anymore, a part invokes the destroy operation through the fac terminal.

UTL_PRCBA removes the property from the byte array.

5.5 Property Queries

This use case describes the query operation of UTL_PRCBA:

Several properties are created and set in the property container.

A part opens a query on the properties by invoking the qry_open operation through the prp terminal. Many property queries can be opened.

A part gets the first property in the query by invoking the qry_first operation through the prp terminal.

Subsequent properties in the query are retrieved by invoking the qry_next operation through the prp terminal.

The current property query is retrieved by invoking the qry_curr operation through the prp terminal.

When the property query is not needed anymore, the query is closed by invoking the qry_close operation through the prp terminal.

Property queries can also be handled through the fac terminal using the get_first and get_next operations.

6. Typical Usage

6.1 Using UTL_PRCBA for storage of persistent system parameters

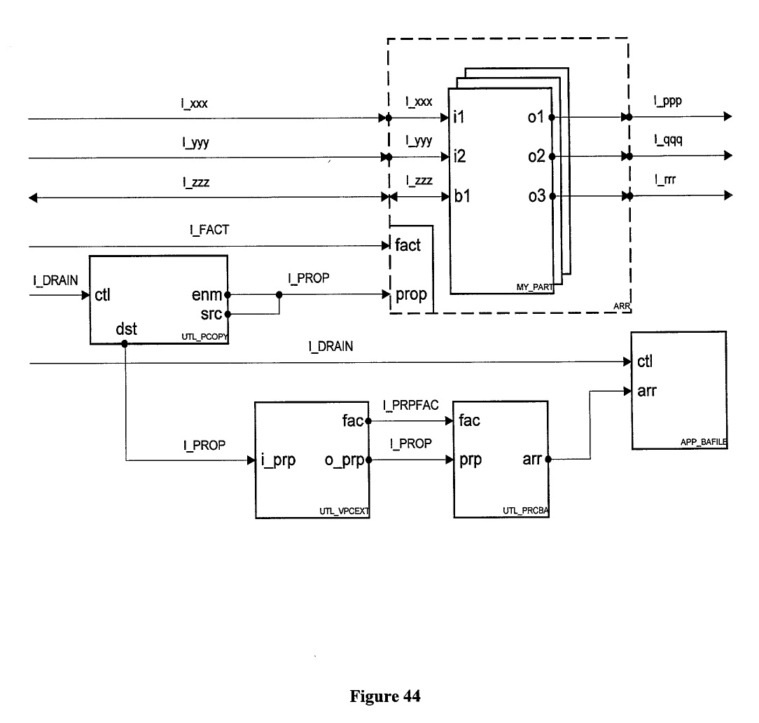

FIG. 44 illustrates an advantageous use of part, UTL_PRCBA

This use case demonstrates how to serialize properties of multiple part instances to persistent storage. The mechanism described here can be used to save the entire state of a system.

Part instances are created by using the fact terminal of ARR. When the state of the parts in the part array need to be saved to persistent storage, a begin transaction notification is first sent to APP_BAFILE. This notification opens a transaction on the byte array for the properties that need to be stored. Next a trigger event is sent to UTL_PCOPY through its ctl terminal (used to trigger serialization).

Upon receiving the trigger event (usually on system shutdown), UTL_PCOPY enumerates all the persistent properties of the parts in the array and sets them through its dst terminal.

UTL_VPCEXT receives the set operation call and attempts to set the specified property in the property container (UTL_PRCBA). If the property does not exist, UTL_VPCEXT creates the property in the container and then updates its value.

The property container UTL_PRCBA uses the byte array on file (APP_BAFILE) to store the property information.

After the serialization of the parts persistent properties is complete, an end transaction notification is sent to APP_BAFILE. APP_BAFILE saves the state of the byte array to a file on the user's hard-drive. Later when the system is brought back up, UTL_PRCBA can be enumerated and the state of the parts in the array can be restored.

7. Document References

None.

8. Unresolved Issues

None.

UTL_VPCEXT—Virtual Property Container Extender

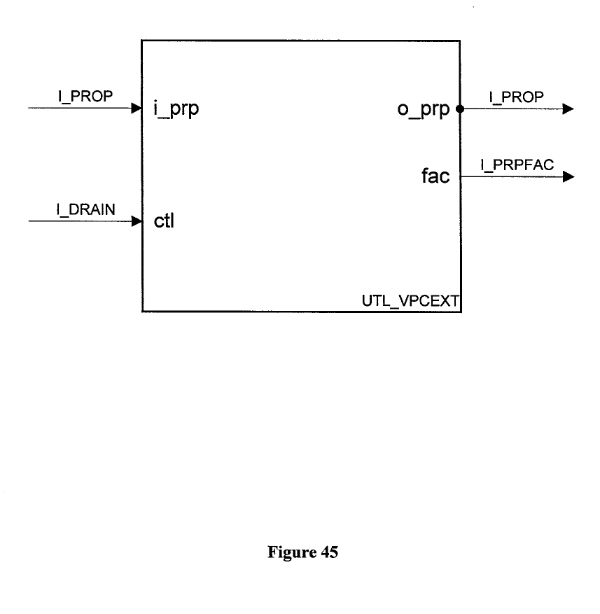

FIG. 45 illustrates the boundary of part, Virtual Property Container Extender (UTL_VPCEXT)

1. Functional Overview

UTL_VPCEXT extends the virtual property container (UTL_VPC) by enabling properties to be operated on without first having to be explicitly created. When a get/set operation is received for a property that does not exist, UTL_VPCEXT first creates the property and then submits the property request.

When a property ‘get info’ operation is received on i_prp terminal, UTL_VPCEXT returns a predefined property type and attributes for a non-existing property if it is in the range of supported properties.

Upon a ‘reset’ request received on its control terminal (ctl), UTL_VPCEXT destroys all properties through its fac terminal.

The range of non-existing properties, for which UTL_VPCEXT is responsible, the predefined property type, property attributes and ‘reset’ request ID are specified through properties. Only one range of properties can be specified. Multiple instances of UTL_VPCEXT can be cascaded to provide multiple property ranges. 2. Boundary

2.1 Terminals

| Name | Dir | Interface | Notes |
|---|---|---|---|
| i_prp | in | I_PROP | v-table, infinite cardinality |
| | | | Input property interface. All operations are |
| | | | passed transparently to o_prp. |
| o_prp | out | I_PROP | v-table, cardinality 1 |
| | | | All property operations on the i_prp input |
| | | | are passed transparently to this output. |
| clr | in | I_DRAIN | v-table, infinite cardinality |
| | | | The requests for destroying all properties |
| | | | are received on this terminal. |
| fac | out | I_PRPFAC | v-table, cardinality 1 |
| | | | This terminal is used to create and destroy |
| | | | properties. |

2.2 Properties

| Property | | |
|---|---|---|
| name | Type | Notes |
| reset_ev_id | uint32 | Specifies the event ID of the reset request. |
| | | Default is EV_RESET. |
| path | asciz | Specifies a property range for which to provide |
| | | auto creation and default property type and |
| | | attributes. The property range is specified |
| | | through a wildcard type property. The wildcard |
| | | characters are asterisk (‘*’ - must be the last |
| | | character. It replaces zero or more characters in |
| | | the property name.) and question mark |
| | | (‘?’ - represents exactly one character from the |
| | | property name). |
| | | Default is “*” - all properties. |
| type | uint32 | Default property type for the range of properties |
| | | specified in path. |
| | | Default is ZPRP_T_NONE |
| attr | uint32 | Default property attributes for the range of |
| | | properties specified in path. |
| | | Default is ZPRP_A_NONE. |
| force_free | uint32 | Set to TRUE to free self-owned events without |
| | | regard of what the returned status is. |
| | | Default is FALSE. |

Events and Notifications

2.4 Terminal: ctl

| Event | Dir | Bus | Notes |
|---|---|---|---|
| (reset_ev_id) | in | void | Request to destroy all properties through fac |
| | | | terminal. |

2.5 Special Events, Frames, Commands or Verbs

None.

3. Encapsulated Interactions

None.

4. Specification

4.1 Responsibilities

Forward all operations coming on i_prp terminal out through o_prp terminal without modification.

Recognize range of properties by using a ‘wildcard’ comparison between the property name and path property.

Provide auto-creation for a range of recognized properties, when property ‘set’ operation fails because the specified property does not exist. Use the values specified in type and attr properties as default property in the creation when creates the properties through fac terminal.

When get property ‘info’ operation fails and the property name is in the range recognized by UTL_VPCEXT, provide default property type and attributes as they are specified in type and attr properties respectively.

Destroy all properties in the virtual property container upon receiving the specified ‘reset’ event (reset_ev_id).

4.2 Theory of Operation

4.2.1 State Machine

None.

4.2.2 Main Data Structures

None.

4.2.3 Mechanisms

### Set Property Operation

All property ‘set’ operations received on i_prp terminal, are forwarded through the opposite (o_prp) terminal. If the operation completes with status different from ST_NOT_FOUND, UTL_VPCEXT propagates the returned status to the caller.

If property ‘set’ operation fails with status ST_NOT_FOUND and the property name is in the specified by the path range, UTL_VPCEXT creates a property using the name specified in the property ‘set’ operation bus. For property type and property attributes are used the values specified in type and attr respectively. After a successful property creation, UTL_VPCEXT resubmits the property ‘set’ request and propagates the returned status to the caller.

### Get Property Info Operation

UTL_VPCEXT forwards get property ‘info’ operation received on its i_prp terminal through the opposite (o_prp) terminal. UTL_VPCEXT returns the status returned, if the operation completes with a status different from ST_NOT_FOUND.

If the property name is part of the range specified by the path, UTL_VPCEXT copies the default property type (type) and attributes (attr) into the request bus and completes the request with status ST_OK.

5. Use Cases

5.1 UTL_VPCEXT Parameterization

UTL_VPCEXT, in the following example is used to provide auto-creation for all uint32 properties whose names begin with “baud.” (Note the dot at the end of the string):

part (vpcext, UTL_VPCEXT)

param (path, “baud.*”)
param (type, ZPRP_T_UINT32)
param (attr, ZPRP_A_NONE)

UTL_VPCEXT, in the following example is used to provide auto-creation for all string properties whose names begins with “device” and have two other characters at the end:

part (vpcext, UTL_VPCEXT)

param (path, “device??”)
param (type, ZPRP_T_ASCIZ)
param (attr, ZPRP_A_NONE)

5.2 Cascading Multiple UTL_VPCEXT

Cascading several instances of UTL_VPCEXT provides the full UTL_VPCEXT functionality over multiple ranges of properties.

The example below demonstrates how to provide type, attributes and auto creation for different range of properties. Each property range is recognized by a key word embedded in the property name. All property names have four letters prefix, followed by the property type identifier and are suffixed with zero or more characters. The recognized key words are: “string” for ASCIIZ properties, “DWORD” for unsigned 32-bit properties and “byte” for unsigned 8-bit properties.

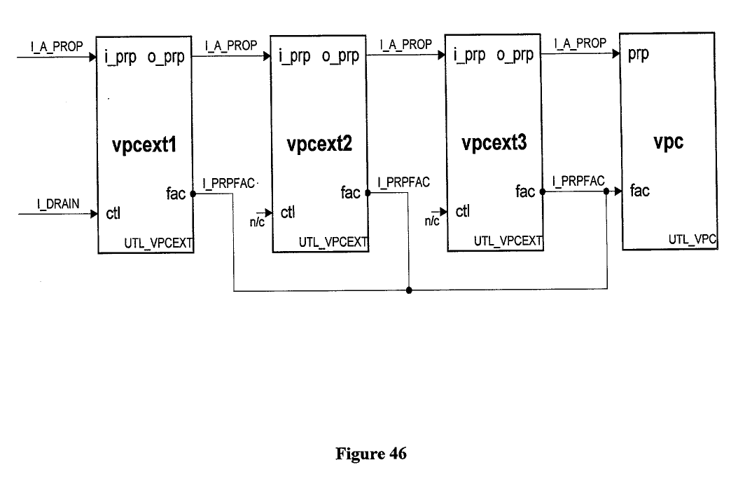

FIG. 46 illustrates Chaining Multiple Virtual Property Container Extenders

The part definition and default parameterization follows:

| | |
|---|---|
| part | (vpcext1, UTL_VPCEXT) |
| | param (path, “????string*”) |
| | param (type, ZPRP_T_ASCIZ) |
| | param (attr, ZPRP_A_NONE) |
| part | (vpcext2, UTL_VPCEXT) |
| | param (path, “????dword*”) |
| | param (type, ZPRP_T_UINT32) |
| | param (attr, ZPRP_A_NONE) |
| part | (vpcext3, UTL_VPCEXT) |
| | param (path, “????byte*”) |
| | param (type, ZPRP_T_UCHAR) |
| | param (attr, ZPRP_A_NONE) |

### UTL—Event Manipulation

### UTL_ST2ES—Return Status to Event Status Converter

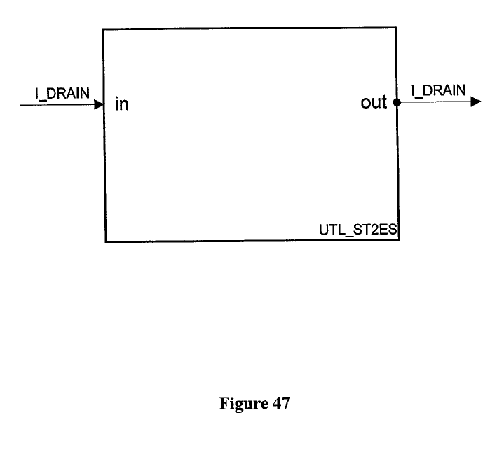

FIG. 47 illustrates the boundary of part, Return Status to Event Status Converter (UTL_ST2ES)

1. Functional Overview

UTL_ST2ES is a plumbing part that stamps the return status from an outgoing operation into the status field of the event and returns a predefined status.

All events received on in terminal are sent out through out terminal. The ‘self-owned’ and ‘asynchronously completable’ events are converted to normal events (ZEVT_A_SELF_OWNED, ZEVT_A_ASYNC_CPLT and ZEVT_A_COMPLETED attributes are cleared) before sending them out of the out terminal.

Note that if the event is constant (ZEVT_A_CONSTANT attribute is set) the UTL_ST2ES fails and returns status ST_REFUSE.

When the event sent through the out terminal completes, UTL_ST2ES stamps the returned status in the event. The modified event attributes are restored to their original value before completing the event with status specified through a property.

UTL_ST2ES is typically used in situations where it is necessary to have the actual return status stamped into the event and a predefined status be returned.

UTL_ST2ES's input terminal is unguarded and therefore may be invoked at interrupt time.

2. Boundary

2.1 Terminals

| Name | Dir | Interface | Notes |
|---|---|---|---|
| in | in | I_DRAIN | All events coming on this terminal are |
| | | | converted to normal events (attributes |
| | | | ZEVT_A_SELF_OWNED, |
| | | | ZEVT_A_ASYNC_CPLT and |
| | | | ZEVT_A_COMPLETED are cleared) and |
| | | | sent out of the out terminal. |
| | | | When the out call returns, the completion status |
| | | | is placed in the event bus and the event attributes |
| | | | modified by UTL_ST2ES are restored. |
| out | out | I_DRAIN | Events received from the in terminal are |
| | | | remapped (if needed) and are passed out |
| | | | this terminal. |

2.2 Properties

| Property name | Type | Notes |
|---|---|---|
| ret_s | uint32 | Status to return on raise operation invoked on |
| | | in terminal. Default is ST_OK. |

2.3 Events and Notifications

UTL_ST2ES forwards all events received on its in terminal to the out terminal.

2.4 Environmental Dependencies

2.5 Encapsulated Interactions

None.

3. Specification

3.1 Responsibilities

Convert all events received on the in terminal to be normal synchronous events and send modified event out the out terminal.

Store completion status of the call to the out terminal in the evt_stat field of the event and restore the original attributes.

Return the status specified by the ret_s property.

3.2 External States

None.

3.3 Use Cases

None.

3.4 Typical Usage

None.

### UTL—Data Manipulation

### UTL_EDC—Error Detection Coder and Verifier

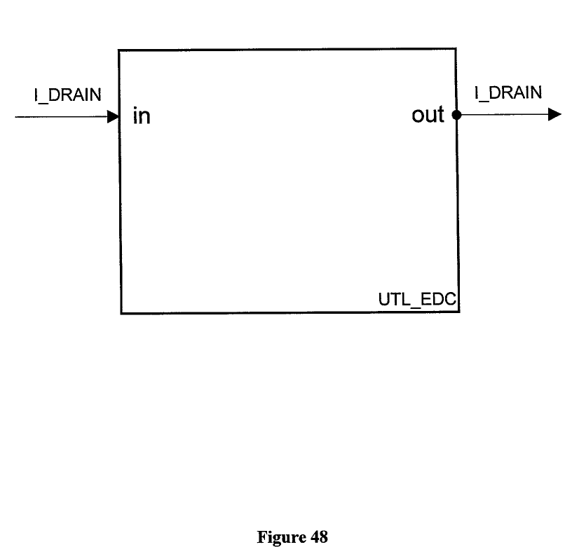

FIG. 48 illustrates the boundary of part, Error Detection Coder and Verifier (UTL_EDC)

1. Functional Overview

UTL_EDC calculates and verifies error detection codes in event data.

UTL_EDC supports two types of error detection codes (EDC): 8-bit LRC (Longitudinal Redundancy Check) and 16-bit CRC (Cyclic Redundancy Check).

UTL_EDC is parameterized with the range of event fields that are included in the EDC calculation and where the EDC value is stored in the event.

If UTL_EDC is parameterized for encoding EDCs, UTL_EDC calculates the EDC and depending on how UTL_EDC is parameterized, it either inserts the EDC into the event or uses the provided storage.

If UTL_EDC is parameterized for EDC verification and it detects an EDC error in an event received from the in terminal (i.e., by calculating the EDC of the event and comparing it to the value stored in the event), it sets a flag in the attributes field of the event and forwards it through the out terminal. The error flag value is parameterized via a property.

All events received from the in terminal are forwarded through the out terminal after EDC calculation or verification.

2. Boundary

2.1 Terminals

| Name | Dir | Interface | Notes |
|---|---|---|---|
| in | in | I_DRAIN | For events received through this terminal, |
| | | | UTL_EDC either calculates the proper EDC for |
| | | | the event or verifies the EDC stored in the event. |
| out | out | I_DRAIN | UTL_EDC forwards the event received through |
| | | | the in terminal (either the original event or a |
| | | | replica) through this terminal. |

2.2 Properties

| Property name | Type | Notes |
|---|---|---|
| verify_edc | uint32 | Boolean. If TRUE, UTL_EDC verifies |
| | | the EDC of the events received on the in |
| | | terminal. Otherwise, UTL_EDC |
| | | calculates the EDC and stores it in the |
| | | event according to its properties. |
| | | Default is FALSE. |
| edc_type | ASCIZ | Type of the error detection code (EDC) |
| | | that UTL_EDC calculates and verifies for |
| | | events received on its in terminal. |
| | | Can be one of the following values: |
| | | “LRC” - 8-bit LRC (Longitudinal |
| | | Redundancy Check) |
| | | “CRC” - 16-bit CRC (Cyclic |
| | | Redundancy Check) |
| | | The default value is “CRC”. |
| edc_begin_offs | uint32 | Offset to the first byte that is included in |
| | | the calculation of the error detection code |
| | | (EDC) for the event data (specified in |
| | | bytes). |
| | | The default value is 0. |
| begin_offs_neg | uint32 | Boolean. If TRUE, the offset is event |
| | | size - the value of the edc_begin_offs |
| | | property; otherwise, the offset is |
| | | calculated from the beginning of the event. |
| | | The default is FALSE. |
| edc_end_offs | uint32 | Offset to the last byte that is included in |
| | | the calculation of the error detection code |
| | | (EDC) for the event data (specified in |
| | | bytes). |
| | | The default value is 1. |
| end_offs_neg | uint32 | Boolean. If TRUE, the offset is event |
| | | size - the value of the edc_end_offs |
| | | property; otherwise, the offset is |
| | | calculated from the beginning of the event. |
| | | The default is TRUE (up to and including |
| | | the last byte in the event) |
| edc_stg_offs | uint32 | Offset to the storage for the error detection |
| | | code (EDC) for the event data (specified |
| | | in bytes). Depending on the EDC type, the |
| | | size of the storage varies (1 byte for LRC |
| | | and 2 bytes for CRC) |
| | | The default value is 1. |
| stg_offs_neg | uint32 | Boolean. If TRUE, the offset is event |
| | | size - the value of the edc_stg_offs |
| | | property: otherwise, the offset is |
| | | calculated from the beginning of the event. |
| | | The default is TRUE (following the last |
| | | byte in the event) |
| edc_byte_order | sint32 | Specifies the byte order of the EDC |
| | | field in the incoming event. |
| | | Can be one of the following values: |
| | | 0 Native machine format |
| | | 1 MSB (Motorola) - Most-significant byte |
| | | first |
| | | −1 LSB (Intel) - Least- significant byte |
| | | first |
| | | Default is 0 (Native machine format). |
| edc_stg_provided | uint32 | Boolean. If TRUE, the events sent to and |
| | | from UTL_EDC contain storage for the |
| | | EDC value. If FALSE, UTL_EDC |
| | | inserts/removes the error detection code at |
| | | the specified offset (edc_stg_offs) |
| | | in the event. |
| | | The default value is FALSE. |
| err_flag | uint32 | EDC error flag value. This flag is set |
| | | (using bit-wise OR) in the event attributes |
| | | to indicate that an EDC error was |
| | | detected. |
| | | If no EDC error was detected, this bit flag |
| | | is cleared. |
| | | The default value is 0x01. |

3. Events and Notifications

UTL_EDC accepts any Dragon event.

3.1 Special Events, Frames, Commands or Verbs

None.

3.2 Encapsulated Interactions

None.

4. Specification

4.1 Responsibilities

If verify_edc is TRUE, verify the EDC for events received on the in terminal (according to the property values). If the verification fails set the appropriate flag in the event. If needed, shrink the event to remove the EDC value at the specified offset (edc_stg_provided=FALSE). Forward the event through the out terminal.

If verify_edc is FALSE, calculate and store the EDC for events received on the in terminal (according to the property values) and send them through the out terminal. If needed, re-allocate the event received on in to store the EDC at the specified offset (edc_stg_provided=FALSE).

If the EDC storage is not provided with the incoming event, allocate a new event bus and copy the data. Allocate such new events as self-owned.

Process synchronously all events received on the in terminal. Return the status received from the out terminal.

For multi-byte EDC (such as CRC) stored or retrieved from the event data, use the byte order specified in the edc_byte_order property.

4.2 Theory of Operation

4.2.1 State Machine

None.

4.2.2 Main Data Structures

None.

4.2.3 Mechanisms

### Calculating the Error Detection Code (EDC)

If verify_edc is FALSE, UTL_EDC calculates the EDC for all events received on the in terminal. The following types of EDCs are supported:

LRC (Longitudinal Redundancy Check)—8-bit, exclusive-OR sum of all bytes defined by the offset properties

CRC (Cyclic Redundancy Check)—16-bit, calculated as defined by standard ISO/IEC 3309

The range of bytes in the event that are used in the EDC calculation is defined by the edc_begin_offs and edc_end_offs properties. The calculation of this range depends on whether the offsets are from the beginning or the end of the event (xxx_offs_neg is FALSE or TRUE). If the calculated range is empty, the error detection code is zero.

offset=xxx_offs_neg? evt_sz(bp)−edc_xxx_offs:edc_xxx_offs

After the range of bytes for the EDC calculation are known, UTL_EDC calculates the appropriate EDC and stores or verifies the value in the event as described below.

### Storing the Error Detection Code (EDC) in the Event

After the error detection code is calculated (as described above), it must be stored in the event and sent through the out terminal.

The storage for the EDC is calculated using the edc_stg_offs and edc_stg_provided properties.

offset=stg_offs_neg? evt_sz(bp)−edc_stg_offs:edc_stg_offs

The event may either provide storage for the EDC or UTL_EDC can insert the EDC in the event (at the specified location).

If the EDC value should be inserted into the event (edc_stg_provided=FALSE), UTL_EDC allocates a new event (using z_evt_create) that contains storage for the EDC. UTL_EDC copies the original event (received on the in terminal), updates the new event with the EDC value and consumes the original event (if needed). The newly allocated event is then passed through the out terminal.

Note: The event that is sent through the out terminal contains the same attributes as the incoming event did except for the following modifications:

ZEVT_A_SELF_OWNED attribute is added.

ZEVT_A_SELF_CONTAINED attribute is added.

ZEVT_A_SYNC_ANY attribute is added.

ZEVT_A_ASYNC_CPLT and ZEVT_A_COMPLETED attributes are removed (UTL_EDC does not support asynchronous completion).

### Error Detection Code (EDC) Verification

If verify_edc is TRUE, UTL_EDC verifies the EDC for all events received on the in terminal.

According to the EDC type, UTL_EDC calculates the EDC for the event and compares it to the EDC contained within the event.

If the EDC values do not match, there is a data error in the event. UTL_EDC sets a flag in the event to indicate this error. To set the flag, UTL_EDC does the following:

Bit-wise OR the err_flag to the event attributes value (attr field)

If the EDC values match, UTL_EDC clears the error flag.

Note that before the event is passed through the out terminal, if the EDC was added to the event by UTL_EDC (edc_stg_provided=FALSE), UTL_EDC allocates a new event (equivalent to the size of the event without the storage for the EDC value) and copies the event data. The new event contains the attributes of the old event plus the ZEVT_A_SELF_OWNED attribute.

5. Use Cases

To illustrate the usage of UTL_EDC, the use cases below use the following frame definition for an imaginary network protocol.

| | | | | | | |
|---|---|---|---|---|---|---|
| DA | SA | FT | LEN | HEDC | DATA | EDC |

The fields labeled DA through LEN comprise the frame header where the HEDC is the frame header EDC. The data field contains the frame's data. All fields except the DATA field are fixed size.

The fields are defined as follows:

DA—destination address, 1 byte long

SA—source address, 1 byte long

FT—frametype, 1 byte long

LEN—length of the data field in bytes, 2 bytes long

HEDC—frame header EDC, 1 byte long

DATA—the frames data, variable length

EDC—whole frame EDC, 1-2 bytes long depending on EDC type

5.1 Computing the LRC for a frame header (EDC storage provided)

The event sent to UTL_EDC in this case contains the standard event header (CMEVENT_HDR) plus the frame fields DA through DATA. UTL_EDC is created and parameterized with the following:

verify_edc=FALSE

edc_type=“LRC”

edc_begin_offs=0

edc_end_offs=offset of LEN field (3 bytes)

edc_stg_offs=offset of HEDC field (4 bytes)

edc_stg provided=TRUE

err_flag=MY_ERROR_FLAG

Below illustrates what happens when such an event is sent through the in terminal:

The event containing the frame fields is sent through UTL_EDC's in terminal.

UTL_EDC calculates the LRC for the fields DA through LEN.

UTL_EDC stores the EDC value in the HEDC field as described by the properties.

UTL_EDC passes the event through the out terminal.

To validate the header EDC of the frame, another UTL_EDC part is used. This instance is parameterized exactly the same way as above except that the verify_edc property is TRUE. Below illustrates what happens when the event is sent through the in terminal:

UTL_EDC calculates the LRC for the fields DA through LEN and compares it with the EDC stored in the HEDC field.

If the EDCs match, the event is forwarded through the out terminal.

There is an error in the frame header. UTL_EDC sets the error flag in the event attributes and forwards the event through the out terminal.

5.2 Computing the CRC for frame data (EDC appended to end)

The event sent to UTL_EDC is the same as the one in the previous use case. UTL_EDC is created and parameterized with the following:

verify_edc=FALSE

edc_type=“CRC”

edc_begin_offs=0

edc_end_offs=1 (include all fields in frame)

end_offs_neg=TRUE

edc_stg_offs=1 (insert EDC at the end of the frame)

stg_offs_neg=TRUE

edc_stg_provided=FALSE

err flag=MY_ERROR_FLAG

Below illustrates what happens when such an event is sent through the in terminal:

The event containing the frame fields is sent through UTL_EDC's in terminal.

UTL_EDC calculates the CRC for the entire frame (DA through DATA).

UTL_EDC allocates a new event with two more bytes for the EDC field and stores the EDC value at the last two bytes of the event.

UTL_EDC passes the event through the out terminal.

To validate the entire frame EDC, another UTL_EDC part is used. This instance is parameterized exactly the same way as above except that the verify_edc property is TRUE. Below illustrates what happens when the event is sent through the in terminal:

UTL_EDC allocates a new event that does not contain storage for the EDC value.

UTL_EDC calculates the CRC for the fields DA through DATA and compares it with the EDC stored at the end of the event.

If the EDCs match, the event is forwarded through the out terminal.

There is an error in the frame header. UTL_EDC sets the error flag in the event attributes and forwards the event through the out terminal.

### UTL_EDLAT—Event Data Latch

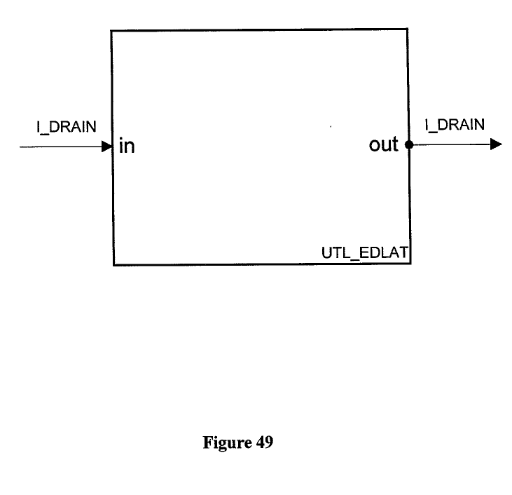

FIG. 49 illustrates the boundary of part, Event Data Latch (UTL_EDLAT)

1. Functional Overview

UTL_EDLAT latches or queues either part or all of the data from the incoming events. Upon receiving a trigger event it emits a single event through out containing the latched/queued data. When used in the “latch” mode, only the data from the last event received before the trigger event is remembered and emitted; in the “queue” mode, the data from all events is concatenated (in the order it was received) and emitted upon the trigger event.

The offset and size of the data to latch from the incoming events are specified as either fixed values or taken from the event data itself (for variable sized events). If programmed to use variable offset/size (that is, retrieved from the event data itself), UTL_EDLAT can take this information from the data in any byte order—either the CPU's natural order or fixed MSB-first or LSB-first order. This feature can be used in processing network packets or other data with a fixed byte order that may or may not match the host CPU's natural byte order.

UTL_EDLAT can optionally reserve zero-initialized space in the events sent through out either before and/or after the latched data in the event.

UTL_EDLAT emits an event containing the latched data only when it receives the emit event on the in terminal. The IDs of the events used by UTL_EDLAT are controlled through properties.

2. Boundary

2.1 Terminals

| Name | Dir | Interface | Notes |
|---|---|---|---|
| in | in | I_DRAIN | UTL_EDLAT latches the event data from |
| | | | the events received on this terminal. It also |
| | | | expects the trigger event on this terminal. |
| out | out | I_DRAIN | When the specified trigger event is received |
| | | | through in, UTL_EDLAT emits an event |
| | | | through this terminal containing the latched data |
| | | | collected from the event(s) received through in. |

2.2 Properties
These properties control the behavior of UTL_EDLAT:

| Property name | Type | Notes |
|---|---|---|
| latch_ev_id | uint32 | ID of the incoming event on which to |
| | | latch data from. EV_NULL may be |
| | | specified to latch data from all incoming |
| | | events except for those specified as |
| | | emit_ev_id and clear_ev_id. |
| | | Default value is EV_NULL. |
| emit_ev_id | uint32 | ID of the incoming event on which |
| | | UTL_EDLAT emits the latched data |
| | | event through the out terminal. |
| | | This property is mandatory. |
| clear_ev_id | uint32 | ID of the incoming event on which |
| | | UTL_EDLAT clears the contents of |
| | | the data latch. |
| | | If EV_NULL, no event is recognized by |
| | | UTL_EDLAT to clear the data latch. |
| | | In this case, clear_on_emit should be |
| | | TRUE so UTL_EDLAT clears the latch |
| | | automatically. |
| | | Default value is EV_NULL. |
| out_ev_id | uint32 | ID of the event sent through the out |
| | | terminal that contains the latched data. |
| | | This property is mandatory. |
| out_ev_attr | uint32 | Attributes of the event containing the |
| | | latched data sent through the out terminal. |
| | | Default value is ZEVT_A_ASYNC. |
| out_prefix_sz | uint32 | Number of bytes UTL_EDLAT inserts |
| | | before the latched data on events sent |
| | | through out. UTL_EDLAT zero initializes |
| | | the space added to the event. |
| | | Default is 0. |
| out_suffix_sz | uint32 | Number of bytes UTL_EDLAT inserts |
| | | after the latched data on events sent |
| | | through out. UTL_EDLAT zero initializes |
| | | the space added to the event. |
| | | Default is 0. |
| clear_on_emit | uint32 | Boolean. If TRUE, UTL_EDLAT clears |
| | | the contents of the data latch before |
| | | emitting the out_ev_id event through the |
| | | out terminal. |
| | | If FALSE, the data latch is cleared only |
| | | upon receiving a clear_ev_id event |
| | | through the in terminal. |
| | | Default value is TRUE. |
| send_empties | uint32 | Boolean. If TRUE, UTL_EDLAT emits |
| | | an out_ev_id event even if no data has |
| | | been latched (an event with data size of |
| | | 0 is emitted in this case). |
| | | If FALSE, UTL_EDLAT emits an |
| | | out_ev_id event only if data has been |
| | | latched from event(s) received through the |
| | | in terminal, otherwise the trigger event is |
| | | ignored. |
| | | Default value is FALSE. |
| append | uint32 | Boolean. If TRUE, UTL_EDLAT appends |
| | | the latched data from the incoming events |
| | | to the current contents of the data latch |
| | | (“queue” mode). |
| | | If FALSE, UTL_EDLAT replaces the |
| | | latched data with the data from the |
| | | incoming event (“latch last” mode). |
| | | Default value is FALSE. |

The following properties are used to specify the location of the data to be latched from the incoming events:

| Property name | Type | Notes |
|---|---|---|
| latch_offs.val | uint32 | Data offset. |
| | | Specifies the offset into the incoming event's data |
| | | to take the data from (in bytes). |
| | | Default is 0. |
| latch_offs.val_neg | uint32 | Boolean. If TRUE, the offset is event size − the |
| | | value of the latch_offs.val_neg property; |
| | | otherwise, the offset is calculated from the |
| | | beginning of the event. |
| | | The default is TRUE (up to and including the last |
| | | byte in the event) |
| latch_offs.use_fld | uint32 | TRUE to use a field value in the incoming event to |
| | | compute the data offset. If TRUE, UTL_EDLAT |
| | | adds the latch_offs.val property value to the |
| | | offset extracted from the event to calculate the data |
| | | offset⁹. |
| | | If this property is set to FALSE, UTL_EDLAT uses |
| | | only the latch_offs.val property to determine |
| | | the data latch location. |
| | | Default is FALSE. |
| latch_offs.fld_offs | uint32 | Offset to the field in the incoming event used for |
| | | determining the data offset (specified in bytes). |
| | | The value in this field is not sign extended. |
| | | This property is used only if latch_offs.use_fld |
| | | is TRUE. |
| | | Default is 0. |
| latch_offs.fld_sz | uint32 | Specifies the size of the offset value field in the |
| | | incoming event (specified in bytes). |
| | | The size can be one of the following: 1, 2, 3, or 4. |
| | | This property is used only if latch_offs.use_fld |
| | | is TRUE. |
| | | Default is 4 (size of uint32) |
| latch_offs.fld_order | sint32 | Specifies the byte order in the offset field in the |
| | | incoming event. |
| | | Can be one of the following values: |
| | | 0 Native machine format |
| | | 1 MSB—Most-significant byte first |
| | | (Motorola) |
| | | −1 LSB—Least-significant byte first (Intel) |
| | | This property is used only if latch_offs.use_fld |
| | | is TRUE. |
| | | Default is 0 (Native machine format). |

⁹This allows compensating any fixed offset that should be added to the value extracted from the event bus.

The following properties are used to specify the size of the data to be latched from the incoming events:

| Property name | Type | Notes |
|---|---|---|
| latch_sz.val | uint32 | Data latch location size. |
| | | Specifics the number of bytes which UTL_EDLAT |
| | | latches from the incoming event. |
| | | Depending on the latch_sz.from_end property, the |
| | | size is considered to be either the number of bytes |
| | | from the data latch offset (latch_offs.xxx) or the |
| | | number of bytes from the end of the event. |
| | | If zero, no data is latched from the incoming events. |
| | | Default value is 0. |
| latch_sz.from_end | uint32 | Boolean. If TRUE, the number of bytes latched from |
| | | the event is calculated from the end of the event. |
| | | If FALSE, the number of bytes latched from the event |
| | | is calculated from the specified offset |
| | | (latch_offs.xxx). |
| | | If latch_sz.val is 0 and latch_sz.from_end is |
| | | TRUE, all the bytes from the specified offset |
| | | (latch_offs.xxx) to the end of the event are latched |
| | | by UTL_EDLAT. |
| | | Default value is FALSE. |
| latch_sz.use_fld | uint32 | TRUE to use a field value in the incoming event for the |
| | | latch location size. Otherwise UTL_EDLAT uses |
| | | only the latch_sz.val property to determine the |
| | | data latch size. |
| | | If TRUE, UTL_EDLAT also adds the latch_sz.val |
| | | property value to the offset extracted from the event |
| | | to calculate the data latch size. |
| | | Default is FALSE. |
| latch_sz.fld_offs | uint32 | Offset to the field in the incoming event used for |
| | | determining the data latch size (specified in bytes). |
| | | The value in this field is not sign extended. |
| | | This property is used only if latch_sz.use_fld is |
| | | TRUE. |
| | | Default is 0 |
| latch_sz.fld_sz | uint32 | Specifies the size of the offset value field in the |
| | | incoming event (specified in bytes). |
| | | The size can be one of the following: 1, 2, 3, or 4. |
| | | This property is used only if latch_sz.use_fld is |
| | | TRUE. |
| | | Default is 4 (size of DWORN) |
| latch_sz.fld_order | sint32 | Specifies the byte order in the offset field in the |
| | | incoming event. |
| | | Can be one of the following values: |
| | | Specifies the byte order in the offset field in the |
| | | incoming event. |
| | | Can be one of the following values: |
| | | 0 Native machine format |
| | | 1 MSB—Most-significant byte first (Motorola) |
| | | −1 LSB—Least-significant byte first (Intel) |
| | | This property is used only if latch_sz.use_fld is |
| | | TRUE. |
| | | Default is 0 (Native machine format). |

3. Events and Notifications

All event IDs recognized and emitted by UTL_EDLAT are specified as properties. In the table below, the names specified in parentheses correspond to the property name that defines a given event ID.

| | | | |
|---|---|---|---|
| Event | Dir | Bus | Notes |

3.1 Terminal: in

| | | | |
|---|---|---|---|
| (latch_ev_id) | in | (any) | Event on which UTL_EDLAT extracts |
| | | | the specified data and saves it in the data |
| | | | latch. |
| (emit_ev_id) | in | void | Event on which UTL_EDLAT emits |
| | | | the latched data through the out terminal. |
| | | | Event data is ignored. |
| (clear_ev_id) | in | void | Event on which UTL_EDLAT clears the |
| | | | data saved in the data latch. Event data is |
| | | | ignored. |

3.2 Terminal: out

| | | | |
|---|---|---|---|
| (out_ev_id) | out | (any) | Event sent through the out terminal that |
| | | | contains the latched data saved by |
| | | | UTL_EDLAT. |

3.3 Special Events, Frames, Commands or Verbs

None.

3.4 Encapsulated Interactions

None.

4. Specification

4.1 Responsibilities

Latch data from the incoming events and store it until the specified emit event is received. Send the latched data through the out terminal as an out_ev_id event with the proper attributes.

Calculate the event data latch location and size according to the parameterization; either use fixed values or the values specified in the event.

When determining the event data latch location and size by field value, convert the value using the proper byte order (as specified through properties).

If needed, insert space after the event header and/or after the latched data in the out_ev_id events sent through the out terminal.

Fail emit events (emit_ev_id) with ST_NO_ACTION if the data latch is empty and send_empties is FALSE.

Allocate and free the outgoing events according to the outgoing event attributes (ZEVT_A_SELF_OWNED).

4.2 Theory of Operation

4.2.1 State Machine

None.

4.2.2 Main Data Structures

None.

4.2.3. Mechanism

### Latching Data from the Incoming Events

Upon receiving an event from the in terminal (latch_ev_id), UTL_EDLAT latches the data from event according to the latch location and size (as specified through properties).

The data latch location and size are calculated as follows and is summarized in the table below:

| val_neg | use_fid | Formaula |
|---|---|---|
| 0 | 0 | offset = latch_offs.val |
| 0 | 1 | offset = *latch_offs.fld_offs + latch_offs.val |
| 1 | 0 | offset = evt_sz(bp) − latch_offs.val |
| 1 | 1 | offset = *latch_offs.fld_offs − latch_offs.val |

If latch_offs.val neg_is FALSE and latch offs.use_fld is FALSE, offset specified by latch_offs .val is calculated from the beginning of the event.

If latch_offs.val_neg is FALSE and latch_offs_use_fld is TRUE, the data latch offset is calculated by adding the value specified by latch_offs.val to the value specified in latch_offs.fld_offs

If latch_offs.val_neg is TRUE and latch_offs.use_field is FALSE, the offset specified by latch_offs .val is calculated from the end of the event.

If latch_offs. val_neg is TRUE and latch_offs. use_field is TRUE, the data latch offset is calculated by subtracting the value specified by latch_offs .val from the value specified in latch_offs. fld_offs.

If needed, UTL_EDLAT converts the value to use the native machine byte order.

If the calculated data latch size is larger than the size of the incoming event, all the data up until of the event is latched.

If the calculated data latch offset is larger than the size of the incoming event, UTL_EDLAT fails the event with ST_INVALID.

After determining the data to latch from the incoming event, UTL_EDLAT either appends the data to the current contents of the latch or replaces it (controlled through the append property). Note that initially the data latch is empty.

Note that the data is latched only from latch_ev_id events. If latch_ev_id is EV_NULL, data is latched from all the events received through in except for emit_ev_id and clear_ev_id.

### Emitting the Latched Data Maintained by UTL_EDLAT

When UTL_EDLAT receives an emit_ev_id event through the in terminal, it sends an out_ev_id event through the out terminal, which contains the latched data. The attributes of the outgoing events are controlled through the out ev attr property.

Before sending the event with the latched data, if clear_on_emit is TRUE, UTL_EDLAT clears the contents of the data latch. If clear_on_emit is FALSE, the contents of the data latch remains and its up to the client of UTL_EDLAT to clear the latch by sending a clear_ev_id event to UTL_EDLAT.

If needed, UTL_EDLAT inserts space in the outgoing event after the event header and/or after the latched data (according to the out_prefix_sz and out_suffix_sz properties).

Note that if the send_empties property is FALSE and the latch is empty, UTL_EDLAT fails the emit event with ST_NO_ACTION.

UTL_EDLAT always returns ST_OK for the processing of the emit event except in the empty data latch case described above.

5. Use Cases

The first use case uses UTL_EDLAT to concatenate strings of different lengths into one. The following latch event is used:

EVENT (B_EV_STRING)

char *strp; // pointer to a string

END_EVENT

UTL_EDLAT is parameterized as follows:

a. latch_ev_id=EV_STRING

b. emit_ev_id=EV_EMIT

C. clear_on_emit=TRUE

d. append=TRUE

e. out_ev_id=EV_STRING

f. out_ev_attr=ZEVT_A_SELF_CONTAINED|ZEVT_A_SYNC

g. latch_offs.val=offsetof (B_EV_STRING, strp)

h. latch_sz.val=0

i. latch_sz.from_end=TRUE (latch string at end of the event)

The client of UTL_EDLAT sends an EV_STRING event through the in terminal containing the string “abc”.

UTL_EDLAT copies the data starting from strp to the end of the event into the data latch (the string “abc”).

The client of UTL_EDLAT sends another EV_STRING event through the in terminal containing the string “123”.

UTL_EDLAT appends the data starting from strp to the end of the event to the data latch (the string “123”).

The client of UTL_EDLAT sends an EV_EMIT event through the in terminal.

UTL_EDLAT allocates a new event (EV_STRING) and copies the latched data into it.

UTL_EDLAT clears the data latch and forwards the event through the out terminal.

The EV_STRING event sent through the out terminal contains the string “abc123”.

The second use case uses UTL_EDLAT to concatenate fragments of a message into one (i.e., chained messages in a network protocol). The length of each message is stored in the event in a separate field. The following latch event is used:

typedef struct B_EV_MSG

| { | | |
|---|---|---|
| dword | len; | // message length |
| char | *msgp; | // pointer to a message fragment |
| dword | edc; | // error detection code for message |

}B_EV_MSG;

UTL_EDLAT is parameterized as follows:

a. latch_ev_id=EV_MSG

b. emit_ev_id=EV_EMIT

C. clear_on_emit=TRUE

d. append=TRUE

e. out_ev_id=EV_MSG

f. out_ev_attr=ZEVT_A_SELF_CONTAINED|ZEVT_A_SYNC

g. latch_offs.val=offsetof (B_EV_MSG, msgp)

h. latch_sz.val=0

i. latch_sz.from_end=FALSE

j. latch_sz.use_fld=TRUE

k. latch_sz.fld_offs=offsetof (B_EV_MSG, len)

l. latch_sz.fld_sz=szof (B_EV_MSG, len)

m. latch_sz..fld_order=1 (MSB format)

The client of UTL_EDLAT sends an EV_MSG event through the in terminal containing the first message fragment.

UTL_EDLAT copies the data starting from msgp. The length of the data is retrieved from the len field in the event. Before copying the data, UTL_EDLAT converts the len field to the native machine format. The data is stored in the data latch.

The client of UTL_EDLAT sends another EV_MSG event through the in terminal containing the second fragment of the message.

UTL_EDLAT appends the data starting from msgp to the data latch.

The client may send more message fragments until a complete message is constructed.

The client then sends an EV_EMIT event through the in terminal.

UTL_EDLAT allocates a new event (Ev_MSG) and copies the latched data into it.

UTL_EDLAT clears the data latch and forwards the event through the out terminal.

The EV_MSG event sent through the out terminal contains a complete message made up of all the message fragments that the client sent to UTL_EDLAT (the message data is in the same order as received from the client).

### UTL_EDMRG—Event Data Merger

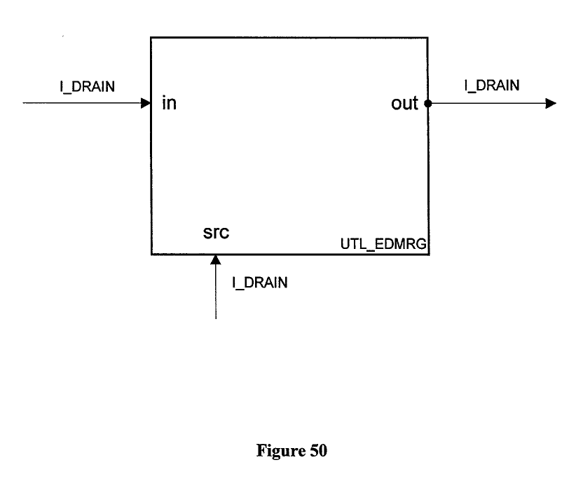

FIG. 50 illustrates the boundary of part, Event Data Merger (UTL_EDMRG)

1. Functional Overview

UTL_EDMRG caches one event received on the src terminal and pastes some or all of its data into the data buffer of the next event that comes on the in terminal, before forwarding the latter event to out. The “source” data is not re-used, once it is pasted into an event it is discarded and any new events coming on in pass to out undisturbed—therefore UTL_EDMRG should receive a new “source” event for each event on in that needs to have data pasted into it.

Depending on the attributes stored in the event received on the src terminal and UTL_EDMRG's parameterization, UTL_EDMRG may simply retain the pointer to the entire event bus (i.e., the event is self-owned) or copy the contents of the event into a private buffer. It must be noted here that if the event is self-owned, UTL_EDMRG performs a single memory copy in order to merge the data; otherwise two copies are performed. This may have a bearing on the efficiency of the system using this part if the amount of data being merged is quite large.

One or more instances of UTL_EDMRG can be used to add data to an un-initialized event generated by another part. NFY2, UTL_EDLAT and UTL_E2AR are examples of parts that can generate such events. In combination with other parts, it can also be used to break up the data carried by an event and re-assemble it in a different order.

2. Boundary

2.1 Terminals

| Name | Dir | Interface | Notes |
|---|---|---|---|
| in | in | I_DRAIN | Input for events into which cached data is to be |
| | | | merged with. The data is merged with the event |
| | | | before the event is forwarded to the out terminal. |
| out | out | I_DRAIN | Events received on the in terminal are forwarded |
| | | | to this terminal after data has been merged |
| | | | into them. If UTL_EDMRG does not have any |
| | | | cached data, events that are received on the in |
| | | | terminal are forwarded out this terminal |
| | | | unmodified. |
| src | in | I_DRAIN | Input for events containing data that is to |
| | | | be merged with the next event passing from |
| | | | in to out. |

2.2 Properties

| Property | | |
|---|---|---|
| name | Type | Notes |
| src_offs | uint32 | Offset of data in source event received on the |
| | | src terminal to merge. |
| | | The default is sizeof (CMEVENT_HDR). |
| dest_offs | uint32 | Offset in event bus received on the in terminal |
| | | where cached data is to be merged. |
| | | The default is sizeof (CMEVENT_HDR). |
| max_sz | uint32 | Specifies the maximum amount of data to merge |
| | | in bytes. Note: the amount of data that |
| | | UTL_EDMRG merges is the minimum of |
| | | max_sz and the size of the event bus. |
| | | If 0 × ffffffff, merge all data from offset to end of |
| | | event bus. The default is 0 × ffffffff. |
| size_delta | sint32 | Value that is added to max_sz in order |
| | | to alter the amount of data that is merged. |
| | | The default is 0. |
| cache_data | uint32 | Boolean. If FALSE UTL_EDMRG will |
| | | only accept self-owned events on its src terminal. |
| | | It retains the pointer to the event received on its |
| | | src terminal and frees the event after merging |
| | | its data with an event received on the in terminal |
| | | or has received another event on its src terminal. |
| | | If TRUE, UTL_EDMRG copies the data of |
| | | all events received into a buffer of size max_sz + |
| | | size_delta regardless of the incoming event |
| | | attributes. When this property is TRUE, |
| | | the max_sz property should be set to a valid |
| | | value. Default is FALSE. |

3. Events and Notifications

UTL_EDMRG merges data from events received on its src terminal with events it receives on its in terminal regardless of the event ID.

3.1 Special Events, Frames, Commands or Verbs

None.

3.2 Encapsulated Interactions

None.

4. Specification

4.1 Responsibilities

If cache_data is TRUE, allocate a buffer of size max_sz+size_delta to be used to cache data that is to be merged.

Refuse to accept non-self-owned events on the src terminal when cache_data is FALSE.

Copy data from events received on src into private buffer when cache_data is TRUE; otherwise store pointer to event bus.

Copy cached data (if any) into the next event received on the in terminal and forward the modified event out the out terminal.

Discard cached data after it has been merged.

4.2 Theory of Operation

4.2.1 State Machine

UTL_EDMRG keeps state as to whether or not it currently has cached data.

4.2.2 Mechanisms

### Caching Data with no Currently Cached Data

When UTL_EDMRG receives an event on its src terminal and it does not currently have any cached data, it performs the following actions based on the event type:

If cache_data is FALSE and the event is self-owned, UTL_EDMRG stores the pointer to the event bus and returns ST_OK. If the event is not self-owned, UTL_EDMRG returns ST_REFUSE.

If cache_data is TRUE, UTL_EDMRG copies the data from the event into its private buffer, frees the event if it is self-owned, and returns ST_OK.

### Caching Data with Currently Cached Data

When UTL_EDMRG receives an event on its src terminal and it currently has cached data that has not yet been merged, it performs the following actions:

If cache_data is FALSE and the event is self-owned, UTL_EDMRG frees the event bus that it had previously received and stores the pointer to the just received event bus and returns ST_OK. If the event is not self-owned, UTL_EDMRG returns ST_REFUSE.

If cache_data is TRUE, UTL_EDMRG copies the data from the event into its private buffer (overwriting any data that was previously stored), frees the event if it is self-owned, and returns ST_OK.

### Merging Data

When UTL_EDMRG receives an event on its in terminal and does not currently have any cached data, it forwards the event out its out terminal unmodified.

If UTL_EDMRG has cached data, UTL_EDMRG copies the data to the event and forwards the modified event out the out terminal. If the data had been copied from a self-owned event, UTL_EDMRG frees the event bus.

5. Use Cases

5.1 Merging Data from Notification to Another Event

The most elementary use of UTL_EDMRG is when it is used to copy one or more contiguous fields from a notification it receives on its src terminal into another event.

5.2 Merging Non-contiguous Data

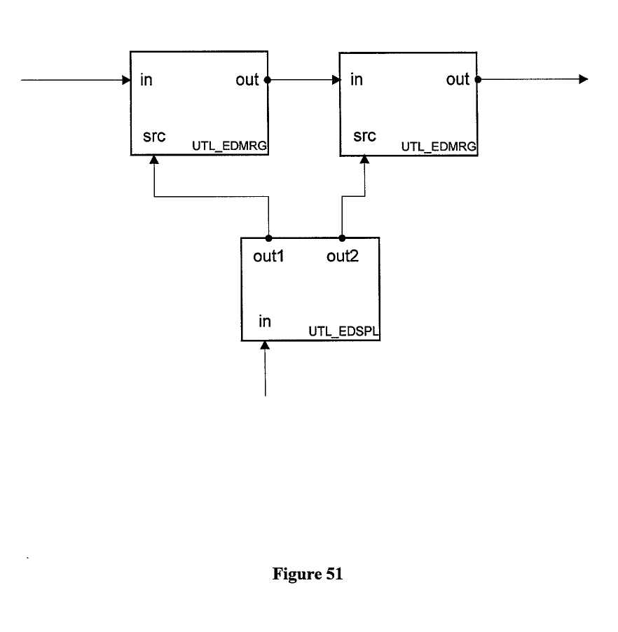

FIG. 51 illustrates an advantageous use of part, UTL_EDMRG

UTL_EDMRG can also be used with the Event Data Splitter to copy non-contiguous chunks of data into an event passing through UTL_EDMRG.

### UTL_EDSPL—Event Data Splitter

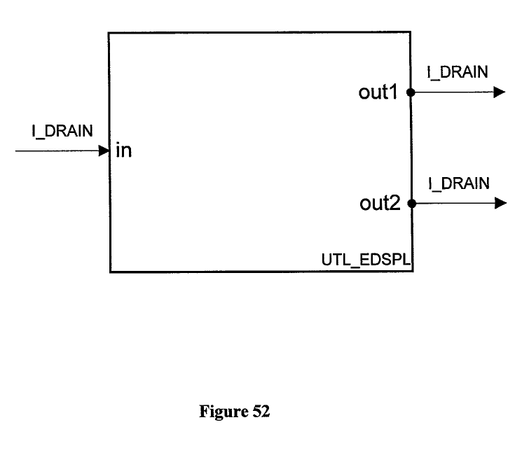

FIG. 52 illustrates the boundary of part, Event Data Splitter (UTL_EDSPL)

1. Functional Overview

UTL_EDSPL splits the data received with each event that comes on in, generates two events out of the two pieces of data and sends them to the out1 and out2 terminals respectively.

The offset at which the incoming data is split is specified as either a fixed offset or is computed by adding a fixed offset to a value taken from the event data itself. If programmed to use variable offset, UTL_EDSPL can take this information from the data in any byte order—either the CPU's natural order or fixed MSB-first or LSB-first order. This feature can be used in processing network packets or other data with a fixed byte order that may or may not match the host CPU's natural byte order.

UTL_EDSPL can optionally reserve space in the events sent through out1 or out2 at the beginning and/or at the end of the event data.

2. Boundary

2.1 Terminals

| Name | Dir | Interface | Notes |
|---|---|---|---|
| in | in | I_DRAIN | Each event received on this terminal is split |
| | | | into two events according to the specified offset |
| | | | in the event. |
| out1 | out | I_DRAIN | v-table, cardinality 1 |
| | | | The first event from the event split is sent through |
| | | | this terminal. |
| out2 | out | I_DRAIN | v-table, cardinality 1 |
| | | | The second event from the event split is sent |
| | | | through this terminal. |

2.2 Properties

| Property name | Type | Notes |
|---|---|---|
| offs | uint32 | Split location offset. |
| | | Specifies the location where UTL_EDSPL |
| | | should split the incoming events (in bytes). |
| | | The first event from the split contains all |
| | | the bytes up to the specified offset. |
| | | Usually, the offset contains the size of the |
| | | desired event to be sent through |
| | | the out1 terminal. |
| | | Default is 0. |
| offsneg | uint32 | Boolean. If TRUE, the offset is event |
| | | size − the value of the |
| | | offs property; otherwise, |
| | | the offset is calculated from |
| | | the beginning of the event. |
| | | The default is FALSE |
| attr_and_mask | uint32 | Attributes that UTL_EDSPL should keep |
| | | in the events sent through the out1 and out2 |
| | | terminals. After UTL_EDSPL splits |
| | | the event, the attributes for the two events |
| | | are determined by taking the |
| | | original attributes, |
| | | ANDing them with attr_and_mask |
| | | and ORing them with attr_or_mask. |
| | | Default is ˜ (ZEVT_A_ASYNC_CPLT \| |
| | | ZEVT_A_COMPLETED). |
| attr_or_mask | uint32 | Attributes that UTL_EDSPL should add to |
| | | the events sent through the out1 and out2 |
| | | terminals. After UTL_EDSPL splits the |
| | | event, the attributes for the two |
| | | events are determined by taking |
| | | the original attributes, ANDing them |
| | | with attr_and_mask and ORing them with |
| | | attr_or_mask. |
| | | Default is ZEVT_A_SELF_OWNED. |
| out1_ev_id | uint32 | Event lD of the event sent through the out1 |
| | | terminal. If EV_NULL the event ID |
| | | is the same as the incoming event. |
| | | Default is EV_NULL. |
| out1_prefix_sz | uint32 | Number of bytes UTL_EDSPL inserts |
| | | after the event header on events sent |
| | | through out 1. |
| | | UTL_EDSPL zero initializes |
| | | the space added to the event. |
| | | Default is 0. |
| out1_suffix_sz | uint32 | Number of bytes UTL_EDSPL inserts |
| | | at the end of the event sent through out 1. |
| | | UTL_EDSPL zero initializes |
| | | the space added to the event. |
| | | Default is 0. |
| out2_ev_id | uint32 | Event ID of the event sent through |
| | | the out2 terminal. If EV_NULL, |
| | | the event ID is the same as |
| | | the incoming event. |
| | | Default is EV_NULL. |
| out2_prefix_sz | uint32 | Number of bytes UTL_EDSPL inserts |
| | | after the event header on events |
| | | sent through out2. UTL_EDSPL zero |
| | | initializes the space added to the event. |
| | | Default is 0. |
| out2_suffix_sz | uint32 | Number of bytes UTL_EDSPL |
| | | inserts at the end of the event |
| | | sent through out2. UTL_EDSPL zero |
| | | initializes the space added to the event. |
| | | Default is 0. |
| send_empties | uint32 | If FALSE, UTL_EDSPL discards |
| | | empty events (events with data size of 0) |
| | | from the event split. It does not send |
| | | them through the respective output. |
| | | UTL_EDSPL does not take the prefix |
| | | or suffix sizes into consideration |
| | | for empty events. Default is TRUE. |

The following properties are used only if the split offset is taken
from the event data.

| | | |
|---|---|---|
| use_fld | uint32 | TRUE to use a field value in the incoming |
| | | event for the split location offset. |
| | | Otherwise, UTL_EDSPL uses only the offs |
| | | property to determine the split location. |
| | | If TRUE, UTL_EDSPL also adds the offs |
| | | property value to the offset extracted |
| | | from the event to calculate the split |
| | | location¹⁰. |
| | | Default is FALSE. |
| fld_offs | uint32 | Offset to the field in the incoming |
| | | event used for determining the split location |
| | | (in bytes). The value in this field is |
| | | not sign extended. This property is used |
| | | only if use_fld is TRUE. |
| | | Default is 0. |
| fld_sz | uint32 | Specifies the size of the offset value field |
| | | in the incoming event (in bytes). |
| | | The size can be one of the following: |
| | | 1, 2, 3, or 4. This property is used |
| | | only if use_fld is TRUE. |
| | | Default is 4 (size of uint32) |
| fld_order | sint32 | Specifies the byte order in the offset |
| | | field in the incoming event. |
| | | Can be one of the following values: |
| | | 0 Native machine format |
| | | 1 MSB - Most-significant byte first |
| | | (Motorola) |
| | | −1 LSB - Least-significant byte first (Intel) |
| | | This property is used only if use_fld is |
| | | TRUE. |
| | | Default is 0 (Native machine format). |

¹⁰This allows compensating for any fixed offset that should be added to the value extracted from the event bus.

3. Events and Notifications

UTL_EDSPL accepts any event on its input. The generated output events have the same ID as the input event.

3.1 Special Events, Frames, Commands or Verbs

None.

3.2 Encapsulated Interactions

None.

4. Specification

4.1 Responsibilities

Split the incoming event into two events. Send the first event through out1 and the second event through out2.

Calculate the event split location according to parameterization; either use a fixed offset or the offset specified in the event.

When determining where to split the event by field value, convert the offset value using the proper byte order (as specified through properties).

If needed, insert space after the event header and at the end of the events sent through the output terminals.

Modify the outgoing event's ID and attributes as parameterized.

Discard empty events if needed.

Allocate and free the outgoing events according to the outgoing event attributes (ZEVT_A_SELF_OWNED).

4.2 Theory of Operation

4.2.1 State Machine

None.

4.2.2 Main Data Structures

None.

4.2.3 Mechanisms

### Splitting the Incoming Event

Upon receiving an event from the in terminal, UTL_EDSPL splits the event into two events according to split location.

The split location is calculated as follows:

If use_fld is FALSE, the offset is calculated using only the offs property. The offset is calculated from the beginning or the end of the event depending on whether the value is positive or negative.

Split=offs_neg? evt_sz(bp)−offs:offs

If use_fld is TRUE, UTL_EDSPL calculates the offset by retrieving the value of the specified field in the event and adding the offs property to that value. The location of the offset value in the event is controlled through the fld_offs and fld_sz properties. If needed, UTL_EDSPL converts the value to use the native machine byte order.

Split=offs_neg? *fld_offs−offs:*fld_offs+offs)

If the calculated split offset is larger than the size of the incoming event, the event is not split. In this case, UTL_EDSPL replicates the incoming events and only updates the event IDs and attributes as specified by its properties (the event is sent through the out1 terminal, an empty event is sent through out2).

After determining where to split the incoming event, UTL_EDSPL allocates two new events and copies the data from the original event (according to the split location). If the split location is 0, UTL_EDSPL generates an empty event through the out1 terminal and a replica of the incoming event through the out2 terminal.

If needed, UTL_EDSPL inserts space in the new events after the event header and at the end of the events (according to the out1_prefix_sz, out1_suffix_sz, out2_prefix_sz, and out2_suffix_sz properties).

Generating new events from the incoming event

After UTL_EDSPL splits the incoming event into two (as described above), it initializes the event IDs and attributes of the new events.

The event IDs are set according to the out1_ev_id and out2_ev_id properties. If these properties are EV_NULL, the IDs of both events are set to the ID of the incoming event that was split. Otherwise, the IDs are set according to the properties.

The attributes of the new events are initially set to the attributes specified in the incoming event. UTL_EDSPL then does a bit-wise AND between the attributes and the attr_and_mask. This removes unwanted attributes from the event. Next, UTL_EDSPL does a bit-wise OR between the attributes and the attr_or_mask; this adds new attributes to the event.

After the event IDs and the attributes are set in the two events, UTL_EDSPL sends the first event through out1 and the second event through out2. The second event may eventually be fed back into UTL_EDSPL to repeat the process (i.e., split an event into multiple events).

If UTL_EDSPL fails to send the first event through out 1, it returns the status (returned from the call) without sending the second event. The return status from the second event is propagated back to the caller.

Note that if the send_empties property is FALSE, and the size of the data to be transferred into an output event is 0, UTL_EDSPL will not send that event (note that the size of data copied into the event is what counts, not the actual size of the event—the latter may depend on the prefix_sz and suffix_sz properties).

5. Use Cases

To illustrate the usage of UTL_EDSPL, the first two use cases below use the following structure definition used for defining a frame.

| | | |
|---|---|---|
| STX | DATA | ETX |

The fields are defined as follows:

STX—Start of frame, fixed size, 2 bytes

DATA—frame data, variable size

ETX—End of frame, fixed size, 2 bytes

The use cases described below use UTL_EDSPL to separate the starting and ending sections of the frame from the rest of the frame.

5.1 Split Incoming Event by Fixed Offset From the Beginning of Event

This use case splits the incoming event into two: one containing the start of the frame and the other containing the rest of the frame (data plus the end of the frame).

UTL_EDSPL is parameterized as follows:

a. off=size of STX field (2 bytes)

A frame is received (as an event) and is passed to UTL_EDSPL's in terminal. The event contains the structure described above.

UTL_EDSPL splits the event at offset 14 (after the STX field)—the boundary between STX and the rest of the frame.

The first event containing only the STX field is sent through the out1 terminal and is processed.

The second event containing the rest of the frame (DATA and ETX fields) is sent through the out2 terminal and is processed.

5.2 Split Incoming Event by Fixed Offset From the End of Event

This use case splits the incoming event into two: one containing the start of the frame and the frame's data, the other containing only the end of the frame. For this use case, assume that the size of the data field in the frame is 8 bytes.

UTL_EDSPL is parameterized as follows:

a. offs=−2 (beginning of the ETX field from the end of the event)

A frame is received (as an event) and is passed to UTL_EDSPL's in terminal. The event contains the structure described above.

UTL_EDSPL splits the event at offset 22 (after the DATA field, 2 bytes from the end of the event)—the boundary between DATA and the end of the frame (ETX).

The first event containing the STX and DATA fields is sent through the out1 terminal and is processed.

The second event containing only the end of the frame (ETX field) is sent through the out 2 terminal and is processed.

5.3 Split Incoming Event by Specified Offset in Event Field

This use case uses the following structure definition used for modifying and retrieving property values.

| | | |
|---|---|---|
| LEN | NAME | DATA |

The fields are defined as follows:

LEN—length of property name in bytes, 1 byte long, MSB

NAME—property name, LEN bytes long

DATA—the property value to be set or the retrieved value, variable length depending on property type

This use case splits the property name from its data using the LEN field in the event:

UTL_EDSPL is parameterized as follows:

a. offs=size of LEN field (1 byte)

b. use_fld=TRUE

c. fld_offs=0

d. fld_sz=1 byte

An event is received containing the above structure and is passed to UTL_EDSPL's in terminal.

UTL_EDSPL retrieves the value of the LEN field at offset 12 from the beginning of the event. The value is converted from MSB to LSB (assuming implementation is on an Intel-based machine).

UTL_EDSPL splits the event at the boundary between the NAME and DATA fields (by taking the value of the LEN field and adding it to the offs property value)

The first event containing the LEN and NAME fields is sent through the out1 terminal and is processed.

The second event containing only the DATA field is sent through the out2 terminal and is processed.

### UTL—State Machines

### UTL_ECNT—Event Counter

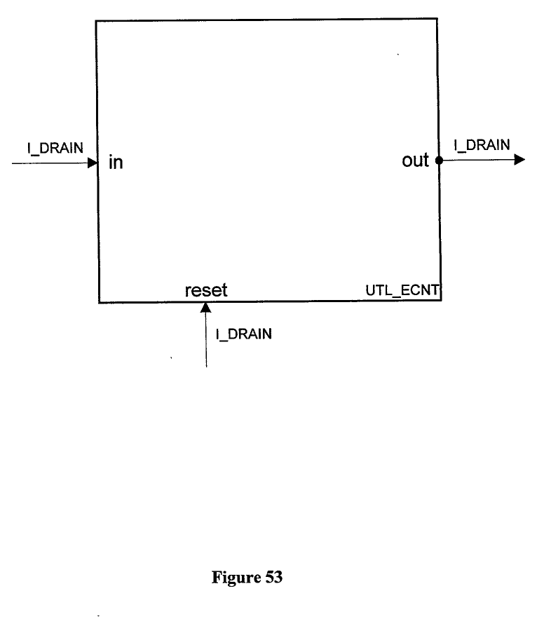

FIG. 53 illustrates the boundary of part, Event Counter (UTL_ECNT)

1. Functional Overview

UTL_ECNT is a state machine part used to count and consume events received on the in terminal until a predetermined number of events are reached—the next event is passed through. The number of events to be consumed is specified through a property. The number of the events consumed can be adjusted (in positive and/or negative direction) by modifying the value of an active time property.

UTL_ECNT recognizes the events to be counted by comparing the event ID with a value specified through a property. Unrecognized events can be forwarded out through the opposite terminal or completed with the status specified in the unknown_ret_s property. UTL_ECNT frees the self-owned event if the returned status (specified in ret_s or unknown_ret_s properties) is ST_OK. For compatibility reasons, UTL_ECNT exposes a property, which can force freeing the event memory regardless of the return status.

2. Boundary

2.1 Terminals

| Name | Dir | Interface | Notes |
|---|---|---|---|
| in | in | I_DRAIN | v-table, infinite cardinality, floating |
| | | | UTL_ECNT counts the events received on this |
| | | | terminal and depending on the current count, |
| | | | either consumes the event or forwards |
| | | | it through the out terminal. |
| out | out | I_DRAIN | v-table, cardinality 1 |
| | | | UTL_ECNT forwards events received on in |
| | | | through this terminal if the event |
| | | | counter reaches a specific value |
| reset | in | I_DRAIN | v-table, infinite cardinality, floating |
| | | | The event received through this terminal is |
| | | | used to reset the current event counter |
| | | | to zero. |

2.2 Properties

| Property Name | Type | Notes |
|---|---|---|
| count_ev_id | uint32 | Event ID of the events to be counted. |
| | | EV_NULL - count all events ignoring the |
| | | event ID. Default is EV_NULL. |
| reset_ev_id | uint32 | Reset Event ID. |
| | | Upon receiving of this event on the reset |
| | | terminal, the event counter (cur_count) |
| | | will be set to zero. |
| | | EV_NULL - any event can reset the |
| | | event counter. |
| | | Default is EV_NULL. |
| auto_reset | uint32 | Boolean. When set to TRUE, the event |
| | | counter will be automatically |
| | | reset when the event counter |
| | | reaches its threshold specified in |
| | | max_count and count_offset. |
| | | When FALSE, the counter will continue to |
| | | increment after reaching its threshold. |
| Default is TRUE. | | |
| roll_over | uint32 | Boolean. TRUE - specifies whether to |
| | | reset the event counter when it |
| | | goes above 0 × FFFFFFFF. |
| | | Default is FALSE. |
| curr_count | uint32 | Read-only. Current value of the event |
| | | counter. Default is 0. |
| count_offset | int32 | Active time. The value of this property is |
| | | added to the current counter |
| | | (curr_count) in order to calculate the |
| | | number of the events consumed by the |
| | | UTL_ECNT. |
| The default is 0. | | |
| max_count | uint32 | Specifies the number of the events to be |
| | | consumed by UTL_ECNT: All events |
| | | for which the curr_count plus |
| | | count_offset is greater than max_count |
| | | will be forwarded through out terminal. |
| | | The default is 0 (all events will be |
| | | forwarded). |
| ret_s | uint32 | The completion status (ST_xxx) for all |
| | | counted events that are consumed by |
| | | UTL_ECNT. Default is |
| | | ST_NO_ACTION. |
| pass_unknown | uint32 | Boolean. When TRUE, all unrecognized |
| | | events (the event id does not match the |
| | | value specified in count_ev_id)are |
| | | forwarded through the out terminal. |
| | | Default is FALSE. |
| unknown_ret_s | uint32 | The completion status (ST_xxx) for the |
| | | events which ID does not match the |
| | | count_ev_id. |
| | | Default is ST_NOT_SUPPORTED. |
| force_free | uint32 | Boolean. Set to TRUE to free self-owned |
| | | events without regard of what ret_s value is. |
| | | Default: FALSE. |

3. Events and Notifications

UTL_ECNT accepts any Dragon event.

3.1 Special Events, Frames, Commands or Verbs

None.

3.2 Encapsulated Interactions

None.

4. Specification

4.1 Responsibilities

Count all recognized events coming on its in terminal.

Complete with status ret_s all events for which the cur_count plus count_offset is smaller than the max_count.

Reset the event counter cur_counter upon receiving of an reset_ev_id on its reset terminal.

When pass_unknown is set, forward all unrecognized events through out terminal.

When pass_unknown is clear, complete all unrecognized events with the status specified in unknown_ret_s.

For all consumed events, if necessary, free the memory allocated for self-owned events.

4.2 Theory of Operation

4.2.1 State Machine

None.

4.2.2 Main Data Structures

None.

4.2.3 Mechanisms

### Passing the Events Out Through the ‘out’ Terminal.

When an event comes on in terminal, UTL_ECNT increments the event counter cur_count with one. If the event counter is equal to zero and roll over is not allowed (e.g., roll_over is FALSE), the previous value of cur_count is restored.

If cur_count plus count_offset¹¹ is greater or equal to the max_count, the event is passed out through the out terminal.

If auto-reset is enabled (auto_reset is not FALSE) the current count (curr_count) is set to zero.

4.3 Use Cases

None.

¹¹Note that count_offset could have positive and negative values.

### APP—Distributors

### APP_LFS—Life-Cycle Sequencer

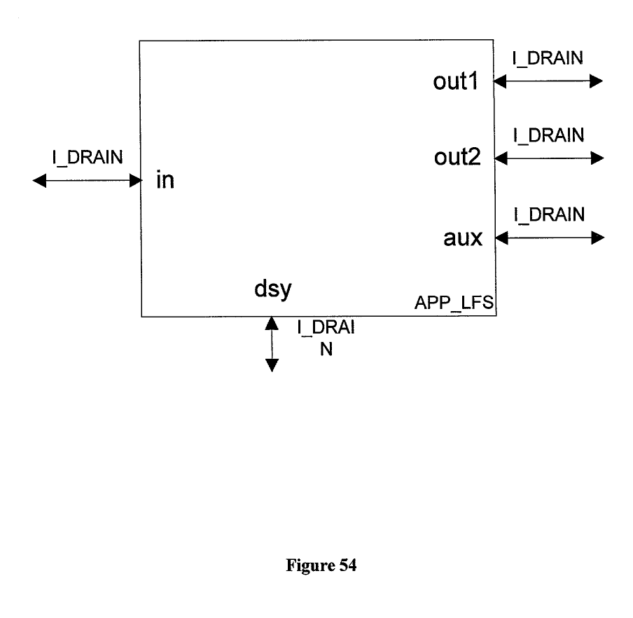

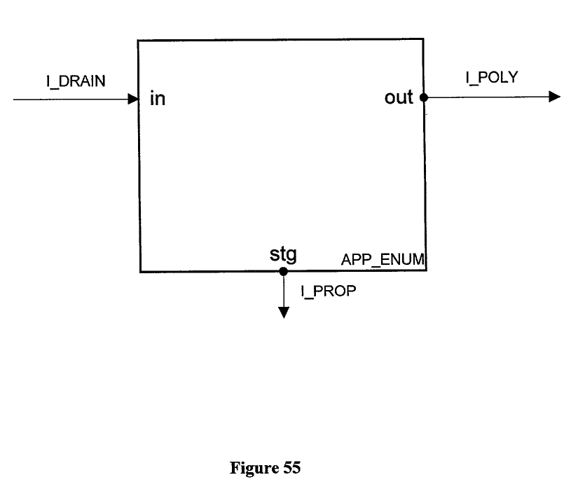

FIG. 54 illustrates the boundary of part, Life-Cycle Sequencer (APP_LFS)

1. Functional Overview

The primary function of APP_LFS is to distribute incoming life-cycle events received on in to the parts connected to the out1 and out2 terminals.

APP_LFS is identical to SEQ in regards to the event distribution functionality. APP_LFS distributes the EV_LFC_REQ_START and EV_LFC_REQ_STOP life cycle events. Additional events may be distributed by setting properties on APP_LFS. For more information about the event distribution, see the SEQ documentation.

2. Boundary

2.1 Terminals

| Name | Dir | Interface | Notes |
|---|---|---|---|
| in | bi | I_DRAIN | v-table, synchronous, cardinality 1 |
| | | | Incoming events for distribution are received |
| | | | here. All recognized events are distributed |
| | | | according to their discipline. All unrecognized |
| | | | events are passed though Unrecognized events |
| | | | (received from aux) are sent out this |
| | | | terminal. |
| out1 | bi | I_DRAIN | v-table, synchronous, cardinality 1 |
| | | | Event distribution terminal. |
| | | | The distribution depends upon the discipline |
| | | | of the event received on in. |
| out2 | bi | I_DRAIN | v-table, synchronous, cardinality 1 |
| | | | Event distribution terminal. |
| | | | The distribution depends upon the |
| | | | discipline of the event |
| | | | received on in. |
| aux | bi | I₁₃ DRAIN | v-table, synchronous, cardinality 1, |
| | | | floating Unrecognized events received |
| | | | from this terminal are passed out in. |
| | | | Unrecognized events received from in |
| | | | are passed out this terminal. |

2.2 Properties

| Property name | Type | Notes |
|---|---|---|
| unsup_ok | uint32 | If TRUE, a return status of ST_NOT_SUPPORTED |
| | | from the event distribution terminals out1 or out2 is |
| | | remapped to ST_OK. |
| | | Default is TRUE. |
| ev[0].ev_id- | uint32 | Event IDs that APP_LFS distributes to out1 and |
| ev[8].ev_id | | out2 when received on the in terminal. |
| | | The default values are EV_NULL. |
| ev[0].disc- | asciz | Distribution disciplines for ev[0].ev_id- |
| ev[8].disc | | ev[8].ev_id, can be one of the following: |

fwd_ignore
bwd_ignore
fwd_cleanup
bwd_cleanup

| | | |
|---|---|---|
| | | See the SEQ documentation for descriptions of the |
| | | disciplines. |
| | | The default values are fwd_ignore. |
| ev[0].cleanup_id- | uint32 | Event IDs used for cleanup if the event distribution |
| ev[8].cleanup_id | | fails. |
| | | The cleanup event is not sent if it is EV_NULL. |
| | | Cleanup events are used only if the distribution |
| | | discipline is fwd_cleanup or bwd_cleanup. |
| | | The default values are EV_NULL. |

2.4 Special Events, Frames, Commands or Verbs

None.

2.3 Events and notifications

| Event | Dir | Bus | Description |
|---|---|---|---|
| 2.3.1 Terminal: in | | | |
| EV_LFC_REQ_START | In | void | This event is sequenced with fwd_cleanup |
| | | | discipline. The cleanup event is EV_LFC_REQ_STOP |
| EV_LFC_REQ_STOP | In | void | This event is sequenced with bwd_ignore |
| | | | discipline. |
| 2.3.2 Terminal: out | | | |
| EV_LFC_REQ_START | out | void | Start normal operation |
| EV_LFC_REQ_STOP | out | void | Stop normal operation |

2.5 Encapsulated Interactions

None.

3. Specification

3.1 Responsibilities

Sequence EV_LFC_REQ_START and EV_LFC_REQ_STOP life cycle events.

For all unrecognized events received from in, pass out aux without modification.

For all unrecognized events received from aux, pass out in without modification.

For all recognized events received from in, distribute them to out1 and out2 according to their corresponding discipline (parameterized through properties.

Allow both synchronous and asynchronous completion of the distributed events.

Fail the event distribution if a recognized synchronous event received on in is processed asynchronously by out1 or out2.

Track events and their sequences, ignoring events that come out-of-sequence (e.g., completion coming back through a terminal on which APP_LFS did not initiate an operation; or getting a new event through in while event distribution is in progress).

Do not process any new recognized events while event distribution is pending (return ST_BUSY).

If so configured, remap the status ST_NOT_SUPPORTED received from the event distribution to ST_OK.

3.2 Theory of Operation

See the SEQ data sheet.

### APP—Dynamic Structure

### APP_ENUM—Instance Enumerator on Property Container

FIG. 55 illustrates the boundary of part, Instance Enumerator on Property Container (APP_ENUM)

1. Functional Overview

APP_ENUM is a dynamic structure part used to enumerate part instance information stored within an external property container or information source and generates ‘create’ and ‘destroy’ requests for each part instance upon receiving a ‘start’ and ‘stop’ trigger event respectively.

When a ‘start’ trigger event is received on its in terminal, APP_ENUM enumerates part instances, through the stg terminal, and for each instance found, it submits a ‘creation’ request out through the out terminal. The ‘creation’ request contains the class name of the part to be created and the part persistent name (a unique part instance identifier).

APP_ENUM saves the instance identifier that is returned on the ‘creation’ request. Upon receiving a ‘stop’ trigger event, APP_ENUM enumerates all created instances and for each of them, submits a ‘destroy’ request out through its out terminal.

APP_ENUM serializes the execution of ‘start’ and ‘stop’ events, i.e., any subsequent request to enumerate/de-enumerate part instances will be blocked until the previous request is completed.

The container used for instance enumeration can be an NVRAM, a file, a hardware bus or any instance information source.

APP_ENUM cannot be used at interrupt level due to the blocking mechanism used for serializing the events received on in terminal.

2. Boundary

2.1 Terminals

| Name | Dir | Interface | Notes |
|---|---|---|---|
| in | In | I_DRAIN | Receives life-cycle ‘start’ and ‘stop’ request upon which |
| | | | APP_ENUM submits requests for creation or destruction of |
| | | | multiple part instances. |
| Out | Out | I_POLY | Submit requests to create or destroy part instances. |
| stg | Out | I_PROP | Storage container connection terminal. APP_ENUM calls the |
| | | | storage container in order to enumerate or get part instance |
| | | | information. |

2.2 Properties

| Property name | Type | Notes |
|---|---|---|
| start_ev | uint32 | Specifies the trigger event ID upon which the part |
| | | instances are enumerated and created. |
| | | The default value is EV_LFC_REQ_START. |
| stop_ev | uint32 | Specifies the trigger event ID upon which all created |
| | | part instances are destroyed. |
| | | The default value is EV_LFC_REQ_STOP. |
| create_op | uint32 | Specifies the operation number (one based) to be used |
| | | for part instance creation. |
| | | The allowed values are between 1 and 64. |
| | | Default value is 1. (first interface operation) |
| destroy_op | uint32 | Specifies the operation number (one based) to be used |
| | | for part instance destruction. |
| | | The allowed values are between 1 and 64. |
| | | Default value is 2. (second interface operation) |
| save_id | uint32 | Boolean. If TRUE. the part instance ID is saved in |
| | | ‘<persistant name>.id‘ property in the property |
| | | container when the part instance is destroyed. |
| | | The default value is FALSE (do not save instance |
| | | IDs). |
| external_id | uint32 | Boolean. If TRUE, the part instance IDs are generated |
| | | externally on create_op operation. |
| | | When FALSE, the part instance ID is extracted by |
| | | APP_ENUM form the property container and is |
| | | stamped in the create_op bus before sending the |
| | | operation out through out terminal. |
| | | The default value is TRUE (part instance ID is |
| | | provided externally). |
| bus_sz | uint32 | Specifies the size of the operation bus used for part |
| | | instance creation or destruction. |
| | | This property is mandatory. |
| class_name.offs | uint32 | Specifies the offset in the create_op bus, where the |
| | | part instance class name will be stored. |
| | | Default value is 0. |
| class_name.sz | uint32 | Specifies the size of the class name field (in bytes). |
| | | Default value is 16. |
| persist_name.offs | uint32 | Specifies the offset in the create_op bus where the |
| | | persistent name will be stored. |
| | | Default value is 0. |
| persist_name.sz | uint32 | Specifies the size of the persistence name field (in |
| | | bytes). |
| | | Default value is 16. |
| id.offs | uint32 | Offset of the part instance ID in the operation bus. |
| | | The size of the field specified by id.offs is specified |
| | | in id.sz property. |
| | | This property is mandatory. |
| id.sz | uint32 | Specifies the size of the part instance ID (in bytes). |
| | | The allowed values are 1, 2, 3 and 4. |
| | | Default value is size of DWORD. |
| id.sgnext | uint32 | Boolean. If TRUE, part instance IDs less than four |
| | | bytes are sign extended. |
| | | The default value is FALSE. |
| qry_string | asciz | Query string to use when enumerating part instances. |
| | | Default value is “*” (serialize all properties) |

3. Events and notifications
3.1 Terminal: in

| Event | Dir | Bus | Notes |
|---|---|---|---|
| (start_ev) | in | any | Upon this event, APP_ENUM enumerates the part instances |
| | | | through stg terminal and for each instance found, it submits |
| | | | a ‘create’ operation out through out terminal. |
| (stop_ev) | in | any | Upon this event, APP_ENUM destroys instances for which |
| | | | the ‘create’ operation was completed successfully. |

3.2 Special Events, Frames, Commands or Verbs

The part instance information stored in the property container, used by APP_ENUM for instance enumeration, have the following structure:

| Field | Field Description |
|---|---|
| <property name> | Used as a persistent name for the newly created part |
| | instance. |
| Value of <property name> | Used as a class name for the newly created part instance. |
| Value of | Used as an instance ID if gen_id is set to TRUE. |
| <property name>.id | The part instance ID is stored in <property name>.id, if |
| | save_id is set to TRUE. |
| Value of | Not used by APP_ENUM. |
| <property name>.xxx | |

Note: The type of the <property name> property is always ZPRP_T_ASCIZ. The type of the <property name>.id property is always ZPRP_T_UINT32.

4. Environmental Dependencies

Due to the way APP_ENUM implements pointer arithmetic, APP_ENUM cannot be used in systems that a pointer cannot be represented as a single unsigned integer value with a size up to four bytes.

4.1 Encapsulated Interactions

None.

4.2 Other Environmental Dependencies

None.

5. Specification

5.1 Responsibilities

Enumerate all properties from the property container when ‘start’ event is received and generate a ‘create’ operation out the out terminal for each property returned.

For all successfully completed create_op operations, extract the part instance ID and store it in self.

Enumerate all part instance stored in self and generate a ‘destroy’ operation out the out terminal for each instance found.

Serialize the execution of ‘start’ and ‘stop’ events.

5.2 External States

None

5.3 Use Cases

5.3.1 Processing of ‘start’ event

When a ‘start’ event is received on the in terminal, APP_ENUM performs the following actions:

Enumerate all properties form the property container attached to the stg terminal and for each property found:

Create an operation bus

Place the name of the property at persist_prop_offs within the operation bus

Place the value of the enumerated property at class_name_offs within the operation bus.

If external_id is FALSE, retrieve instance id from container and store in operation bus at id_offs.

Submit ‘create’ operation out through the out terminal

5.3.2 Processing of ‘stop’ Event

When a ‘stop’ event is received on the in terminal, APP_ENUM performs the following actions:

Enumerate all created part instance and for each instance found

Submit a destroy_op operation out through the out terminal

If save_id is TRUE, save part instance ID in persistant_name.id property out the stg terminal.

6. Typical Usage

6.1 Dynamic Creation and Destruction of Multiple Part Instances

This example shows a simple way to create and destroy multiple instances upon one system event. All part instances are enumerated (discovered) from a property container and a part instance is created for each of the instances found.

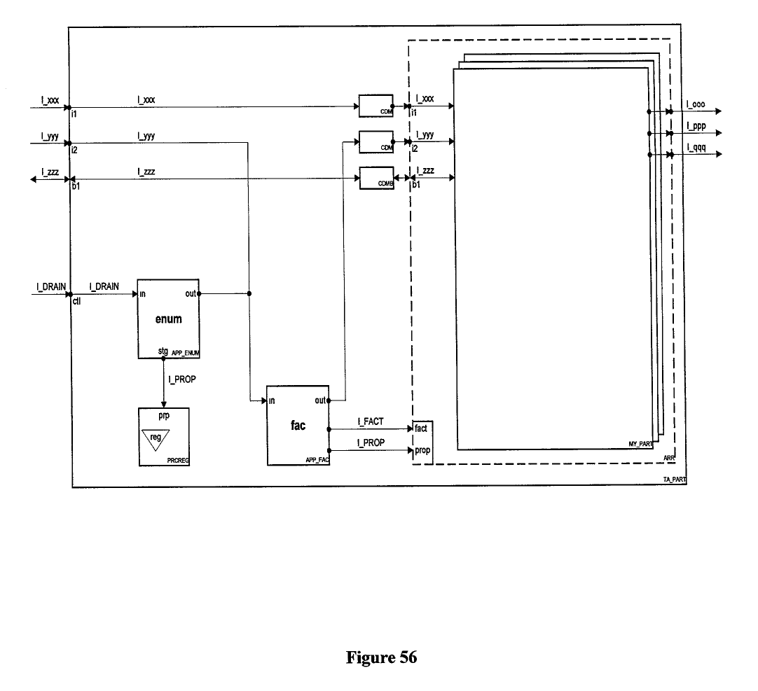

FIG. 56 illustrates Dynamic Creation and Destruction of a part Instance based on instance enumeration by property container

In this example, the instance enumeration is triggered by an event received on the control terminal (ctl). Upon that event, enum enumerates all properties in the property container (PRCREG). For each property found, it generates a ‘create’ request by putting the enumerated property name as part instance persistent name. The value of the enumerated property is placed at the position of the part instance class name. Finally, ‘create’ request is then sent out through enum's out terminal. This request is used by the part instance factory (fac) to create and activate the desired part instance. enum keeps the part instance ID for all successfully created instances until a ‘stop’ event is received on its in terminal.

When a ‘stop’ event is received on the control terminal, enum issues a ‘destroy’ request for each of the successfully created part instances. If necessary, the instance context information of the active instances can be stored back in the Property Container.

7. Document References

None.

8. Unresolved Issues

None.

### APP_FAC—Part Instance Factory

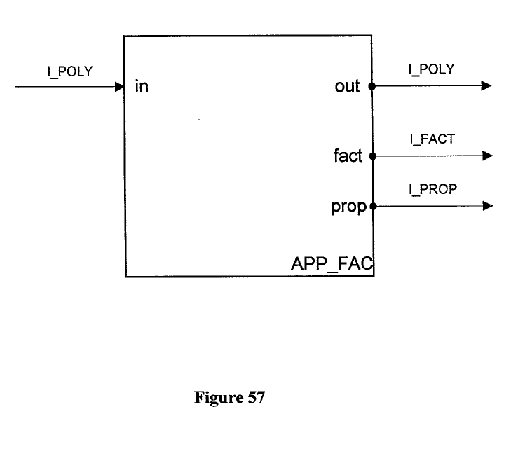

FIG. 57 illustrates the boundary of part, APP_FAC

1. Functional Overview

APP_FAC is a dynamic structure part that can be used to dynamically create and destroy part instances based on an execution flow. APP_FAC generates and sequences part factory operations through the fact terminal when certain operations (e.g., ‘create’ and ‘destroy’) are invoked on its in terminal.

When a request to ‘create’ a part instance is received on its in input, APP_FAC creates and activates the part through its fact terminal. In addition, APP_FAC extracts the part unique identifier (persistent name) from the ‘create’ operations and sets it on the just-created part instance as properties through its prop terminal. The property ‘set’ operation is executed after successful ‘create’ operation but before the part instance is activated. Up to eight additional parameters can be extracted from the ‘create’ operation bus and set as properties to the newly created part instance. When the part instance is activated, APP FAC forwards the creation operation out through its out terminal.

When a request to ‘destroy’ a part instance is received on APP_FAC's input, APP_FAC forwards the request through its out terminal, deactivates and destroys the specified part. APP_FAC serializes the execution of ‘create’ and ‘destroy’ operations, i.e., any subsequent request for creation/destruction of a part instance will be blocked until the previous request is completed.

APP_FAC can be used at interrupt level as long as no part creation/destruction is invoked. Using part creation/destruction functionality at interrupt level may lead to unpredictable results.

Note that APP_FAC cannot be used with I_DRAIN interface or any other single operation interface.

2. Boundary

2.1 Terminals

| Name | Dir | Interface | Notes |
|---|---|---|---|
| in | In | I_POLY | All operations received on this terminal are forwarded through |
| | | | the out terminal. One or more part factory operations may be |
| | | | generated through the fact and prop terminals either before |
| | | | or after the request is forwarded. |
| out | Out | I_POLY | Output for the operations received on in terminal. |
| fact | Out | I_FACT | Output for part factory operations. |
| prop | Out | I_PROP | Output for property set or property get operations. |

2.2 Properties
This section identifies all public properties exposed on the APP_FAC boundaries.

| Property name | Type | Notes |
|---|---|---|
| create_op | uint32 | Specifies the operation number (one based) that |
| | | results in a part instance being created and |
| | | activated through the fact terminal. |
| | | The allowed values are between 1 and 64. |
| | | Default value is 1. (first interface operation) |
| destroy_op | uint32 | Specifies the operation number (one based) that |
| | | results in a part instance being deactivated and |
| | | destroyed through the fact terminal. |
| | | The allowed values are between 1 and 64. |
| | | Default value is 2. (second interface operation) |
| bus_sz | uint32 | Specifies the size of the operation bus received on |
| | | in terminal. |
| | | This property is mandatory. |
| class_name.dflt | asciz | The class name to use when creating |
| | | part instances in case the class name is not provided |
| | | with the ‘create’ event. |
| | | If the value of this property is not an empty string, |
| | | class_name.xxx properties are used in order to |
| | | extract the class name from the property bus. |
| | | The default value is “” (extract the class name |
| | | from the bus) |
| class_name.offs | uint32 | If class_name.dflt is an empty string, specifies the |
| | | offset in the create_op bus (received on the in |
| | | terminal) of the class name to use when creating |
| | | part instances. |
| | | Default value is 0. (first field of the operation |
| | | bus) |
| class_name.by_ref | uint32 | Boolean. Used only if class_name.dflt is an empty |
| | | string, |
| | | If TRUE, the data at class_name.offs contains a |
| | | pointer, to the part instance class name. |
| | | If FALSE, the part instance class name is |
| | | self-contained in the operation bus. |
| | | The default value is FALSE. (class name is |
| | | contained in the bus) |
| persist_name.prop | asciz | Specifies the property name, inside of the newly |
| | | created part instance, in which the persistence |
| | | name will be stored. |
| | | When empty string, no persistence name is |
| | | specified for the part. |
| | | The default value is “” |
| persist_name.sz | uint32 | Specifies the size of the persistent name field in |
| | | the incoming create_op operation bus. |
| | | The default value is 0 |
| persist_name.offs | uint32 | If persist_name.by_ref is FALSE, specifies the |
| | | offset in the create_op bus of the persistent |
| | | name to be set on the newly created part instance. |
| | | Note that the persistent name is set as a property |
| | | to the newly created part. |
| | | Default value is 0 (persistent name and class |
| | | name of the part are the same¹²). |
| persist_name.ptr_offs | uint32 | If persist_name.by_ref is TRUE, specifies the |
| | | location in the create_op bus of the pointer to |
| | | the persistent name. |
| | | Note that the persistent name is set as a property |
| | | to the newly created part. |
| | | Default value is 0. |
| persist_name.by_ref | uint32 | Boolean. |
| | | If TRUE, the data at persist_name.ptr_offs |
| | | contains a pointer, to the persistent part name |
| | | string. |
| | | If FALSE, the persistent part name is contained in |
| | | the operation bus at persist_name.offs offset. |
| | | The default value is FALSE. (persistent name is |
| | | contained in the bus) |
| gen_id | uint32 | Boolean. If TRUE, the part instance ID returned |
| | | is generated by the creator of the part. i.e., the |
| | | part instance ID is returned on factory create |
| | | operation sent out through APP_FAC's fact |
| | | output. |
| | | If FALSE, the incoming create_op operation |
| | | contains the ID to be used as an instance identifier |
| | | when creating the part. |
| | | The default value is TRUE. |
| id.sz | uint32 | Size of the part instance ID. |
| | | The allowed values are 1, 2, 3 and 4. |
| | | Default value is sizeof (uint32). |
| id.sgnext | uint32 | Boolean. If TRUE, part instance IDs less than |
| | | four bytes are sign extended. |
| | | The default value is FALSE. |
| id.offs | uint32 | Offset of storage in operation bus for part |
| | | instance ID. |
| | | The default value is 0×0 (beginning of the event) |

¹²Note that persistence name can be equal to the class name only if ZP_FAC is used for creating one instance per part class. The persistence name for a part instance have to be unique for the set of part instances created by the ZP_FAC.

The following table describes the APP_FAC properties specifying how to extract the part instance parameters from the incoming create_op operation bus and set the extracted data as properties on newly created part.

| Property name | Type | Notes |
|---|---|---|
| param1.prop_name | asciz | Property name in the newly created part instance, |
| . . . | | which will receive the parameterization data |
| param8.prop_name | | contained within the create_op operation bus. |
| | | When empty, no property is set. |
| | | The default value is “”. (no property is set) |
| param1.prop_type | uint32 | Type [ZPRP_T_xxx] of the part instance |
| . . . | | property, which will be set with the value of the |
| param8.prop_type | | data parameter extracted from the incoming |
| | | create_op operation bus. |
| | | The default value is ZPRP_T_NONE. |
| param1.data_type | uint32 | Data type [DAT_T_xxx] of the data parameter to |
| . . . | | be extracted from the incoming create_op |
| param8.data_type | | operation bus and set as a property on the newly |
| | | created part. |
| | | The default value is DAT_T_NONE. |
| param1.var_sz | uint32 | Boolean. |
| . . . | | If TRUE, the length of the value to extract from |
| param8.var_sz | | the incoming operation has a variable size |
| | | specified through the paramy.len.xxx |
| | | properties. |
| | | If FALSE, the value has a constant size specified |
| | | through val.sz property. |
| | | The default value is FALSE (the length is |
| | | constant). |
| param1.val.by_ref | uint32 | Boolean. |
| | | If TRUE, the value to extract from the operation |
| param8.val.by_ref | | is identified by a reference pointer contained |
| | | within the operation bus. The offset of the |
| | | reference pointer is specified by |
| | | paramy.val.ptr_offs property. |
| | | If FALSE, the value is contained within the event. |
| | | The offset of the value is specified by |
| | | paramy.val.offs property. |
| | | The default value is FALSE (the value is |
| | | contained within the event). |
| param1.val.ptr_offs13 | uint32 | When the paramy.val.by_ref property is |
| . . . | | TRUE, this property specifies the location (in the |
| param8.val.ptr_offs | | incoming operation) of the pointer to the value |
| | | that APP_FAC extracts from the operation. |
| | | The default value is 0 (first field of the event). |
| param1.val.offs | uint32 | When the paramy.val.by_ref property is |
| . . . | | FALSE, this property specifies the location (in |
| param8.val.offs | | the incoming operation) of the pointer to the |
| | | value that APP_FAC extracts from the operation. |
| | | The default value is 0 (first field of the event). |
| param1.val.sz | uint32 | When the paramy.var_sz property is FALSE, |
| . . . | | this property specifies the length (specified in |
| param8.val.sz | | bytes) of the value in the incoming operation |
| | | identified by paramy.val.offs. |
| | | The default value is 4 (size of DWORD) |
| param1.val.order | sint32 | Specifies the byte order of the value that is to be |
| . . . | | extracted (identified by paramy.val.offs) from |
| param8.val.order | | the incoming operation. |
| | | Can be one of the following values: |
| | | 0 -Native machine format |
| | | 1 -MSB-Most-significant byte first |
| | | (Motorola) |
| | | −1 -LSB-Least-significant byte first (Intel) |
| | | This property is valid for only integral values. |
| | | The default value is 0 (Native machine format). |
| param1.val.sgnext | uint32 | Boolean. |
| . . . | | If TRUE, integral values smaller than 4 bytes are |
| param8.val.sgnext | | sign extended before the extracted value is |
| | | operated on using the paramy.val.mask and |
| | | paramy.val.shift properties. |
| | | This property is valid for only integral values. |
| | | The default value is FALSE. (no sign extension) |
| param1.val.mask | uint32 | Mask that is bit-wise ANDed with the extracted |
| . . . | | value before sending it out through prop terminal |
| parama8.val .mask | | as a property. |
| | | This property is valid for only integral values. |
| | | The default value is 0×FFFFFFFF (no value |
| | | change). |
| param1.val.shift | uint32 | Number of bits to shift the extracted value before |
| . . . | | sending it out through prop terminal as a |
| param8.val.shift | | property. |
| | | If the value is positive (greater than 0), the value |
| | | is shifted to the right. If the value is negative |
| | | (lesser than 0), the value is shifted to the left. |
| | | This property is valid for only integral values. |
| | | The default value is 0 (no change) |

¹³Note that the reference pointer is always stored in the processor native format. Its size may vary, depending on the system implementation.

The following properties are used to specify where the value length is stored in the incoming event. These properties are used only if the var_sz property is TRUE (variable size data values).

| Property | | |
|---|---|---|
| name | Type | Notes |
| param1.len.by_ref | uint32 | Boolean. |
| ... | | If TRUE, the storage in the incoming |
| param8.len.by_ref | | operation for the length of the value to |
| | | extract is identified by a reference |
| | | pointer contained within the event. |
| | | The offset of the length pointer (in the |
| | | event) is specified by |
| | | paramy.len.ptr_offs property. |
| | | If FALSE, the storage for the value |
| | | length is contained within the event. |
| | | The offset of the storage is specified |
| | | by the paramy.len.offs property. |
| | | The default value is FALSE (the storage |
| | | is contained within the event). |
| param1.len.ptr_offs14 | uint32 | When the paramy.len.by_ref property |
| ... | | is TRUE, paramy.len.ptr_offs specifies |
| param8.len.ptr_offs | | the location (in the incoming event) of |
| | | the pointer to where the value length is |
| | | stored. |
| | | The default value is 0 (first field of the |
| | | event). |
| param1.len.offs | uint32 | When the paramy.len.by_ref property |
| ... | | is FALSE, paramy.len.offs specifies |
| param8.len.offs | | the location (in the incoming event) at |
| | | which the value length is stored. |
| | | The default value is 0 (first field of the |
| | | event). |
| param1.len.sz | uint32 | Specifies the size of the field used to |
| ... | | store the value length. The length field |
| param8.len.sz | | is specified through the |
| | | paramy.len.ptr_offs or paramy.len.offs |
| | | properties. |
| | | The size can be one of the following: 1, |
| | | 2, 3, or 4. |
| | | The default value is 4 (size of |
| | | DWORD) |
| param1.len.order | sint32 | Specifies the byte order of the value |
| ... | | length. The length field is specified |
| param8.len.order | | through the paramy.len.ptr_offs |
| | | or paramy.len.offs properties. |
| | | Can be one of the following values: |
| | | 0 -Native machine format |
| | | 1 -MSB-Most-significant byte first |
| | | (Motorola) |
| | | −1 -LSB-Least-significant byte first |
| | | (Intel) |
| | | The default value is 0 (Native machine |
| | | format). |
| param1.len.mask | uint32 | Mask that is bit-wise ANDed with the |
| ... | | length value. |
| param8.len.mask | | The default value is OxFFFFFFFF (no |
| | | length change). |
| param1.len.shift | sint32 | Number of bits to shift the value length. |
| ... | | If the value is positive (greater than 0), |
| param8.len.shift | | the value is shifted to the right. If the |
| | | value is negative (lesser than 0), the |
| | | value is shifted to the left. |
| | | The default value is 0 (no change) |

¹⁴ Note that the reference pointer is always stored in the processor native format. Its size may vary, depending on the system implementation.

3. Events and Notifications

None.

4. Environmental Dependencies

None.

4.1 Encapsulated Interactions

None.

4.2 Other Environmental Dependencies

None.

5. Specification

5.1 Responsibilities

Pass all operation calls on the in terminal out through the out terminal.

Create, parameterize, and activate a part instance out the fact and prop terminals when create_op operation is received on the in terminal.

Deactivate and destroy a part instance out the fact terminal when destroy_op operation is received on the in terminal.

Serialize the creation and destruction of the part instances.

5.2 External States

None

5.3 Use Cases

5.3.1 Create Part Instances

When a create_op operation is received on the in terminal, APP_FAC perform the following operations before forwarding it through the out terminal:

Extract the part instance class name from the operation bus;

Create an part instance of the specified class by submitting factory create request out through fact terminal;

Extract persistent instance name from the creation operation and set it as a property on the newly created part instance by submitting a property set request out through prop terminal;

Extract up to eight properties from the creation operation and set them as properties on the newly created part instance by submitting a property set request out through prop terminal;

Activate the part instance by submitting factory activate request out through fact terminal.

5.3.2 Destroying Part Instances

When a destroy op_operation is received on the in terminal, APP_FAC performs the following operations after forwarding it through out terminal:

Deactivate the part instance by submitting factory deactivate request out through fact terminal;

Destroy the part instance by submitting factory destroy request out through fact terminal;

6. Typical Usage

6.1 Dynamic Creation and Destruction of a Part Instance

Part Instance factory (APP_FAC) provides the functionality to dynamically create and destroy part instances within the Instance Container in response to external events.

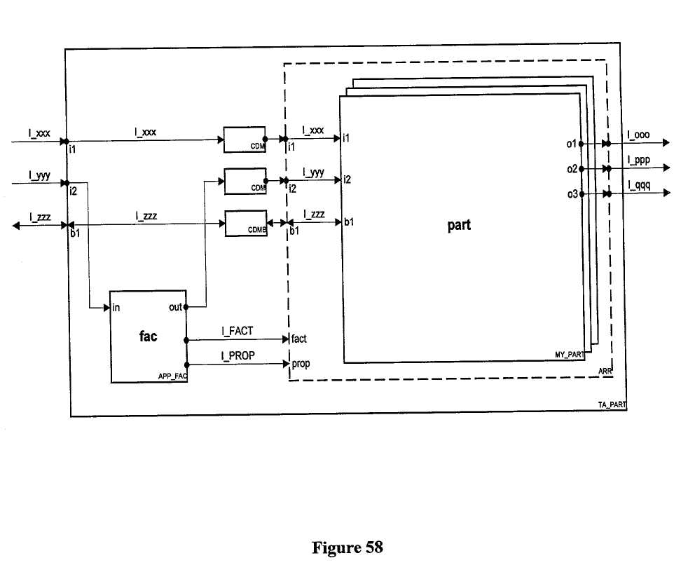

FIG. 58 illustrates instance creation by a factory upon receiving of a creation request

When the creation request (e.g., create_op) is received on the i2 terminal, APP_FAC extracts from the request the data necessary to construct the instance class. Then it creates a part instance through ARR's fact terminal. Any additional parameterization arguments (paramy.xxx) in the request are set as properties on the newly created part instance through fact's prop terminal. After the part instance is activated, the original request and any subsequent requests are forwarded to the created instance through i2 terminal.

When a destroy instance request (destroy_op) is received, fac forwards the request to the specified instance and then it deactivates and destroys the instance through the ARR's fact terminal.

Note that when a request is distributed to any of the part instances it carries an identifier that uniquely specifies the actual recipient (part instance ID). The connection multiplexers (CDM/CDMB) extract the identifier from the incoming request and dispatch the request to the corresponding part instance.

7. Document References

None.

8. Unresolved Issues

None.

### APP_LFCCTL—Life cycle Controller

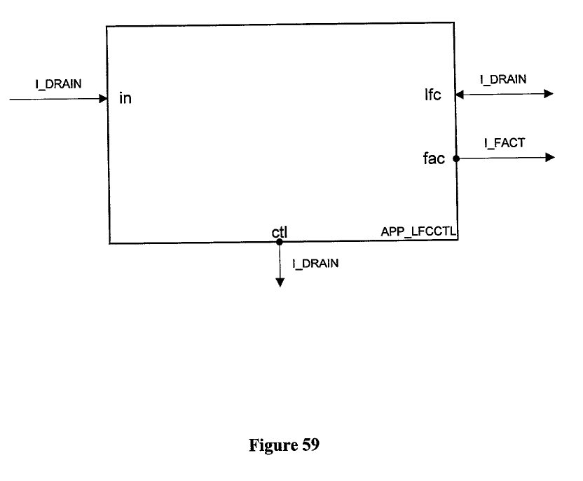

FIG. 59 illustrates the boundary of part, APP_LFCCTL

1. Functional Overview

APP_LFCCTL is a dynamic structure part used to control and maintain the life cycle of a single part instance.

In response to receiving a life cycle event on the in terminal, APP_LFCCTL implements a sequence of operations out its fac, ctl, and lfc terminals necessary to control the life cycle of the part instance. The sequence of operations include:

Creation, destruction, activation, and deactivation of the part via the fac terminal

Generation of events out the ctl terminal to control the parameterization and persistent state of the part instance

Generation of life cycle events out the lfc terminal.

In addition to the life cycle start and stop events, APP_LFCCTL accepts a special “run” event and soft and hard reset events on the in terminal.

The “run” event is used to perform the normal operation of a system. APP_LFCCTL can be parameterized to block this event until a life cycle stop event is received or it can consume the event immediately and return.

The soft and hard reset events cause APP_LFCCTL to reset the part instance. The resetting of the part instance may include stopping, re-parameterizing, and restarting the part instance in the case of a soft reset or stopping and completely destroying the part instance in the case of a hard reset. The hard-reset request is also forwarded through the ctl terminal to trigger the hard reset (e.g., reboot) of the system. Note that the rebooting of the system is handled outside of APP_LFCCTL.

All event Ids and data necessary to create the part instance are specified through properties.

APP_LFCCTL is typically used to control and maintain the life cycle of the top-most assembly of a Dragon application or system. APP_LFCCTL is usually used in conjunction with APP_CFGM in order to maintain the persistent state of the application's assembly.

APP_LFCCTL's terminals are guarded and cannot be used in interrupt contexts.

2. Boundary

2.1 Terminals

| Name | Dir | Interface | Notes |
|---|---|---|---|
| in | in | I_DRAIN | This terminal is used to start and stop the |
| | | | system in which APP_LFCCTL is used. |
| | | | It is also used to perform soft and hard system |
| | | | resets. |
| lfc | Plug | I_DRAIN | APP_LFCCTL generates life cycle |
| | | | start and stop events through this terminal. |
| fac | out | I_FACT | APP_LFCCTL uses this terminal to create, |
| | | | activate, deactivate and destroy the |
| | | | parameterized part. |
| ctl | out | I_DRAIN | APP_LFCCTL generates events |
| | | | through this terminal to serialize and |
| | | | de-serialize persistent configuration parameters |
| | | | of the system in which APP_LFCCTL is used. |

2.2 Properties

| Property name | Type | Notes |
|---|---|---|
| part.class_nm | uint32 | Pointer to the name of the part class |
| | | which APP_LFCCTL instantiates |
| | | through the fac terminal. |
| | | If the part class is “” (empty string), |
| | | the default class name is used. The |
| | | default class name is defined by the |
| | | part connected to APP_LFCCTL's |
| | | fac terminal. |
| | | APP_LFCCTL passes the value of |
| | | this property as a parameter on the |
| | | create operation invoked through the |
| | | fac terminal. |
| | | APP_LFCCTL can control the life |
| | | cycle of only one part instance at a |
| | | time. |
| | | The default value is “” (use the |
| | | default class name). |
| part.gen_id | uint32 | Boolean. TRUE to generate a unique |
| | | ID for the part instance. FALSE to |
| | | use the specified ID (part.id) as the |
| | | instance identifier for the part |
| | | instantiated through the fac terminal. |
| | | APP_LFCCTL passes the value of |
| | | this property as a parameter on the |
| | | create operation invoked through the |
| | | fac terminal. |
| | | The default value is TRUE (generate |
| | | part ID). |
| part.id | uint32 | Part instance identifier to use for the |
| | | part instantiated through the fac |
| | | terminal. This property is used only if |
| | | part.gen_id is FALSE. |
| | | APP_LFCCTL passes the value of |
| | | this property as a parameter on the |
| | | create operation invoked through the |
| | | fac terminal. |
| | | The default value is 0. |
| id_offs | uint32 | Offset in the outgoing event bus |
| | | passed through the ctl terminal to |
| | | the field that contains the part |
| | | instance ID that identifies the part |
| | | instantiated by APP_LFCCTL |
| | | (specified in bytes). |
| | | If −1, outgoing events passed through |
| | | the ctl terminal do not contain |
| | | the part instance ID. APP_LFCCTL |
| | | remembers the part instance identifier |
| | | and stamps it into the outgoing events |
| | | at the specified offset. |
| | | The part ID is stamped only into |
| | | configuration related requests |
| | | (EV_CFG_REQ_xxx) sent |
| | | through the ctl terminal. |
| | | The default value is −1 (no part ID |
| | | field is used). |
| gen_save_lkg | uint32 | Boolean. If TRUE, APP_LFCCTL |
| | | generates an |
| | | EV_CFG_REQ_SAVE_LKG |
| | | event through the ctl terminal if the |
| | | specified part is successfully |
| | | instantiated and parameterized with |
| | | its configuration settings. |
| | | If FALSE, APP_LFCCTL does not |
| | | generate the |
| | | EV_CFG_REQ_SAVE_LKG |
| | | event. |
| | | The default value is TRUE. |
| start_ev_id | uint32 | ID of the life cycle start trigger event |
| | | received through the in terminal. |
| | | The default value is |
| | | EV_LFC_REQ_START. |
| stop_ev_id | uint32 | ID of the life cycle stop trigger event |
| | | received through the in terminal. |
| | | The default value is |
| | | EV_LFC_REQ_STOP. |
| run_ev_id | uint32 | ID of the “run” event received |
| | | through the in terminal. |
| | | If EV_NULL, no “run” event is |
| | | used. |
| | | The default value is EV_NULL. |
| block_run_ev | uint32 | Boolean. TRUE to block the run |
| | | event until a life cycle stop or |
| | | hard-reset request is received. If |
| | | FALSE, the run event is completed |
| | | immediately with ST_OK. |
| | | The default value is FALSE. |
| req_hard_reset_ev_id | uint32 | ID of the trigger event used to |
| | | perform a hard reset on the system |
| | | in which APP_LFCCTL is used. |
| | | If EV_NULL, hard resets are not |
| | | used. |
| | | The default value is EV_NULL (not |
| | | used). |
| req_soft_reset_ev_id | uint32 | ID of the trigger event used to |
| | | perform a soft reset on the system |
| | | in which APP_LFCCTL is used. |
| | | If EV_NULL, soft resets are not |
| | | used. |
| | | The default value is EV_NULL (not |
| | | used). |

3.1 Terminal: in

| Event | Dir. | Bus | Notes |
|---|---|---|---|
| (start_ev_id) | in | any | When this event is received, the specified |
| | | | part is created, parameterized and activated. |
| | | | After successful activation, APP_LFCCTL |
| | | | generates an EV_LFC_REQ_START request |
| | | | through the lfc terminal. |
| | | | If the specified part started successfully and |
| | | | the gen_save_lkg property is TRUE, |
| | | | APP_LFCCTL generates an |
| | | | EV_CFG_REQ_SAVE_LKG event through the |
| | | | ctl terminal. |
| | | | If any of the operations performed by |
| | | | APP_LFCCTL fails, APP_LFCCTL fails |
| | | | the start event. |
| (stop_ev_id) | in | any | When this event is received, APP_LFCCTL |
| | | | stops the specified part by generating an |
| | | | EV_LFC_REQ_STOP request through the lfc |
| | | | terminal. |
| | | | Next, APP_LFCCTL deactivates the part |
| | | | and generates an EV_CFG_REQ_SERIALIZE |
| | | | request that triggers the serialization of the |
| | | | part's persistent state. |
| | | | Lastly, APP_LFCCTL destroys the part |
| | | | instance through the fac terminal. |
| | | | If a run event is currently blocked, |
| | | | APP_LFCCTL unblocks the event and |
| | | | completes it with ST_OK. |
| (req_hard_reset_ev_id) | in | any | This event triggers a hard reset of the |
| | | | system in which APP_LFCCTL is used. |
| | | | When this event is received, APP_LFCCTL |
| | | | performs all of the same operations as when |
| | | | it receives a stop ev_id_event. |
| | | | Afterwards, APP_LFCCTL passes the |
| | | | event through the ctl terminal, which |
| | | | triggers the hard reset of the system. |
| | | | The hard reset event is desynchronized |
| | | | inside of APP_LFCCTL to allow the thread |
| | | | execution to return back to the generator of |
| | | | the event before the hard reset actually |
| | | | occurs. Care must be taken if the instance |
| | | | maintained by APP_LFCCTL is the one |
| | | | who sends this event. The instance should |
| | | | not complete the life cycle stop request if a |
| | | | hard reset request it generated has not |
| | | | completed. This will guarantee that it is |
| | | | safe to destroy the instance after stopping it |
| | | | without crashing the system. |
| (req_soft_reset_ev_id) | in | any | This event triggers a soft reset of the system |
| | | | in which APP_LFCCTL is used. |
| | | | APP_LFCCTL stops and de-serializes the |
| | | | persistent state of the part maintained |
| | | | through the fac terminal. It then |
| | | | deactivates the part. Next, APP_LFCCTL |
| | | | re-parameterizes, activates and starts the |
| | | | specified part. |

3.2 Terminal: lfc

| | | | |
|---|---|---|---|
| EV_LFC_REQ_START | out | any | This event is generated by APP_LFCCTL after the |
| | | | specified part is created, parameterized and |
| | | | activated successfully. |
| EV_LFC_REQ_STOP | out | any | This event is generated by APP_LFCCTL before |
| | | | the specified part is deactivated and destroyed. |

3.3 Terminal: ctl
The EV_CFG_XXX events are defined in e_cfg.h.

| | | | |
|---|---|---|---|
| EV_CFG_REQ_SERIALIZE | out | any | This event is used to save the persistent |
| | | | state of the specified part. |
| | | | This event is generated by APP_LFCCTL |
| | | | after the specified part is deactivated and |
| | | | before it is destroyed on life cycle stop. |
| EV_CFG_REQ_DESERIALIZE | out | any | This event is used to restore the persistent |
| | | | state of the specified part from the “last |
| | | | saved” configuration. |
| | | | This event is generated by APP_LFCCTL |
| | | | after the specified part is created on life |
| | | | cycle start. |
| EV_CFG_REQ_SAVE_LKG | out | any | This event is generated by APP_LFCCTL |
| | | | in order to create a backup copy of the |
| | | | serialized state of the part instantiated |
| | | | through the fac terminal. |
| | | | This event is generated when the life cycle |
| | | | start event is successfully completed |
| | | | through the lfc terminal and when the |
| | | | gen_save_lkg property is TRUE. |
| EV_CFG_REQ_USE_LKG | out | any | This event is generated by APP_LFCCTL |
| | | | in order to restore the persistent state of the |
| | | | part created through the fac terminal using |
| | | | the “last known good” configuration. |
| | | | This event is generated when |
| | | | APP_LFCCTL fails to restore the |
| | | | persistent state using the “last saved” |
| | | | configuration. |
| EV_CFG_REQ_USE_FAC_DFLT | out | any | This event is generated by APP_LFCCTL |
| | | | in order to restore the persistent state of the |
| | | | part created through the fac terminal using |
| | | | the “factory defaults” configuration. |
| | | | This event is generated when |
| | | | APP_LFCCTL fails to restore the |
| | | | persistent state using both the “last saved” |
| | | | and “last known good” configurations. |
| (req_hard_reset_ev_id) | out | any | This event is generated by APP_LFCCTL |
| | | | when it needs to issue a hard reset of the |
| | | | system in which it is running. |

4. Environmental Dependencies

4.1 Encapsulated Interactions

None.

4.2 Other Environmental Dependencies

None.

5. Specification

5.1 Responsibilities

Upon receiving a start_ev_id request through the in terminal: execute the following operations in order:

1 .Create the specified part through the fac terminal.

2. Generate an EV_CFG_REQ_DESERIALIZE event through the cfg terminal to de-serialize the persistent state of the part instance.

3. If the de-serialization fails, generate an EV_CFG_REQ_USE_LKG event through the cfg terminal. If the de-serialization from the “last known good” configuration fails, generate an EV_CFG_REQ_USE_FAC_DFLT event through the cfg terminal. If the de-serialization from the “factory defaults” configuration fails, fail the start request.

4. Activate the part instance through the fac terminal.

5. If the activation fails, re-parameterize the part instance by generating either EV_CFG_REQ_USE_LKG or EV_CFG_REQ_USE_FAC_DFLT depending on which configuration was used in step C. If no configuration works with the part instance, fail the start request.

6. Generate an EV_LFC_REQ_START request through the lfc terminal.

7. If the start request fails, re-parameterize the part instance by generating either EV_CFG_REQ_USE_LKG or EV_CFG_REQ_USE_FAC_DFLT depending on which configuration was used in step C and E. If no configuration works with the part instance, fail the start request.

8. If gen_save_lkg is TRUE, generate an EV_CFG_REQ_SAVE_LKG request through the ctl terminal.

If any of the above operations fail, perform cleanup of previously executed operations and fail the start request.

Upon receiving a stop_ev_id request through the in terminal: execute the following operations in order:

1. Generate an EV_LFC_REQ_STOP request through the lfc terminal.

2. Deactivate the part instance through the fac terminal.

3. Generate an EV_CFG_REQ_SERIALIZE event through the cfg terminal to serialize the persistent state of the part instance.

4. Destroy the part instance through the fac terminal.

5. If a run event is currently blocked, unblock the event and complete the event with ST_OK.

Ignore errors in all of the above operations.

If a run event is received through the ctl terminal, either block the event until a life cycle stop event is received or complete the event immediately with ST_OK.

Upon receiving a req_hard_reset_ev_id request through the in terminal, perform the same operations as in the second responsibility. Finally, pass the event through the ctl terminal. Ignore any incoming events after a hard reset is performed.

Upon receiving a req_soft_reset_ev_id request through the in terminal, perform the same operations as in the second and first responsibilities except do not destroy or re-create the part instance.

For all events and requests generated through the ctl terminal, stamp the part instance ID into the specified field in the event if parameterized to do so.

Complete incoming start and stop requests synchronously.

Desynchronize incoming hard reset requests.

Fail all unrecognized events received through the in terminal with ST_NOT_SUPPORTED.

5.2 External States

None.

6. Use Cases

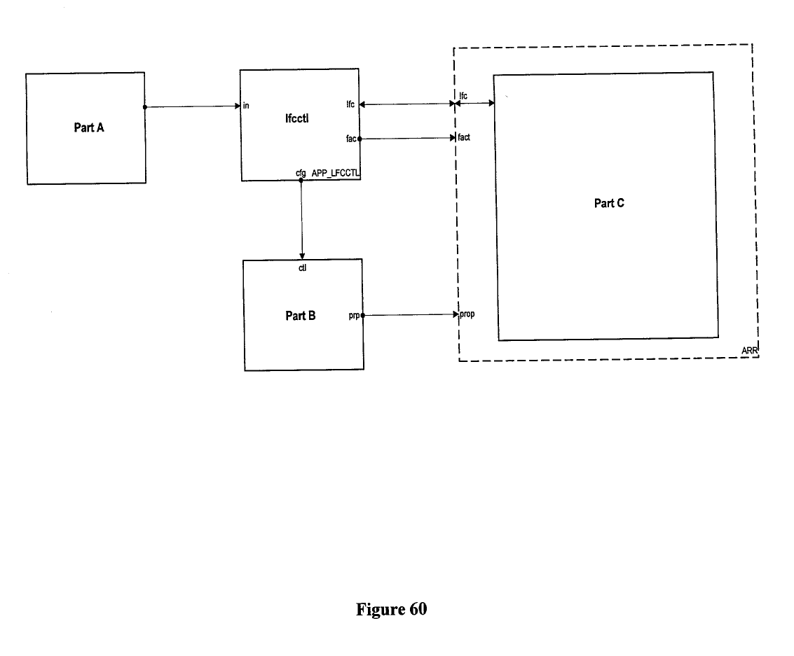

FIG. 60 illustrates an advantageous use of part, APP_LFCCTL

6.1 Starting a System Using APP_LFCCTL

This use case describes how APP_LFCCTL is used to start a system.

The system is created, connected and activated.

Part A sends a life cycle start request to APP_LFCCTL.

APP_LFCCTL creates the parameterized part by invoking the create operation through the fac terminal. The part array ARR creates Part C and returns.

Depending on how APP_LFCCTL is parameterized, the part instance ID is either generated by ARR or it is specified as a constant.

APP_LFCCTL generates an EV_CFG_REQ_DESERIALIZE event through the cfg terminal to de-serialize the persistent state of the part instance. This event is received by Part B which parameterizes Part C using properties stored in some external storage (“last saved” configuration).

APP_LFCCTL activates the part instance by invoking the activate operation through the fac terminal. ARR activates Part C.

APP_LFCCTL generates an EV_LFC_REQ_START request through the lfc terminal. Part C receives this request and returns ST_OK.

If the gen_save_lkg property is TRUE, APP_LFCCTL generates an EV_CFG_REQ_SAVE_LKG through the ctl terminal. Part B receives the request and creates a back-up copy of the properties in which it parameterized Part B with earlier.

APP_LFCCTL completes the incoming life cycle start request with success.

6.2 De-serialization Failure: Use “Last Known Good” Configuration

This use case describes how APP_LFCCTL handles situations where the de-serialization of the instance parameters from the “last saved” configuration fails.

The system is created, connected and activated.

Part A sends a life cycle start request to APP_LFCCTL.

APP_LFCCTL creates the parameterized part by invoking the create operation through the fac terminal. The part array ARR creates Part C and returns. Depending on how APP_LFCCTL is parameterized, the part instance ID is either generated by ARR or it is specified as a constant.

APP_LFCCTL generates an EV_CFG_REQ_DESERIALIZE event through the cfg terminal to de-serialize the persistent state of the part instance. This event is received by Part B which fails it with a bad status due to an error in retrieving the properties to parameterize on the part (“last saved” configuration).

APP_LFCCTL generates an EV_CFG_REQ_USE_LKG event through the cfg terminal to de-serialize the persistent state of the part instance from the “last known good” configuration.

This event is received by Part B, which parameterizes Part C using properties stored in some external storage in the “last known good” configuration.

APP_LFCCTL activates the part instance by invoking the activate operation through the fac terminal. ARR activates Part C.

APP_LFCCTL generates an EV_LFC_REQ_START request through the lfc terminal. Part C receives this request and returns ST_OK.

If the gen_save_lkg property is TRUE, APP_LFCCTL generates an EV_CFG_REQ_SAVE_LKG through the ctl terminal. Part B receives the request and creates a back-up copy of the properties in which it parameterized Part B with earlier.

APP_LFCCTL completes the incoming life cycle start request with success.

Note that this use case is valid also when either the activation or start request fails when using the “last saved” configuration.

6.3 De-serialization Failure: Use “Factory Defaults” configuration

This use case describes how APP_LFCCTL handles situations where the de-serialization of the instance parameters from the “last saved” and the “last known good” configurations fail.

The system is created, connected and activated.

Part A sends a life cycle start request to APP_LFCCTL.

APP_LFCCTL creates the parameterized part by invoking the create operation through the fac terminal. The part array ARR creates Part C and returns.

Depending on how APP_LFCCTL is parameterized, the part instance ID is either generated by ARR or it is specified as a constant.

APP_LFCCTL generates an EV_CFG_REQ_DESERIALIZE event through the cfg terminal to de-serialize the persistent state of the part instance. This event is received by Part B which fails it with a bad status due to an error in retrieving the properties to parameterize on the part (“last saved” configuration).

APP_LFCCTL generates an EV_CFG_REQ_USE_LKG event through the cfg terminal to de-serialize the persistent state of the part instance from the “last known good” configuration. This event is received by Part B, which fails it with a bad status due to an error in retrieving the properties to parameterize on the part (“last known good” configuration).

APP_LFCCTL generates an EV_CFG_REQ_USE_FAC_DFLT event through the cfg terminal to de-serialize the persistent state of the part instance from the “factory default” configuration.

This event is received by Part B, which parameterizes Part C using properties stored in some external storage in the “factory default” configuration.

APP_LFCCTL activates the part instance by invoking the activate operation through the fac terminal. ARR activates Part C.

APP_LFCCTL generates an EV_LFC_REQ_START request through the lfc terminal. Part C receives this request and returns ST_OK.

If the gen_save_lkg property is TRUE, APP_LFCCTL generates an EV_CFG_REQ_SAVE_LKG through the ctl terminal. Part B receives the request and creates a back-up copy of the properties in which it parameterized Part B with earlier.

APP_LFCCTL completes the incoming life cycle start request with success.

Note that this use case is valid also when either the activation or start request fails when using the “last saved” configuration.

6.4 Stopping a system using APP_LFCCTL

This use case describes how APP_LFCCTL is used to stop a system.

The system is created, connected and activated.

Part A sends a life cycle start request to APP_LFCCTL. The operations described in the previous use case are executed.

At some time later, Part A sends a life cycle stop request to APP_LFCCTL

APP_LFCCTL generates an EV_LFC_REQ_STOP request through the lfc terminal. Part C receives this request and returns ST_OK.

APP_LFCCTL deactivates the part instance by invoking the deactivate operation through the fac terminal. ARR deactivates Part C.

APP_LFCCTL generates an EV_CFG_REQ_SERIALIZE event through the cfg terminal to serialize the persistent state of the part instance. This event is received by Part B which retrieves all the persistent properties from Part C and stores the values in some external storage.

APP_LFCCTL destroys the part instance by invoking the destroy operation through the fac terminal. ARR destroys Part C.

If there is a blocked run event, APP_LFCCTL completes the event with ST_OK.

APP_LFCCTL completes the incoming life cycle stop request with success.

6.5 Soft Reset

This use case describes how APP_LFCCTL handles a soft reset request.

The system is created, connected and activated.

Part A sends a life cycle start request to APP_LFCCTL. The operations described in the previous use case are executed.

At some time later, Part A sends a soft reset request to APP_LFCCTL.

APP_LFCCTL emulates a life cycle stop and start request by executing all the steps in the above two use cases except for destroying and creating the part.

6.6 Hard Reset

This use case describes how APP_LFCCTL handles a hard reset request.

The system is created, connected and activated.

Part A sends a life cycle start request to APP_LFCCTL. The operations described in the previous use case are executed.

At some time later, Part A sends a hard reset request to APP_LFCCTL.

APP_LFCCTL emulates a life cycle stop request by executing all the steps in the above use cases.

APP_LFCCTL forwards the hard reset request through the ctl terminal.

The hard reset request is received by Part B which reboots the system.

7. Typical Usage

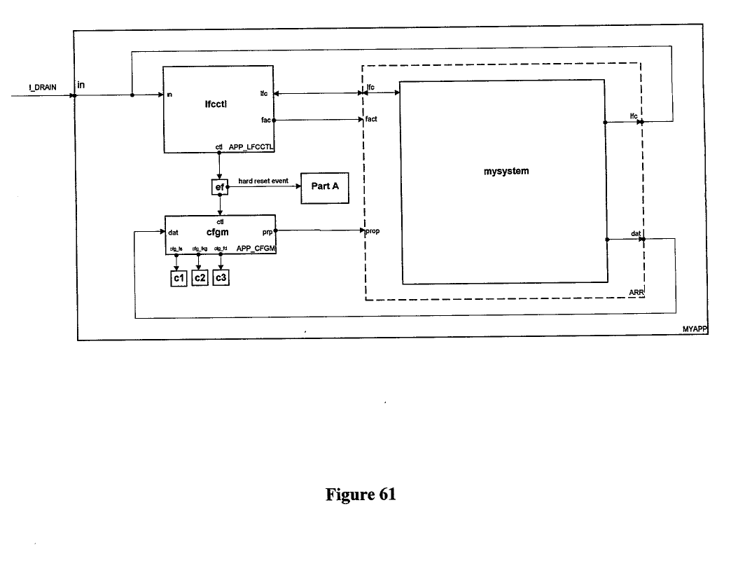

This use case presents how APP_LFCCTL is typically used in Dragon applications. This example shows the internal structure of the MYAPP assembly discussed in this section. FIG. 61 illustrates an advantageous use of part, APP_LFCCTL

The MYAPP assembly is comprised of the following subordinates:

lfcctl is used to control the life cycle of the assembly. Its main function is to create and activate mysystem inside the part array ARR. It also generates events to cfgm in order to serialize and de-serialize the persistent state of the mysystem part.

cfgm is used to maintain the persistent state of the mysystem part.

c1, c2, & c3 (APP_BAFILE) are property containers used to store each type of configuration.

arr (ARR) is used to maintain the mysystem instances created and destroyed by lfcctl.

mysystem is an application-specific assembly that implements the functionality needed by the application.

ef (EFLT) is used to filter out hard reset events and forwards them to Part A which reboots the system in which MYAPP is running.

The MYAPP assembly is the top most assembly in the Dragon system. Dragon creates and activates this assembly and then feeds the assembly the EV_SYS_INIT event. After initialization is complete, the Dragon system sends an EV_SYS_RUN event. When the system is ready to be brought down, the Dragon system feeds the assembly the EV_SYS_CLEANUP event. The life cycle controller (APP_LFCCTL) is parameterized with these system events (start_ev_id=EV_SYS_INIT, stop_ev_id=EV_SYS_CLEANUP, and run_ev_id=EV_SYS_RUN).

The sections below describe what happens when the assembly receives the system events and how it operates.

7.1 System Initialization

When MYAPP receives a EV_SYS_INIT event, it is forwarded to lfcctl. lfcctl first creates an instance of mysystem in the part array. After successful creation, lfcctl generates an EV_CFG_REQ_DESERIALIZE event to cfgm through cfgm's ctl terminal. The event bus contains the part instance ID of the mysystem part in the part array.

cfgm enumerates and retrieves all the “last saved” parameters from the specified file and sets each parameter on the mysystem instance in the part array (through the prp terminal). cfgm uses the part instance ID stored in the incoming event when setting properties through the prp terminal. When the parameterization is complete, control is returned back to lfcctl.

lfcctl activates the mysystem part and generates a life cycle start request through the lfc terminal. Upon success, lfcctl generates an EV_CFG_REQ_SAVE_LKG event to cfgm. cfgm creates a back-up copy of the “last saved” parameters as the “last known good” parameters and returns. In the future, in case the “last saved” configuration file becomes damaged or corrupt, the configuration may be restored from the “last known good” configuration.

The serialized state of mysystem is now restored. lfcctl completes the original EV_SYS_INIT event received through the in terminal.

Next, the Dragon system sends an EV_SYS_RUN event, which is forwarded to lfcctl. lfcctl blocks the run event until a cleanup or hard-reset event is received.

7.2 System Cleanup

When MYAPP receives a EV_SYS_INIT event, it is forwarded to lfcctl. lfcctl first generates a life cycle stop request to mysystem. Next, it generates an EV_CFG_REQ_SERIALIZE event to cfgm through cfgm's ctl terminal. The event bus contains the part instance ID of the mysystem part in the part array.

cfgm enumerates and retrieves all the modifiable-persistent properties from the mysystem part and saves them as the “last saved” configuration parameters. cfgm uses the part instance ID stored in the incoming event when setting properties through the prp terminal. When the serialization is complete, control is returned back to lfcctl.

lfcctl deactivates and destroys mysystem and completes the original EV_SYS_INIT event received through the in terminal.

The state of mysystem is now serialized to a binary file on persistent storage.

Lastly, the run event is unblocked and completed with ST_OK.

7.3 De-serialization Errors

If an attempt to de-serialize the parameters from the “last saved” configuration fails, lfcctl tries to restore the parameters from either the “last known good” or the “factory default” parameters.

In this case, lfcctl generates an EV_CFG_REQ_USE_LKG event to cfgm. cfgm attempts to parameterize mysystem with the “last known good” configuration. If an error occurs, lfcctl tries to restore the state of the system from the “factory defaults” configuration (using EV_CFG_REQ_USE_FAC_DFLT). If another error occurs, the state of the system can not be restored from persistent storage and lffcctl fails the incoming EV_SYS_INIT event.

Note that this also applies to cases when the activation or starting of the part instance fails. APP_LFCCTL will try all possible parameter sets until either the part instance successfully activates and starts or none of the parameter sets work with the part instance (in this case, the init event completes with failure).

7.4 Soft System Reset

mysystem at some point needs to perform a soft-reset of the system. mysystem generates a soft system reset event through its lfc terminal which is forwarded through lfcctl's in terminal.

lfcctl executes the operations executed on EV SYS CLEANUP and also on EV SYS INIT in order to reset the mysystem assembly.

7.5 Hard System Reset

mysystem at some point needs to reboot the system upon a user's request. mysystem generates a hard system reset event through its lfc terminal which is forwarded through lfcctl's in terminal. lfcctl de-synchronizes the event before processing.

lfcctl executes the operations executed on EV_SYS_CLEANUP. Afterwards, the hard reset event is forwarded through the ctl terminal.

ef filters the hard reset event and forwards the event to Part A. Part A then reboots the system in which the MYAPP assembly is running.

8. Document References

None.

9. Unresolved Issues

APP_LFCCTL does not support life cycle start and stop timeouts or delays between stopping and starting the part instance. This is due to a limitation in the Dragon engine. When the init event is received, the timer and interrupt services are not available. These features cannot be implemented until the Dragon engine is updated.

### APP—Property Space Support

### APP_CFGM—Configuration Manager

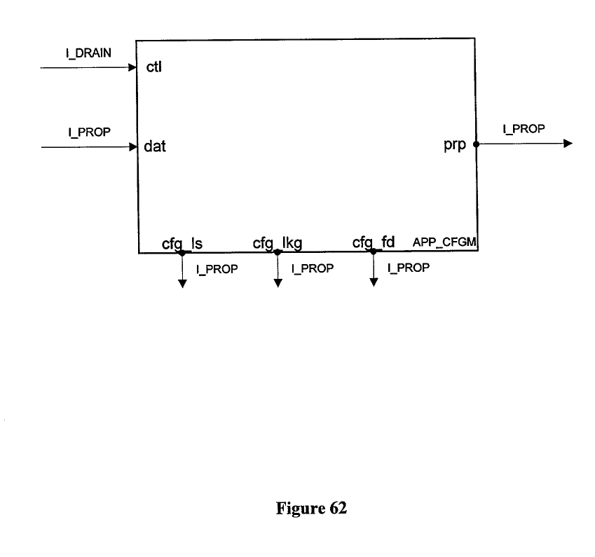

FIG. 62 illustrates the boundary of part, APP_CFGM

1. Functional Overview

APP_CFGM manages different sets of configuration parameters for a Dragon application or system. The configuration parameters are stored in external containers that are accessed through APP_CFGM's output terminals.

APP_CFGM manages the following four sets of configuration parameters for an application:

“current” configuration: current parameterization of an application, accessed through the prp terminal

“last saved” configuration: serialized persistent state of an application, accessed through the cfg_ls terminal

“last known good” configuration: backup copy of the “last saved” configuration, accessed through the cfg lkg terminal

“factory defaults” configuration: factory default parameterization of an application, accessed through the cfg_fd terminal

APP_CFGM is typically used for the serialization and de-serialization of an application's persistent state. APP_CFGM can copy parameters from one configuration to another.

APP_CFGM can perform any of the following operations (by sending the corresponding event through the ctl terminal): serialization/de-serialization of the “current” configuration to/from the “last saved” configuration, create a back-up copy of the “last saved” configuration, de-serialize the parameters from either the “last known good” or “factory defaults” configurations, and lastly, restore the “last saved” configuration from either the “last known good” or “factory defaults” configurations.

APP_CFGM also allows access of individual parameters in the “last saved”, “last known good” and “factory default” configurations through the dat terminal. Note that the “last known good” and “factory default” configurations are read-only.

APP_CFGM's terminals are unguarded and may be used in interrupt contexts.

2. Boundary

2.1 Terminals

| Name | Dir | Interface | Notes |
|---|---|---|---|
| ctl | In | I_DRAIN | This terminal is used to invoke operations |
| | | | over the following sets of configuration |
| | | | parameters: “current”, “last saved”, |
| | | | “last known good” and “factory default”. |
| dat | In | I_PROP | This terminal is used to access individual |
| | | | configuration parameters of the “last saved”, |
| | | | “last known good” and “factory default” |
| | | | configuration parameter sets. |
| | | | Use the following values in the ID field of |
| | | | the property operation bus to identify which |
| | | | set of parameters to access: |
| | | | 1 - “last saved” configuration (read-write |
| | | | access) |
| | | | 2 - “last known good” configuration |
| | | | (read-only access) |
| | | | 3 - “factory defaults” configuration |
| | | | (read-only access) |
| prp | Out | I_PROP | Used to access the current configuration |
| | | | parameters maintained by a part connected to |
| | | | this terminal. |
| cfg_ls | Out | I_PROP | Used to access the “last saved” configuration |
| | | | parameters. |
| | | | The ID field of the property operation bus |
| | | | passed through this terminal is not used and |
| | | | is set to zero. |
| cfg_lkg | Out | I_PROP | Used to access the “last known good” |
| | | | configuration parameters. |
| | | | The ID field of the property operation bus |
| | | | passed through this terminal is not used and |
| | | | is set to zero. |
| cfg_fd | Out | I_PROP | Used to access the “factory default” |
| | | | configuration parameters. |
| | | | The ID field of the property operation bus |
| | | | passed through this terminal is not used and |
| | | | is set to zero. |

2.2 Properties

| Property name | Type | Notes |
|---|---|---|
| Id_offs | uint32 | Offset in the incoming event bus to the |
| | | field that contains the part instance ID that |
| | | identifies the part accessed through the prp |
| | | terminal (specified in bytes). |
| | | If −1, the ID field in the property |
| | | operation bus is not used and is set to |
| | | zero. |
| | | The default value is −1 (not used). |
| ser_qry_string | asciz | Query string to use when enumerating |
| | | properties through the prp terminal during |
| | | serialization. |
| | | The default value is “*” (all properties). |
| ser_qry_attr | uint32 | Specifies the attributes to use when |
| | | enumerating properties through the prp |
| | | terminal during serialization. |
| | | The default value is ZPRP_A_PERSIST. |
| ser_qry_attr_mask | uint32 | Specifies the attribute mask to use when |
| | | enumerating properties through the prp |
| | | terminal during serialization. |
| | | The default value is ZPRP_A_PERSIST. |

3. Events and Notifications

3.1 Terminal: ctl
The following events are defined in e_cfgm.h.

| Event | Dir | Bus | Notes |
|---|---|---|---|
| EV_CFG_REQ_SERIALIZE | in | any | When this event is received, |
| | | | APP_CFGM enumerates the |
| | | | properties through the prp terminal |
| | | | and sets their values through the |
| | | | cfg_ls terminal. |
| | | | This event is used to save the |
| | | | persistent state of a part connected to |
| | | | the prp terminal. |
| EV_CFG_REQ_DESERIALIZE | in | any | When this event is received, |
| | | | APP_CFGM enumerates the |
| | | | properties through the cfg_ls |
| | | | terminal and sets their values through |
| | | | the prp terminal. |
| | | | This event is used to restore the |
| | | | persistent state of a part connected to |
| | | | the prp terminal using the “last saved” |
| | | | configuration parameters. |
| EV_CFG_REQ_SAVE_LKG | in | any | When this event is received, |
| | | | APP_CFGM enumerates the |
| | | | properties through the cfg_ls |
| | | | terminal and sets their values through |
| | | | the cfg_lkg terminal. |
| | | | This event is used to save the “last |
| | | | saved” parameters as the “last known |
| | | | good” parameters; essentially creating |
| | | | a backup copy of the “last saved” |
| | | | configuration parameters. |
| EV_CFG_REQ_RESTORE_LKG | in | any | When this event is received, |
| | | | APP_CFGM enumerates the |
| | | | properties through the cfg_lkg |
| | | | terminal and sets their values through |
| | | | the cfg_ls terminal. |
| EV_CFG_REQ_RESTORE_FAC_DFLT | in | any | When this event is received, |
| | | | APP_CFGM enumerates the |
| | | | properties through the cfg_fd |
| | | | terminal and sets their values through |
| | | | the cfg_ls terminal. |
| EV_CFG_REQ_USE_LKG | in | any | When this event is received, |
| | | | APP_CFGM enumerates the |
| | | | properties through the cfg_lkg |
| | | | terminal and sets their values through |
| | | | the prp terminal. |
| | | | This event is used to restore the |
| | | | persistent state of a part connected to |
| | | | the prp terminal using the “last known |
| | | | good” configuration parameters. |
| EV_CFG_REQ_USE_FAC_DFLT | in | any | When this event is received, |
| | | | APP_CFGM enumerates the |
| | | | properties through the cfg_fd |
| | | | terminal and sets their values through |
| | | | the prp terminal. |
| | | | This event is used to restore the |
| | | | persistent state of a part connected to |
| | | | the prp terminal using the “factory |
| | | | default” configuration parameters. |
| (other) | in | any | These events are completed with |
| | | | status ST_NOT_SUPPORTED. |

4. Environmental Dependencies

4.1 Encapsulated Interactions

None.

4.2 Other Environmental Dependencies

None.

5. Specification

5.1 Responsibilities

Upon receiving an EV_CFG_REQ_SERIALIZE event through the ctl terminal, enumerate and retrieve the specified properties through the prp terminal and set their values through the c fg_l s terminal.

Upon receiving an EV_CFG_REQ_DESERIALIZE event through the ctl terminal, enumerate and retrieve the specified properties through the cfg_ls terminal and set their values through the prp terminal.

Upon receiving an EV_CFG_REQ_SAVE_LKG event through the ctl terminal, enumerate and retrieve the specified properties through the cfg_ls terminal and set their values through the cfg_lkg terminal.

Upon receiving an EV_CFG_REQ_RESTORE_LKG event through the ctl terminal, enumerate and retrieve the specified properties through the cfg_lkg terminal and set their values through the cfg_ls terminal.

Upon receiving an EV_CFG_REQ_RESTORE_FAC_DFLT event through the ctl terminal, enumerate and retrieve the specified properties through the cfg_fd terminal and set their values through the cfg_is terminal.

Upon receiving an EV_CFG_REQ_USE_LKG event through the ctl terminal, enumerate and retrieve the specified properties through the cfg_lkg terminal and set their values through the prp terminal.

Upon receiving an EV_CFG_REQ_USE_FAC_DFLT event through the ctl terminal, enumerate and retrieve the specified properties through the cfg_fd terminal and set their values through the prp terminal.

When copying configuration parameters, ignore errors when setting property values through the prp terminal.

Fail all unrecognized events received through the ctl terminal with ST_NOT_SUPPORTED.

Allow access to individual properties in the “last saved”, “last known good” and “factory default” configuration parameters through the dat terminal. Enforce read-only access to the “last known good” and “factory default” parameters. Allow full access to the “last saved” parameters.

If id_offs is not equal to −1, use the part instance ID in the incoming event when invoking operations through the prp terminal. Otherwise, set the ID field in the outgoing property operation bus to zero.

Complete all incoming events and operations synchronously.

5.2 External States

None.

6. Use Cases

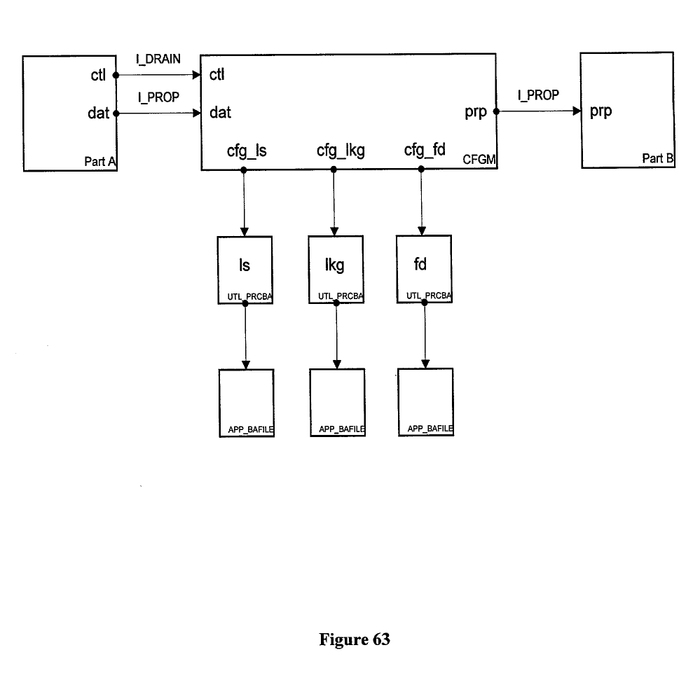

FIG. 63 illustrates an advantageous use of part, APP_CFGM

Part A controls the life-cycle and parameterization of Part B. Part A emits events to APP_CFGM to control the parameterization of part B.

The APP_BAFILEs are parameterized to load the three sets of configuration parameters (“last saved”, “last known good” and “factory defaults”) from a binary file.

The UTL_PRCBA's are used to represent the configuration parameters as properties over the binary files. UTL_PRCBA implements a property container using the binary files as storage.

In all of the following use cases, APP_CFGM is used using its default parameterization.

6.1 Saving and Restoring the Persistent State of Part B

This use case describes how APP_CFGM saves and restores the persistent state of a part connected to the prp terminal:

The system presented above is created, connected and activated. The property containers are initialized with the contents of the parameterized binary files.

After the system has been brought up, Part A sends an EV_CFG_REQ_DESERIALIZE event to APP_CFGM.

APP_CFGM enumerates all the properties through the cfg_ls terminal and for each one, retrieves the property value and sets the property through the prp terminal. The properties are set on Part B.

Next, Part A sends an EV_CFG_REQ_SAVE_LKG event to APP_CFGM (assuming the parameterization on Pat B was successful).

APP_CFGM enumerates all the properties through the cfg_ls terminal and for each one, retrieves the property value and sets the property through the cfg_lkg terminal. This operation creates a back-up copy of the “last saved” parameters.

At some later time after the system has been up and running for a while, Part A sends an EV_CFG_REQ_SERIALIZE event to APP_CFGM.

APP_CFGM enumerates all the persistent properties through the prp terminal and for each one, retrieves the property value and sets the property through the cfg_is terminal.

At some time later before all the parts are destroyed, the properties in the containers are saved back to the binary files.

6.2 Failure When Restoring the Persistent State of Part B From the “Last Saved” Configuration

This use case describes a situation where the restoration of the persistent state from the “last saved” configuration fails. Part A attempts to restore the state of the system using the “last known good” configuration parameters:

The system presented above is created, connected and activated. The property containers are initialized with the contents of the parameterized binary files.

After the system has been brought up, Part A sends an EV_CFG_REQ_DESERIALIZE event to APP CFGM.

APP_CFGM fails the request because the “last saved” configuration file is corrupt and it fails to enumerate the properties.

Part A sends an EV_CFG_REQ_USE_LKG event to APP_CFGM.

APP_CFGM enumerates all the properties through the cfg_lkg terminal and for each one, retrieves the property value and sets the property through the prp terminal. The property is set on Part B.

At some later time after the system has been up and running for a while, Part A sends an EV_CFG_REQ_SERIALIZE event to APP_CFGM.

APP_CFGM enumerates all the persistent properties through the prp terminal and for each one, retrieves the property value and sets the property through the cfg_ls terminal. The “last saved” configuration file is now restored.

At some time later before all the parts are destroyed, the properties in the containers are saved back to the binary files.

6.3 Failure When Restoring the Persistent State of Part B From the “Last Known Good” Configuration

This use case describes a situation where the restoration of the persistent state from the “last saved” and the “last known good” configuration fails. Part A attempts to restore the state of the system using the “factory default” configuration parameters:

The system presented above is created, connected and activated. The property containers are initialized with the contents of the parameterized binary files.

After the system has been brought up, Part A sends an EV_CFG_REQ_DESERIALIZE event to APP_CFGM.

APP_CFGM fails the request because the “last saved” configuration file is corrupt and it fails to enumerate the properties.

Part A sends an EV_CFG_REQ_USE_LKG event to APP_CFGM.

APP_CFGM fails the request because the “last known good” configuration file is corrupt and it fails to enumerate the properties.

Part A sends an EV_CFG_REQ_USE_FAC_DFLT event to APP_CFGM.

APP_CFGM enumerates all the properties through the cfg_fd terminal and for each one, retrieves the property value and sets the property through the prp terminal. The property is set on Part B.

At some later time after the system has been up and running for a while, Part A sends an EV_CFG_REQ_SERIALIZE event to APP_CFGM.

APP_CFGM enumerates all the persistent properties through the prp terminal and for each one, retrieves the property value and sets the property through the cfg_ls terminal.

At some time later before all the parts are destroyed, the properties in the containers are saved back to the binary files.

6.4 Restoring the “Last Saved” Configuration From the “Last Known Good” Configuration

This use case describes a situation where the “last saved” configuration is corrupt and needs to be restored from the “last known good” configuration. This is typically done before the system is reset so it can re-start normally using the recovered “last saved” configuration.

The system presented above is created, connected and activated. The property containers are initialized with the contents of the parameterized binary files.

After the system has been brought up, Part A sends an EV_CFG_REQ_DESERIALIZE event to APP_CFGM.

APP_CFGM enumerates all the properties through the cfg_ls terminal and for each one, retrieves the property value and sets the property through the prp terminal. The properties are set on Part B.

Next, Part A sends an EV_CFG_REQ_SAVE_LKG event to APP_CFGM (assuming the parameterization on Pat B was successful).

APP_CFGM enumerates all the properties through the cfg_ls terminal and for each one, retrieves the property value and sets the property through the cfg_lkg terminal. This operation creates a back-up copy of the “last saved” parameters.

At some time later, the “last saved” configuration becomes corrupt and needs to be restored from the “last known good” configuration before the next system re-start.

Triggered upon a user request or some other event, Part A sends an EV_CFG_REQ_RESTORE_LKG event to APP_CFGM.

APP_CFGM enumerates all the properties through the cfg_lkg terminal and for each one, retrieves the property value and sets the property through the cfg_ls terminal. This operation restores the “last saved” parameters from the “last known good” parameters.

At some point later, the system is reset.

After the system has been brought up, Part A sends an EV_CFG_REQ_DESERIALIZE event to APP_CFGM. The parameters from the “last saved” configuration are enumerated and set on Part B.

The system is successfully started using the restored “last saved” configuration.

6.5 Restoring the “Last Saved” Configuration From the “Factory Defaults” Configuration

This use case describes a situation where the “last saved” configuration is corrupt and needs to be restored from the “factory defaults” configuration. This is typically done before the system is reset so it can re-start normally using the recovered “last saved” configuration.

The system presented above is created, connected and activated. The property containers are initialized with the contents of the parameterized binary files.

After the system has been brought up, Part A sends an EV_CFG_REQ_DESERIALIZE event to APP_CFGM.

APP_CFGM enumerates all the properties through the cfg_ls terminal and for each one, retrieves the property value and sets the property through the prp terminal. The properties are set on Part B.

Next, Part A sends an EV_CFG_REQ_SAVE_LKG event to APP_CFGM (assuming the parameterization on Pat B was successful).

APP_CFGM enumerates all the properties through the cfg_ls terminal and for each one, retrieves the property value and sets the property through the cfg_lkg terminal. This operation creates a back-up copy of the “last saved” parameters.

At some time later, the “last saved” configuration becomes corn_pt and needs to be restored from the “factory defaults” configuration before the next system re-start.

Triggered upon a user request or some other event, Part A sends an EV_CFG_REQ_RESTORE_FAC_DFLT event to APP_CFGM.

APP_CFGM enumerates all the properties through the cfg_fd terminal and for each one, retrieves the property value and sets the property through the cfg_ls terminal. This operation restores the “last saved” parameters from the “factory defaults” parameters.

At some point later, the system is reset.

After the system has been brought up, Part A sends an EV_CFG_REQ_DESERIALIZE event to APP_CFGM. The parameters from the “last saved” configuration are enumerated and set on Part B.

The system is successfully started using the restored “last saved” configuration.

6.6 Accessing Individual Parameters of the Configurations Through the “dat” Terminal

This use case describes how to access individual configuration parameters through APP_CFGM:

The system above is created, connected and activated.

Part A generates an EV_CFG_REQ_DESERIALIZE event to APP_CFGM.

APP_CFGM enumerates all the properties through the cfg_ls terminal and for each one, retrieves the property value and sets the property through the prp terminal. The properties are set on Part B.

Part A sets a property of the “last saved” configuration parameters through the dat terminal by specifying an ID of 1 in the property operation bus.

APP_CFGM updates the specified property in the “last saved” configuration and returns (the property operation is forwarded through the cfg_ls terminal).

Part A gets a property of the “last known good” configuration parameters through the dat terminal by specifying an ID of 2 in the property operation bus.

APP_CFGM retrieves the specified property in the “last known good” configuration and returns (the property operation is forwarded through the cfg_lkg terminal).

Part A gets a property of the “factory default” configuration parameters through the dat terminal by specifying an ID of 3 in the property operation bus.

APP_CFGM retrieves the specified property in the “factory default” configuration and returns (the property operation is forwarded through the cfg_fd terminal).

7. Typical Usage

See the use cases described above.

8. Document References

None.

9. Unresolved Issues

None.

### APP_PARAM—Parameterizer on Property Container

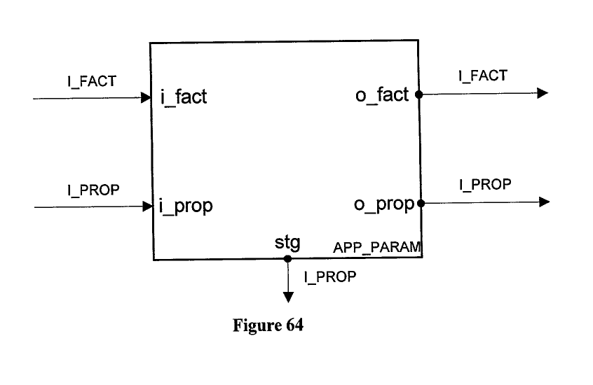

FIG. 64 illustrates the boundary of part, APP_PARAM

1. Functional Overview

APP_PARAM is a dynamic structure part that uses an external property container to deserialize and serialize properties to/from part instances contained within a part container such as ARR.

Deserialization of the properties from the property container connected to stg terminal is triggered when the property with a particular name is set through terminal i_prop.

Serialization of properties to the property container is triggered after the part instance has been successfully deactivated through the o_fact terminal.

All property operations received on the i_prop input are passed unchanged to o_prop. This allows APP_PARAM to be inserted between two parts connected through an I_PROP interface. APP_PARAM transparently passes all operations on its i_f act input to o_fact as well.

In order to provide instance specific parameterization, APP_PARAM uses the value set as a persistent property on the part instance assembly as a prefix to all operations sent out through stg terminal. All property requests are prefixed with the value of the persistent property name followed by a delimiter character.

The input terminals are guarded by a critical section. APP_PARAM does not leave the critical region when it calls out. It cannot be used at interrupt context.

2. Boundary

2.1 Terminals

| Name | Dir | Interface | Notes |
|---|---|---|---|
| i_prop | In | I_PROP | Input part property interface. All operations |
| | | | are passed transparently to o_prop terminal. |
| | | | When the property specified by |
| | | | persist_prop_name property is set, |
| | | | APP_PARAM enumerates all instance |
| | | | properties and sets them on the part instance. |
| o_prop | Out | I_PROP | All property operations received on i_prop |
| | | | input are passed transparently through this |
| | | | output. |
| i_fact | In | I_FACT | Input part-factory interface. All operations |
| | | | are passed transparently through o_fact |
| | | | output. |
| o_fact | Out | I_FACT | Calls received to i_fact are passed to this |
| | | | output. APP_PARAM assumes that the |
| | | | o_prop and o_fact terminals are |
| | | | connected to the same part container. |
| | | | This output may remain unconnected if |
| | | | i_fact input is not connected. |
| stg | Out | I_PROP | Property storage container connection |
| | | | terminal. |
| | | | APP_PARAM calls the storage container in |
| | | | order to enumerate, get or set different part |
| | | | instance properties. |

2.2 Properties

| Property name | Type | Notes |
|---|---|---|
| persist_prop_name | asciz | Name of an asciz property to monitor on |
| | | i_prop::set operations. |
| | | When this property is set, APP_PARAM |
| | | starts part instance parameterization. |
| | | The value of this property, appended with |
| | | a dot, is used as a name prefix on all set, |
| | | get and qry_open operations sent out |
| | | through stg terminal. |
| | | The default value is “persist_prop_name” |
| enforce_out_prop | uint32 | Boolean. If TRUE, property |
| | | deserialization is executed only when |
| | | o_prop::set operation on the property |
| | | specified by persist_prop_name is |
| | | successful. |
| | | Default value is TRUE. |
| serialize | uint32 | Boolean. If TRUE, serialize properties |
| | | when o_fact::deactivate is successfully |
| | | completed. |
| | | Default value is TRUE. |
| qry_string | asciz | Query string to use when |
| | | serializing/deserializing instance |
| | | properties. |
| | | Default value is “*” (serialize all |
| | | properties) |
| qry_attr | uint32 | Property attribute value to use when |
| | | performing query operation to |
| | | serialize/deserialize instance properties. |
| | | Default value is ZPRP_A_PERSIST. |
| | | (serialize persistent properties only) |
| qry_attr_mask | uint32 | Property attribute mask to be used when |
| | | performing query operation to |
| | | serialize/deserialize instance properties. |
| | | Default value is ZPRP_A_PERSIST. |
| | | (serialize persistent properties only) |

3. Events and Notifications

None.

3.1 Environmental Dependencies

None.

3.2 Encapsulated Interactions

None.

3.3 Other Environmental Dependencies

None.

4. Specification

4.1 Responsibilities

Pass all operation calls on the i_Prop terminal out through the o_prop terminal.

Pass all operation calls on the i_fact terminal out through the o_fact terminal.

When the trigger property is set, enumerate the specified container properties. For each property found, set the corresponding instance property.

When a property serialization is enabled and the part instance is deactivated, save the values of the specified instance properties in the property container.

Add an instance specific prefix (persistent name plus a dot) to all property get, property set and ‘query open’ operations set out through stg terminal.

4.2 External States

None

4.3 Use Cases

None.

5. Typical Usage

5.1 Property Parameterization and Serialization

When a part instance is created, it requires some parameterization in order to start its operation. Normally, the properties of the Dragon parts can be changed only when the part is not active, i.e., when the part is created but before it is activated. The following example demonstrates how APP_PARAM can be used to parameterize a part instance within Part Array container (ARR).

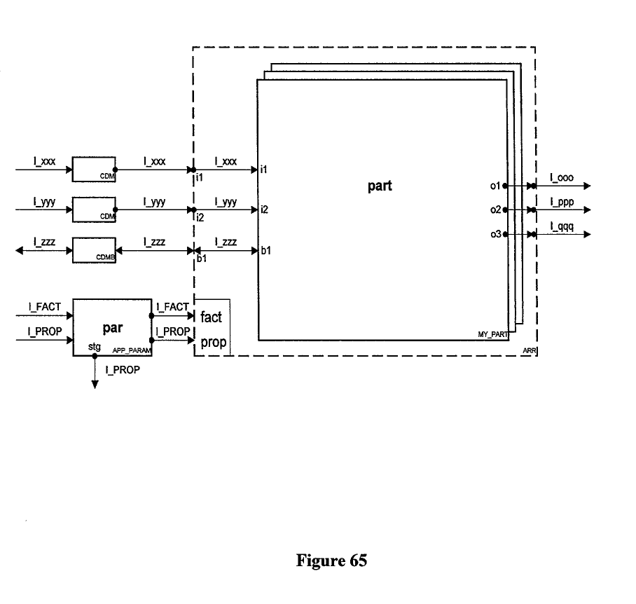

FIG. 65 illustrates Property Parameterization and Serialization

The property parameterizer (APP_PARAM) monitors the requests passing through its i_fact and i_prop terminal for property set request. When the monitored property is modified, APP_PARAM extracts all instance properties through its stg terminal and sets them to the part instance within the instance container (ARR). APP_PARAM uses qry_string property as a specific key to obtain only the properties related to the part instance being parameterized.

When the part instance is deactivated, through i_fact, APP_PARAM extracts all properties and store them in a property storage that is attached to its stg terminal.

6. Document References

None.

7. Unresolved Issues

None.

### APP—I/O Access

### APP_BAFILE—Byte Array on File

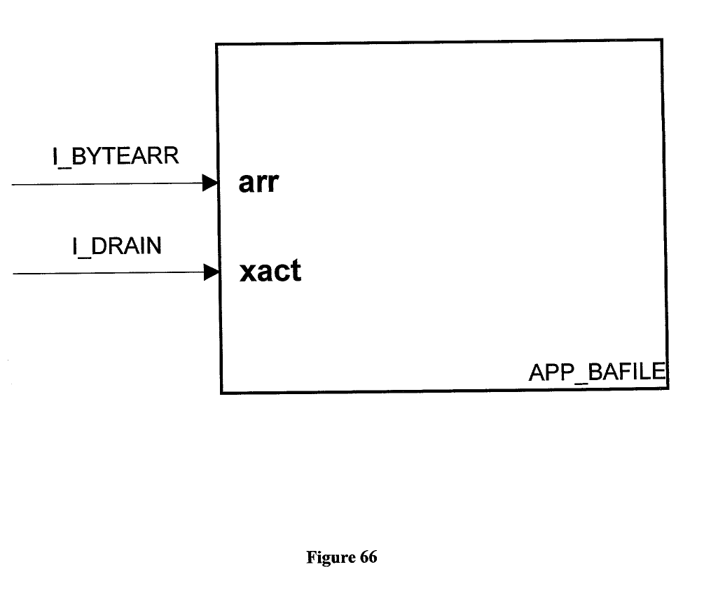

FIG. 66 illustrates the boundary of part, APP_BAFILE

1. Functional Overview

APP_BAFILE is a peripheral access part that implements a dynamic byte array over a standard binary file. A byte array can be used to store any type of data. APP_BAFILE's arr terminal is used to read and write data to and from the byte array.

APP_BAFILE implements a transactional-based byte array. Transactions over the byte array can be started, ended and canceled by sending parameterized events through the xact terminal.

After a transaction on the byte array has started, APP_BAFILE executes all read and write operations over a byte array stored in memory (RAM). Once the transaction has ended, APP_BAFILE commits the cached byte array stored in memory to the parameterized binary file. This mechanism provides fast manipulation of the byte array and reduces the number of accesses to the file media.

APP_BAFILE is typically used in assemblies to store small amounts of persistent data to a binary file on the user's system.

APP_BAFILE's terminals are guarded in order to prevent data corruption in the byte array. Therefore, APP_BAFILE cannot be used in interrupt contexts.

2. Boundary

2.1 Terminals

| Name | Dir | Interface | Notes |
|---|---|---|---|
| arr | in | I_BYTEARR | This terminal is used to access the byte array |
| | | | over the parameterized file. |
| xact | in | I_DRAIN | This terminal is used to begin, end and |
| | | | cancel transactions over the byte array. |

2.2 Properties

| Property name | Type | Notes |
|---|---|---|
| file_path | asciz | File name and path that APP_BAFILE uses to store the |
| | | byte array data. |
| | | This property is mandatory. |
| read_only | uint32 | Boolean. TRUE to enforce that only read operations are |
| | | allowed over the byte array. |
| | | The default value is FALSE. |
| write_only | uint32 | Boolean. TRUE to enforce that only write operations |
| | | are allowed over the byte array. |
| | | The default value is FALSE. |
| init_byte_array | uint32 | Boolean. TRUE to initialize the byte array cache on |
| | | activation with the contents of the specified file. |
| | | Otherwise the contents of the byte array cache are |
| | | initialized with zeros. |
| | | The default value is TRUE. |
| ev_xact_begin_id | uint32 | ID of the event used to begin transactions over the byte |
| | | array. |
| | | This property is mandatory. |
| ev_xact_end_id | uint32 | ID of the event used to end transactions over the byte |
| | | array. |
| | | This property is mandatory. |
| ev_xact_cancel_id | uint32 | ID of the event used to cancel transactions over the |
| | | byte array. |
| | | If EV_NULL, byte array transactions can not be |
| | | cancelled. |
| | | The default value is EV_NULL. |

3. Events and Notifications

3.1 Terminal: xact

| Event | Dir | Bus | Notes |
|---|---|---|---|
| (ev_xact_begin_id) | in | any | Begins a transaction over the byte array. |
| | | | All subsequent read and write operations are |
| | | | executed over the byte array cache until the |
| | | | transaction has ended. |
| (ev_xact_end_id) | in | any | Ends a transaction over the byte array. |
| | | | APP_BAFILE updates the specified file with the |
| | | | contents of the byte array cache. |
| (ev_xact_cancel_id) | in | any | Cancels all current byte array transactions. |
| | | | APP_BAFILE restores the contents of the byte |
| | | | array cache to the point before the current |
| | | | transactions had started. APP_BAFILE also ends |
| | | | all current transactions. |

4. Environmental Dependencies

4.1 Encapsulated Interactions

APP_BAFILE uses the ANSI standard file I/O functions for file access.

4.2 Other Environmental Dependencies

None.

5. Specification

5.1 Responsibilities

On activation, if the init_byte_array property is TRUE, initialize the contents of the byte array cache with the contents of the specified file.

If APP_BAFILE is parameterized for read only, fail all write operations.

If APP_BAFILE is parameterized for write only, fail all read operations.

Fail all read and write operations if the execution of the operation exceeds the boundary of the byte array.

Fail all write operations if no transaction has been started.

Once a transaction has been started, execute all read and write operations over the byte array memory cache. Do not interpret the byte array data.

A byte array transaction may be cancelled at any time. When a transaction is cancelled, restore the byte array cache to the state before the transaction had begun and end the current transaction.

When a transaction has ended, commit the contents of the byte array cache to the specified file.

Allow multiple transactions to be started at any time and implement the transaction begin, end and cancel functionality cumulatively. Commit the contents of the byte array to the specified file only when the last transaction has ended.

5.2 External States

None.

6. Use Cases

6.1 Transactional Operation

This use case describes the basic operation of APP_BAFILE:

1. APP_BAFILE is created, parameterized and activated.

2. Sending an ev_xact_begin_id event through the xact terminal starts a transaction.

3. Read and write operations are invoked on the byte array. APP_BAFILE modifies the contents of the byte array cache (not the actual file).

4. Sending an ev_xact_end_id event through the xact terminal ends the transaction.

5. APP_BAFILE commits the contents of the byte array cache to the specified file.

6. Steps 2-5 are executed many times until APP_BAFILE is deactivated and destroyed.

6.2 Canceling a Single Transaction

This use case describes the canceling of a single transaction over the byte array:

1. APP_BAFILE is created, parameterized and activated.

2. Sending an ev_xact_begin_id event through the xact terminal starts a transaction.

3. Read and write operations are invoked on the byte array. APP_BAFILE modifies the contents of the byte array cache (not the actual file).

4. The transaction is canceled by sending an ev_xact_cancel_id event through the xact terminal.

5. APP_BAFILE restores the contents of the byte array cache to the state before the transaction was started. The current transaction is ended.

6.3 Canceling Nested Transactions

This use case describes the canceling of nested transactions over the byte array:

1. APP_BAFILE is created, parameterized and activated.

2. Sending an ev_xact_begin_id event through the xact terminal starts a transaction.

3. Read and write operations are invoked on the byte array. APP_BAFILE modifies the contents of the byte array cache (not the actual file).

4. Sending an ev_xact_begin_id event through the xact terminal starts a new transaction.

5. Read and write operations are invoked on the byte array. APP_BAFILE modifies the contents of the byte array cache (not the actual file).

6. The current transactions are canceled by sending an ev_xact_cancel_id event through the xact terminal.

7. APP_BAFILE restores the contents of the byte array cache to the state before the first transaction was started. All current transactions are ended.

6.4 Maintaining Persistent State

APP_BAFILE can be used to maintain persistent state for an assembly or a system.

1. APP_BAFILE is created and parameterized. APP_BAFILE's init_byte_array property is set to TRUE. All other properties are parameterized as needed.

2. On activation, APP_BAFILE opens the specified file and loads the file's entire contents into the byte array cache.

3. A part connected to APP_BAFILE executes transactions over the byte array. When the last transaction has ended, APP_BAFILE updates the specified file with the contents of the byte array cache.

4. Step 3 is executed many times until APP_BAFILE is deactivated and destroyed.

6.5 Enforcing Byte Array Access

APP_BAFILE can be parameterized to prevent the execution of specific operations over the byte array.

1. APP_BAFILE is created and parameterized. APP_BAFILE's read_only property is set to TRUE. All other properties are parameterized as needed.

2. APP_BAFILE is activated.

3. A part connected to APP_BAFILE begins a transaction on the byte array. The part executes read operations over the byte array. If the part tries to write data into the byte array, APP_BAFILE fails the operation with CMST_REFUSE.

4. Step 3 is executed many times until APP_BAFILE is deactivated and destroyed.

7. Typical Usage

None.

7.1 Document References

None.

7.2 Unresolved Issues

None.

### APP—Debugging and Instrumentation

### APP_EFD—Event Field Dumper

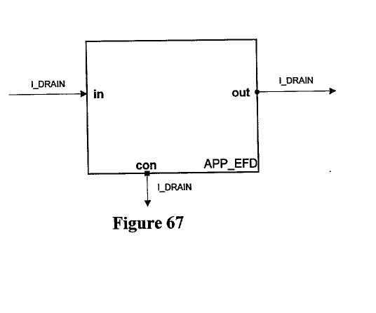

FIG. 67 illustrates the boundary of part, APP_EFD

1. Functional Overview

APP_EFD is a debugging and instrumentation part that can be used to dump the fields of a Dragon event. APP_EFD is used to trace the program execution through I_DRAIN part connections. It can be inserted between any two parts that have an I_DRAIN unidirectional connection.

When an operation is invoked on its in terminal, APP_EFD generates a printable output containing hexadecimal representations of the event ID, attributes, and completion status fields in the event. APP_EFD does not dump any other data contained in the event. APP_BSD can be used for this purpose.

The output is sent either to the debug console or to the con terminal as an EV_MESSAGE event (if the con terminal is connected). The operation is then forwarded to the out terminal. When the call returns, APP_EFD dumps the bus again. The dumping of the bus before and after the operation call can be selectively disabled through properties.

APP_EFD does not modify the operation bus.

The printable output has the following format:

<APP_EFD id>pre or post: id=<evt_id>, size=<evt_sz>, attr=<evt_attr>, stat=<evt_stat>

APP_EFD's output can be disabled through properties. When disabled, all operations are directly passed through out, allowing for selective tracing through a system.

Each APP_EFD instance is uniquely identified. The instance identification is included in the formatted output. This identification includes the APP_EFD unique instance id, recurse count of the operation invoked, and other useful information. This identification may also include the value of the name property (if specified).

APP_EFD is unguarded and may be used within interrupt context. APP_EFD does keep state as to how many times it has been reentered. If APP_EFD is used within an environment where it may be entered from multiple threads, an external guard should be provided.

2. Boundary

2.1 Terminals

| Name | Dir | Interface | Notes |
|---|---|---|---|
| in | in | I_DRAIN | All operations invoked through this terminal are passed |
| | | | through the out terminal. |
| | | | APP_EFD does not modify the bus passed with the |
| | | | operation. |
| out | out | I_DRAIN | All operations invoked on the in terminal are passed |
| | | | through this terminal. If this terminal is not connected, |
| | | | APP_EFD will return with ST_NOT_CONNECTED after |
| | | | dumping the bus information. |
| con | out | I_DRAIN | If connected, APP_EFD sends an EV_MESSAGE event |
| | | | containing the bus dump through this terminal. In this case |
| | | | no debug output is printed. |

2.2 Properties

| Property | | |
|---|---|---|
| name | Type | Notes |
| name | asciz | This is the instance name of APP_EFD. It is the first field of |
| | | the formatted output. If the name is “”, the instance name |
| | | printed is “APP_EFD”. |
| | | Default is “”. |
| enabled | uint32 | If TRUE APP_EFD will dump the call information to either |
| | | the debug console or as an EV_MESSAGE event sent through the |
| | | con terminal. |
| | | If FALSE, APP_EFD will not output anything. It passes the |
| | | operation call through the out terminal. |
| | | Default is TRUE. |
| dump_before | uint32 | If TRUE, APP_EFD dumps the event fields before passing the |
| | | call through the out terminal. |
| | | Default is FALSE. |
| dump_after | uint32 | If TRUE, APP_EFD dumps the event fields after passing the |
| | | call through the out terminal. Care should be taken when |
| | | using this option because the bus is typically not accessible |
| | | upon return (the event object may have been freed by the time |
| | | the call returns). |
| | | Default is FALSE. |

3.1 Terminal: con

| Event | Dir | Bus | Notes |
|---|---|---|---|
| EV_MESSAGE | out | B_EV_MSG | This event contains APP_EFD's formatted output. |
| | | | This allows the dump to be sent to mediums other |
| | | | than the debug console. |

4. Environmental Dependencies

None.

4.1 Encapsulated Interactions

None.

4.2 Other Environmental Dependencies

None.

5. Specification

5.1 Responsibilities

Dump the values of the event header fields (evt_id, evt_attr, and evt_stat) to an output medium when enabled.

Pass all operation calls on the in terminal out through the out terminal.

5.2 External States

None.

6. Use Cases

6.1 Behavior When Disabled

This use case describes APP_EFD's behavior when its enable property is FALSE.

APP_EFD is created and parameterized (enable property is FALSE)

APP_EFD receives a call on its in terminal.

APP_EFD forwards the call to its out terminal and returns the status from the call.

If the out terminal is not connected, APP_EFD returns ST_NOT_CONNECTED.

6.2 Behavior When Enabled and Con Terminal is Not Connected This use case describes APP_EFD's behavior when it is enabled and its con terminal is not connected.

APP_EFD has been created and the con terminal remains unconnected and the enable property is set to TRUE.

APP_EFD receives a call on its in terminal.

If the dump_before property is TRUE, APP_EFD formats an output string containing the event header fields and dumps the output to the debug console.

APP_EFD forwards the call to the out terminal.

If the dump_after property is TRUE, APP_EFD formats an output string containing the event header fields and dumps the output to the debug console.

APP_EFD returns the status from the call to the out terminal.

6.3 Behavior When Enabled and Con Terminal is Connected

This use case describes APP_EFD's behavior when it is enabled and its con terminal is connected.

APP_EFD has been created and the con terminal remains unconnected and the enable property is set to TRUE.

APP_EFD receives a call on its in terminal.

If the dump_before property is TRUE, APP_EFD formats an output string containing the event header fields, creates an EV_MESSAGE event containing the output string and sends the event out the con terminal.

APP_EFD forwards the call to the out terminal.

If the dump_after property is TRUE, APP_EFD formats an output string containing the event header fields, creates an EV_MESSAGE event containing the output string and sends the event out the con terminal.

APP_EFD returns the status from the call to the out terminal.

7. Typical Usage

7.1 Dumping Event Header Fields Only

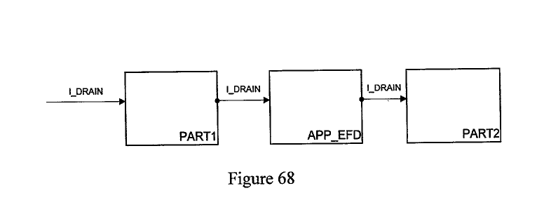

FIG. 68 illustrates an advantageous use of part, APP_EFD

This example illustrates the typical usage of APP_EFD to dump the event header fields on the debug console. PART1 creates an event and sends it to APP_EFD. APP_EFD displays the event header fields and then forwards the event to PART2. PART2 performs some processing and returns.

7.2 Dumping Entire Event Using Output Medium

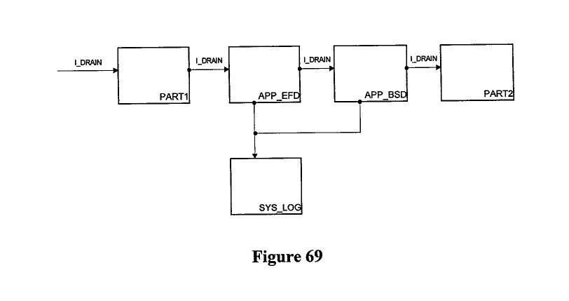

FIG. 69 illustrates an advantageous use of part, APP_EFD

This example illustrates the usage of APP_EFD used in conjunction with APP_BSD to dump the entire contents of the event to a log file. SYS_LOG is parameterized to auto-enable itself. PART1 creates an event and sends it to APP_EFD. APP_EFD creates an EV_MESSAGE event containing the output string and sends it out its con terminal to SYS_LOG. SYS_LOG writes the output string to a file. APP_EFD then forwards the event to APP_BSD creates an output string containing the remaining fields of the event bus, creates an EV_MESSAGE event containing that output string and sends it out its con terminal to SYS_LOG to be written to the file. APP_BSD then sends the event to PART2.

7.3 Document References

None.

7.4 Unresolved Issues

None.

### APP_HEX—Event Hex Dump

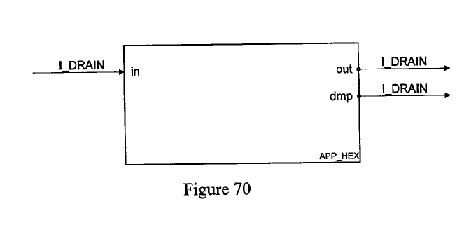

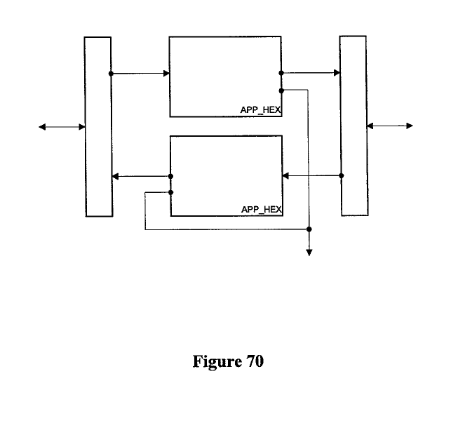

FIG. 70 illustrates the boundary of part, Event Hex Dump (APP_HEX)

1. Functional Overview

APP_HEX is a pass-through filter that generates a hex dump of part or all of the data in the events that pass through it. The hex dump is formatted as a printable string and placed in the data field of an event, which is sent to the dmp output.

The hex dump is formatted using programmable prefix and suffix strings.

The part has the option of allocating the events it sends to dmp as ‘self-owned’ so that the final recipient can free them.

2. Boundary

2.1 Terminals

| Name | Dir | Interface | Notes |
|---|---|---|---|
| in | in | I_DRAIN | All events coming to this terminal are forwarded to out. A hex |
| | | | dump of the event data is generated and sent to the dmp |
| | | | terminal. |
| out | out | I_DRAIN | Events from in are forwarded to this output with no |
| | | | modification. |
| dmp | out | I_DRAIN | Formatted hex dump is sent to this output in the form of events |
| | | | (the event ID is specified as a property). |

2.2 Properties

| Property | | |
|---|---|---|
| name | Type | Notes |
| prefix | asciz | Prefix string to append to formatted data. APP_HEX provides |
| | | no less than 40 characters of storage for this property. |
| | | Default value: “” (empty). |
| suffix | asciz | Suffix string to add to formatted data. |
| | | APP_HEX provides no less than 40 characters of storage for |
| | | this property. |
| | | Default value: “\n” (new line) |
| offs | uint32 | Byte offset into the event bus of the first byte to be dumped. |
| | | Default value: 0 |
| len | uint32 | Maximum number of bytes to dump. APP_HEX will output the |
| | | minimum of len and bp->sz-offs bytes. If this property is set to |
| | | zero, all bytes from offs to the end of the event data are output. |
| | | Default value: 0 |
| enable | uint32 | A non-zero value enables the generation of dump messages. A |
| | | zero value disables the dump messages, making APP_HEX a |
| | | no-functionality pass-through. |
| | | Default value: 1 (dump enabled). |
| dmp_first | uint32 | A non-zero value specifies that the hex dump is generated |
| | | before the incoming event is forwarded to out. |
| | | A zero value makes APP_HEX generate the dump after the |
| | | event is sent to out. WARNING: care should be taken when |
| | | using this option because the recipient frequently frees event |
| | | buses before the call returns. |
| | | Default value: 1 (dump before forwarding). |
| dmp_delay | uint32 | A non-zero value delays sending of the generated dump |
| | | message to after the incoming event is sent to out. Note that |
| | | this property has no effect when dmp_first is set to 0 (see |
| | | above). |
| | | dmp_delay does not change the data that would be output, just |
| | | the order of execution. This option can be used if it is |
| | | necessary to change the order in which events are recorded |
| | | when using multiple instances of APP_HEX or if it is |
| | | necessary to have the possible processing delay introduced by |
| | | parts connected to the dmp output to happen after the call |
| | | passes through APP_HEX. |
| | | Default value: 0. |
| dmp_id | uint32 | Defines the event ID to put in the id field of the event sent to |
| | | the dmp terminal. |
| | | Default value: EV_PULSE. |
| dmp_offs | uint32 | Offset into the event data where the hex dump is to be placed. |
| | | If the value of this property is greater than 0, APP_HEX fills |
| | | the space between the end of the event header and the |
| | | beginning of hex data with binary zeros. |
| | | Default value: 0 |
| attr | uint32 | Attributes to ‘or’ with the ‘attr’ field of the events sent to dmp. |
| | | APP_HEX does not interpret that value, except that if the value |
| | | of attr includes the SELF_OWNED bit, APP_HEX will not |
| | | free the bus that it allocates for the events if the call to dmp |
| | | returns ST_OK. |
| | | Default value: ZEVT_A_SELF_CONTAINED + |
| | | ZEVT_A_SELF_OWNED. |

3. Events and Notifications

APP_HEX sends events with formatted hex data to the dmp terminal. Depending on parameterization, it may expect the recipient to free the event bus (see Properties above).

3.1 Special Events, Frames, Commands or Verbs

None.

4. Encapsulated Interactions

None.

5. Specification

5.1 Responsibilities

Generate formatted hex dump of incoming or returned data and send it to dmp.

6. Theory of Operation

6.1 State Machine

APP_HEX has no state.

6.2 Main Data Structures

None.

6.3 Mechanisms

No special mechanisms are used in APP_HEX.

7. Use Cases

APP_HEX can be inserted anywhere in the path of unidirectional I_DRAIN connections.

APP_HEX can be combined with the standard library parts BSP and EFLT to produce assemblies for monitoring data on bidirectional I_DRAIN connection. Examples:

A. Monitoring requests and request completions on an asynchronous “client-server” connection:

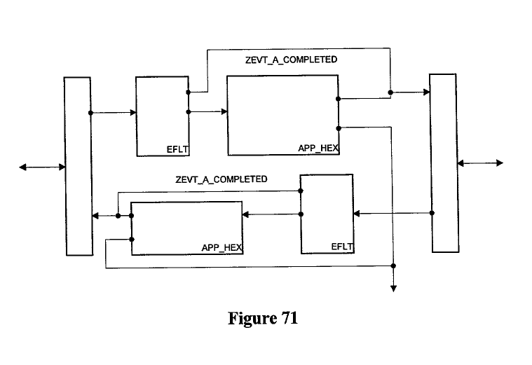

FIG. 71 illustrates an advantageous use of part, APP_HEX

B. Monitoring requests only on a symmetrical bidirectional connection. (Both the EFLT parts are programmed to filter the events with the ZEVT_A_COMPLETED attribute set, so that they bypass the two APP_HEX parts.

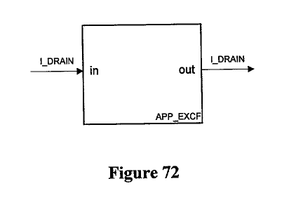

FIG. 72 illustrates an advantageous use of part, APP_HEX

### APP_EXCF—Exception Formatter

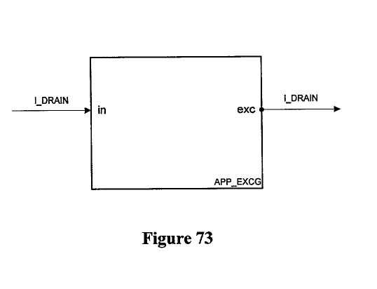

FIG. 73 illustrates the boundary of part, Exception Formatter (APP_EXCF)

1. Functional Overview

APP_EXCF accepts exception events (EV_EXCEPTION) on its in input and formats an exception message using the received data and a C ‘printf’ style format string. The formatted message is contained within one or more EV_MESSAGE event(s) that APP_EXCF generates out its out terminal.

APP_EXCF is parameterized with a set of format ID and format string pairs that it uses to format exception messages.

The format strings are used to format only the binary data from the exception event (the data field), all other fields are formatted using a pre-programmed format (described later in this document). APP_EXCF does not verify the validity of its format string properties in relation to the data it receives with the exception event, so care must be taken to ensure that the data passed with the event matches the specific format string arguments.

2. Boundary

2.1 Terminals

| Name | Dir | Interface | Notes |
|---|---|---|---|
| in | in | I_DRAIN | APP_EXCF formats the data coming with the EV_EXCEPTION |
| | | | events on its input and generates one or more EV_MESSAGE |
| | | | events out its out terminal. |
| out | ot | I_DRAIN | EV_MESSAGE events are sent out this terminal. They |
| | | | contain the formatted exception data. |

2.2 Properties

| Property name | Type | Notes |
|---|---|---|
| fmt[0].id. . . | uint32 | Exception IDs |
| fmt[15].id | | The default value is 0. |
| fmt[0].string | asciz | Format string to be used to format exception message |
| . . . | | with fmt[x].id. |
| fmt[15].string | | The syntax of this property is similar to the format string |
| | | of the C printf function. |
| | | The following formats are supported: % [l]d, % [l]u, % [l]x, |
| | | % s, and % c. |
| | | The default value is “”. |

| | | | |
|---|---|---|---|
| Event | Dir | Bus | Notes |

3.1 Terminal: in

| | | | |
|---|---|---|---|
| EV_EXCEPTION | in | B_EV_EXC | Exception event |

3.2 Terminal: out

| | | | |
|---|---|---|---|
| EV_MESSAGE | out | B_EV_MSG | This event contains a formatted exception |
| | | | message. The event that is generated is self- |
| | | | contained and is expected to be processed |
| | | | synchronously. |

3.3 Special Events, Frames, Commands or Verbs

None.

3.4 Encapsulated Interactions

None.

4. Specification

4.1 Responsibilities

Format data coming with EV_EXCEPTION events and generate EV_MESSAGE event(s) out the out terminal containing the formatted data.

4.2 Theory of Operation

4.2.1 State Machine

None.

4.2.2 Mechanisms

### Unpacking Exception Data

APP_EXCF unpacks the exception data in the following way:

| | |
|---|---|
| byte, word, char | → unpacked as words |
| dword, integer, and unsigned | → unpacked as dwords |
| integer | |
| asciz string | → pointer to first character in data |
| unicode string | → unpacked as an empty string (i.e., |
| | not supported) |
| binary data | → unpacked as specified number of |
| | dwords |

### Formatting Exception Messages

APP_EXCF searches its fmt[x].id properties for the exception id specified in the exception event. If the ID is found, it unpacks the data contained in the event and uses the fmt[x].string property along with the unpacked data as arguments to the vsprintf( ) function.

The formatted exception message contained in the EV_MESSAGE event that is generated by APP_EXCF has the following format:

File: <file_name>, Line: <line #>

formatted string from fmt[x].string and data fields received with the exception event

Class: <class_name>, Terminal: <term_name>, Operation: <oper_name>

<blank line>

If any of the fields is not specified in the exception message, it is not included. For example, if all fields in the exception message are blank except for the data, then APP_EXCF includes the following in the EV_MESSAGE event:

formatted string from fmt[x].string and data fields received with the exception event.

### <blank line>

### APP_EXCG—Exception Generator

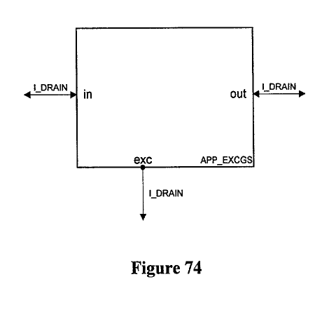

FIG. 74 illustrates the boundary of part, Exception Generator (APP_EXCG)

1. Functional Overview

APP_EXCG generates an exception event out its exc terminal when it receives a specific event on its in input. APP_EXCG is hard parameterized with the trigger event ID and exception event parameters.

APP_EXCG does not have the ability to validate the correctness of the exception ID or its data parameters.

2. Boundary

2.1 Terminals

| Name | Dir | Interface | Notes |
|---|---|---|---|
| in | in | I_DRAIN | Input for events that when received, APP_EXCG generates the |
| | | | exception event specified by its properties. |
| exc | out | I_DRAIN | Output for generated exception events. |

2.2 Properties

| Property name | Type | Notes |
|---|---|---|
| enable | uint32 | Boolean. When non-zero, APP_EXCG generates |
| | | exception events. When zero, APP_EXCG simply |
| | | returns a successful status. |
| | | This property is modifiable and the default is TRUE |
| | | (1). |
| trigger_ev | uint32 | Event ID on which to generate an exception. If this |
| | | property is NULL, APP_EXCG will generate an |
| | | exception on every event. |
| | | This property is modifiable and the default is EV_PULSE. |
| exc_id | uint32 | Exception ID to generate. If this property is 0, |
| | | APP_EXCG does not generate an exception. |
| | | This property is modifiable and the default value is 0. |
| severity | uint32 | Exception severity [ZERR_XXX] to be filled in exception |
| | | bus. |
| | | This property is modifiable and the default value is |
| | | ZERR_ERROR. |
| class_name | asciz | DriverMagic Class name of originator of exception. |
| | | This property is modifiable and the default value is |
| | | “APP_EXCG”. |
| file_name | asciz | Source file name of originator of exception. |
| | | This property is modifiable and the default value is |
| | | “APP_EXCG.C” |
| line | uint32 | Line number in file where exception occurred. |
| | | This property is modifiable and the default value is 0. |
| oid | uint32 | Object ID of part generating exception. |
| | | This property is modifiable and the default value is the |
| | | oid of APP_EXCG. |
| fmt_string | asciz | Format string to store in “format” field of B_EV_EXC |
| | | bus. The format string can contain up to 4 formats |
| | | where their data values are stored in APP_EXCG's |
| | | xxx_arg properties. APP_EXCG only supports one |
| | | value for each format. See E_STD.H for a description of |
| | | the different formats. |
| | | This property is modifiable and the default value is “”. |
| byte_arg | uchar | Data storage for the following types of formats: b, c. |
| | | This property is modifiable and the default value is 0. |
| word_arg | uint16 | Data storage for the following types of formats: w. |
| | | This property is modifiable and the default value is 0. |
| uint_arg | uint32 | Data storage for the following types of formats: d, i, u. |
| | | This property is modifiable and the default value is 0. |
| string_arg | asciz | Data storage for the following types of formats: s. |
| | | This property is modifiable and the default value is “”. |
| unicode_arg | unicodez | Data storage for the following types of formats: S. |
| | | This property is modifiable and the default value is “”. |

3.1 Events and notifications
3.1 Terminal: in

| Event | Dir | Bus | Notes |
|---|---|---|---|
| (trigger_ev) | in | void | APP_EXCG receives this event on its in terminal. In |
| | | | response, it generates an EV_EXCEPTION event out its exc |
| | | | terminal. |
| EV_EXCEPTION | out | B_EV_EXC | APP_EXCG sends this event out its exc terminal in |
| | | | response to receiving an event on its in terminal. |

3.3 Special Events, Frames, Commands or Verbs

None.

3.4 Encapsulated Interactions

None.

4.Specification

4.1 Responsibilities

If enabled and exc_id property is non-zero, generate an EV_EXCEPTION event out exc when (trigger_ev) event is received on in.

4.2 Theory of Operation

4.2.1 State Machine

None.

4.2.2 Mechanisms

### Initializing B_EV_EXC Bus

When APP_EXCG receives the (trigger_ev) event on its in terminal, it is enabled, and its exc_id property is non-zero, it allocates and initializes a B_EV_EXC bus to zero.

APP_EXCG then fills out the bus in the following way:

| | | |
|---|---|---|
| B_EV_EXC.exc_id | → | exo_id |
| B_EV_EXC.exc_severity | → | serverity |
| B_EV_EXC.class_name | → | class_name |
| B_EV_EXC.file_name | → | file_name |
| B_EV_EXC.line | → | line if not 0 otherwise_LINE_ |
| B_EV_EXC.oid | → | oid |
| B_EV_EXC.oid2 | → | self |
| B_EV_EXC.format | → | fmt_string |
| B_EV_ESC.data | → | formatted exception data |

The exception data is formatted in the following way: APP_EXCG uses the contents of the fmt_string properties and packs the data using the appropriate values of its xxx_arg properties.

### APP_EXCGS—Exception Generator on Status

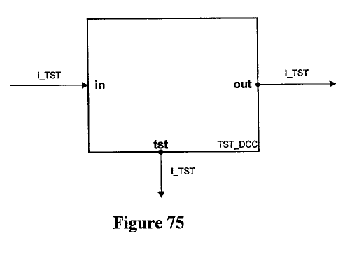

FIG. 75 illustrates the boundary of part, Exception Generator on Status (APP_EXCGS)

1. Functional Overview

APP_EXCGS is an exception generator that generates an exception when an outgoing operation completes with a specific status.

APP_EXCGS passes all events received on its input to its output. If the completion status for a monitored event (received on in terminal) is equal to a specific status, APP_EXCGS generates an exception event (EV_EXCEPTION) and sends it out its exc terminal. The monitored event may complete synchronously or asynchronously. The monitored event id(s) and completion status can be parameterized through properties.

APP_EXCGS provides the ability to generate detailed exception messages upon specific event completion. It can be used in any application that requires generation of different exception events depending on the event completion status.

Note: For asynchronously completed events, APP_EXCGS does not enforce the completion to correspond to any of the events passed through its out terminal.

2. Boundary

2.1 Terminals

| Name | Dir | Interface | Notes |
|---|---|---|---|
| in | bi | I_DRAIN | All events received on this terminal are forwarded through out |
| | | | terminal. If a monitored event completes with the specified |
| | | | status, an exception event will be submitted out through |
| | | | terminal. |
| out | bi | I_DRAIN | All events received on this terminal are forwarded through in |
| | | | terminal. |
| | | | If the completion of the monitored event has the specified |
| | | | completion statue, an exception event will be submitted out |
| | | | through exc terminal. |
| exc | out | I_DRAIN | Depending on the completion status of the monitored event(s), |
| | | | APP_EXCGS may generate an EV_MESSAGE event out through |
| | | | this terminal. |

2.2 Properties

| Property name | Type | Notes |
|---|---|---|
| trigger_ev | uint32 | ID of the monitored event. If EV_NULL, all events will |
| | | be monitored. |
| | | Default is EV_NULL. |
| trigger_stat | uint32 | Completion status that determines if APP_EXCGS should |
| | | generate a notification through its exc terminal. |
| | | Default is ST_OK. |
| enable | uint32 | Boolean. When non-zero APP_EXCGS generates |
| | | exception events. When zero, APP_EXCGS does not |
| | | generate any exceptions. |
| | | This property is modifiable and the default is TRUE (1). |
| exc_id | uint32 | Exception ID to generate. If this property is 0, |
| | | APP_EXCGS does not generate an exception. This ID has |
| | | to correspond to an actual exception message event from |
| | | the application/device exception messages DLL. |
| | | This property is modifiable and the default value is 0. |
| severity | uint32 | Exception severity [ZERR_XXX] to be filled in exception |
| | | bus. |
| | | This property is modifiable and the default value is |
| | | ZERR_ERROR. |
| class_name | asciz | Class name of originator of exception. |
| | | This property is modifiable and the default value is |
| | | “APP_EXCGS”. |
| file_name | asciz | Source file name of originator of exception. |
| | | This property is modifiable and the default value is |
| | | “APP_EXCGS.C” |
| line | uint32 | Line number in file where exception occurred. |
| | | This property is modifiable and the default value is 0. |
| oid | uint32 | Object ID of part generating exception. |
| | | This property is modifiable and the default value is the |
| | | oid of APP_EXCGS. |
| fmt_string | asciz | Format string to store in “format” field of B_EV_EXC bus. |
| | | The format string can contain up to 4 formats where their |
| | | data values are stored in APP_EXCGS's xxx_arg |
| | | properties. APP_EXCGS only supports one value for |
| | | each format. See CM_EVT.H for a description of the |
| | | different formats. |
| | | This property is modifiable and the default value is “”. |
| byte_arg | uchar | Data storage for the following types of formats: b, c. |
| | | This property is modifiable and the default value is 0. |
| word_arg | uint16 | Data storage for the following types of formats: w. |
| | | This property is modifiable and the default value is 0. |
| uint_arg | uint32 | Data storage for the following types of formats: d, i, u. |
| | | This property is modifiable and the default value is 0. |
| string_arg | asciz | Data storage for the following types of formats: s. |
| | | This property is modifiable and the default value is “”. |
| unicode_arg | unicodez | Data storage for the following types of fonnats: S. |
| | | This property is modifiable and the default value is L“”. |

3. Events and notifications
3.1 Terminal: in

| Event | Dir | Bus | Notes |
|---|---|---|---|
| (trigger_ev) | in | void | APP_EXCGS receives this event(s) on its in terminal. |
| | | | When the event completes with trigger_stat, |
| | | | APP_EXCGS generates an exception event through its |
| | | | exc terminal. |

3.2 Terminal: exc

| | | | |
|---|---|---|---|
| Event | Dir | Bus | Notes |
| EV_EXCEPTION | in | B_EV_EXCEPTION | This event is generated by APP_EXCGS when the |
| | | | completion status of the monitored event submitted |
| | | | through out is equal to trigger_stat. |

3.3 Special Events, Frames, Commands or Verbs

None.

3.4 Encapsulated Interactions

None.

4. Specification

4.1 Responsibilities

Monitor the events the events coming on in terminal and their completions coming on out terminal.

For the events which event ID is equal to trigger_ev (or all events if trigger_ev is EV_NULL) and completion status is equal to trigger_stat generate an exception event (EV_MESSAGE) through exc terminal.

When enable is equal to zero do not submit any events through exc terminal.

4.2 Theory of Operation

4.2.1 State Machine

None.

4.2.2 Mechanisms

### Generating Exceptions

On its in terminal, APP_EXCGS monitors the events that have their events ID equal to trigger_ev. If trigger_ev is s equal to EV_NULL, all events are monitored. Monitored events are forwarded through out terminal. When a monitored event completes with status equal to trigger_stat and if the enable property is TRUE, APP_EXCGS generates an exception message based upon its parameterization and submits it out through the exc terminal.

All non-monitored events are forwarded through out terminal without modification.

On its out terminal, APP_EXCGS monitors the completions of the events with ID equal to trigger_ev. If trigger_ev is s equal to EV_NULL, all completions are monitored. Monitored completions are forwarded through in terminal. If the completion status is equal to trigger_stat and the enable property is TRUE, APP_EXCGS creates an exception message, based upon its parameterization, and submits it out through the exc terminal.

Non-monitored events and events that do not have their ZEVT_A_COMPLETED attribute set are forwarded through in terminal without modification.

4.3 Use Cases

None.

### Test Framework

### TST_DCC—Daisy-chain Connector for Tests

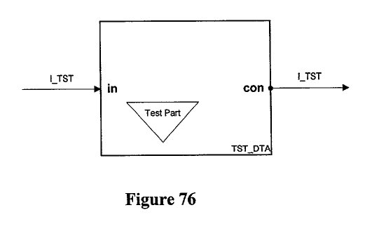

FIG. 76 illustrates the boundary of part, TST_DCC Component

1. Functional Overview

TST_DCC is a connector part for creating extendible test assemblies. It works in conjunction with the Test Menu Dispatcher (TST_TMD) to create hierarchical test menus that can be extended or modified by simply adding or replacing tester parts in the test assembly (see use case in the TST_TMD data sheet).

2. Boundary

2.1 Terminals

| | | | |
|---|---|---|---|
| Name | Dir | Interface | Notes |
| in | in | I_TST | Chain input. When called on this input TST_DCC decrements |
| | | | the chn_cnt field in the bus and if it is 0, passes the call to tst, |
| | | | otherwise it passes the call to out. Exception: on I_TST.run, if |
| | | | all=TRUE, call is passed to tst first, then to out, return status in |
| | | | this case is the status from tst if it is not OK, otherwise the |
| | | | status from out;(ST_NOT_CONNECTED from out is |
| | | | converted to ST_OK if all=TRUE). |
| out | out | I_TST | Chain output. Calls from in are passed to out if chn_cnt was |
| | | | not 1 on input or if all=TRUE (see in description). This output |
| | | | may be left unconnected. |
| tst | out | I_TST | Tester connection output. Calls from in are passed to tst if |
| | | | chn_cnt was 1 on input or if all=TRUE. |

2.2 Properties

none.

### TST_DTA—Dynamic Test Adapter

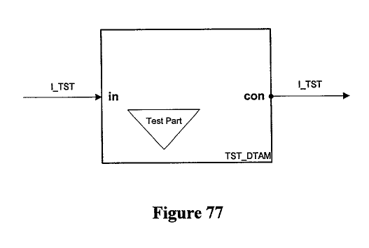

FIG. 77 illustrates the boundary of part, TST_DTA—Dynamic Test Adapter

1. Functional Overview

The dynamic test adapter (TST_DTA) can be used in place of a tester part in cases when the creation/destruction of the tester part is a part of the test or when the tester part should not be created until other tests have been executed.

TST_DTA has the boundary of a tester part and can be used as one in creating test assemblies with the test framework parts (see TST_DCC and TST_TMD).

2. Boundary

2.1 Terminals

| Name | Dir | Interface | Notes |
|---|---|---|---|
| in | in | I_TST | Command input. TST_DTA behaves like a tester part on this |
| | | | input (see the TST data sheet that describes a tester boundary). |
| | | | When called on I_TST.get_info it returns the data specified |
| | | | by its name and attr properties. |
| | | | When called on 'run', TST_DTA creates the tester part |
| | | | specified by its tst_cls property, binds to its terminals and |
| | | | passes the call on to that part. When the call returns it destroys |
| | | | the tester part. |
| con | out | UCON | Console I/O connection. This output should be connected to a |
| | | | part that provides console I/O services. |
| | | | TST_DTA redirects calls from the tester part's console output |
| | | | to this output. |

2.2 Properties

| Property name | Type | Notes |
|---|---|---|
| name | asciz | Menu title. This string is returned by TST_TMD) when |
| | (80 | ′get_info′ is invoked on the in terminal. |
| | max) | Mandatory. |
| attr | uint32 | Attributes to return on ′get_info′. This should be either 0 or |
| | | TST_A_IS_MANUAL if the tests connected to the out |
| | | terminal should be executed only in manual mode. |
| | | Default value: 0. |
| tst_cls | asciz | Class name of the tester part to create. This should specify |
| | (128 | the class name of a part that conforms to the boundary |
| | max) | definition of a tester part (see TST data sheet). TST_DTA |
| | | will not provide any properties to the tester part. If the tester |
| | | part requires parameterization, create an assembly that |
| | | contains the tester part & parameterization for it, then |
| | | specify that assembly's name as the value of this property. |
| | | This property is mandatory. |
| tst_in | asciz | Terminal name of the tester part's command input. |
| | (64 | Default value: “in” |
| | max) | |
| tst_con | asciz | Terminal name of the tester part's console I/O output. |
| | (64 | Default value: “con” |
| | max) | |
| create_s | uint32 | Expected return status from I_FACT.cm_create. If this is not |
| | | OK, TST_DTA will not attempt to activate or call the tester |
| | | part at all, instead it will expect the part creation to fail with |
| | | the specified status. |
| | | Default value: ST_OK |
| destroy_s | uint32 | Expected return status from I_P_FACT.cm_destroy. The |
| | | test is considered as ′failed′ if the status does not match, even |
| | | if the tester part returned OK on the I_TST.run call. |
| | | Default value: ST_OK |
| activate_s | uint32 | Expected return status from I_CTRL.cm_activate. If this is |
| | | not OK, TST_DTA will not attempt to call the tester part at |
| | | all, instead it will expect the activation to fail with the |
| | | specified status. |
| | | Default value: ST_OK |
| deactivate_s | uint32 | Expected return status from I_CTRL.cm_deactivate. The test |
| | | is considered as ′failed′ if the status does not match, even if |
| | | the tester part returned OK on the I_TST.run call. |
| | | Default value: ST_OK |

3. Use Cases

Use the TST_DTA in place of a tester part by placing an instance of TST_DTA where the tester part should be and parameterizing TST DTA to create the tester part itself. This provides the following benefits as opposed to creating the tester as part of the test assembly:

the tester part creation failure is properly reported as a failure of the test itself

the failure to create the tester does not prevent other tests in the assembly from running

the failure of the tester is expected and is the normal conclusion of the test

status from tester's destructor is verified

### TST_DTAM—Dynamic Test Adapter for Multiple Tests

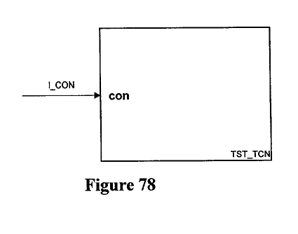

FIG. 78 illustrates the boundary of part, TST_DTAM—Dynamic Test Adapter for Multiple Tests

1. Functional Overview

The dynamic test adapter for multiple tests (TST_DTAM) can be used in place of a tester part in cases when the creation/destruction of the tester part is a part of the test, when the tester part should not be created until other tests have been executed or when multiple tests of a tester part need to be executed. This allows the tester part to be tested in different configurations (the configurations are kept in a descriptor which is specified through a property on TST_DTAM).

TST_DTAM has the boundary of a tester part and can be used as one in creating test assemblies with the test framework parts (see TST_DCC and TST_TMD).

2. Boundary

2.1 Terminals

| Name | Dir | Interface | Notes |
|---|---|---|---|
| in | in | I_TST | Command input. TST_DTAM behaves like a tester part on this |
| | | | input (see the TST data sheet that describes a tester boundary). |
| | | | When called on I_TST.get_info, it returns the data specified |
| | | | by its name and attr properties. |
| | | | When called on ′run′, TST_DTAM enumerates a descriptor |
| | | | and for each instance parameterization set, creates the tester |
| | | | part specified by its tst_cls property. For each instance, |
| | | | TST_DTAM binds to its terminals, parameterizes the part |
| | | | according to the descriptor and passes the ′run′ call on to that |
| | | | part. When the call returns it destroys the tester part. |
| Con | out | I_CON | Console I/O connection. This output should be connected to a |
| | | | part that provides console I/O services. |
| | | | TST_DTAM redirects calls from the tester part's console |
| | | | output to this output. |

2.2 Properties

| Property name | Type | Notes |
|---|---|---|
| name | asciz | Menu title. This string is returned by TST_DTAM |
| | (80 max) | when ′get_info′ is invoked on the in terminal. |
| | | Mandatory. |
| attr | uint32 | Attributes to return on ′get info′. This should be either |
| | | 0 or TST_A_IS_MANUAL if the tests connected to the |
| | | out terminal should be executed only in manual mode. |
| | | Default value: 0. |
| tst_cls | asciz | Class name of the tester part to create. This should |
| | (128 max) | specify the class name of a part that conforms to the |
| | | boundary definition of a tester part (see TST data |
| | | sheet). TST_DTAM will parameterize the part |
| | | according to descriptor. |
| | | This property is mandatory. |
| tst_in | asciz | Terminal name of the tester part's command input. |
| | (64 max) | Default value: “in” |
| tst_con | asciz | Terminal name of the tester part's console I/O output. |
| | (64 max) | Default value: “con” |
| descp | uint32 | Pointer to the parameterization descriptor. Must be a |
| | | valid pointer. |
| | | See below for the definition of the descriptor. |
| | | Mandatory. |

3. Parameterization Descriptor

The parameterization descriptor is used to define the number of tester part instances that TST_DTAM should create along with their parameterization and expected return code for activation operations.

The descriptor is an array of DTAM_ENTRY structures defined as follows:

typedef struct DTAM_ENTRYtag

| { | | | |
|---|---|---|---|
| uint32 | et_type | ; | // entry type, [DTAM_ET_xxx] |
| char | *namep | ; | // property name or scenario title |
| uint32 | type | ; | // property type, [ZPRP_T_xxx] |
| uint32 | value | ; | // either property value to set or expected return |
| | | | // status for instance activation operations |

} DTAM_ENTRY;

The possible entry types are as follows:

| Entry Type | Description |
|---|---|
| DTAM_ET_SCEN | Defines the beginning of a scenario for an instance of the tester |
| | part. |
| DTAM_ET_PROP | Property to set on the tester part instance. If the set operation |
| | fails, the test is considered as ′failed′. |
| DTAM_ET_ACT | Expected return status from I_CTRL.cm_activate. If this is not |
| | OK, TST_DTAM will not attempt to call the tester part at all, |
| | instead it will expect the activation to fail with the specified |
| | status. |
| DTAM_ET_END | Marks the end of the descriptor. This must always appear in the |
| | last entry in the descriptor. |

Below is a list of macros used to define the descriptor:

| Macro | Description |
|---|---|
| dtam_begin (name) | Begin the descriptor definition. The name |
| | parameter defines the name of the descriptor. |
| dtam_end | End the descriptor definition. |
| dtam_scenario (title) | Start a new scenario for the tester part. The |
| | title parameter is a string that is displayed |
| | on the console before the test is ran. |
| dtam_propX (name, type, | Define a property to be set on the part |
| value) | instance. |
| dtam_prop (name, value) | Define a property to be set on the part |
| | instance. Property type none |
| | (ZPRP_T_NONE) is assumed. |
| dtam_act_stat (stat) | Define the expected part activation return |
| | status. If this is not used in a scenario the |
| | expected return status for activation is |
| | ST_OK. |

After defining the descriptor, it should be parameterized as the descp property on a TST_DTAM instance

Here is an example of a descriptor defining the parameterization for two instances of the same tester part. The first instance passes the activation life-cycle operation OK but the second instance failed activation because a mandatory property is not set.

dtam_begin (mydesc)

// instance #1

| | |
|---|---|
| dtam_scenario | (“Pass”) |
| dtam_propX | (“prop1”, ZPRP_T_UINT32, 32) |
| dtam_propX | (“prop2”, ZPRP_T_ASCIZ , “Hello”) |

// instance #2

| | |
|---|---|
| dtam_scenario | (“Fail activation: mandatory property is not set”) |
| dtam_propX | (“prop1”, ZPRP_T_UINT32, 32) |
| dtam_act_stat | (ST_REFUSE) // prop2 is not set |

dtam_end

4. Use Cases

Use the TST_DTAM in place of a tester part by placing an instance of TST_DTAM where the tester part should be and parameterizing TST_DTAM to create the tester part itself. This provides the following benefits as opposed to creating the tester as part of the test assembly:

multiple instances of the tester part can be created and parameterized in different ways as defined by descriptor

the tester part creation failure is properly reported as a failure of the test itself

the failure to create the tester does not prevent other tests in the assembly from running

the failure of the tester is expected and is the normal conclusion of the test

status from tester's destructor is verified

### TST_TCN—Test Console I/O

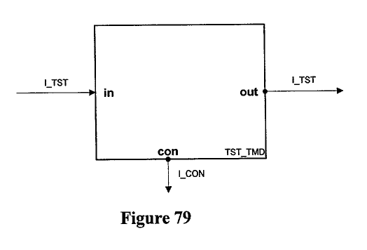

FIG. 79 illustrates the boundary of part, TST_TCN—Test Console I/O

5. Functional Overview

The test console implements the I_CON interface. It can be used to build tests or in any other case where a system with console I/O functionality has to be built entirely out of parts connected with the standard Dragon terminal connection mechanisms.

A single instance of TST_TCN can serve any number of clients.

This part is system-specific. The actual physical implementation of the console is not defined here; it could be a serial I/O channel, a built-in text console, a window in a GUI environment or any other console-like device.

Note: in some implementations, TST_TCN may be restricted to a single instance. To avoid compatibility problems, always build test systems with a single TST_TCN instance and connect all parts that require console I/O to that instance.

6. Boundary

6.1 Terminals

| Name | Dir | Interface | Notes |
|---|---|---|---|
| con | in | I_CON | Accept console I/O requests. This terminal will accept any |
| | | | number of connections. In a multi-threaded environment, the |
| | | | calls from different threads will be serialized. |

6.2 Properties

| Name | Type | Notes |
|---|---|---|
| dev_name | asciz | Device name to use as a console device. On some implementations, |
| | | this property may be ignored (e.g., if there is only one device that |
| | | could possibly be a console device). |
| | | Default value: system-specific; The implementation will always |
| | | provide a default value that represents a valid console I/O device. |

### TST_TMD—Test Menu Dispatcher

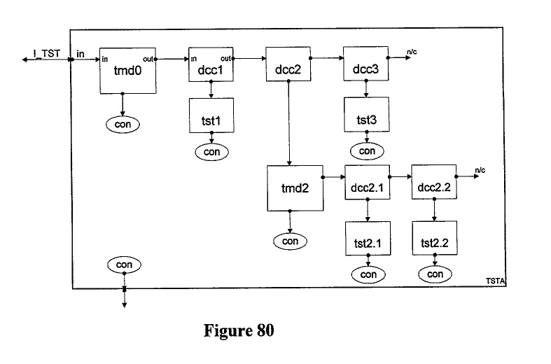

FIG. 80 illustrates the boundary of part, TST_TMD

7. Functional Overview

TST_TMD is a generic menu for use in creating tests and other similar text-based menu-driven systems.

This part works together with the daisy-chain connector (TST_DCC) to allow extendible and modifiable networks of tests to be created by using multiple instances of TST_TMD and TST_DCC in a Z-force assembly (see use case).

The menu displayed by TST_TMD is generated by collecting information from the chain of tester parts connected to the out terminal (which may include other TST_TMD parts as sub-menus). TST_TMD supports a chain of up to 35 tester parts (limitation imposed to simplify menu selection keys, which are 1..9, A..Z). TST_TMD also adds “run all” and “exit” items to the menu; a sample result looks as follows:

Title (as specified by the ‘name’ property)

1. <test1 name> (obtained by calling out on get_info)

2. <test2 name>

. . .

*.Run All

0. Exit

Select (<esc> to exit, <sp>—re-display menu):

8. Boundary

8.1 Terminals

| Name | Dir | Type | Notes |
|---|---|---|---|
| in | in | I_TST | Command input. TST_TMD behaves like a tester part on this |
| | | | input (see the TST data sheet that describes a tester boundary). |
| | | | When called on I_TST.get_info, it returns the data specified by |
| | | | its name and attr properties. |
| | | | When called on I_TST.run with all=FALSE, it enumerates and |
| | | | displays the chained tests connected to its output (out), displays |
| | | | a menu and runs the test(s) selected by the operator. |
| | | | When called on I_TST.run with all=TRUE, it enumarates and |
| | | | executes all chained tests connected to out , possibly skipping |
| | | | tests that are manual-only (if TST_A_MANUAL is not |
| | | | specified in the attr field). |
| out | out | I_TST | Test output. This output should be connected to a chain of one or |
| | | | more DCC parts (see use case). TST_TMD calls this output on |
| | | | I_TST.get_info to collect information about the chained tests |
| | | | connected to the DCC parts when displaying the menu. |
| | | | TST_TMD executes I_TST.run when the operator selects a |
| | | | menu item. |
| con | out | I_CON | Console I/O connection. This output should be connected to a |
| | | | part that provides console I/O services. TST_TMD uses this |
| | | | output to display the test menu and to request operator input. |

8.2 Properties

| Property name | Type | Notes |
|---|---|---|
| name | asciz | Menu title. This string is returned by TST_TMD when |
| | (80 max) | ′get_info′ is invoked on the in terminal. |
| | | Mandatory. |
| attr | uint32 | Attributes to return on ′get_info′. This should be either 0 |
| | | or TST_A_IS_MANUAL if the tests connected to the out |
| | | terminal should be executed only in manual mode. |
| | | Default = 0. |
| quiet_on_all | uchar | Set to TRUE to make TST_TMD set the A_QUIET bit |
| | | when operator selects “run all”. Default = FALSE. |
| force_all | uchar | Setting this to TRUE disables the menu and makes |
| | | TST_TMD convert each call to in.run to out.run with the |
| | | all field set to TRUE. This effectively makes the instance |
| | | of TST_TMD appear as a single test that aggregates all |
| | | tests chained to its out terminal. |
| | | Default=FALSE. |

9. Use Cases

This example shows how to assemble a test system that has a total of four tests, organized as a menu with three items (2 tests and 1 sub-menu with 2 more tests). Note that typically if a test is a sub-menu it will be made as an assembly and not directly connected as shown here with the dcc2/tmd2/dcc 2.1/dcc2.2 branch.

All that has to be done to add new tests to the menu is to connect a new instance of DCC to the end of the chain and attach the new tester part to it.

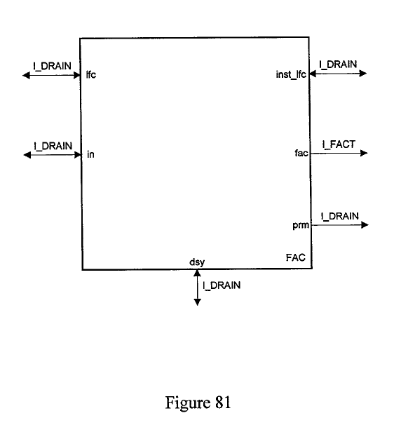

FIG. 81 illustrates an advantageous use of part, TST_TMD and TST_DCC

### FAC—The Factory

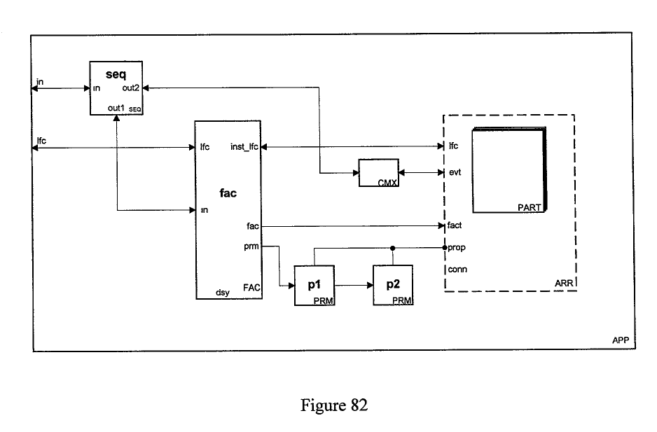

FIG. 82 illustrates the boundary of part, FAC—Factory

1. Functional Overview

FAC is a dynamic structure part that is compliant with the XDL creation pattern meaning that the lifecycle of a part is as follows:

create→parameterize→activate→lifecycle start→normal operation→lifecycle stop→deactivate→destroy

FAC provides the ability to dynamically create, destroy and provide lifecycle to part instances based on an event flow.

FAC generates and sequences part factory operations and lifecycle events out its fac and inst_lfc terminals when certain events (e.g., “create” and “destroy”) are received on its in terminal. In addition, FAC sends the “create” event out its prm terminal between the creation and activation of the part instance so that others may have the opportunity to parameterize the part; the event will contain the part instance ID of the newly created part.

Lifecycle events sent out the inst_lfc terminal contain the part's instance ID and will have the same attributes as the pending create or lifecycle event. FAC supports asynchronous completion of all lifecycle events.

FAC desynchronizes lifecycle completion events received on its inst_lfc terminal that would result in the deactivation and destruction of the part instance. This mechanism is used to prevent FAC from destroying a part while it is within the context of a call. It is the responsibility of the recipient of the event to allow enough time for the path of execution to unwind before giving the event back to FAC.

In addition to factory create and destroy events, FAC accepts part enumeration events on its in terminal (i.e., get_first and get_next). FAC simply converts these events into the corresponding I_FACT operation out its fac terminal.

FAC will refuse to accept any events on its in terminal before it has received a lifecycle start event on its lfc terminal. When a lifecycle stop event is received on the lfc terminal, FAC enumerates the part instances out its fac terminal and for each instance: generates a lifecycle stop event out its inst_lfc terminal and deactivates and destroys the instance when the stop event completes.

All event IDs as well as offsets into the events used to extract and store instance IDs and enumeration contexts are provided as properties.

FAC may be used at interrupt level although it is not recommended because creating and destroying parts at interrupt level may lead to unpredictable results.

1. Boundary

1.1 Terminals

| Name | Dir | Interface | Notes |
|---|---|---|---|
| lfc | Bidir | I_DRAIN | Input for lifecycle events. FAC will refuse |
| | | | to create any parts before it receives a |
| | | | lifecycle start event. |
| | | | FAC destroys all remaining parts when it |
| | | | receives a lifecycle stop event. |
| in | Bidir | I_DRAIN | Input for factory create, destroy and |
| | | | enumeration events. |
| | | | No self-owned events are allowed on this |
| | | | terminal. |
| inst_lfc | Bidir | I_DRAIN | Output for part instance lifecycle events. |
| | | | FAC generates a start event after a part |
| | | | instance has been created, parameterized, |
| | | | and activated. |
| | | | FAC generates a stop event just prior to |
| | | | deactivating and destroying a part |
| | | | instance. The events have the part instance |
| | | | ID stamped at offset 0 and have identical |
| | | | attributes to create or destroy event that |
| | | | was received on the in terminal. |
| fac | Out | I_FACT | Output for part instance factory |
| | | | operations. FAC uses this terminal to |
| | | | create/destroy part instances. |
| prm | Out | I_DRAIN | FAC sends the create event (w/modified |
| | | | attributes) out this terminal just prior to |
| | | | activating the part instance. |
| | | | The event will have the part instance ID |
| | | | stamped into the event at the specified |
| | | | offset. |
| | | | A failed return status will result in FAC |
| | | | destroying the part instance and failing the |
| | | | pending create event. |
| | | | This terminal may remain unconnected. |
| dsy | Bidir | I_DRAIN | Floating terminal used to desynchronize |
| | | | the deactivation and destruction of a part |
| | | | instance resulting from the asynchronous |
| | | | completion of a lifecycle event. |
| | | | if this terminal is not connected, FAC only |
| | | | generates synchronous events out its |
| | | | inst_lfc terminal |

1.2 Properties

| Property name | Type | Notes |
|---|---|---|
| create_ev | uint32 | Specifies the ID of the event received on the in |
| | | terminal that signals the creation, parameterization, |
| | | activation, and lifecycle starting of a part instance out |
| | | FAC's fac and inst_lfc terminals. |
| | | This property is mandatory |
| destroy_ev | uint32 | Specifies the ID of the event received on the in |
| | | terminal that signals the lifecycle stopping, |
| | | deactivation, and destruction of a part instance out |
| | | FAC's inst_lfc and fac terminals. |
| | | This property is mandatory. |
| get_first_ev | uint32 | Specifies the ID of the event received on the in |
| | | terminal that is translated into an I_FACT.get_first |
| | | operation out the fac terminal. |
| | | If the value is EV_NULL, no event is specified. |
| | | The default is EV_NULL. |
| get_next_ev | uint32 | Specifies the ID of the event received on the in |
| | | terminal that is translated into an I_FACT.get_next |
| | | operation out the fac terminal. |
| | | If the value is EV_NULL, no event is specified. |
| | | The default is EV_NULL. |
| use_id | uint32 | Boolean. If TRUE, use the value stored at id_offs as the |
| | | instance ID. If FALSE, the instance ID is generated by |
| | | the creator of the part out the fac terminal. |
| | | This property is used only when processing the create |
| | | event. |
| | | the default is FALSE. |
| id_offs | uint32 | Specifies the offset in the event bus where the part |
| | | instance id resides. FAC assumes that the part |
| | | instance ID as a 32-bit self-contained value. |
| | | The default is 0. |
| class_name.offs | uint32 | Specifies the offset in the event bus where the zero- |
| | | terminated class name of the part instance to be |
| | | created is stored. |
| | | If the value is −1, FAC will not specify a class name in |
| | | the I_FACT.create operation bus. |
| | | This property is used only when processing the create |
| | | event. |
| | | The default is −1. |
| class_name.by_ref | uint32 | Boolean. If TRUE, the field at class_name.offs is a |
| | | 32-bit pointer. If FALSE, the class name is contained |
| | | within the event. |
| | | This property is used only when processing the create |
| | | event. |
| | | The default is FALSE. |
| enum_ctx_offs | uint32 | Specifies the offset in the event bus where to store the |
| | | enumeration context. If the value is −1, don't use. |
| | | This property is only used if the get_first_ev and/or |
| | | get_next_ev properties are not EV_NULL. |
| | | Note that the context storage must be at lease sizeeof |
| | | (_ctx) big. |
| | | The default is −1. |

1.3 Events and Notifications

| | | | |
|---|---|---|---|
| Event | Dir | Bus | Notes |

1.4 Terminal: lfc

| | | | |
|---|---|---|---|
| EV_LFC_REQ_START | In | void | Start normal operation. FAC will refuse all |
| | | | events on its in terminal prior to the |
| | | | receipt of this event. |
| EV_LFC_REQ_STOP | In | void | Stop normal operation. FAC enumerates, |
| | | | lifecycle stops, deactivates and destroys all |
| | | | existing part instances out its inst_lfc |
| | | | and fac terminals. |
| | | | This event should be asynchronously |
| | | | completable. |

1.5 Terminal: in

| | | | |
|---|---|---|---|
| (create_ev) | In | void | When this event is received, FAC creates a |
| | | | part instance, forwards the event out the |
| | | | prm terminal, activates it, and feeds it a |
| | | | lifecycle start event. |
| | | | This event should have whatever attributes |
| | | | that are required for the generated lifecycle |
| | | | start event |
| (destroy_ev) | In | void | When this event is received, FAC |
| | | | generates a lifecycle stop event to the |
| | | | specified instance and deactivates and |
| | | | destroys the part instance. |
| | | | This event should have whatever attributes |
| | | | that are required for the generated lifecycle |
| | | | stop event |

1.6 Terminal: inst_lfc

| | | | |
|---|---|---|---|
| EV_LFC_REQ_START | Out | 4 bytes | FAC sends this event to a newly created |
| | | | instance after it has activated the instance |
| | | | and before completing the “create” event it |
| | | | received on its in terminal. |
| | | | This event contains the part instance ID |
| | | | stored at offset 0 and has attributes |
| | | | identical to those of the create event |
| | | | received on the in terminal. |
| EV LFC_REQ_STOP | Out | 4 bytes | FAC sends this event just prior to |
| | | | deactivating and destroying a part instance. |
| | | | This event contains the part instance ID |
| | | | stored at offset 0 and has attributes |
| | | | identical to those of the destroy event |
| | | | received on the in terminal or the lifecycle |
| | | | stop event received on FAC's lfc terminal. |

1.7 Terminal: prm

| | | | |
|---|---|---|---|
| (create_ev) | Out | void | This event is identical to the create event |
| | | | received on the in terminal except that is |
| | | | synchronous and contains the just-created |
| | | | part's instance ID stamped at id_offs |

1.8 Terminal: dsy

| | | | |
|---|---|---|---|
| EV_LFC_REQ_START | Bidir | void | This event is sent when the lifecycle start |
| | | | event sent to a part instance completes |
| | | | asynchronously with a failed status. |
| | | | When FAC receives this event, it |
| | | | deactivates and destroys the part instance |
| | | | and completes the pending create operation |
| | | | with the failed status. |
| EV_LFC_REQ_STOP | Bidir | void | This event is sent when the lifecycle stop |
| | | | event sent to a part instance completes |
| | | | asynchronously with a successful status. |
| | | | When FAC receives this event, it |
| | | | deactivates and destroys the part instance |
| | | | and successfully completes the pending |
| | | | destroy operation. |

2. Environmental Dependencies

3. Encapsulated Interactions

None.

4. Other Environmental Dependencies

None.

### Specification

1. Responsibilities

Create, activate, and provide lifecycle start to a part instance out the fac and inst_lfc terminals when create_ev is received on the in terminal.

Provide lifecycle stop to, deactivate and destroy a part instance out the inst_lfc and fac terminals when destroy_ev is received on the in terminal.

Forward the create_ev event received on the in terminal out the prm terminal just prior to activating the just-created part instance

Desynchronize asynchronously completed part instance lifecycle events out the dsy terminal when the completion of the event results in the deactivation and destruction of the part instance.

Deactivate and destroy the part instance out the fac terminal and complete the pending create or destroy event out the in terminal when an event is received on the dsy terminal.

Translate get_first_ev and get_next_ev events received on the in terminal into get_first and get_next operations out the fac terminal.

2. External States

None.

3. Use Cases

4. Creating a Part Instance

This use case describes the actions taken by FAC when a create_ev event is received on the in terminal.

create_ev event is received on the in terminal.

FAC generates a create operation out its fac terminal

If the create operation is successful, FAC stores the part instance ID in the create_ev event and forwards the event out the prm terminal.

If the return status is successful, FAC generates an activate operation out its fac terminal.

If the return status is successful, FAC generates a lifecycle start event out its inst_lfc terminal with the same attributes as the create_ev event received on the in terminal.

If any part of this process fails, FAC deactivates and destroys the part instance and fails the create_ev event.

5. Destroying a Part Instance

This use case describes the actions taken by FAC when a destroy_ev event is received on the in terminal.

destroy_ev event is received on the in terminal.

FAC generates a lifecycle stop event out its inst_lfc terminal with the same attributes as the destroy_ev event received on the in terminal.

When the stop event completes, FAC deactivates and destroys the part instance out its fac terminal.

FAC completes the destroy_ev event.

Note: If for some reason, the part instance fails deactivation or destruction, FAC will not attempt to re-start or re-activate the part instance.

6. Enumerating Part Instances

This use case describes the enumeration of part instances.

FAC receives a get_first ev_event on its in terminal

FAC generates a get_first_operation out its fac terminal, stores the returned part instance ID and enumeration context into the event, and returns.

FAC receives one or more get_next_ev events on its in terminal.

FAC extracts the enumeration context from the event, generates a get_next operation out its fac terminal, stores the returned part instance ID and enumeration context into the event, and returns.

7. Asynchronous Completion of Part Instance Lifecycle

This use case describes the actions taken by FAC when a part instance asynchronously completes a lifecycle event that results in the deactivation and destruction or the part instance.

There are two situations where the asynchronous completion of a part instance lifecycle event will result in the deactivation and destruction of the part instance: asynchronous completion of lifecycle start event with a failed status and asynchronous completion of lifecycle stop event with a successful status.

### Asynchronous Failure of Lifecycle Start Event

FAC receives a create_ev on its in terminal and has created and activated the part instance.

FAC generates an asynchronous lifecycle start event out its inst_lfc terminal and the call returns ST_PENDING; FAC returns ST_PENDING for the create_ev.

At a later time, FAC receives the lifecycle start completion event on its inst_lfc terminal containing a failed status.

FAC forwards the lifecycle event out its dsy terminal and returns.

FAC receives the lifecycle event on its dsy terminal and proceeds to deactivate and destroy the part instance out its fac terminal followed by completing the pending create_ev event out its in terminal with the failed status.

### Asynchronous Completion of Lifecycle Stop Event with a Failed Status

FAC receives a destroy_ev on its in terminal.

FAC generates an asynchronous lifecycle stop event out its inst_lfc terminal and the call returns ST_PENDING; FAC returns ST_PENDING for the destroy_ev.

At a later time, FAC receives the lifecycle stop completion event on its inst_lfc terminal containing a successful status.

FAC forwards the lifecycle event out its dsy terminal and returns.

FAC receives the lifecycle event on its dsy terminal and proceeds to deactivate and destroy the part instance out its fac terminal followed by completing the pending destroy_ev event out its in terminal with the successful status.

### Typical Usage

1. Creating & Parameterizing Part Instances Based on Event Flow

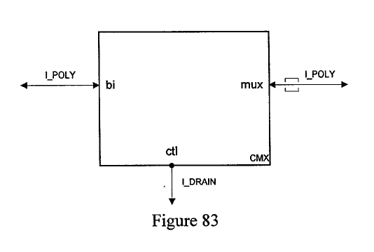

FIG. 83 illustrates an advantageous use of part, FAC—Factory

In this usage, FAC is assembled with PRM and ARR so that in addition to the standard lifecycle, newly created parts may also be parameterized using fields within the create event. A sequencer (SEQ) is used to forward the create and destroy events to FAC as well as to the part instance.

### System Startup

APP receives a lifecycle start event on its if c terminal and is directed to fac and therefore fac is ready to start accepting factory events.

### Instance Creation

APP receives a create event and is forwarded to seq. seq first sends the event out its out1 terminal and is received by fac. fac creates the part instance and stores the instance ID in the event bus. fac then sends the event out its prm terminal. p1 and p2 receive the event and generated property set operations as per their parameterization. fac then activates the part instance and sends a lifecycle start event to the part's lfc terminal. The lifecycle event completes successfully and fac completes the create event successfully. seq then forwards the create event to the part instance out its out2 terminal.

### Instance Destruction

APP receives a destroy event and is forwarded to seq. seq first sends the event out its out2 terminal and is received by the part instance. The event completes and then seq sends the event out its out1 terminal and is received by fac. fac generates a lifecycle stop event out its inst_lfc terminal and is received by the part instance's lfc terminal. The event completes successfully and fac proceeds to deactivate and destroy the part instance out its fac terminal and returns.

### System Shutdown

APP receives a lifecycle stop event on its if c terminal and is subsequently received by fac. fac enumerates the part instances out its fac terminal and for each instance found, generates a lifecycle stop event and then deactivates and destroys the instance. When all instances have been destroyed, fac completes the stop event.

2. Document References

None.

3. Unresolved Issues

None.

### CMX—Connection Multiplexer/De-multiplexer

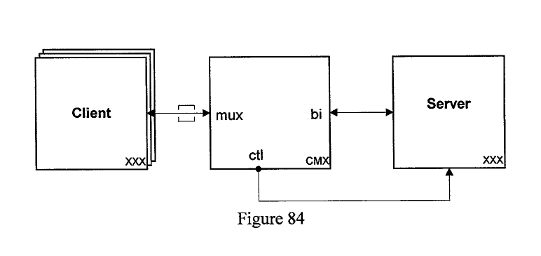

FIG. 84 illustrates the boundary of part, CMX—Connection Multiplexer/De-multiplexer

1. Functional Overview

CMX is a connectivity part that allows a single bidirectional terminal to be connected to multiple distinguishable bidirectional terminals and vice versa. Operations received on the bi terminal are forwarded out the mux terminal using a connection ID or an internally generated id stored in the operation bus. Operations received on the mux terminal are forwarded out the bi terminal with CMX stamping the connection id and optionally stamping an external connection context into the bus.

While CMX is active, it has the option to generate event requests out its ctl terminal when a connection is established and/or dissolved on its mux terminal. These requests provide the recipient with the ability to assign an external context to the connection, which can be used at a later time to process operation requests more efficiently.

CMX can be used to dispatch requests to one of many recipients (e.g., parts within a part array) or to connect multiple clients to a single server.

Both of CMX's input terminals are unguarded and may be invoked at interrupt time.

2. Boundary

2.1 Terminals

| Name | Dir | Interface | Notes |
|---|---|---|---|
| bi | bi | I_POLY | Operations received on this terminal are forwarded to |
| | | | the mux terminal. The connection is specified by a |
| | | | connection ID or an internally generated identifier |
| | | | stored in the operation bus. |
| mux | bi | I_POLY | Operations received on this tenninal are redirected to |
| | | | the bi terminal. CMX stamps a connection identifier |
| | | | and context into the operation bus before forwarding |
| | | | the operation. |
| | | | This is an “infinite cardinality” output-unlike a |
| | | | normal output terminal, it will accept any number of |
| | | | simultaneous connections. |
| | | | This terminal may be connected and disconnected while |
| | | | the part is active. |
| ctl | Out | I_DRAIN | Event requests are generated out this terminal when the |
| | | | mux terminal is connected and/or disconnected while |
| | | | CMX is active. |
| | | | This terminal may remain unconnected and may not be |
| | | | connected while the part is active. |

2.2 Properties

| Property name | Type | Notes |
|---|---|---|
| use_conn_id | uint32 | Boolean. When TRUE, CMX uses a connection ID |
| | | to dispatch operations received on the bi terminal |
| | | to the mux terminal. |
| | | When FALSE, CMX uses an internally generated id |
| | | stored in the operation bus to dispatch the call |
| | | (faster than when using the connection id). |
| | | Default is FALSE. |
| Id_offset | uint32 | Offset in operation bus for connection ID storage. |
| | | When use_conn_id is FALSE,it is assumed that |
| | | id_offset specifies the offset of a _ctx field in |
| | | the operation bus; otherwise it assumes that |
| | | id_offset specifies the offset of a DWORD field. |
| | | The default is 0. |
| conn_c tx_offset | uint32 | Offset in operation bus where the connection |
| | | context returned on ctl_connect_ev request is |
| | | stored for operations traveling from mux to bi. This |
| | | field must be properly aligned. |
| | | When the value is −1 and/or CMX's ctl terminal is |
| | | not connected, no context is stored in the bus. |
| | | The default is −1. |
| Ctl_connect_ev | uint32 | Event request to generate out ctl when a |
| | | connection on the mux terminal is established |
| | | (connected). |
| | | When the value is EV_NULL, no event is generated. |
| | | The default is EV_NULL. |
| ctl_disconnect_ev | uint32 | Event to generate out ctl when a connection on the |
| | | mux terminal is dissolved (disconnected). |
| | | When the value is EV_NULL no event is generated. |
| | | The default is EV_NULL. |
| ctl_bus_sz | uint32 | Size of event bus for connect and disconnect event |
| | | requests generated out the ctl terminal. |
| | | The value of this property must be at least as large |
| | | to accommodate storage for connection ID and |
| | | context as specified the ctl_id_offset and |
| | | ctl_conn_ctx_offset properties. |
| | | The default is 0. |
| Ctl_id_offset | uint32 | Offset in event bus for connection id storage. |
| | | When use_conn_id is FALSE, it is assumed that |
| | | ctl_id_offset specifies the offset of a _ctx field |
| | | in the operation bus; otherwise it is assumes that |
| | | Ctl_id_offset specifies the offset of a DWORD |
| | | field. Either field must be properly aligned. |
| | | When the value is −1, no ID is stored in the event |
| | | bus. |
| | | The default is −1. |
| Ctl_Conn_Ctx_offset | uint32 | Offset in event bus for connection context storage. |
| | | The recipient of the ctl_connect_ev request |
| | | provides the connection context and this context is |
| | | stamped into the bus of operations traveling from |
| | | mux to bi. The field must be properly aligned. |
| | | When the value is −1, no context is stored in the |
| | | event bus. |
| | | The default is −1. |

3. Events and notifications
3.1 Terminal: ctl

| Event | Dir | Bus | Notes |
|---|---|---|---|
| (Ctl_connect_ev) | out | any | CMX generates this request when a connection is |
| | | | established on its mux terminal. |
| | | | The event data may contain a connection identifier as |
| | | | specified by the use_conn_id property. |
| (Ctl_disconnect_ev) | out | any | CMX generates this request when a connection is |
| | | | dissolved on its mux terminal. |
| | | | The event data may contain a connection identifier as |
| | | | specified by the use_conn_id property and or a |
| | | | connection context that was returned with the |
| | | | ctl_connect_ev request. |

4. Environmental Dependencies

4.1 Encapsulated Interactions

None.

4.2 Other Environmental Dependencies

None.

5. Specification

6. Responsibilities

1. Forward operations received on bi to mux using the connection ID specified at id_offset when use_conn_id is TRUE.

2. Forward operations received on bi to mux using an internally generated connection id specified at id_offset when use_conn_id is FALSE.

3. Stamp connection ID as specified by use_conn_id into bus on operations traveling from mux to bi.

4. Stamp connection context into bus of operations traveling from mux to bi if conn_ctx_offset is not −1.

5. Generate event request out ctl terminal when a connection on mux terminal is established and the value of the ctl_connect ev property is not EV_NULL.

6. Generate event request out ctl terminal when a connection on mux terminal is dissolved and the value of the ctl_disconnect_ev property is not EV_NULL.

7. External States

None.

8. Use Cases

8.1 Mux Terminal Connection

This use case describes the actions taken by CMX when it receives a request to establish a connection on its mux terminal

If the value of the ctl_connect_ev property is EV_NULL or the ctl terminal is not connected, CMX establishes the connection and returns.

CMX allocates a ctl_connect_ev event request and if the use_conn_id property is TRUE, stores the actual connection ID at ctl_conn_id_offset; otherwise it stores an internally generated connection ID at ctl_conn_id_offset.

CMS sends the event out the ctl terminal. If the return status is not ST_OK, CMX fails the connect request with ST_REFUSE; otherwise CMX stores the connection context specified at ctl_conn_ctx_offset into the data for the connection and returns success.

8.2 Mux Terminal Disconnection

This use case describes the actions taken by CMX when it receives a request to dissolve a connection on its mux terminal.

If the value of the ctl_disconnect_ev property is EV_NULL or the ctl terminal is not connected, CMX dissolves the connection and returns.

CMX allocates a ctl_disconnect_ev event request and if the use_conn_id property is TRUE, stores the actual connection ID at ctl_conn_id_offset; otherwise it stores an internally generated connection ID at ctl_conn_id_offset. CMX also stores the connection context that was returned on ctl_connect_ev at ctl_conn_ctx_offset.

CMX sends the event out the ctl terminal. If the return status is not ST_OK, CMX displays output to the debug console, dissolves the connection, and returns ST_OK; otherwise it simply dissolves the connection and returns ST_OK.

8.3 De-multiplexing Operations

When CMX receives an operation on its bi terminal, it extracts the connection identifier stored at id_offset in the operation bus and interprets its value based on the value of its use_conn_id property. CMX selects the appropriate connection on its mux terminal and forwards the operation without modification.

8.4 Multiplexing Operations

When CMX receives on operation on its mux terminal, it performs the following actions before forwarding the operation to its bi terminal:

Stamps the connection identifier at id_offset based on the value of its use_conn_id property.

Stamps the connection context associated with the connection at conn_ctx_offset.

Forwards the operation to the bi terminal.

9. Typical Usage

9.1 Using CMX to Allow Connection of Multiple Clients to a Single Server

This example illustrates how CMX can be used to manage the connections between multiple clients and a single server component. It is assumed that the server is able to handle multiple sessions at a time.

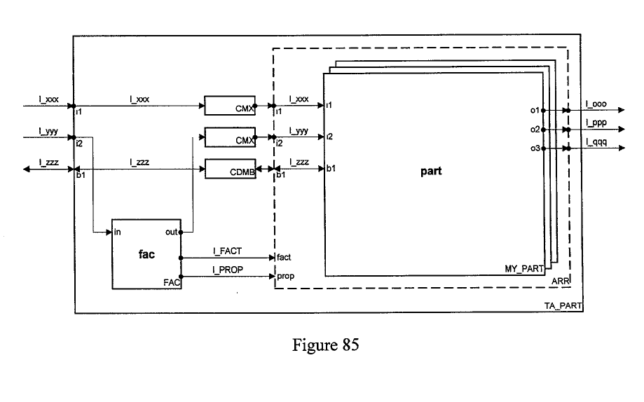

FIG. 85 illustrates an advantageous use of part, CMX—Connection Multiplexer/De-multiplexer

In the above scenario, CMX's use_conn_id property is set to FALSE. When a connection is established, CMX generates a connect request out its ctl terminal and the server returns a connection context that CMX is to stamp into the bus of operations received on that connection of the mux terminal. This gives the server the ability to quickly identify the client that originated an operation request it receives.

When CMX receives a request on its mux terminal, it stamps the connection identifier of the connection on which it received the call into the operation bus and stamps the connection context provided by the server and forwards the call out its bi terminal. When CMX receives a request on its bi terminal from the server, it extracts the connection identifier from the operation bus, resolves the mux terminal connection and forwards the operation.

When CMX receives a disconnect request, it generates an event request out its ctl terminal to allow the server to perform any necessary cleanup before the connection is dissolved.

9.2 Using CMX with the Dynamic Structure Framework

This example illustrates how CMX is used with the Dynamic Structure Framework parts. Its functionality is similar to that of CDMB.

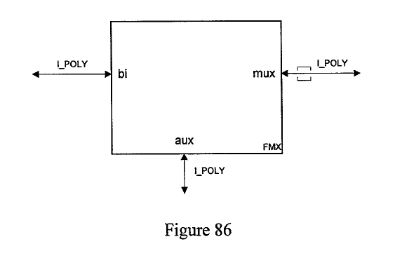

FIG. 86 illustrates an advantageous use of part, CMX—Connection Multiplexer/De-multiplexer

In the above scenario, CMX's use_conn_id property is set to TRUE. When a request is distributed to any of the part instances it carries an identifier that uniquely specifies the actual recipient (part instance (i.e., connection) ID). CMX extracts the identifier from the incoming request and dispatches the request to the corresponding part instance.

10. Document References

None.

11. Unresolved Issues

None.

### FMX—Fast Connection Multiplexer/De-multiplexer

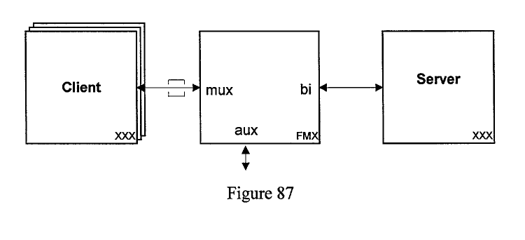

FIG. 87 illustrates the boundary of part, FMX—Fast Connection Multiplexer/De-multiplexer

1. Functional Overview

FMX is a connectivity part that allows a single bidirectional terminal to be connected to multiple distinguishable bi-directional terminals and vice versa. Operations received on the bi terminal are forwarded out the mux terminal using an externally generated ID (i.e., connection ID), provided that the ID is in a single pre-defined contiguous range (bit field). If for some reason, FMX is not able to dispatch the operation out the mux terminal (e.g., due to invalid ID or the ID is out of range), the incoming operation is forwarded out the aux terminal.

Operations received on the mux terminal are forwarded out the bi terminal with FMX optionally stamping the connection id into the bus. All operations received on the aux terminal are forwarded out the bi terminal without modification.

FMX can be used to quickly dispatch requests (by index rather than searching) to one of many recipients (e.g., parts within a part array) or to connect multiple clients to a single server.

All of FMX's input terminals are unguarded and may be invoked at interrupt time.

2. Boundary

2.1 Terminals

| Name | Dir | Interface | Notes |
|---|---|---|---|
| bi | bi | I_POLY | Operations received on this terminal are forwarded to |
| | | | the mux terminal. The connection is specified by a |
| | | | connection ID. |
| mux | bi | I_POLY | Operations received on this terminal are redirected to |
| | | | the bi terminal. |
| | | | If parameterized, FMX applies the reverse action of |
| | | | mask and shift to the connection ID and stamps it into |
| | | | the operation bus before forwarding the operation. |
| | | | This is an “infinite cardinality” output-unlike a normal |
| | | | output terminal, it will accept any number of |
| | | | simultaneous connections. |
| | | | If connections are established while the part is inactive, |
| | | | the id_xxx properties must have been set first. |
| | | | Otherwise connection may fail. FMX will fail |
| | | | activation if the id_xxx properties are changed after a |
| | | | connection is established. |
| aux | bi | I_POLY | Operations received on this terminal are redirected to |
| | | | the bi terminal. Non-dispatch-able operations received |
| | | | on the bi terminal are redirected out this terminal. |
| | | | This terminal may remain unconnected (floating) |

2.2 Properties

| Property name | Type | Notes |
|---|---|---|
| id_offset | uint32 | Specifies the offset in the operation bus for connection |
| | | ID storage. |
| | | FMX assumes that id_offset specifies the offset of a |
| | | DWORD field. |
| | | The default is 0. |
| id_mask | uint32 | Specifies a bit mask that is ANDED with the ID |
| | | stored at id_offset before determining if the ID is |
| | | within FMX's parameterized range. |
| | | The default is Oxffffffff. |
| id_shift | uint32 | Specifies the number of bits to shift the ID stored at |
| | | id_offset to the right. |
| | | The ID is shifted after the application of id_mask. |
| | | The default is 0. |
| id_base | uint32 | Specifies the base value of connection IDs for |
| | | operations to be dispatched out the mux terminal. |
| | | The default is 0. |
| n_conn | uint32 | Specifies the maximum number of connections that |
| | | can be established on the mux terminal. |
| | | Note: memory resources are allocated, which are |
| | | proportional to the number of connections. |
| | | The default is 1. |
| stamp_id | uint32 | Boolean. If TRUE, FMX stamps the connection ID into |
| | | the bus before forwarding operations received on mux |
| | | to bi. If FALSE, FMX forwards the operation without |
| | | modification. |
| | | The default is FALSE. |

3. Events and Notifications

None.

4. Environmental Dependencies

4.1 Encapsulated Interactions

None.

4.2 Other Environmental Dependencies

None.

5. Specification

5.1 Responsibilities

1. Reject attempts to connect the mux terminal if the specified connection ID is outside the range specified by id_base and n_conn or if a connection has already been established for that ID.

2. Apply id_mask and id_shift to connection IDs received on terminal operations before determining if the ID is in range.

3. Forward operations received on bi to mux using the connection ID specified at id_offset.

4. Apply id_mask and id_shift operations to the connection ID and verify that the resulting value is within range before forwarding operation out the mux terminal.

5. Forward operations received on bi out aux if the operation cannot be dispatched out mux (e.g., connection ID is out of range).

6. If stamp_id is TRUE, stamp connection ID into bus on operations traveling from mux to bi with the mask and shift applied (affecting only the bits for which id_mask is 1, preserving those that are 0 in id_mask).

7. Forward operations received on aux to bi without modification.

5.2 External States

None.

6. Use Cases

6.1 De-multiplexing Operations

When FMX receives an operation on its bi terminal, it extracts the connection identifier stored at id_offset in the operation bus, applies the id_mask and id_shift properties to the value, verifies that the resulting ID within range, selects the appropriate connection on its mux terminal and forwards the operation without modification.

If for some reason, FMX is unable to dispatch the operation out the mux terminal, it forwards the operation out the aux terminal. If the aux terminal is not connected, it returns ST_INVALID for the call.

6.2 Multiplexing Operations

When FMX receives an operation on its mux terminal, it performs the following actions before forwarding the operation to its bi terminal:

Applies the reverse action of id_mask and id_shift properties to the connection identifier if stamp_id is TRUE. The ID is shifted to the left the number of bits specified by id_shift. And the mask is applied in such a way that it affects only the bits for which id mask is 1, preserving those that are 0 in id_mask.

Stamps the connection identifier at id_offset if stamp_id is TRUE.

Forwards the operation to the bi terminal.

7. Typical Usage

7.1 Using FMX to Allow Connection of multiple Clients to a Single Server

This example illustrates how FMX can be used to manage the connections between multiple clients and a single server component. It is assumed that the server is able to handle multiple sessions at a time.

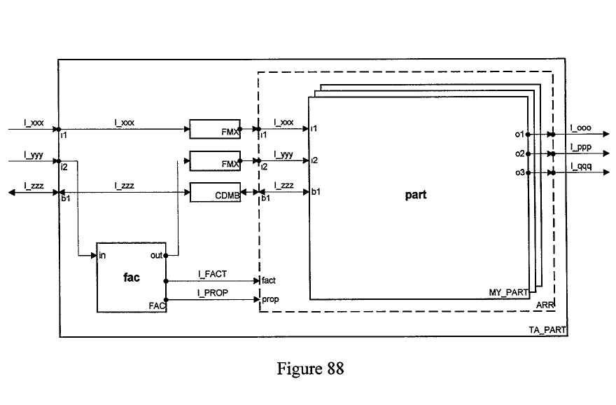

FIG. 88 illustrates an advantageous use of part, FMX—Fast Connection Multiplexer/De-multiplexer

In the above scenario, FMX's stamp_id property is set to TRUE.

When FMX receives a request on its mux terminal, it stamps the connection identifier of the connection on which it received the call into the operation bus and forwards the call out its bi terminal. When FMX receives a request on its bi terminal from the server, it extracts the connection identifier from the operation bus, resolves the mux terminal connection and forwards the operation.

7.2 Using FMX with the Dynamic Structure Framework

This example illustrates how FMX is used with the Dynamic Structure Framework parts. Its functionality is similar to that of CDMB and CMX.

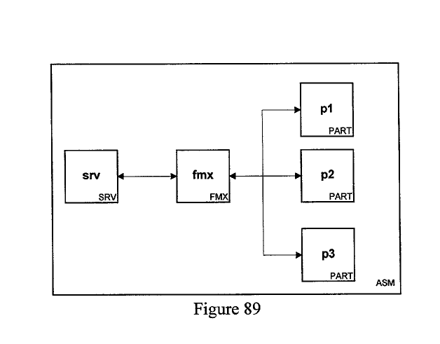

FIG. 89 illustrates an advantageous use of part, FMX—Fast Connection Multiplexer/De-multiplexer

In the above scenario, FMX's stamp_id property is set to FALSE. When a request is distributed to any of the part instances it carries an identifier that uniquely specifies the actual recipient (part instance (i.e., connection ID). FMX extracts the identifier from the incoming request and dispatches the request to the corresponding part instance.

7.3 Using FMX with Static Connection IDs

Please note, this typical usage requires the ability to explicitly specify connection IDs when connecting parts statically within an XDL assembly.

This example illustrates how FMX is used to multiplex/de-multiplex connections between statically assembled parts.

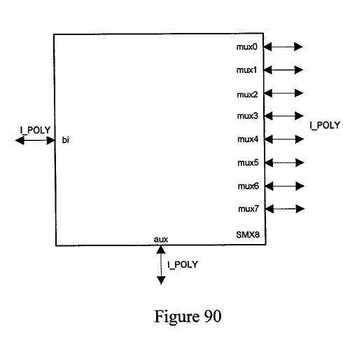

FIG. 90 illustrates an advantageous use of part, FMX—Fast Connection Multiplexer/De-multiplexer

This example is similar to the one previously described (using FMX to allow connection of multiple clients to single server) except that rather than the clients residing within an array, the clients are statically connected to FMX using unique connection IDs specified in the assembly's connection table.

The clients generate requests to FMX's mux terminal. FMX stamps the connection ID into the bus and forwards the operation to SRV. SRV does some stuff and then sends a response back to the client. FMX receives the response, extracts the ID and dispatches the operation to the specified client.

8. Document References

None.

9. Unresolved Issues

None.

### SMX8—Static Multiplexer/De-multiplexer

FIG. 91 illustrates the boundary of part, SMX8—Static Multiplexer/De-multiplexer

1. Functional Overview

SMX8 is a connectivity part that allows multiplexing a single bi-directional terminal through 8 bi-directional terminals based on a value within the operation bus.

Operations received on the bi terminal are forwarded through one of the muxX terminals based on the terminal index retrieved from the operation bus. If SMX8 is unable to dispatch the operation through one of the muxX terminals (e.g., due to a terminal index that is out of range), the incoming operation is forwarded out the aux terminal.

Operations received through one of the muxX terminals are forwarded through the bi terminal. Before forwarding the operation through bi, SMX8 stamps the corresponding terminal index into the operation bus. All operations received on the aux terminal are forwarded through the bi terminal without modification.

SMX8 is typically used to multiplex incoming operations from multiple parts to one recipient and then de-multiplex the operations back to their respective parts upon completion.

All of SMX8's input terminals are unguarded and may be invoked at interrupt time.

2. Boundary

2.1 Terminals

| Name | Dir | Interface | Notes |
|---|---|---|---|
| bi | i/o | I_POLY | Operations received through this terminal are forwarded |
| | | | through one of the muxX terminals (mux0 through mux7) |
| | | | based on the terminal index stored in the operation bus |
| | | | at the parameterized location. |
| mux0- | i/o | I_POLY | Operations received through these terminals are passed |
| mux7 | | | through the bi terminal. The corresponding terminal |
| | | | index is stamped in the bus at the parameterized |
| | | | location before the operation is forwarded through bi. |
| | | | These terminals may remain unconnected (floating). |
| aux | i/o | I_POLY | Operations received on this terminal are passed through |
| | | | the bi terminal without modification. Non-dispatchable |
| | | | operations received on the bi terminal are passed |
| | | | through this terminal without modification. |
| | | | This terminal may remain unconnected (floating). |

2.2 Properties

| Property name | Type | Notes |
|---|---|---|
| offset | uint32 | Specifies the offset in the operation bus where the |
| | | terminal index is stored (specified in bytes). |
| | | SMX8 assumes that offset specifies the offset of |
| | | a DWORD field. |
| | | The default is 0 (first field in the operation bus). |
| mask | uint32 | Specifies a bit mask that is ANDed with the |
| | | terminal index stored at offset before shifting it. |
| | | The default is OxFFFFFFFF (no change). |
| shift | uint32 | Specifies the number of bits to shift the terminal |
| | | index stored at offset. |
| | | The value at the offset field is shifted after the |
| | | application of mask and before multiplexing the |
| | | operation. |
| | | SMX8 always shifts the terminal indexes to the |
| | | right. |
| | | The default is 0 (no shift). |
| base | uint32 | Specifies the base value of the terminal indexes. |
| | | A value of(0 + base) identifies mux0, a value of(1 + |
| | | base) identifies mux1, ..., and a value of(7 + |
| | | base) identifies mux7. |
| | | The default is 0. |
| stamp_ndx | uint32 | Boolean. |
| | | Specifies whether to stamp the terminal index in |
| | | the operation bus for operations received through |
| | | the muxX terminals. |
| | | The default value is FALSE. |

3. Events and Notifications

None.

4. Environmental Dependencies

4.1 Encapsulated Interactions

None.

4.2 Other Environmental Dependencies

None.

5. Specification

5.1 Responsibilities

1. Forward operations received on bi through one of the muxX terminals (mux0 through mux7) using the terminal index specified by of f set.

2. Apply mask and shift operations to the terminal index in the incoming operation bus.

3. If specified, before forwarding through bi, stamp the terminal index into the operation bus for operations received on the muxX terminals with the specified mask and shift applied (affecting only the bits for which mask is 1, keeping those that are 0 in mask the same as previous).

4. Forward operations received through bi out aux if the operation cannot be dispatched through one of the muxX terminals (e.g., terminal index is out of range).

5. Forward operations received through aux to bi without modification.

5.2 External States

None.

6. Use Cases

6.1 De-multiplexing Operations

When SMX8 receives an operation through its bi terminal, it extracts the terminal index from the operation bus at offset, identifying which terminal to send the operation through. SMX8 then applies the mask and shift properties to the value and forwards the operation through the corresponding muxX terminal.

If the terminal index is out of range (or the corresponding muxX terminal is not connected), SMX8 forwards the operation through the aux terminal. If the aux terminal is not connected, SMX8 returns ST_NOT_CONNECTED.

6.2 Multiplexing Operations

When SMX8 receives an operation on one of its muxX terminals, it performs the following actions before forwarding the operation through the bi terminal:

SMX8 calculates a value to stamp into the operation bus by adding the terminal index to base. After the value to stamp is calculated, SMX8 ANDs (bitwise) it with the mask property value. Next, SMX8 ANDs (bitwise) the event field value with the complement of the mask property value. Finally, the two resulting values are ORed together. Below is the formula used by SMX8 to update the specified event field in the incoming event:

event field value=(event field value & ˜mask)|(value & mask)

SMX8 then forwards the operation through the bi terminal.

7. Typical Usage

7.1 Using SMX8 to Distribute Events Among Multiple Parts

This example illustrates how SMX8 can be used to forward events among multiple parts.

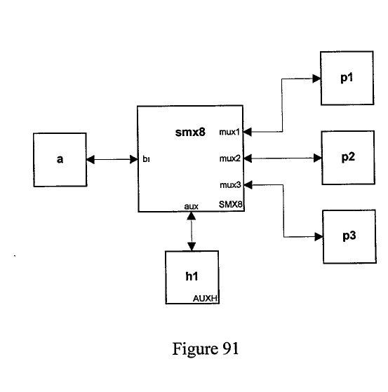

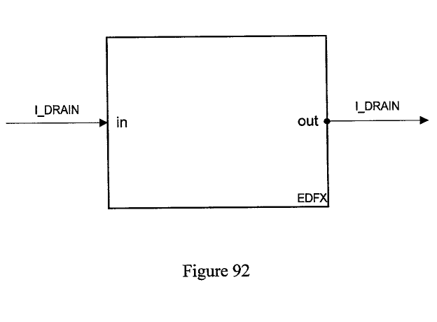

FIG. 92 illustrates an advantageous use of part, SMX8—Static Multiplexer/De-multiplexer

Above, smx8 receives an event from p1 intended for part a through the mux1 terminal. smx8 stamps a multiplex context in the event bus identifying the terminal and then forwards the event through bi to a. At a later time, smx8 receives the completion of this event from a through bi and de-multiplexes (based on the multiplex index stamped by smx8) the event to p1 through mux1.

8. Document References

None.

9. Unresolved Issues

None.

### EDFX—Extended Data Field Extractor

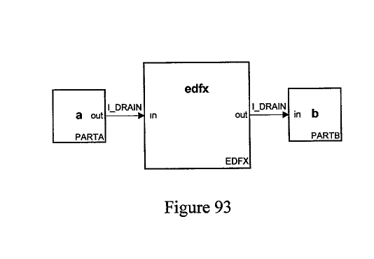

FIG. 93 illustrates the boundary of part, EDFX—Extended Data Field Extractor

1. Functional Overview

EDFX is a data manipulation part that extracts a value from the incoming event and stores it into another location in the same event. The location of the value to extract and the target storage are parameterized through properties.

EDFX modifies the data value before storing it in the event using a bit-wise AND mask and by performing a SHIFT operation on the data. The place from which the value is extracted is either in the body of the event or specified by a reference pointer placed in the event body.

The size of the source data may be 1, 2, 3 or 4 bytes long and can be in various byte orders (i.e., MSB first, LSB first or the processor native byte order).

The target storage is always in the event body, 4 bytes aligned and in native byte order.

EDFX is typically used to extract values from event data and store it in a native processor format in the event body, so the value can be processed by another part.

EDFX is not guarded and may be used in interrupt contexts.

2. Boundary

2.1 Terminals

| Name | Dir | Type | Notes |
|---|---|---|---|
| in | in | I_DRAIN | Data is extracted from events received on this terminal (as |
| | | | specified by EDFX's properties) and stamped into another |
| | | | location in the event before or after the event is forwarded to |
| | | | the out terminal. |
| out | out | I_DRAIN | Events received from the in terminal are passed through this |
| | | | terminal either before or after the data has been extracted from |
| | | | the event. |

2.2 Properties

| Property name | Type | Notes |
|---|---|---|
| stg.off | uint32 | Specifies the location in the incoming event |
| | | into which the extracted value is to be stamped. |
| | | The size of the value stamped is 4 bytes (size |
| | | of DWORD). The data in the event may be |
| | | unaligned. |
| | | Default is 0 (first field in event). |
| val.offs | uint32 | Specifies the location of the value in the |
| | | incoming event that EDFX should extract |
| | | (specified in bytes). This value specifies the |
| | | offset from beginning of event from which to |
| | | extract the field. If val.by_ref is TRUE, this |
| | | value determines the offset into the buffer at |
| | | which the field is to be extracted. The data in |
| | | the event may be unaligned. |
| | | Default is 4. |
| val.sz | uint32 | Specifies the size of the value field in the |
| | | incoming event identified by val.offs (specified |
| | | in bytes). The size can be one of the following: |
| | | 1, 2, 3, or 4. |
| | | Default is 4 (size of DWORD). |
| val.order | sint32 | Specifies the byte order of the field (identified |
| | | by val.offs) in the incoming event. Can be one |
| | | of the following values: |

| | |
|---|---|
| 0 | Native machine format |
| 1 | MSB—Most-significant byte first |
| | (Motorola) |
| −1 | LSB—Least-significant byte first (Intel) |

| | | |
|---|---|---|
| | | Default is 0 (Native machine format). |
| val.sgnext | bool32 | Boolean. |
| | | If TRUE, values smaller than 4 bytes are sign |
| | | extended before the value is operated on using |
| | | val.mask and val.shift properties. |
| | | The default is FALSE. |
| val.mask | uint32 | Mask that is bit-wise ANDed with the field |
| | | value before being stored. |
| | | Default is 0xFFFFFFFF (no change). |
| val.shift | sint32 | Number of bits to shift the field value before |
| | | being stored. If the value is >0, the value is |
| | | shifted to the right. If the value is <0, the value |
| | | is shifted to the left. |
| | | Default is 0 (no change) |
| val.by_ref | bool32 | Boolean. |
| | | If TRUE, the extracted value is identified by a |
| | | reference pointer contained within the event. |
| | | The offset of the reference pointer is specified |
| | | by the val.ptr_offs property. |
| | | If FALSE, the value is contained within the |
| | | event. The offset to value is specified by |
| | | val.offs property. The default value is FALSE |
| | | (the value is contained within the event). |
| val.ptr_offs | uint32 | When the val.by_ref property is TRUE, |
| | | val.ptr_offs specifies the location (in the |
| | | incoming event) of the pointer to the buffer |
| | | containing the value that EDFX extracts. The |
| | | extracted value is placed at val.offs offset from |
| | | the beginning of the specified buffer. |
| | | The default value is 4 (second field of the |
| | | event). |
| extract_first | bool32 | Boolean. |
| | | If TRUE, the data value is extracted before |
| | | the event is passed to the out terminal; |
| | | otherwise the data value is extracted after the |
| | | event is passed to the out terminal. |
| | | Default is TRUE. |
| set_first | bool32 | Boolean. If TRUE, the data value is stored |
| | | before the event is passed to the out terminal. |
| | | This property is valid only when extract_first |
| | | is TRUE; otherwise it is ignored. |
| | | Default is TRUE. |

3. Events and Notifications

| | | | |
|---|---|---|---|
| Event | Dir | Bus | Notes |

3.1 Terminal: in

| | | | |
|---|---|---|---|
| any | in | any | Data event. |
| | | | Values are extracted from events received |
| | | | through this terminal and stamped into the |
| | | | event body. The event is then forwarded |
| | | | through the out terminal. |

3.2 Terminal: out

| | | | |
|---|---|---|---|
| any | out | any | Data event. |
| | | | Values are extracted from events received |
| | | | through in and stamped into the event |
| | | | body. The event is then forwarded through |
| | | | this terminal. |

4. Environmental Dependencies

4.1 Encapsulated Interactions

None.

4.2 Other Environmental Dependencies

None.

5. Specification

5.1 Responsibilities

Extract the parameterized data field from the incoming event using the calculated offset either before or after forwarding the event through out as specified by the extract_first property.

Stamp the parameterized data field into the outgoing event using the calculated offset either before or after forwarding the event through out as specified by the set_first property.

Sign extend data values with size less than 4 bytes when val.sgnext property is TRUE.

Modify the extracted value as specified by the val.mask and val.shift properties.

5.2 External States

None.

6. Use Cases

6.1 Extracting a Value Contained in the Event Body

EDFX is parameterized to extract a value from the event body (val.by_ref is FALSE) starting at an offset specified by val.offs. EDFX receives an event on its in terminal and extracts the value from the event at offset val.offs. EDFX stamps this value into the event at the location specified by stg.offs and forwards the event through the out terminal.

6.2 Extracting a Value by Reference

EDFX is parameterized to extract a value from a buffer referenced by a field in the event (val.by_ref is TRUE). EDFX receives an event on its in terminal and calculates the pointer to the buffer at offset val.ptr_offs. EDFX extracts the value from the buffer at offset val.offs. EDFX stamps this value into the event at the location specified by stg.offs and forwards the event through the out terminal.

6.3 Modification of the Value to be Stamped

After the value is extracted like in one of the use cases above, the following operations can be performed on it before it is stamped into the event:

1. The value's byte order is converted (val.order).

2. If needed, the value is sign-extended (val.sngext).

3. The value is masked (val.mask)

4. The value is shifted (val.shift)

The value is then stamped into the event at offset val.offs.

7. Typical Usage

7.1 EDFX Extracting and Stamping an Unsigned Integer

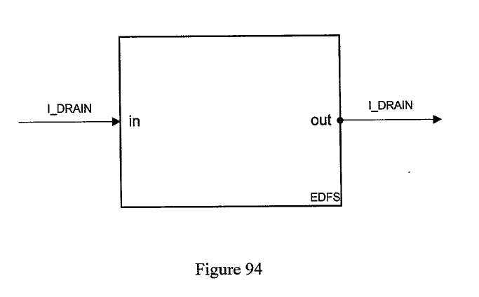

FIG. 94 illustrates an advantageous use of part, EDFX—Extended Data Field Extractor

In this example, part a generates an event intended for part b. Part a stamps a 16-bit unsigned integer into a particular location in the event. Part b needs this value but is designed to extract the value from a different location in the event. Additionally, part b only needs the least significant 8 bits of the value. Part a sends the event to edfx through its in terminal. edfx extracts the unsigned integer from the event in the original location, masks out the last 8 bits, and stamps it into the event at the location from which bis designed to extract the value. edfx then forwards the event to part b through the out terminal.

8. Document References

None.

9. Unresolved Issues

None.

### EDFS—Extended Data Field Stamper

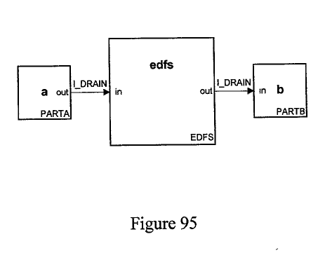

FIG. 95 illustrates the boundary of part, EDFS—Extended Data Field Stamper

1. Functional Overview

EDFS is a data manipulation part that extracts a value from the incoming event and stores it into another location in the same event. The location of the value to extract and the target storage are parameterized through properties.

EDFS modifies the data value before storing it in the event using a bit-wise AND mask and by performing a SHIFT operation on the data. The place from which the value is extracted must be contained in the body of the event, 4 bytes aligned and in native byte order.

The size of the source data may be 1, 2, 3 or 4 bytes long and can be in various byte orders (i.e., MSB first, LSB first or the processor native byte order).

The target storage is either in the event body or specified by a reference pointer placed in the event body. The target storage may be unaligned.

EDFS is typically used to extract values from event data and store it in a native processor format in the event body, so the value can be processed by another part.

EDFS is not guarded and may be used in interrupt contexts.

2. Boundary

2.1 Terminals

| Name | Dir | Type | Notes |
|---|---|---|---|
| in | in | I_DRAIN | Data is extracted from events received on this |
| | | | terminal (as specified by EDFS's properties) and |
| | | | stamped into another location in the event before |
| | | | or after the event is forwarded to the out terminal. |
| out | out | I_DRAIN | Events received from the in terminal are passed |
| | | | through this terminal either before or after the |
| | | | data has been extracted from the event. |

2.2 Properties

| Property name | Type | Notes |
|---|---|---|
| stg.offs | uint32 | Specifies the location of the value in the |
| | | incoming event that EDFS should extract |
| | | (specified in bytes). The size of this field must |
| | | be size of uint32. The storage location in the |
| | | event must be aligned. This property is |
| | | mandatory. |
| val.offs | uint32 | Specifies the location in the incoming event |
| | | where the extracted value is stamped. The |
| | | location where to stamp the value may be |
| | | unaligned. This property is mandatory. |
| val.sz | uint32 | Specifies the size of the value field in the |
| | | incoming event identified by val.offs (specified |
| | | in bytes). The size can be one of the following: |
| | | 1, 2, 3, or 4. |
| | | The default value is 4 (size of DWORD) |
| val.order | sint32 | Specifies the byte order of the field (identified |
| | | by val.offs) in the incoming event. Can be one |
| | | of the following values: |

| | |
|---|---|
| 0 | Native machine format |
| 1 | MSB—Most-significant byte first |
| | (Motorola) |
| −1 | LSB—Least-significant byte first (Intel) |

| | | |
|---|---|---|
| | | The default value is 0 (Native machine format). |
| val.mask | uint32 | Mask that defines which portions of the |
| | | destination value can be modified by EDFS. |
| | | Bits in the mask with a value of 1 define the |
| | | bits that can be modified by EDFS in the |
| | | destination value. All other bits remain the |
| | | same. The default value is 0xFFFFFFFF |
| | | (modify the entire value). |
| val.shift | sint32 | Number of bits to shift the field value before |
| | | being stored. If the value is >0, the value is |
| | | shifted to the right. If the value is <0, the value |
| | | is shifted to the left. The default value is 0 (no |
| | | change) |
| val.by_ref | uint32 | Boolean. |
| | | If TRUE, the location in the incoming event |
| | | where the extracted value is stamped is |
| | | identified by a reference pointer contained |
| | | within the event. The offset of the reference |
| | | pointer is specified by the val.ptr_offs |
| | | property. If FALSE, the location is contained |
| | | within the event. The offset to value is |
| | | specified by val.offs property. The default |
| | | value is FALSE (the location is contained |
| | | within the event). |
| val.ptroffs | uint32 | When the val_by ref property is TRUE, |
| | | val.ptr_offs specifies the location (in the |
| | | incoming event) of the pointer to the buffer |
| | | where the extracted value is stamped. The |
| | | extracted value is placed at val.offs offset from |
| | | the beginning of the specified buffer. |
| | | The default value is 0 (first field of the event). |
| get_first | uint32 | Boolean. If TRUE, the value is extracted before |
| | | the event is passed to the out terminal; |
| | | otherwise the value is extracted after the event |
| | | is passed to the out terminal. |
| | | The default value is TRUE. |
| stamp_pre | uint32 | Boolean. If TRUE, the value is stamped in the |
| | | event before the event is passed to the out |
| | | terminal; otherwise the value is stamped after |
| | | the event is passed to the out terminal. |
| | | The default value is TRUE. |

3. Events and Notifications

| | | | |
|---|---|---|---|
| Event | Dir | Bus | Notes |

3.1 Terminal: in

| | | | |
|---|---|---|---|
| any | in | any | Data event. |
| | | | Values are extracted from events received |
| | | | through this terminal and stamped into the |
| | | | same event. The event is then forwarded |
| | | | through the out terminal. |

3.2 Terminal: out

| | | | |
|---|---|---|---|
| any | out | any | Data event. |
| | | | Values are extracted from events received |
| | | | through in and stamped into the same |
| | | | event. The event is then forwarded |
| | | | through this terminal. |

4. Environmental Dependencies

4.1 Encapsulated Interactions

None.

4.2 Other Environmental Dependencies

None.

5. Specification

5.1 Responsibilities

Extract the parameterized data field from the incoming event using the specified offset either before or after forwarding the event through out as specified by the get_first property.

Stamp the parameterized data field into the outgoing event using the calculated offset either before or after forwarding the event through out as specified by the stamp_pre property.

Convert the value based on the parameterized byte order.

Modify the extracted value as specified by the val. mask and val.shift properties.

5.2 External States

None.

6. Use Cases

6.1 Stamping a Value in the Event Body

EDFS is parameterized to extract a value from the event body starting at an offset specified by stg.offs. EDFS receives an event on its in terminal and extracts the value from the event at offset stg.offs. EDFS stamps this value into the event at the location specified by val.offs and forwards the event through the out terminal. This case simply moves one field in an event into a different field contained within the same event.

6.2 Stamping a Value in a Reference Pointer

EDFS is parameterized to extract a value from the event body starting at an offset specified by stg.offs. EDFS receives an event on its in terminal and calculates the pointer to the value at offset stg.offs. EDFS extracts the value from the event and stamps this value into the reference pointer identified by the val.ptr_off s property (the val. offs property is also used to stamp the value into an offset into the reference pointer). EDFS then forwards the event through the out terminal.

6.3 Modification of the Value to be Stamped

After the value is extracted like in one of the use cases above, the following operations can be performed on it before it is stamped into the event:

1. The value is masked (val.mask)

2. The value is shifted (val.shift)

3. The value's byte order is converted (val.order).

The value is then stamped into the event at the specified offset.

7. Typical Usage

7.1 EDFS Extracting and Stamping an Unsigned Integer

FIG. 96 illustrates an advantageous use of part, EDFS—Extended Data Field Stamper

In this example, part a generates an event intended for part b. Part a stamps a 16-bit unsigned integer into a particular location in the event. Part b needs this value but is designed to extract the value from a different location in the event. Additionally, part b only needs the least significant 8 bits of the value. Part a sends the event to EDFS through its i n terminal. EDFS extracts the unsigned integer from the event in the original location, masks out the last 8 bits, and stamps it into the event at the location from which bis designed to extract the value. EDFS then forwards the event to part b through the out terminal.

8. Document References

None.

9. Unresolved Issues

None.

Portions of the present invention may be conveniently implemented using a conventional general purpose or a specialized digital computer or microprocessor programmed according to the teachings of the present disclosure, as will be apparent to those skilled in the computer art.

### Advantages of the Invention

As described herein, the present invention has many advantages over the previous prior art systems. The following list of advantages is provided for purposes of illustration, and is not meant to limit the scope of the present invention, or imply that each and every possible embodiment of the present invention (as claimed) necessarily contains each advantageous feature.

1. The present invention provides a system of reusable and composable objects that manipulate individual aspects of event and data processing, so that components and systems performing complex processing can be assembled by interconnecting these objects.

2. The present invention provides a reusable object that has arbitrary set of properties that can be modified after the object is instantiated. The object provides two independent but complementary mechanisms for accessing the properties, making it possible for designers to utilize the appropriate mechanism.

3. The present invention provides a reusable object that when used as a subordinate object in an assembly, can hold a set of properties of the assembly that no other subordinate has, allowing that set to be arbitrarily defined by the assembly designer.

4. The present invention provides reusable container objects for holding data items. The set of data items held can be defined either by a designer at design time or may be defined at runtime.

5. The present invention provides a reusable object for transferring properties or data items from one object to another.

6. The present invention provides a system of reusable objects that convert variously encoded data fields to and from the native machine format. These objects allow separation of the data encoding from the processing of data, allowing usage of the same data processing objects with variously encoded data, including data received or to be sent to network or other systems.

7. The present invention provides a system of reusable objects that provide the capability of assemblies to keep assembly-specific instance data and store, retrieve and otherwise manipulate that instance data, based on data and events that pass through these parts.

8. The present invention provides a system of reusable objects for copying fields from data passing through these objects to and from instance data kept by the objects.

9. The present invention provides a system of reusable objects for manipulating data in events passing through these objects.

10. The present invention provides a reusable object for distributing and generating events based on the count of events received by that object.

11. The present invention provides reusable objects that facilitate the life cycle—creation, parameterization, serialization and destruction—of dynamically created components.

12. The present invention provides a reusable object for generating a predetermined event upon receiving an event.

### Limits of the Implementation

The following list outlines the limitations of an embodiment of the inventive objects, none of which is necessary for practicing the present invention as claimed herein and none of which is necessarily preferred for the best mode of practicing the invention. Moreover, none of the following should be viewed as a limitation on means envisioned in the claims for practicing the invention as outlined herein above and below:

1. The parts are built for the Z-force object-composition engine used in the Dragon system, and thus can be used directly only with that system. As a result, the parts are Dragon component objects. The reason for choosing that system for the preferred embodiment is that, to inventors best knowledge, it is the best composition-based system applicable in a wide area of applications that does not sacrifice performance.

2. The inventive parts identify object classes, terminals and properties by names (text strings). Other identification mechanisms include without limitation, Microsoft COM GUID, integer values, IEEE 802.3 Ethernet MAC addresses, etc. The reason for using names is that the Dragon system uses names to identify these entities, which makes it easy for practitioners to remember and use.

3. The inventive parts interact with each other through terminals. The reason for choosing this mechanism is that this is the preferred mechanism for such interactions in the Dragon system. Other mechanisms for connecting parts (or objects) may be employed.

The following Appendix further describes preferred implementation of interfaces.

### Appendix 1—Interfaces

This appendix describes preferred definition of interfaces used by parts described herein.

### I_POLY—Universal Polymorphic Bus-based Interface

### Overview

The universal polymorphic bus-based interface is a generic v-table interface that can be used in place of any specific interface (e.g., I_PROP) provided that there are 64 or less operations.

Parts whose functionality is completely independent of the operations being invoked typically expose this interface.

List of Operations

| Name | Description |
|---|---|
| op1 | operation #1 |
| op2 | operation #2 |
| . | |
| . | |
| . | |
| op64 | operation #64 |

### I_DRAIN—Event Drain

### Overview

The Event Drain interface is used for event transportation and channeling. The events are carried with event ID, size, attributes and any event-specific data. Implementers of this interface usually need to perform a dispatch on the event ID (if they care).

Events are the most flexible way of communication between parts; their usage is highly justified in many cases, especially in weak interactions. Examples of usage include notification distribution, remote execution of services, etc.

Events can be classified in three groups: requests, notifications and general-purpose events. The events sent through this interface can be distributed synchronously or asynchronously. This is indicated by two bits in the attr member of the bus.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. In a software system including a standard mechanism for accessing properties, the standard mechanism including:
a first operation for obtaining a property identifier;
a second operation for obtaining a property value; and
a third operation for setting the property value,
an object comprising:
a property, the property comprising a property identifier and a property value;
an implementation of the first operation;
an implementation of the second operation; and
an implementation of the third operation, the implementation of the third operation setting both the property identifier and the property value if the third operation is executed for a first time, and changing the property value to a specified new property value if the third operation was previously executed.

2. The object according to claim 1 wherein the property further comprises a property type and wherein the implementation of the third operation sets the property type in the first entry if the value for the first property has been previously set, the implementation of the third operation sets the property type in the first entry in the table if the value for the first property has not been set.

3. In a software system including a standard mechanism for accessing properties of objects, the standard mechanism including:
a first operation for enumerating property identifiers;
a second operation for obtaining a property value of a property identified by a property identifier; and
a third operation for setting the property value of a property identified by a property identifier,
an object comprising:
a table containing a plurality of entries, each entry comprising a property identifier and a property value;
an implementation of the first operation, the implementation of the first operation retrieving a first property identifier of a first property from one of the entries in the table;
an implementation of the second operation, the implementation of the second operation obtaining the property value from the one entry;
an implementation of the third operation, the implementation of the third operation setting a property value in the one entry if a value for the first property has been previously set, the implementation of the third operation setting a property identifier and a property value in the one entry in the table if a value for the first property has not been set.

4. The object according to claim 3 wherein the each entry further comprises a property type and wherein the implementation of the third operation sets the property type in the first entry if the value for the first property has been previously set, the implementation of the third operation sets the property type in the first entry in the table if the value for the first property has not been set.

5. The object in claim 3 further comprising a terminal through which properties are accessed and their values from the first table.

6. A copier object in a software system, the copier object comprising:
a first terminal through which the copier object requests enumeration of property identifiers;
a second terminal through which the copier object requests obtaining property values;
a third terminal through which the copier object requests setting property values;
a fourth terminal through which the copier object request receipt of a trigger signal, and upon receipt of the trigger signal the copier object obtains a first property name identifier through the first terminal, through which the copier object requests obtaining a first property value using the first property identifier through the second terminal, and through which the copier object requests setting the first property value using the first property identifier through the third terminal.

7. A system of objects in a software system having a data memory, the system comprising:
an extractor object for extracting first encoded values from the data memory and storing them in the data memory in native machine format;
a stamper object for storing second encoded values into the data memory, the second encoded values obtained from the data memory in native machine format.

8. The system in claim 7 the system wherein the data memory is an event object.

9. A system of objects in a software system, the system comprising:
a container object for storing a plurality of data values;
an extractor object for extracting encoded data from data memory and storing the encoded data in the container object;
a stamper object for obtaining the plurality of data values from the container object and storing them as encoded data in the data memory.

10. The system in claim 9 further comprising a comparator object for comparing a first data value of encoded data from the data memory to a second data value from the container object and sending a reference to the data memory to a first terminal if the first value is less than the second value, to a second terminal if the first value is equal to the second value, and to a third terminal if the first value is greater than the second value.

11. The system in claim 9 wherein the data memory is an event object.

12. The system in claim 10 wherein the data memory is an event object.

13. The system in claim 9 further comprising an arithmetic-logic-unit object for performing arithmetic operations on data values in the container object.

14. A method in a composition-based software system for transferring data values in event objects, the method comprising the steps of:
extracting a first value from a first event object;
storing the first value into a container object;
loading the first value from the container object;
storing the first value into a second event object.

15. The method of claim 14 further comprising the step of modifying the first value in the container object.

16. The method of claim 14 wherein the first event object and the second event object are the same event object.

17. A method in a composition-based software system for manipulating encoded data values in event objects, the method comprising the steps of:
extracting a first value from a first data field of a first event object;
decoding the first value into a normalized form;
storing the first value into a second data field of the first event object;
performing an operation that modifies the first value in the second data field, resulting in a second value being stored in the second data field;
loading the second value from the second data field;
storing the second value into the first data field.

18. A system of interconnected objects in a software system, the system comprising:
an extractor object for extracting a first value from a first data field in a first event object and storing it into a second data field in the first event object;
a modifier object for modifying the second data field;
a stamper object for loading a second value from the second data field and storing it into a third data field in the first event object.

19. An object in a software system, the object comprising:
a first terminal through which the object receives a source event;
a first offset property specifying starting offset in the source event;
a size property specifying size in the source event;
a second offset property specifying starting offset for merging;
a reference to a data memory for storing a data portion from the source event, starting from offset specified by the offset property and of size specified by the size property;
a second terminal through which the object receives a merge event;
a third terminal through which the object sends the merge event, the merge event modified by storing the data portion into the merge event at offset specified by the second offset property.

20. The object in claim 19 wherein the first terminal and the second terminal are the same terminal.

21. An object in a software system, the object comprising:
an input terminal through which the object receives an input event;
a first output terminal through which the object sends an event containing a first portion of the input event;
a second output terminal through which the object sends an event containing a second portion of the input event;
a first property specifying the size of the first portion.

22. An object in a software system, the object comprising:
a first input terminal through which the object receives a latch event;
a second input terminal through which the object receives a trigger event;
a field for storing a reference to the latch event when received on the first input terminal;
an output terminal through which the object sends the latch event when the trigger event is received through the second input terminal.

23. An object in a software system, the object comprising:
an input terminal through which the object receives a first input signal;
an output terminal through which the object sends the first input signal;
a factory terminal through which the object requests the creation a new object instance when the object receives the first input signal;
a property terminal through which the object requests the setting of properties on the new object instance.

24. The object in claim 23 further comprising a parameterization terminal through which the object sends a parameterization signal so that an external object can parameterize the new object instance.

25. A system of interconnected objects in a software system, the system of interconnected objects comprising:
a factory object for receiving creation and destruction events;
a dynamic container object for containing objects created by the factory object.

26. An object in a software system, the object comprising:
an input terminal through which the object receives events;
a property specifying a target number of events;
a field for maintaining a count of events received through the input terminal;
a first output terminal through which the object sends events received through the input terminal when the count of events reaches the target number.

27. The object in claim 26 further comprising a reset terminal through which the object receives a request to reset the count to zero.

28. The object in claim 26 further comprising a second output terminal through which the object sends events received through the input terminal when the count of events is under the target number.
